(19) United States
(12) Patent Application Publication
(10) Pub. No.: US 2014/0024527 A1
(43) Pub. Date: Jan. 23, 2014

(54) HERBICIDAL PYRAZINONES

(71) Applicant: Thomas Martin Stevenson, Newark, DE (US)

(72) Inventor: Thomas Martin Stevenson, Newark, DE (US)

(73) Assignee: E I DU DE NEMOURS AND COMPANY, Wilmington, DE (US)

(21) Appl. No.: 14/005,412

(22) PCT Filed: Mar. 29, 2012
(86) PCT No.: PCT/US2012/031189

§ 371 Date: Sep. 16, 2013

Related U.S. Application Data
(60) Provisional application No. 61/480,059, filed on Apr. 28, 2011.

(51) Int. Cl. A01N 43/60; A01N 43/76; A01N 43/66; A01N 43/78

(52) U.S. Cl. CPC A01N 43/60; A01N 43/78; A01N 43/76; A01N 43/66
USPC 504/103; 544/408; 504/136; 504/235; 544/405; 544/219; 504/133; 504/230; 544/295; 504/243; 504/134

(57) ABSTRACT

Disclosed are compounds of Formula 1, including all stereoisomers, N-oxides, and salts thereof,

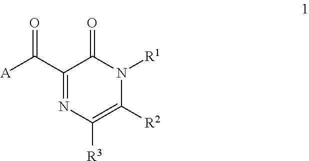

wherein
A is a radical selected from the group consisting of

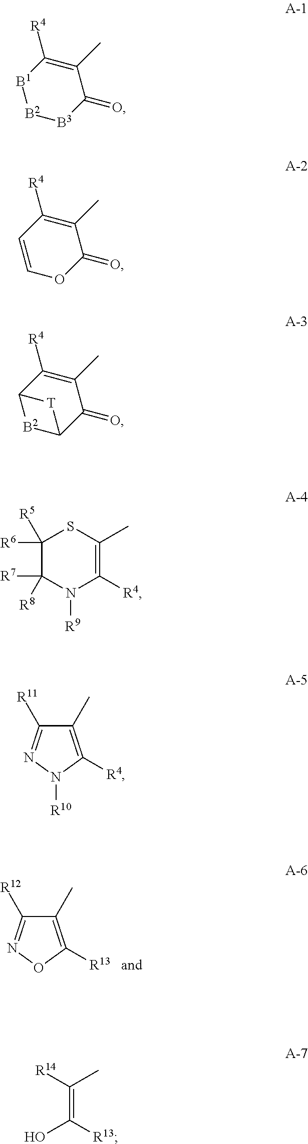

and B¹, B², B³, T, R¹, R² R³, R⁴, R⁵, R⁶, R⁷, R⁸, R⁹, R¹⁰, R¹¹, R¹², R¹³ and R¹⁴ are as defined in the disclosure. Also disclosed are compositions containing the compounds of Formula 1 and methods for controlling undesired vegetation comprising contacting the undesired vegetation or its environment with an effective amount of a compound or a composition of the invention. Also disclosed are compounds useful as intermediates for preparing compounds of Formula 1.

### FIELD OF THE INVENTION

This invention relates to certain pyrazinones, their salts and compositions, processes and intermediates for their preparation, and methods of their use for controlling undesirable vegetation.

### BACKGROUND OF THE INVENTION

The control of undesired vegetation is extremely important in achieving high crop efficiency. Achievement of selective control of the growth of weeds especially in such useful crops as rice, soybean, sugar beet, maize, potato, wheat, barley, tomato and plantation crops, among others, is very desirable. Unchecked weed growth in such useful crops can cause significant reduction in productivity and thereby result in increased costs to the consumer. The control of undesired vegetation in noncrop areas is also important. Many products are commercially available for these purposes, but the need continues for new compounds that are more effective, less costly, less toxic, environmentally safer or have different sites of action. U.S. Patent Publication US 2010/0298372 A1 discloses a genus of compounds broadly including pyrazinones as gamma secretase modulators, but this reference does not disclose the present pyrazinones or their utility as herbicides.

### SUMMARY OF THE INVENTION

This invention is directed to compounds of Formula 1 (including all stereoisomers), N-oxides, and salts thereof, agricultural compositions containing them and their use as herbicides:

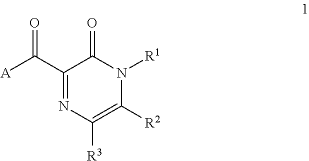

wherein
A is a radical selected from the group consisting of

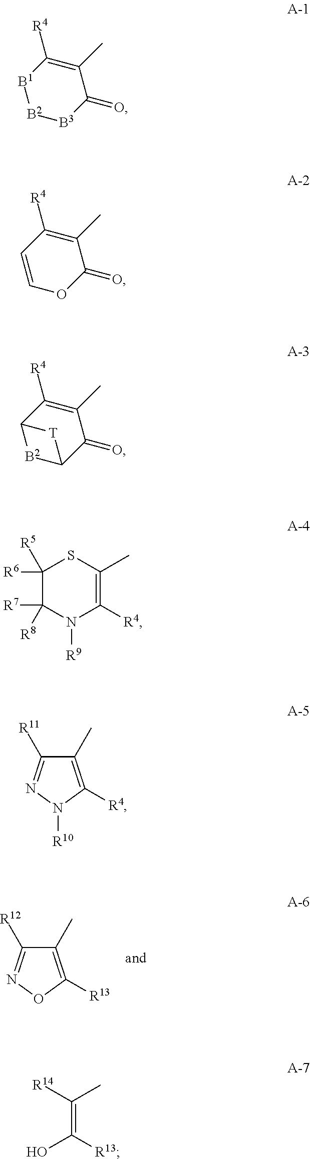

B¹ and B³ are each independently a radical selected from the group consisting of

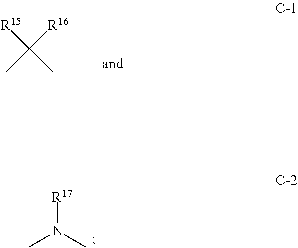

B² is a radical selected from the group consisting of

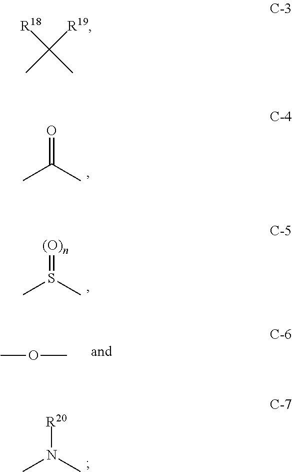

n is 0, 1 or 2;
T is C₁-C₆ alkylene or C₂-C₆ alkenylene;
R¹ is phenyl, phenylsulfonyl, —W¹(phenyl), —W¹(S-phenyl), —W¹(SO₂-phenyl), —W²(SO₂CH₂-phenyl) or —W²(SCH₂-phenyl), each optionally substituted on ring members with up to five substituents selected from R²¹; or -G¹ or —W²G²; or cyano, C₂-C₁₀ cyanoalkyl, hydroxy, amino, —C(═O)OH, —C(═O)NHCN, —C(═O)NHOH, —SO₂NH₂, —SO₂NHCN, —SO₂NHOH, —NHCHO, C₁-C₁₀ alkyl, C₂-C₁₀ alkenyl, C₂-C₁₀ alkynyl, C₁-C₁₀ haloalkyl, C₂-C₁₀ haloalkenyl, C₂-C₁₂ haloalkynyl, C₃-C₁₂ cycloalkyl, C₃-C₁₂ halocycloalkyl, C₄-C₁₄ alkylcycloalkyl, C₄-C₁₄ cycloalkylalkyl, C₆-C₁₈ cycloalkylcycloalkyl, C₄-C₁₄ halocycloalkylalkyl, C₅-C₁₆ alkylcycloalkylalkyl, C₃-C₁₂ cycloalkenyl, C₃-C₁₂ halocycloalkenyl, C₂-C₁₂ alkoxyalkyl, C₃-C₁₂ alkoxyalkenyl, C₄-C₁₄ alkylcycloalkyl, C₄-C₁₄ alkoxycycloalkyl, C₄-C₁₄ cycloalkoxyalkyl, C₅-C₁₄ cycloalkoxyalkoxyalkyl, C₃-C₁₄ alkoxyalkoxyalkyl, C₂-C₁₂ alkylthioalkyl, C₂-C₁₂ alkylsulfinylalkyl, C₂-C₁₂ alkylsulfonylalkyl, C₂-C₁₂ alkylaminoalkyl, C₃-C₁₄ dialkylaminoalkyl, C₂-C₁₂ haloalkylaminoalkyl, C₄-C₁₄ cycloalkylaminoalkyl, C₂-C₁₂ alkylcarbonyl, C₂-C₁₂ haloalkylcarbonyl, C₄-C₁₄ cycloalkylcarbonyl, C₂-C₁₂ alkoxycarbonyl, C₄-C₁₆ cycloalkoxycarbonyl, C₅-C₁₄ cycloalkylalkoxycarbonyl, C₂-C₁₂ alkylaminocarbonyl, C₃-C₁₄ dialkylaminocarbonyl, C₄-C₁₄ cycloalkylaminocarbonyl, C₂-C₉ cyanoalkyl, C₁-C₁₀ hydroxyalkyl, C₄-C₁₄ cycloalkenylalkyl, C₂-C₁₂ haloalkoxyalkyl, C₂-C₁₂ alkoxyhaloalkyl, C₂-C₁₂ haloalkoxyhaloalkyl, C₄-C₁₄ halocycloalkoxyalkyl, C₄-C₁₄ cycloalkenyloxyalkyl, C₄-C₁₄ halocycloalkenyloxyalkyl, C₃-C₁₄ dialkoxyalkyl, C₃-C₁₄ alkoxyalkylcarbonyl, C₃-C₁₄ alkoxycarbonylalkyl, C₂-C₁₂ haloalkoxycarbonyl, C₁-C₁₀ alkoxy, C₁-C₁₀ haloalkoxy, C₃-C₁₂ cycloalkoxy, C₃-C₁₂ halocycloalkoxy, C₄-C₁₄ cycloalkylalkoxy, C₂-C₁₀ alkenyloxy, C₂-C₁₀ haloalkenyloxy, C₃-C₁₀ alkynyloxy, C₃-C₁₀ haloalkynyloxy, C₂-C₁₂ alkoxyalkoxy, C₂-C₁₂ alkylcarbonyloxy, C₂-C₁₂ haloalkylcarbonyloxy, C₄-C₁₄ cycloalkylcarbonyloxy, C₃-C₁₄ alkylcarbonylalkoxy, C₁-C₁₀ alkylthio, C₁-C₁₀ haloalkylthio, C₃-C₁₂ cycloalkylthio, C₁-C₁₀ alkylsulfonyl, C₁-C₁₀ haloalkylsulfinyl, C₁-C₁₀ alkylsulfonyl, C₁-C₁₀ haloalkylsulfonyl, C₃-C₁₂ cycloalkylsulfonyl, C₂-C₁₂ alkylcarbonylthio, C₂-C₁₂ alkyl(thiocarbonyl)thio, C₃-C₁₂ cycloalkylsulfinyl, C₁-C₁₀ alkylaminosulfonyl, C₂-C₁₂ dialkylaminosulfonyl, C₁-C₁₀ alkylamino, C₂-C₁₂ dialkylamino, C₁-C₁₀ haloalkylamino, C₂-C₁₂ halodialkylamino, C₃-C₁₂ cycloalkylamino, C₂-C₁₂ alkylcarbonylamino, C₂-C₁₂ haloalkylcarbonylamino, C₁-C₁₀ alkylsulfonylamino, C₁-C₁₀ haloalkylsulfonylamino or C₄-C₁₄ cycloalkyl(alkyl)amino; or

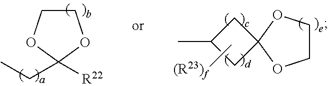

a is 2, 3 or 4;
b, c, d and e are independently 1 or 2;
f is an integer from 0 to 3;
W¹ is C₁-C₆ alkylene, C₂-C₆ alkenylene or C₂-C₆ alkynylene;
W² is C₁-C₆ alkylene;
R² is phenyl or —W³(phenyl), each optionally substituted on ring members with up to five substituents selected from R²¹; or -G³ or —W⁴G⁴; or H, cyano, hydroxy, amino, nitro, —CHO, —C(═O)OH, —C(═O)NH₂, —C(═S)NH₂, —C(═O)NHCN, —C(═O)NHOH, —SH, —SO₂NH₂, —SO₂NHCN, —SO₂NHOH, —SF₅, —NHCHO, —NHNH₂, —NHOH, —NHCN, —NHC(═O)NH₂, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl, C₃-C₈ halocycloalkyl, C₄-C₁₀ alkylcycloalkyl, C₄-C₁₀ cycloalkylalkyl, C₆-C₁₄ cycloalkylcycloalkyl, C₄-C₁₀ halocycloalkylalkyl, C₅-C₁₂ alkylcycloalkylalkyl, C₃-C₈ cycloalkenyl, C₃-C₈ halocycloalkenyl, C₂-C₈ alkoxyalkyl, C₃-C₁₀ alkoxyalkenyl, C₄-C₁₀ cycloalkoxyalkyl, C₃-C₁₀ alkoxyalkoxyalkyl, C₂-C₈ alkylthioalkyl, C₂-C₈ alkylsulfinylalkyl, C₂-C₈ alkylsulfonylalkyl, C₂-C₈ alkylaminoalkyl, C₃-C₁₀ dialkylaminoalkyl, C₂-C₈ haloalkylaminoalkyl, C₄-C₁₀ cycloalkylaminoalkyl, C₂-C₈ alkylcarbonyl, C₂-C₈ haloalkylcarbonyl, C₄-C₁₀ cycloalkylcarbonyl, C₂-C₈ alkoxycarbonyl, C₄-C₁₀ cycloalkoxycarbonyl, C₅-C₁₂ cycloalkylalkoxycarbonyl, C₂-C₈ alkylaminocarbonyl, C₃-C₁₀ dialkylaminocarbonyl, C₄-C₁₀ cycloalkylaminocarbonyl, C₂-C₅ cyanoalkyl, C₁-C₆ hydroxyalkyl, C₄-C₁₀ cycloalkenylalkyl, C₂-C₈ haloalkoxyalkyl, C₂-C₈ alkoxyhaloalkyl, C₂-C₈ haloalkoxyhaloalkyl, C₄-C₁₀ halocycloalkoxyalkyl, C₄-C₁₀ cycloalkenyloxyalkyl, C₄-C₁₀ halocycloalkenyloxyalkyl, C₃-C₁₀ dialkoxyalkyl, C₃-C₁₀ alkoxyalkylcarbonyl, C₃-C₁₀ alkoxycarbonylalkyl, C₂-C₈ haloalkoxycarbonyl, C₁-C₆ alkoxy, C₁-C₆ haloalkoxy, C₃-C₈ cycloalkoxy, C₃-C₈ halocycloalkoxy, C₄-C₁₀ cycloalkylalkoxy, C₂-C₆ alkenyloxy, C₂-C₆ haloalkenyloxy, C₃-C₆ alkynyloxy, C₃-C₆ haloalkynyloxy, C₂-C₈ alkoxyalkoxy, C₂-C₈ alkylcarbonyloxy, C₂-C₈ haloalkylcarbonyloxy, C₄-C₁₀ cycloalkylcarbonyloxy, C₃-C₁₀ alkylcarbonylalkoxy, C₁-C₆ alkylthio, C₁-C₆ haloalkylthio, C₃-C₈ cycloalkylthio, C₁-C₆ alkylsulfinyl, C₁-C₆ haloalkylsulfinyl, C₁-C₆ alkylsulfonyl, C₁-C₆ haloalkylsulfonyl, C₃-C₈ cycloalkylsulfonyl, C₃-C₈ trialkylsilyl, C₃-C₈ cycloalkenyloxy, C₃-C₈ halocycloalkenyloxy, C₂-C₈ haloalkoxyalkoxy, C₂-C₈ alkoxyhaloalkoxy, C₂-C₈ haloalkoxyhaloalkoxy, C₃-C₁₀ alkoxycarbonylalkoxy, C₂-C₈ alkyl(thiocarbonyl)oxy, C₂-C₈ alkylcarbonylthio, C₂-C₈ alkyl(thiocarbonyl)thio, C₃-C₈ cycloalkylsulfinyl, C₁-C₆ alkylaminosulfonyl, C₂-C₈ dialkylaminosulfonyl, C₃-C₁₀ halotrialkylsilyl, C₁-C₆ alkylamino, C₂-C₈ dialkylamino, C₁-C₆ haloalkylamino, C₂-C₈ halodialkylamino, C₃-C₈ cycloalkylamino, C₂-C₈ alkylcarbonylamino, C₂-C₈ haloalkylcarbonylamino, C₁-C₆ alkylsulfonylamino, C₁-C₆ haloalkylsulfonylamino or C₄-C₁₀ cycloalkyl(alkyl)amino; or
R¹ and R² are taken together with the atoms linking R¹ and R² to form a fused 5-, 6- or 7-membered ring containing ring members selected from carbon atoms, 1 to 3 nitrogen atoms, and optionally up to 2 oxygen atoms and up to 2 sulfur atoms, wherein up to 2 carbon atom ring members are selected from C(═O), and the sulfur atom ring members are independently selected from S(═O)ₘ; the ring optionally substituted on carbon atom ring members with substituents selected from R²⁴, and optionally substituted on nitrogen atom ring members with substituents selected from R²⁵;
each m is independently 0, 1 or 2;
W³ is C₁-C₆ alkylene, C₂-C₆ alkenylene or C₂-C₆ alkynylene;
W⁴ is C₁-C₆ alkylene;
R³ is H, halogen, cyano, nitro, C₁-C₆ alkyl, C₁-C₆ haloalkyl, C₁-C₆ alkoxy, C₁-C₆ haloalkoxy, C₁-C₆ alkylthio, C₁-C₆ haloalkylthio, C₁-C₆ alkylsulfinyl, C₁-C₆ haloalkylsulfinyl, C₁-C₆ alkylsulfonyl or C₁-C₆ haloalkylsulfonyl;
R⁴ is H, halogen, cyano, hydroxy, —O⁻M⁺, amino, nitro, —CHO, —C(═O)OH, —C(═O)NH₂, —C(═S)NH₂, —SH, —SO₂NH₂, —SO₂NHCN, —SO₂NHOH, —OCN, —SCN, —SF₅, —NHNH₂, —NHOH, —N═C═O, —N═C═S, C₁-C₆ alkoxy, C₁-C₆ haloalkoxy, C₃-C₈ cycloalkoxy, C₃-C₈ halocycloalkoxy, C₄-C₁₀ cycloalkylalkoxy, C₂-C₆ alkenyloxy, C₂-C₆ haloalkenyloxy, C₃-C₆ alkynyloxy, C₃-C₆ haloalkynyloxy, C₂-C₈ alkoxyalkoxy, C₂-C₈ alkylcarbonyloxy, C₂-C₈ haloalkylcarbonyloxy, C₄-C₁₀ cycloalkylcarbonyloxy, C₃-C₁₀ alkylcarbonylalkoxy, C₁-C₆ alkylthio, C₁-C₆ haloalkylthio, C₃-C₈ cycloalkylthio, C₁-C₆ alkylsulfinyl, C₁-C₆ haloalkylsulfinyl, C₁-C₆ alkylsulfonyl, C₁-C₆ haloalkylsulfonyl, C₃-C₈ cycloalkylsulfonyl, C₁-C₆ alkylsulfonyloxy, C₁-C₆ alkylamino, C₂-C₈ dialkylamino, C₁-C₆ haloalkylamino, C₂-C₈ halodialkylamino, C₃-C₈ cycloalkylamino, C₂-C₈ alkylcarbonylamino, C₂-C₈ haloalkylcarbonylamino, C₁-C₆ alkylsulfonylamino or C₁-C₆ haloalkylsulfonylamino; or benzyloxy, phenyloxy, benzylcarbonyloxy, phenylcarbonyloxy, phenylsulfonyloxy, benzylsulfonyloxy, phenylthio, benzylthio, phenylsulfinyl, benzylsulfinyl, phenylsulfonyl or benzylsulfonyl, each optionally substituted on ring members with up to five substituents selected from R²¹;
M⁺ is an alkali metal cation or an ammonium cation;
R⁵, R⁶, R⁷ and R⁸ are each independently H, halogen, hydroxy, C₁-C₆ alkyl, C₂-C₆ alkenyl, C₂-C₆ alkynyl, C₁-C₆ haloalkyl, C₁-C₆ alkoxy, C₁-C₆ haloalkoxy, C₃-C₈ cycloalkoxy or C₃-C₈ halocycloalkoxy; or phenyl or benzyl, each optionally substituted on ring members with up to five substituents selected from R²¹;
R⁹ is H, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl or C₃-C₈ halocycloalkyl; or benzyl optionally substituted on ring members with up to five substituents selected from R²¹;
R¹⁰ is H, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl, C₃-C₈ halocycloalkyl, C₄-C₁₀ alkylcycloalkyl, C₄-C₁₀ cycloalkylalkyl, C₆-C₁₄ cycloalkylcycloalkyl, C₄-C₁₀ halocycloalkylalkyl, C₅-C₁₂ alkylcycloalkylalkyl, C₃-C₈ cycloalkenyl, C₃-C₈ halocycloalkenyl, C₂-C₈ alkoxyalkyl, C₄-C₁₀ cycloalkoxyalkyl, C₃-C₁₀ alkoxyalkoxyalkyl or C₂-C₈ alkylthioalkyl;
R¹¹ is H, halogen, cyano, hydroxy, amino, nitro, SH, —SO₂NH₂, —SO₂NHCN, —SO₂NHOH, —OCN, —SCN, —SF₅, —NHCHO, —NHNH₂, —N₃, —NHOH, —NHCN, —NHC(═O)NH₂, —N═C═O, —N═C═S, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl, C₃-C₈ halocycloalkyl, C₄-C₁₀ alkylcycloalkyl, C₄-C₁₀ cycloalkylalkyl, C₆-C₁₄ cycloalkylcycloalkyl, C₄-C₁₀ halocycloalkylalkyl, C₅-C₁₂ alkylcycloalkylalkyl, C₃-C₈ cycloalkenyl, C₃-C₈ halocycloalkenyl, C₂-C₈ alkoxyalkyl, C₄-C₁₀ cycloalkoxyalkyl, C₃-C₁₀ alkoxyalkoxyalkyl or C₂-C₈ alkylthioalkyl;
R¹² is H, halogen, cyano, hydroxy, amino, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl, C₃-C₈ halocycloalkyl, C₄-C₁₀ alkylcycloalkyl, C₄-C₁₀ cycloalkylalkyl, C₄-C₁₀ halocycloalkylalkyl, C₅-C₁₂ alkylcycloalkylalkyl, C₃-C₈ cycloalkenyl, C₃-C₈ halocycloalkenyl, C₂-C₈ alkoxyalkyl, C₄-C₁₀ cycloalkoxyalkyl, C₃-C₁₀ alkoxyalkoxyalkyl, C₂-C₈ alkylthioalkyl, C₂-C₈ alkylsulfinylalkyl or C₂-C₈ alkylsulfonylalkyl; or phenyl optionally substituted with up to five substituents selected from R²¹;
R¹³ is H, halogen, cyano, hydroxy, amino, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl, C₃-C₈ halocycloalkyl, C₄-C₁₀ alkylcycloalkyl, C₄-C₁₀ cycloalkylalkyl, C₆-C₁₄ cycloalkylcycloalkyl, C₄-C₁₀ halocycloalkylalkyl, C₅-C₁₂ alkylcycloalkylalkyl, C₃-C₈ cycloalkenyl, C₃-C₈ halocycloalkenyl or C₂-C₈ alkoxycarbonylamino;
R¹⁴ is H, halogen, cyano, hydroxy, amino, nitro or C₂-C₈ alkoxycarbonyl;
each R¹⁵, R¹⁶, R¹⁸ and R¹⁹ is independently H, halogen, cyano, hydroxy or C₁-C₆ alkyl; or
a pair of R¹⁵ and R¹⁸ is taken together as C₂-C₆ alkylene or C₂-C₆ alkenylene;
R¹⁷ and R²⁰ are independently H, C₁-C₆ haloalkyl, C₂-C₆ haloalkenyl, C₁-C₆ alkoxy, C₁-C₆ haloalkoxy, C₃-C₈ cycloalkoxy, C₁-C₆ alkyl, C₂-C₆ alkenyl, C₂-C₆ alkynyl or C₃-C₈ cycloalkyl;
G¹, G², G³ and G⁴ are independently a 5- or 6-membered heterocyclic ring or an 8-, 9- or 10-membered fused bicyclic ring system, each ring or ring system optionally substituted with up to five substituents selected from R²¹ on carbon ring members and R²⁶ on nitrogen ring members;
each R²¹ is independently halogen, cyano, hydroxy, amino, nitro, —CHO, —C(═O)OH, —C(═O)NH₂, —C(═S)NH₂, —C(═O)NHCN, —C(═O)NHOH, —SH, —SO₂NH₂, —SO₂NHCN, —SO₂NHOH, —OCN, —SCN, —SF₅, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl, C₃-C₈ halocycloalkyl, C₄-C₁₀ alkylcycloalkyl, C₄-C₁₀ cycloalkylalkyl, C₃-C₈ cycloalkenyl, C₃-C₈ halocycloalkenyl, C₂-C₈ alkoxyalkyl, C₄-C₁₀ cycloalkoxyalkyl, C₃-C₁₀ alkoxyalkoxyalkyl, C₂-C₈ alkylthioalkyl, C₂-C₈ alkylsulfinylalkyl, C₂-C₈ alkoxyhaloalkyl, C₂-C₅ cyanoalkyl, C₁-C₆ hydroxyalkyl, C₁-C₆ alkoxy, C₁-C₆ haloalkoxy, C₃-C₈ cycloalkoxy, C₃-C₈ halocycloalkoxy, C₄-C₁₀ cycloalkylalkoxy, C₂-C₆ alkenyloxy, C₂-C₆ haloalkenyloxy, C₂-C₈ alkoxyalkoxy, C₂-C₈ alkylcarbonyloxy, C₁-C₆ alkylthio, C₁-C₆ haloalkylthio, C₃-C₈ cycloalkylthio, C₁-C₆ alkylsulfinyl, C₁-C₆ haloalkylsulfinyl, C₁-C₆ alkylsulfonyl, C₁-C₆ haloalkylsulfonyl, C₃-C₈ cycloalkylsulfonyl, C₁-C₆ alkylamino, C₂-C₈ dialkylamino, C₁-C₆ haloalkylamino, C₂-C₈ halodialkylamino or C₃-C₈ cycloalkylamino;
R²² is H or C₁-C₃ alkyl;
each R²³ is independently halogen, cyano, hydroxy, amino, nitro, —CHO, —C(═O)OH, —C(═O)NH₂, —C(═S)NH₂, —C(═O)NHCN, —C(═O)NHOH, —SH, —SO₂NH₂, —SO₂NHCN, —SO₂NHOH, —OCN, —SCN, —SF₅, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl, C₃-C₈ halocycloalkyl, C₄-C₁₀ alkylcycloalkyl, C₄-C₁₀ cycloalkylalkyl, C₃-C₈ cycloalkenyl, C₃-C₈ halocycloalkenyl, C₂-C₈ alkoxyalkyl, C₄-C₁₀ cycloalkoxyalkyl, C₃-C₁₀ alkoxyalkoxyalkyl, C₂-C₈ alkylthioalkyl, C₂-C₈ alkylsulfinylalkyl, C₂-C₈ alkoxyhaloalkyl, C₂-C₅ cyanoalkyl, C₁-C₆ hydroxyalkyl, C₁-C₆ alkoxy, C₁-C₆ haloalkoxy, C₃-C₈ cycloalkoxy, C₃-C₈ halocycloalkoxy, C₄-C₁₀ cycloalkylalkoxy, C₂-C₆ alkenyloxy, C₂-C₆ haloalkenyloxy, C₂-C₈ alkoxyalkoxy, C₂-C₈ alkylcarbonyloxy, C₁-C₆ alkylthio, C₁-C₆ haloalkylthio, C₃-C₈ cycloalkylthio, C₁-C₆ alkylsulfinyl, C₁-C₆ haloalkylsulfinyl, C₁-C₆ alkylsulfonyl, C₁-C₆ haloalkylsulfonyl, C₃-C₈ cycloalkylsulfonyl, C₁-C₆ alkylamino, C₂-C₈ dialkylamino, C₁-C₆ haloalkylamino, C₂-C₈ halodialkylamino or C₃-C₈ cycloalkylamino;
each R²⁴ is independently halogen, cyano, C₁-C₆ alkyl, C₂-C₆ alkenyl, C₂-C₆ alkynyl, C₁-C₆ haloalkyl, C₃-C₈ cycloalkyl or C₂-C₈ alkoxyalkyl; or phenyl optionally substituted with up to 5 substituents independently selected from cyano, nitro, halogen, C₁-C₆ alkyl, C₁-C₆ alkoxy and C₁-C₆ haloalkoxy;
each R²⁵ is independently C₁-C₆ alkyl; or phenyl optionally substituted with up to 5 substituents independently selected from cyano, nitro, halogen, C₁-C₆ alkyl, C₁-C₆ alkoxy and C₁-C₆ haloalkoxy; and
each R²⁶ is independently C₁-C₆ alkyl, C₂-C₆ alkenyl, C₂-C₆ alkynyl, C₁-C₆ haloalkyl, C₃-C₈ cycloalkyl or C₂-C₈ alkoxyalkyl.

More particularly this invention relates to a compound selected from Formula 1, an N-oxide, or a salt thereof.

### DETAILS OF THE INVENTION

As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Where applicants have defined an invention or a portion thereof with an open-ended term such as “comprising,” it should be readily understood that (unless otherwise stated) the description should be interpreted to also describe such an invention using the terms “consisting essentially of” or “consisting of.”

Further, unless expressly stated to the contrary, “or” refers to an inclusive “or” and not to an exclusive “or”. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

As referred to herein, the term “seedling”, used either alone or in a combination of words means a young plant developing from the embryo of a seed.

As referred to herein, the term “broadleaf” used either alone or in words such as “broadleaf weed” means dicot or dicotyledon, a term used to describe a group of angiosperms characterized by embryos having two cotyledons.

In the above recitations, the term “alkyl”, used either alone or in compound words such as “alkylthio” or “haloalkyl” includes straight-chain or branched alkyl, such as, methyl, ethyl, n-propyl, i-propyl, or the different butyl, pentyl or hexyl isomers. “Alkenyl” includes straight-chain or branched alkenes such as ethenyl, 1-propenyl, 2-propenyl, and the different butenyl, pentenyl and hexenyl isomers. “Alkenyl” also includes polyenes such as 1,2-propadienyl and 2,4-hexadienyl. “Alkynyl” includes straight-chain or branched alkynes such as ethynyl, 1-propynyl, 2-propynyl and the different butynyl, pentynyl and hexynyl isomers. “Alkynyl” can also include moieties comprised of multiple triple bonds such as 2,5-hexadiynyl. “Alkylene” denotes a straight-chain or branched alkanediyl. Examples of “alkylene” include CH₂, CH₂CH₂, CH(CH₃), CH₂CH₂CH₂, CH₂CH(CH₃) and the different butylene isomers. “Alkenylene” denotes a straight-chain or branched alkenediyl containing one olefinic bond. Examples of “alkenylene” include CH═CH, CH₂CH═CH, CH═C(CH₃) and the different butenylene isomers. “Alkynylene” denotes a straight-chain or branched alkynediyl containing one triple bond. Examples of “alkynylene” include C≡C, CH₂C≡C, C≡CCH₂ and the different butynylene isomers.

“Alkoxy” includes, for example, methoxy, ethoxy, n-propyloxy, isopropyloxy and the different butoxy, pentoxy and hexyloxy isomers. “Alkoxyalkyl” denotes alkoxy substitution on alkyl. Examples of “alkoxyalkyl” include CH₃OCH₂, CH₃OCH₂CH₂, CH₃CH₂OCH₂, CH₃CH₂CH₂CH₂OCH₂ and CH₃CH₂OCH₂CH₂. “Alkoxyalkoxy” denotes alkoxy substitution on alkoxy. “Alkenyloxy” includes straight-chain or branched alkenyloxy moieties. Examples of “alkenyloxy” include H₂C═CHCH₂O, (CH₃)₂C═CHCH₂O, (CH₃)CH═CHCH₂O, (CH₃)CH═C(CH₃)CH₂O and CH₂═CHCH₂CH₂O. “Alkynyloxy” includes straight-chain or branched alkynyloxy moieties. Examples of “alkynyloxy” include HC≡CCH₂O, CH₃C≡CCH₂O and CH₃C≡CCH₂CH₂O. “Alkoxyalkenyl” includes straight-chain or branched alkenyl substituted by an alkoxy group. Examples of “alkoxyalkenyl” include CH₃OCH═CH, CH₃C(OCH₃)═CH and CH₃CH₂OCH═CHCH₂. “Alkoxyalkoxyalkyl” denotes alkoxyalkoxy substitution on alkyl. Examples of “alkoxyalkoxyalkyl” include CH₃OCH₂OCH₂, CH₃OCH₂OCH₂CH₂, CH₃CH₂OCH₂OCH₂ and CH₃OCH₃CH₂OCH₂CH₂. “Alkylthio” includes branched or straight-chain alkylthio moieties such as methylthio, ethylthio, and the different propylthio, butylthio, pentylthio and hexylthio isomers. “Alkylsulfinyl” includes both enantiomers of an alkylsulfinyl group. Examples of “alkylsulfinyl” include CH₃S(O)—, CH₃CH₂S(O)—, CH₃CH₂CH₂S(O)—, (CH₃)₂CHS(O)— and the different butylsulfonyl, pentylsulfinyl and hexylsulfinyl isomers. Examples of “alkylsulfonyl” include CH₃S(O)₂—, CH₃CH₂S(O)₂—, CH₃CH₂CH₂S(O)₂—, (CH₃)₂CHS(O)₂—, and the different butylsulfonyl, pentylsulfonyl and hexylsulfonyl isomers. The terms “cycloalkylsulfinyl” and “cycloalkylsulfonyl are defined analogously to the terms “alkylsulfinyl” and “alkylsulfonyl” above. “SO₂” means S(O)₂.

“Alkylthioalkyl” denotes alkylthio substitution on alkyl. Examples of “alkylthioalkyl” include CH₃SCH₂, CH₃SCH₂CH₂, CH₃CH₂SCH₂, CH₃CH₂CH₂CH₂SCH₂ and CH₃CH₂SCH₂CH₂; “alkylsulfinylalkyl” and “alkylsulfonylalkyl” include the corresponding sulfoxides and sulfones, respectively. “Alkylamino” includes an NH radical substituted with straight-chain or branched alkyl. Examples of “alkylamino” include CH₃CH₂NH, CH₃CH₂CH₂NH, and (CH₃)₂CHCH₂NH. Examples of “dialkylamino” include (CH₃)₂N, (CH₃CH₂CH₂)₂N and CH₃CH₂(CH₃)N. “Alkylaminoalkyl” denotes alkylamino substitution on alkyl. Examples of “alkylaminoalkyl” include CH₃NHCH₂, CH₃NHCH₂CH₂, CH₃CH₂NHCH₂, CH₃CH₂CH₂CH₂NHCH₂ and CH₃CH₂NHCH₂CH₂. Examples of “dialkylaminoalkyl” include ((CH₃)₂CH)₂NCH₂, (CH₃CH₂CH₂)₂NCH₂ and CH₃CH₂(CH₃)NCH₂CH₂. The term “alkylcarbonylamino” denotes alkyl bonded to a C(═O)NH moiety. Examples of “alkylcarbonylamino” include CH₃CH₂C(═O)NH and CH₃CH₂CH₂C(═O)NH.

“Alkylcarbonylthio” denotes a straight-chain or branched alkylcarbonyl attached to and linked through a sulfur atom. Examples of “alkylcarbonylthio” include CH₃C(═O)S, CH₃CH₂CH₂C(═O)S and (CH₃)₂CHC(═O)S. The term “alkyl(thiocarbonyl)oxy” denotes an alkyl group bonded to a thiocarbonyl moiety attached to and linked through an oxygen atom. Examples of “alkyl(thiocarbonyl)oxy”, include CH₃CH₂C(═S)O and CH₃CH₂CH₂C(═S)O. The term “alkyl(thiocarbonyl)thio” refers to an alkyl group bonded to a thiocarbonyl moiety attached to and linked through a sulfur atom. Examples “alkyl(thiocarbonyl)thio” include CH₃CH₂C(═S)S.

“Trialkylsilyl” includes 3 branched and/or straight-chain alkyl radicals attached to and linked through a silicon atom, such as trimethylsilyl, triethylsilyl and tert-butyldimethylsilyl. Examples of “halotrialkylsilyl” include CF₃(CH₃)₂Si—, (CF₃)₃Si—, and CH₂Cl(CH₃)₂Si—. “Hydroxyalkyl” denotes an alkyl group substituted with one hydroxy group. Examples of “hydroxyalkyl” include HOCH₂CH₂, CH₃CH₂(OH)CH and HOCH₂CH₂CH₂CH₂. “Cyanoalkyl” denotes an alkyl group substituted with one cyano group. Examples of “cyanoalkyl” include NCCH₂, NCCH₂CH₂ and CH₃CH(CN)CH₂.

“Cycloalkyl” includes, for example, cyclopropyl, cyclobutyl, cyclopentyl and cyclohexyl. The term “alkylcycloalkyl” denotes alkyl substitution on a cycloalkyl moiety and includes, for example, ethylcyclopropyl, i-propylcyclobutyl, 3-methylcyclopentyl and 4-methylcyclohexyl. The term “cycloalkylalkyl” denotes cycloalkyl substitution on an alkyl moiety. Examples of “cycloalkylalkyl” include cyclopropylmethyl, cyclopentylethyl and other cycloalkyl moieties bonded to straight-chain or branched alkyl groups. The term “cycloalkoxy” denotes cycloalkyl linked through an oxygen atom such as cyclopentyloxy and cyclohexyloxy. The term “alkylcycloalkyl” denotes alkyl substitution on a cycloalkyl moiety. Examples of “alkylcycloalkyl” include methylcyclopropyl, ethylcyclopentyl and other straight-chain or branched alkyl groups bonded to cycloalkyl moiety. The term “alkoxycycloalkyl” denotes alkoxy substitution on a cycloalkyl moiety. Examples of “alkoxycycloalkyl” include methoxycyclopropyl, ethoxycyclopentyl and other straight-chain or branched alkoxy groups bonded to a cycloalkyl moiety. “Cycloalkylalkoxy” denotes cycloalkylalkyl linked through an oxygen atom attached to the alkyl chain. Examples of “cycloalkylalkoxy” include cyclopropylmethoxy, cyclopentylethoxy and other cycloalkyl moieties bonded to straight-chain or branched alkoxy groups. Examples of “cyanocycloalkyl” include 4-cyanocyclohexyl and 3-cyanocyclopentyl. “Cycloalkenyl” includes groups such as cyclopentenyl and cyclohexenyl as well as groups with more than one double bond such as 1,3- and 1,4-cyclohexadienyl.

The term “halogen”, either alone or in compound words such as “haloalkyl”, or when used in descriptions such as “alkyl substituted with halogen” includes fluorine, chlorine, bromine or iodine. Further, when used in compound words such as “haloalkyl”, or when used in descriptions such as “alkyl substituted with halogen” said alkyl may be partially or fully substituted with halogen atoms which may be the same or different. Examples of “haloalkyl” or “alkyl substituted with halogen” include F₃C—, ClCH₂—, CF₃CH₂— and CF₃CCl₂—. The terms “halocycloalkyl”, “haloalkoxy”, “haloalkylthio”, haloalkylsulfinyl, haloalkylsulfonyl, “haloalkenyloxy”, “haloalkynyloxy” “haloalkenyl”, “haloalkynyl”, “haloalkoxyalkyl”, “haloalkoxyalkoxy” “haloalkoxyhaloalkoxy”, “haloalkoxyhaloalkyl”, “halo alkylamino”, “haloalkylaminoalkyl” “halocycloalkoxy”, “halocycloalkoxyalkyl”, “halocycloalkylalkyl”, “halocycloalkenyl”, “halocycloalkenyloxy”, “halocycloalkenyloxy”, “halocycloalkenyloxyalkyl”, “alkoxyhaloalkoxy”, “alkoxyhaloalkyl”, “haloalkylcarbonyloxy”, “haloalkylcarbonylamino” and the like, are defined analogously to the term “haloalkyl”. Examples of “haloalkoxy” include CF₃O—, CCl₃CH₂O—, HCF₂CH₂CH₂O— and CF₃CH₂O—. Examples of “haloalkylthio” include CCl₃S—, CF₃S—, CCl₃CH₂S— and ClCH₂CH₂CH₂S—. Examples of “haloalkylsulfinyl” include CF₃S(O)—, CCl₃S(O)—, CF₃CH₂S(O)— and CF₃CF₂S(O)—. Examples of “haloalkylsulfonyl” include CF₃S(O)₂—, CCl₃S(O)₂—, CF₃CH₂S(O)₂— and CF₃CF₂S(O)₂—. Examples of “haloalkenyl” include (Cl)₂C═CHCH₂— and CF₃CH₂CH═CHCH₂—. Examples of “haloalkynyl” include HC≡CCHCl—, CF₃C≡C—, CCl₃C≡C— and FCH₂C≡CCH₂—. Examples of “haloalkoxyalkoxy” include CF₃OCH₂O—, ClCH₂CH₂OCH₂CH₂O—, Cl₃CCH₂OCH₂O— as well as branched alkyl derivatives. Examples of “haloalkylamino” include CF₃(CH₃)CHNH, (CF₃)₂CHNH and CH₂ClCH₂NH. The term “halodialkyl”, either alone or in compound words such as “halodialkylamino”, means at least one of the two alkyl groups is substituted with at least one halogen atom, and independently each halogenated alkyl group may be partially or fully substituted with halogen atoms which may be the same or different. Examples of “halodialkylamino” include (BrCH₂CH₂)₂N and BrCH₂CH₂(ClCH₂CH₂)N.

“Alkylcarbonyl” denotes a straight-chain or branched alkyl moieties bonded to a C(═O) moiety. Examples of “alkylcarbonyl” include CH₃C(═O)—, CH₃CH₂CH₂C(═O)— and (CH₃)₂CHC(═O)—. Examples of “alkoxycarbonyl” include CH₃C(═O)—, CH₃CH₂OC(═O)—, CH₃CH₂CH₂C(═O)—, (CH₃)₂CHOC(═O)— and the different butoxy- or pentoxycarbonyl isomers. The terms “haloalkylcarbonyl” “haloalkoxycarbonyl”, “alkoxyalkylcarbonyl”, “cycloalkoxycarbonyl”, “cycloalkylalkoxycarbonyl” and “cycloalkylaminocarbonyl” are defined analogously.

The term “alkoxycarbonylamino” denotes a straight-chain or branched alkoxy moieties bonded to a C(═O) moiety of carbonylamino group. Examples of “alkoxycarbonylamino” include CH₃C(═O)NH— and CH₃CH₂C(═O)NH—. Examples of “alkylaminocarbonyl” include CH₃NHC(═O), CH₃CH₂NHC(═O), CH₃CH₂CH₂NHC(═O), (CH₃)₂CHNHC(═O) and the different butylamino- or pentylaminocarbonyl isomers. Examples of “dialkylaminocarbonyl” include (CH₃)₂NC(═O), (CH₃CH₂)₂NC(═O), CH₃CH₂(CH₃)NC(═O), (CH₃)₂CH(CH₃)NC(═O) and CH₃CH₂CH₂(CH₃)NC(═O). The term “alkylcarbonyloxy” denotes straight-chain or branched alkyl bonded to a C(═O)O moiety. Examples of “alkylcarbonyloxy” include CH₃CH₂C(═O)O and (CH₃)₂CHC(═O)O. The term “alkylcarbonylalkoxy” denotes alkylcarbonyl bonded to an alkoxy moiety. Examples of “alkylcarbonylalkoxy” include CH₃C(═O)CH₂CH₂O and CH₃CH₂C(═O)CH₂O. Examples of “alkoxycarbonyloxy” include CH₃CH₂CH₂C(═O)O and (CH₃)₂CHOC(═O)O. The term “cycloalkylcarbonyloxy” denotes a cycloalkylcarbonyl group bonded to oxygen. Examples of “cycloalkylcarbonyloxy” include cyclopropyl-C(O)O— and cyclohexyl-C(O)O—.

“Alkylsulfonylamino” denotes an NH radical substituted with alkylsulfonyl. Examples of “alkylsulfonylamino” include CH₃CH₂S(═O)₂NH— and (CH₃)₂CHS(═O)₂NH—. The term “alkylsulfonyloxy” denotes an alkylsulfonyl group bonded to an oxygen atom. Examples of “alkylsulfonyloxy” include CH₃S(═O)₂O—, CH₃CH₂S(═O)₂O—, CH₃CH₂CH₂S(═O)₂O—, (CH₃)₂CHS(═O)₂O—, and the different butylsulfonyloxy, pentylsulfonyloxy and hexylsulfonyloxy isomers.

The term “cycloalkoxyalkyl” denotes cycloalkoxy substitution on an alkyl moiety. Examples of “cycloalkoxyalkyl” include cyclopropyloxymethyl, cyclopentyloxyethyl and other cycloalkoxy moieties bonded to straight-chain or branched alkyl groups. The term “cycloalkylthio” denotes cycloalkyl attached to and linked through a sulfur atom such as cyclopropylthio and cyclopentylthio; “cycloalkylsulfonyl” includes the corresponding sulfones. “Alkylcycloalkylalkyl” denotes an alkyl group substituted with alkylcycloalkyl. Examples of “alkylcycloalkylalkyl” include 1-, 2-, 3- or 4-methyl or -ethyl cyclohexylmethyl. The term “cycloalkoxyalkoxyalkyl” denotes a cycloalkoxy moiety attached to the alkoxy moiety of an alkoxyalkyl group. Examples of the term “cycloalkoxyalkoxyalkyl” include cyclopropyloxymethoxymethyl and cyclopentyloxy-ethoxymethyl. The term “cycloalkylcycloalkyl” denotes cycloalkyl substitution on another cycloalkyl ring, wherein each cycloalkyl ring independently has from 3 to 7 carbon atom ring members. Examples of cycloalkylcycloalkyl include cyclopropylcyclopropyl (such as 1,1′-bicyclopropyl-1-yl, 1,1′-bicyclopropyl-2-yl), cyclohexylcyclopentyl (such as 4-cyclopentylcyclohexyl) and cyclohexylcyclohexyl (such as 1,1′-bicyclohexyl-1-yl), and the different cis- and trans-cycloalkylcycloalkyl isomers, (such as (1R,2S)-1,1′-bicyclopropyl-2-yl and (1R,2R)-1,1′-bicyclopropyl-2-yl).

“Dialkoxyalkyl” denotes two independent alkoxy groups substituted on same carbon of the alkyl group. Examples of “dialkoxyalkyl” include (CH₃O)₂CH— and CH₃CH₂O(CH₃O)CH—. “Cycloalkylamino” denotes an NH radical substituted with cycloalkyl. Examples of “cycloalkylamino” include cyclopropylamino and cyclohexylamino. “Cycloalkyl(alkyl)amino” means a cycloalkylamino group where the hydrogen atom is replaced by an alkyl radical. Examples of “cycloalkyl(alkyl)amino” include groups such as cyclopropyl(methyl)amino, cyclobutyl(butyl)amino, cyclopentyl(propyl)amino, cyclohexyl(methyl)amino and the like. The term “cycloalkylaminoalkyl” denotes cycloalkylamino substitution on an alkyl group. Examples of “cycloalkylaminoalkyl” include cyclopropylaminomethyl, cyclopentylaminoethyl, and other cycloalkylamino moieties bonded to straight-chain or branched alkyl groups.

“Cycloalkylcarbonyl” denotes cycloalkyl bonded to a C(═O) group including, for example, cyclopropylcarbonyl and cyclopentylcarbonyl. The term “cycloalkoxycarbonyl” means cycloalkoxy bonded to a C(═O) group, for example, cyclopropyloxycarbonyl and cyclopentyloxycarbonyl. “Cycloalkylaminocarbonyl” denotes cycloalkylamino bonded to a C(═O) group, for example, cyclopentylaminocarbonyl and cyclohexylaminocarbonyl. “Cycloalkylalkoxycarbonyl” denotes cycloalkylalkoxy bonded to a C(═O) group. Examples of “cycloalkylalkoxycarbonyl” include cyclopropylethoxycarbonyl and cyclopentylmethoxycarbonyl. “Cycloalkylcarbonyloxy” denotes cycloalkylcarbonyl attached to and linked through an oxygen atom. Examples of “cycloalkylcarbonyloxy” include cyclohexylcarbonyloxy and cyclopentylcarbonyloxy.

The term “cycloalkenylalkyl” denotes cycloalkenyl substitution on an alkyl moiety. Examples of “cycloalkenylalkyl” include cyclobutenylmethyl, cyclopentenylethyl, and other cycloalkenyl moieties bonded to straight-chain or branched alkyl groups. The term “cycloalkenyloxy” denotes cycloalkenyl linked through an oxygen atom such as cyclopentenyloxy and cyclohexenyloxy. The term “cycloalkenyloxyalkyl” denotes cycloalkenyloxy substitution on an alkyl moiety. Examples of “cycloalkenyloxyalkyl” include cyclobutenyloxymethyl, cyclopentenyloxyethyl, and other cycloalkenyloxy moieties bonded to straight-chain or branched alkyl groups.

The term “alkylaminosulfonyl” denotes a straight-chain or branched alkylamino moiety bonded to a sulfonyl group. Examples of an “alkylaminosulfonyl” group include CH₃NHS(O)₂— or CH₃CH₂CH₂NHS(O)₂—. The term “dialkylaminosulfonyl” denotes a straight-chain or branched dialkylamino moiety bonded to a sulfonyl group. Examples of a “dialkylaminosulfonyl” group include (CH₃)₂NS(O)₂— or (CH₃CH₂CH₂)₂NS(O)₂—.

The total number of carbon atoms in a substituent group is indicated by the “Cᵢ-Cⱼ” prefix where i and j are numbers from 1 to 18. For example, C₁-C₄ alkylsulfonyl designates methylsulfonyl through butylsulfonyl; C₂ alkoxyalkyl designates CH₃OCH₂—; C₃ alkoxyalkyl designates, for example, CH₃CH(OCH₃)—, CH₃OCH₂CH₂— or CH₃CH₂OCH₂—; and C₄ alkoxyalkyl designates the various isomers of an alkyl group substituted with an alkoxy group containing a total of four carbon atoms, examples including CH₃CH₂CH₂OCH₂— and CH₃CH₂OCH₂CH₂—.

When a compound is substituted with a substituent bearing a subscript that indicates the number of said substituents can exceed 1, said substituents (when they exceed 1) are independently selected from the group of defined substituents, e.g., (R^{v})ᵣ, r is 1, 2, 3, 4 or 5 in U-1 of Exhibit 2. When a group contains a substituent which can be hydrogen, for example R², R³, R⁴, R⁵, R⁶, R⁷, R⁸, R⁹, R¹⁰, R¹¹, R¹², R¹³, R¹⁴, R¹⁵, R¹⁸, R¹⁹ or R²⁰, then when this substituent is taken as hydrogen, it is recognized that this is equivalent to said group being unsubstituted. When a variable group is shown to be optionally attached to a position, for example (R^{v})ᵣ in Q-29 of Exhibit 1 then hydrogen may be at the position (i.e. when r is 0) even if not recited in the variable group definition. When one or more positions on a group are said to be “not substituted” or “unsubstituted”, then hydrogen atoms are attached to take up any free valency.

Unless otherwise indicated, a “ring” or “ring system” as a component of Formula 1 (e.g., substituent G¹, G², G³ or G⁴) is carbocyclic or heterocyclic. The term “ring system” denotes two or more fused rings. The terms “bicyclic ring system” and “fused bicyclic ring system” denote a ring system consisting of two fused rings, in which either ring can be saturated, partially unsaturated or fully unsaturated unless otherwise indicated. The term “ring member” refers to an atom or other moiety (e.g., C(═O), C(═S), S(O) or S(O)₂) forming the backbone of a ring or ring system.

The terms “carbocyclic ring”, “carbocycle” or “carbocyclic ring system” denote a ring or ring system wherein the atoms forming the ring backbone are selected only from carbon. Unless otherwise indicated, a carbocyclic ring can be a saturated, partially unsaturated or fully unsaturated ring. When a fully unsaturated carbocyclic ring satisfies Hückel's rule, then said ring is also called an “aromatic ring”. “Saturated carbocyclic” refers to a ring having a backbone consisting of carbon atoms linked to one another by single bonds; unless otherwise specified, the remaining carbon valences are occupied by hydrogen atoms.

The terms “heterocyclic ring”, “heterocycle” or “heterocyclic ring system” denote a ring or ring system in which at least one atom forming the ring backbone is not carbon, e.g., nitrogen, oxygen or sulfur. Typically a heterocyclic ring contains no more than 4 nitrogen atoms, no more than 2 oxygen atoms and no more than 2 sulfur atoms. Unless otherwise indicated, a heterocyclic ring can be a saturated, partially unsaturated or fully unsaturated ring. When a fully unsaturated heterocyclic ring satisfies Hückel's rule, then said ring is also called a “heteroaromatic ring” or “aromatic heterocyclic ring”. Unless otherwise indicated, heterocyclic rings and ring systems can be attached through any available carbon or nitrogen by replacement of a hydrogen on said carbon or nitrogen.

“Aromatic” indicates that each of the ring atoms is essentially in the same plane and has a p-orbital perpendicular to the ring plane, and that (4n+2) π electrons, where n is a positive integer, are associated with the ring to comply with Hückel's rule. The term “aromatic ring system” denotes a carbocyclic or heterocyclic ring system in which at least one ring of the ring system is aromatic.

As used herein, the following definitions shall apply unless otherwise indicated. The term “optionally substituted” is used interchangeably with the phrase “substituted or unsubstituted”. Unless otherwise indicated, an optionally substituted group may have a substituent at each substitutable position of the group, and each substitution is independent of the other.

G¹, G², G³ or G⁴ may be attached to the remainder of Formula 1 through any available carbon or nitrogen ring atom, unless otherwise described. The ring or ring system of G¹, G², G³ or G⁴ may be saturated, partially saturated or fully unsaturated and is optionally substituted with up to 5 substituents selected from a group of substituents as defined in the Summary of the Invention.

Examples of a 5- or 6-membered unsaturated aromatic heterocyclic ring optionally substituted with from up to 4 substituents include the rings Q-1 through Q-60 illustrated in Exhibit 1 wherein R^{v} is any substituent as defined in the Summary of the Invention for R²¹ on carbon ring members or R²⁶ on nitrogen ring members, and r is an integer from 0 to 4, limited by the number of available positions on each Q group. As Q-29, Q-30, Q-36, Q-37, Q-38, Q-39, Q-40, Q-41, Q-42 and Q-43 have only one available position, for these Q groups r is limited to the integers 0 or 1, and r being 0 means that the Q group is unsubstituted and a hydrogen is present at the position indicated by (R^{v})ᵣ.

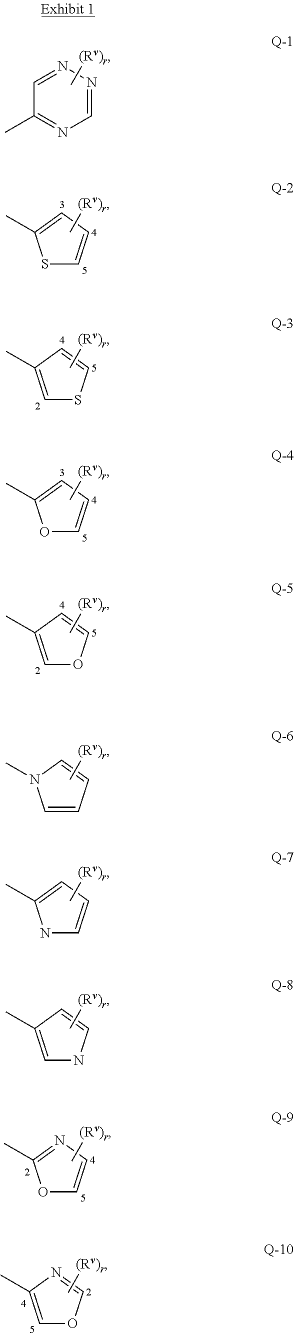

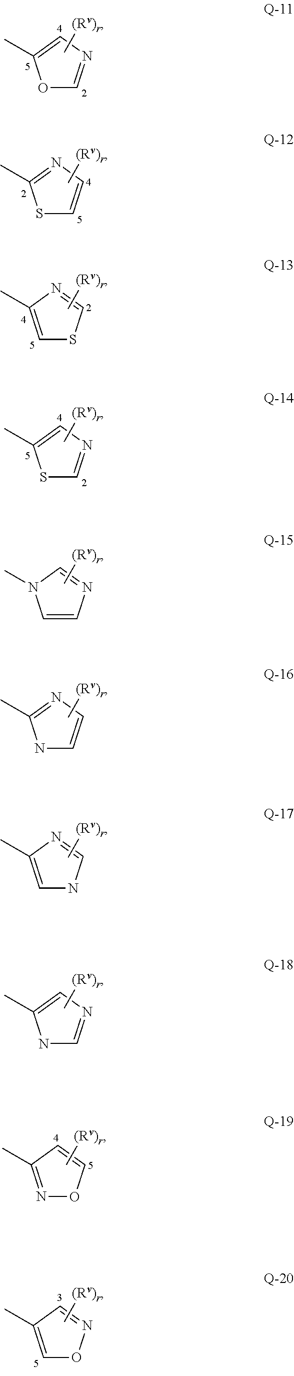

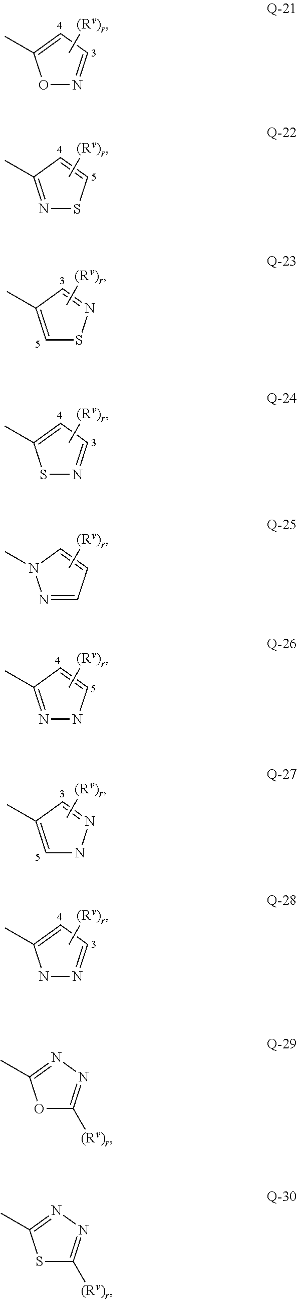

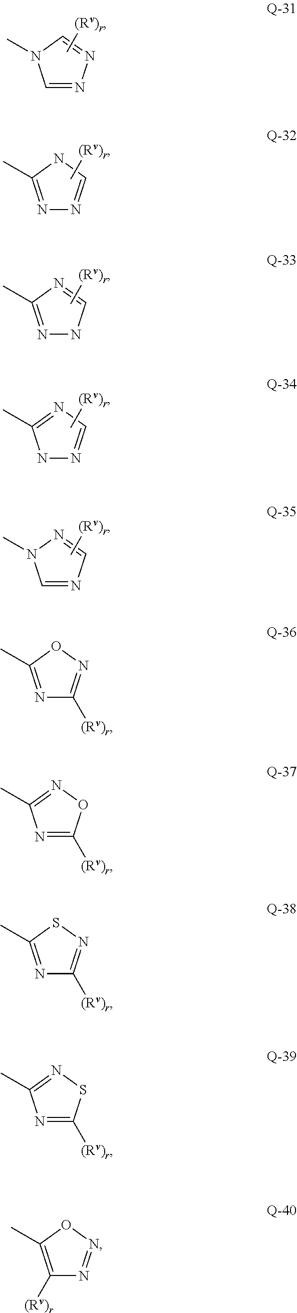

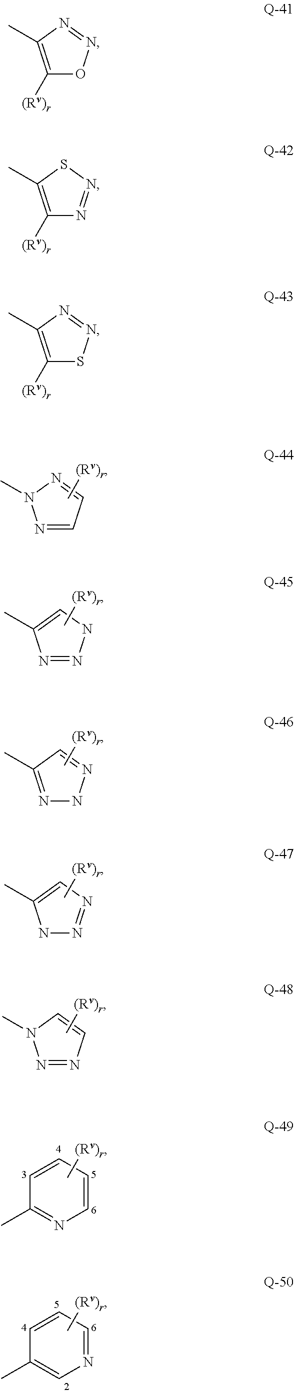

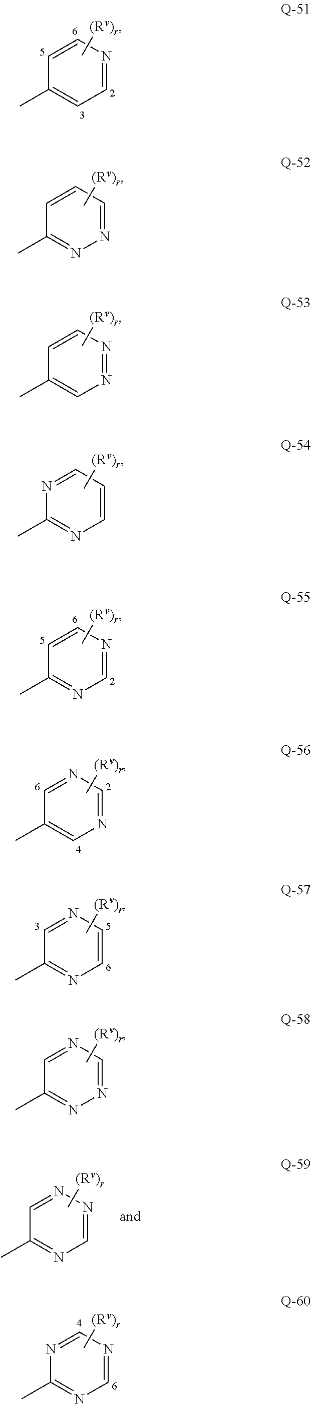

Note that when G¹, G², G³ or G⁴ is an optionally substituted 5- or 6-membered non-aromatic heterocyclic ring, one or two carbon ring members of the heterocycle can optionally be in the oxidized form of a carbonyl moiety.

Examples of a 5- or 6-membered non-aromatic heterocyclic ring include the rings U-1 through U-36 as illustrated in Exhibit 2. Note that when the attachment point on the U group is illustrated as floating, the U group can be attached to the remainder of Formula 1 through any available carbon or nitrogen of the U group by replacement of a hydrogen atom. The optional substituents corresponding to R^{v} can be attached to any available carbon or nitrogen by replacing a hydrogen atom. For these U rings, r is an integer from 0 to 5, more typically 0 to 4, limited by the number of available positions on each U group.

Note that when G¹, G², G³ or G⁴ comprises a ring selected from U-29 through U-36, U² is selected from O, S or N. Note that when U² is N, the nitrogen atom can complete its valence by substitution with either H or the substituents corresponding to R^{v} as defined in the Summary of the Invention for U (i.e. R²¹ or R²⁶).

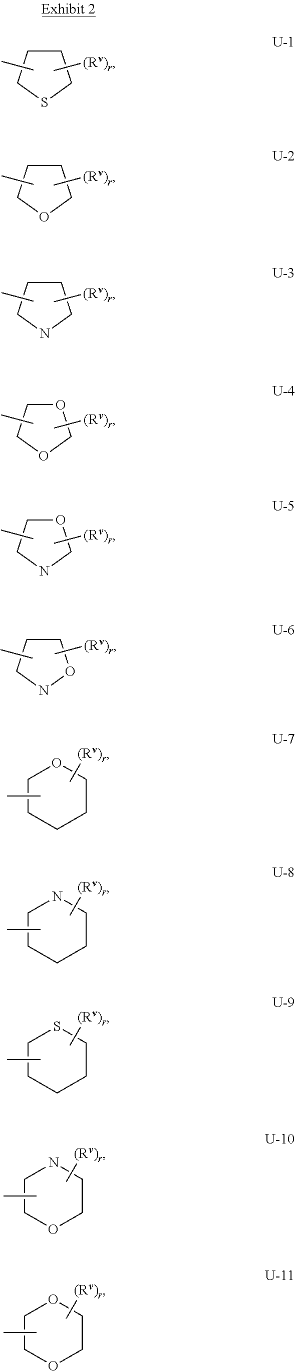

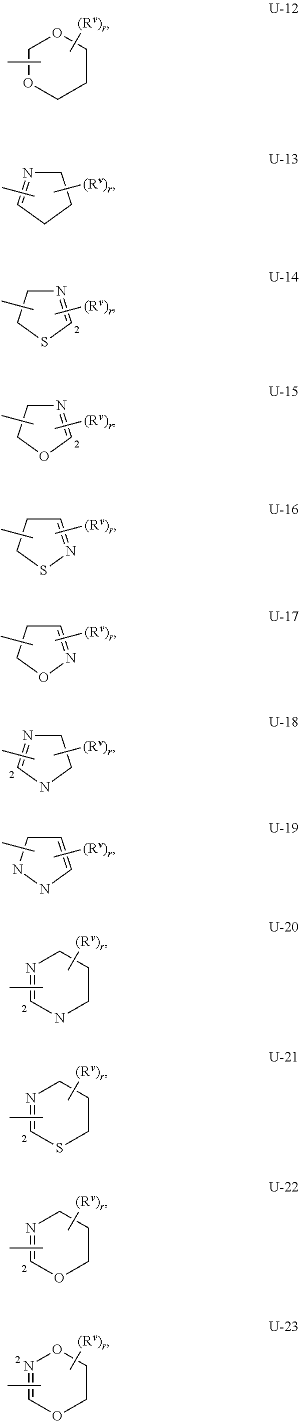

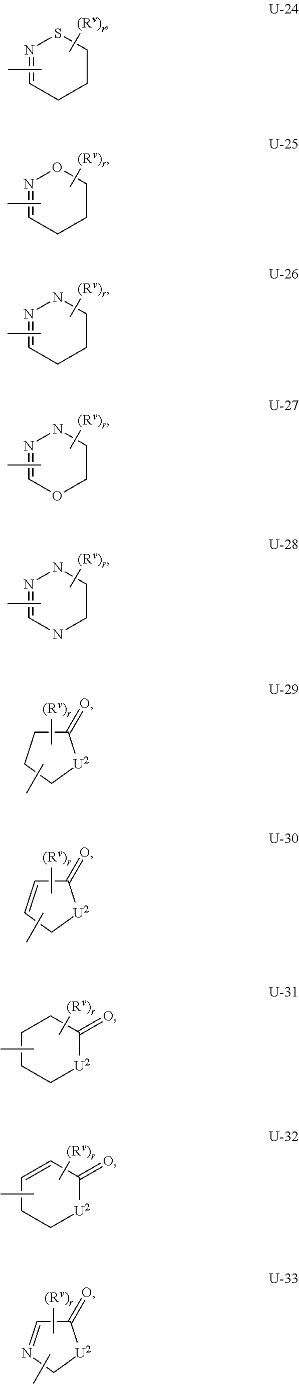

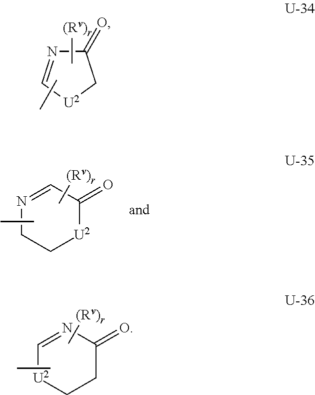

As noted above, G¹, G², G³ or G⁴ can be (among others) an 8-, 9- or 10-membered fused bicyclic ring system optionally substituted with one or more substituents selected from a group of substituents as defined in the Summary of the Invention (i.e. R²¹ or R²⁶). Examples of 8-, 9- or 10-membered fused bicyclic ring system optionally substituted with from one or more substituents include the rings Q-81 through Q-123 illustrated in Exhibit 3 wherein R^{v} is any substituent as defined in the Summary of the Invention for G¹, G², G³ or G⁴ (i.e. R²¹ or R²⁶), and r is an integer from 0 to 5, more typically 0 to 4.

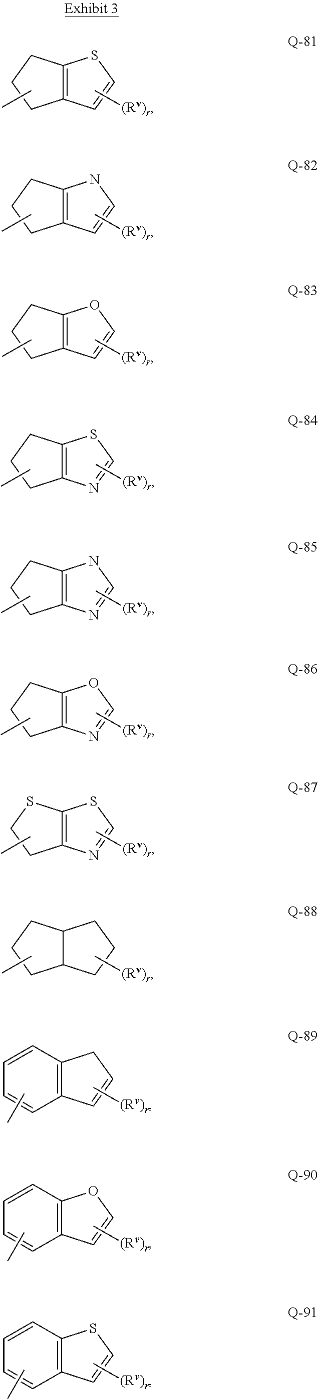

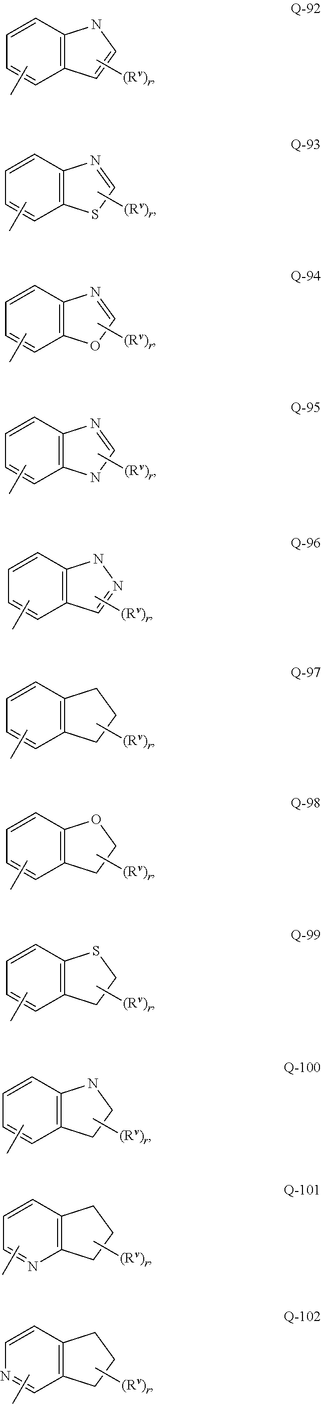

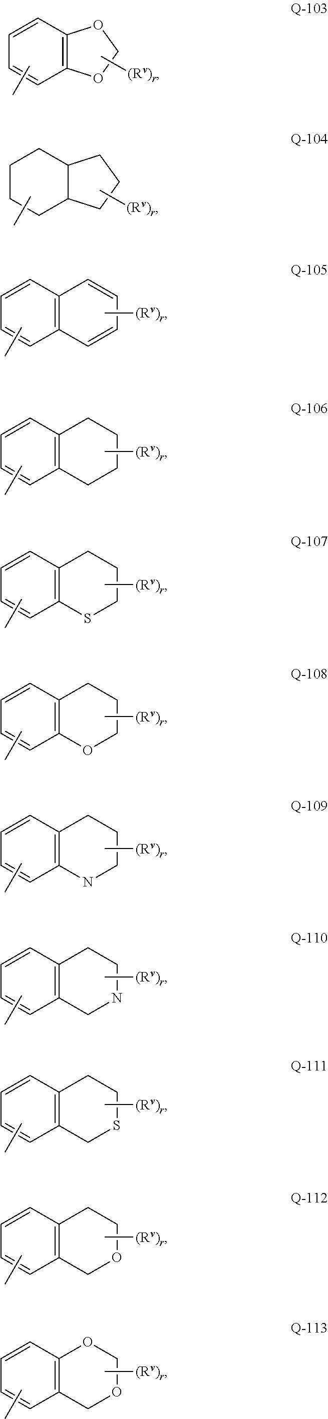

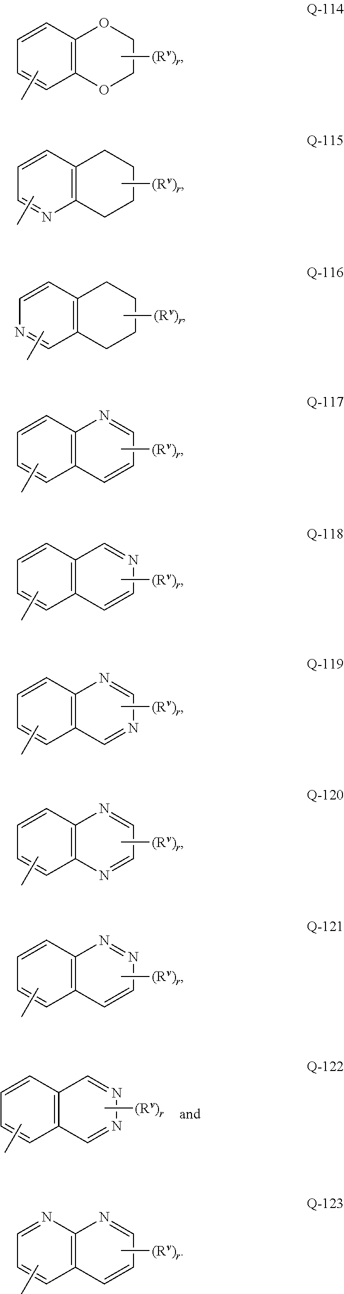

Although R^{v} groups are shown in the structures Q-1 through Q-60 and Q-81 through Q-123, it is noted that they do not need to be present since they are optional substituents. The nitrogen atoms that require substitution to fill their valence are substituted with H or R^{v}. Note that when the attachment point between (R^{v})ᵣ and the Q group is illustrated as floating, (R^{v})ᵣ can be attached to any available carbon atom or nitrogen atom of the Q group. Note that when the attachment point on the Q group is illustrated as floating, the Q group can be attached to the remainder of Formula 1 through any available carbon or nitrogen of the Q group by replacement of a hydrogen atom. Note that some Q groups can only be substituted with less than 4 R^{v} groups (e.g., Q-1 through Q-5, Q-7 through Q-48, and Q-52 through Q-60).

As noted in the Summary of the Invention, besides the possibility of R¹ and R² being separate substituents, they may also be taken together with the pyrazinone nitrogen and carbon atoms linking R¹ and R² to form a 5-, 6- or 7-membered ring fused to the pyrazinone ring. The fused ring includes as ring members the two atoms shared with the pyrazinone ring to which the R¹ and R² substituents are attached. The other 3, 4 or 5 ring members of the fused ring are provided by the R¹ and R² substituents taken together. These other ring members include optionally up to 2 nitrogen atoms, up to 2 oxygen atoms and up to 2 sulfur atoms; the remaining (up to 5 as allowed by ring size) other ring members are carbon atoms. Because one of the ring fusion atoms is nitrogen, the total number of nitrogen atoms in the fused ring is 1 to 3. Up to 2 carbon atom ring members are selected from C(═O), and the sulfur atom ring members are selected from S(═O)ₘ wherein m is 0, 1 or 2. The fused ring is optionally substituted on carbon atom ring members with substituents selected from R²⁴ and on nitrogen atom ring members with substituents selected from R²⁵. Typically the total number of substituents selected from R²⁴ and R²⁵ does not exceed 3.

The fused ring formed by R¹ and R² may be saturated, partially unsaturated or fully unsaturated. However, even when the fused ring is saturated to the fullest extent possible (i.e. only single bonds connecting the ring atoms provided by R¹ and R²), the ring fusion carbon atom will be unsaturated because of the carbon-carbon double bond in the pyrazinone ring. Also, the free electron pair of the ring fusion nitrogen atom will be delocalized due to resonance with double bonds in the pyrazinone ring.

Exhibit 4 provides, as illustrative examples, fused rings formed by R¹ and R² taken together. As these rings are fused with the pyrazinone ring of Formula 1, a portion of the pyrazinone ring is shown and the truncated lines represent the ring bonds of the pyrazinone ring. The rings depicted are fused to the two adjacent atoms of the pyrazinone ring. The optional substituents (R^{v})ᵣ, are independently selected from R²⁴ on carbon atom ring members and from R²⁵ on nitrogen atom ring members. Substituents are limited by the number of available positions on each T-ring. When the attachment point between (R^{v})ᵣ and the T-ring is illustrated as floating, R^{v} may be bonded to any available T-ring carbon or nitrogen atom. One skilled in the art recognizes that while r is nominally an integer from 0 to 3, some of the rings shown in Exhibit 4 have less than 3 available positions, and for these groups r is limited to the number of available positions. When “r” is 0 this means the ring is unsubstituted and hydrogen atoms are present at all available positions. If r is 0 and (R^{v})ᵣ is shown attached to a particular atom, then hydrogen is attached to that atom. The nitrogen atoms that require substitution to fill their valence are substituted with H or R^{v}. Furthermore, one skilled in the art recognizes that some of the rings shown in Exhibit 4 can form tautomers, and the particular tautomer depicted is representative of all the possible tautomers.

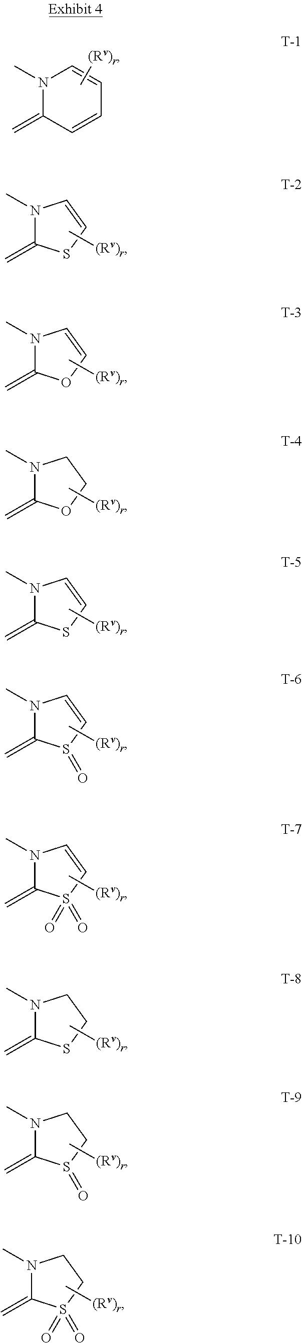

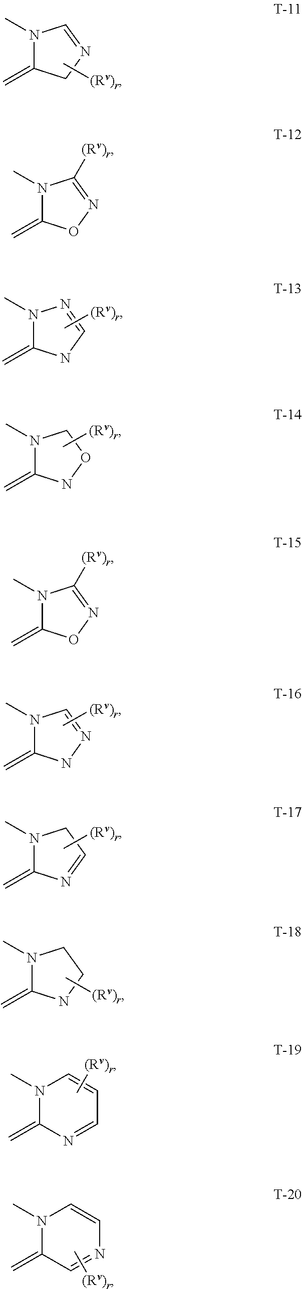

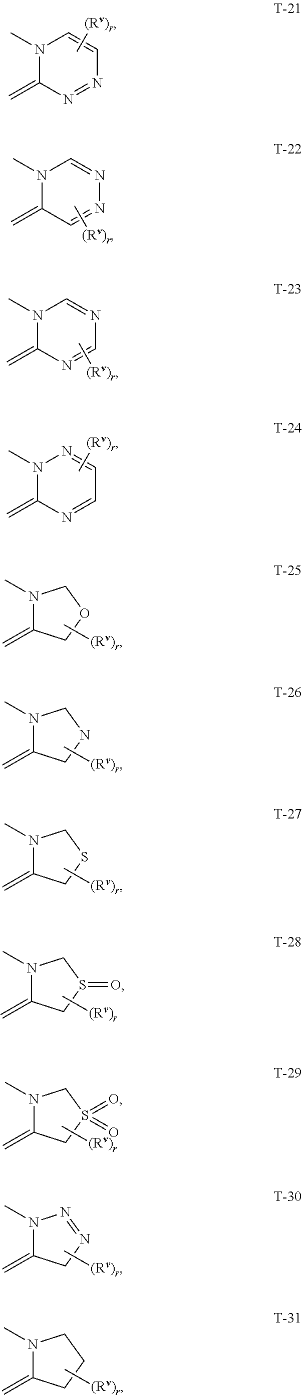

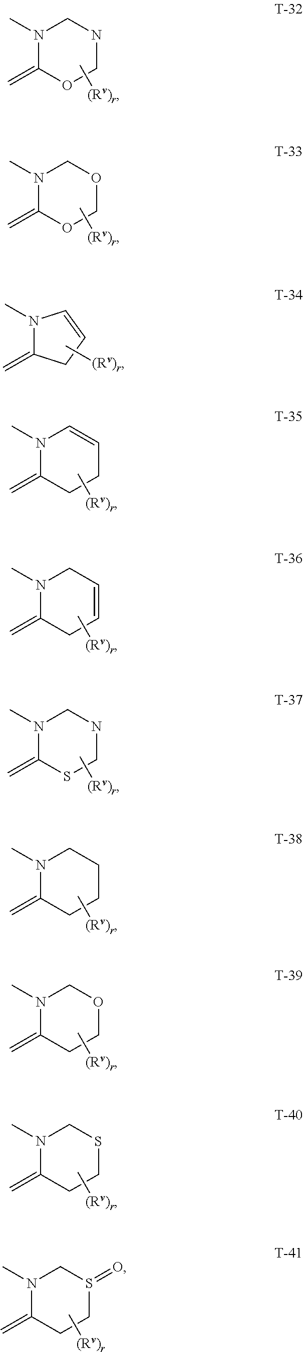

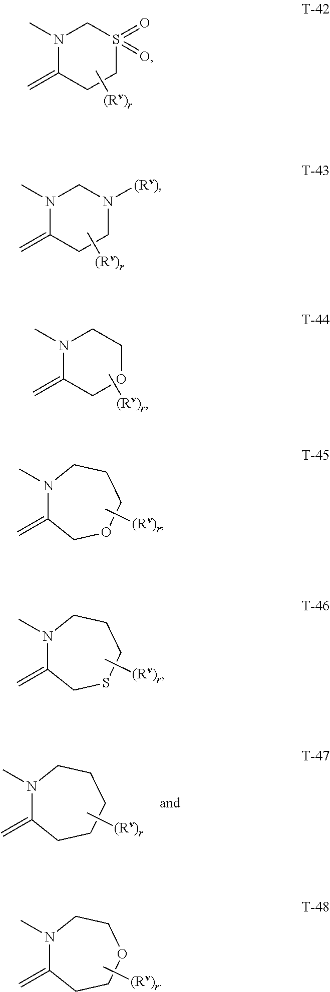

A wide variety of synthetic methods are known in the art to enable preparation of aromatic and nonaromatic heterocyclic rings and ring systems; for extensive reviews see the eight volume set of Comprehensive Heterocyclic Chemistry, A. R. Katritzky and C. W. Rees editors-in-chief, Pergamon Press, Oxford, 1984 and the twelve volume set of Comprehensive Heterocyclic Chemistry II, A. R. Katritzky, C. W. Rees and E. F. V. Scriven editors-in-chief, Pergamon Press, Oxford, 1996.

Compounds of this invention can exist as one or more stereoisomers. The various stereoisomers include enantiomers, diastereomers, atropisomers and geometric isomers. One skilled in the art will appreciate that one stereoisomer may be more active and/or may exhibit beneficial effects when enriched relative to the other stereoisomer(s) or when separated from the other stereoisomer(s). Additionally, the skilled artisan knows how to separate, enrich, and/or to selectively prepare said stereoisomers. The compounds of the invention may be present as a mixture of stereoisomers, individual stereoisomers or as an optically active form.

One skilled in the art will recognize that many of the compounds of the invention as well as intermediate compounds for their preparation can exist in the form of multiple tautomers. For example, when a compound of Formula 1 is identified by A being A-1, A-2 or A-3, and the R⁴ variable being hydroxy or O⁻M⁺, then said compound of Formula 1 can exist as a “triketone” tautomer or a “di-keto enol” tautomer, or a combination thereof. Likewise, when a compound of Formula 1 is identified by A being A-1, A-2 or A-3, and the R⁴ variable being —SH, then said compound of Formula 1 can exist as a “di-keto thioketo” tautomer, a “di-keto thioenol” tautomer or a “keto thioketo enol” tautomer, or a combination thereof. As a further example, a compound of Formula 5 (i.e. A¹-H) wherein A¹ is A¹-1, A¹-2 or A¹-3 can be present as a “di-ketone” tautomer or two possible “keto enol” tautomers, or a combination thereof. Furthermore, acyclic enols (e.g., the fragment A-7 in the definition of the variable A) can exist as tautomers having E and Z configurations. In the context of the present invention, tautomers represent functionally equivalent species, and identification of a compound by one tautomer is to be considered reference to all possible tautomers of the compound unless otherwise indicated.

Compounds selected from Formula 1, stereoisomers, tautomers, N-oxides, and salts thereof, typically exist in more than one form, and Formula 1 thus includes all crystalline and non-crystalline forms of the compounds that Formula 1 represents. Non-crystalline forms include embodiments which are solids such as waxes and gums as well as embodiments which are liquids such as solutions and melts. Crystalline forms include embodiments which represent essentially a single crystal type and embodiments which represent a mixture of polymorphs (i.e. different crystalline types). The term “polymorph” refers to a particular crystalline form of a chemical compound that can crystallize in different crystalline forms, these forms having different arrangements and/or conformations of the molecules in the crystal lattice. Although polymorphs can have the same chemical composition, they can also differ in composition due the presence or absence of co-crystallized water or other molecules, which can be weakly or strongly bound in the lattice. Polymorphs can differ in such chemical, physical and biological properties as crystal shape, density, hardness, color, chemical stability, melting point, hygroscopicity, suspensibility, dissolution rate and biological availability. One skilled in the art will appreciate that a polymorph of a compound of Formula 1 can exhibit beneficial effects (e.g., suitability for preparation of useful formulations, improved biological performance) relative to another polymorph or a mixture of polymorphs of the same compound of Formula 1. Preparation and isolation of a particular polymorph of a compound of Formula 1 can be achieved by methods known to those skilled in the art including, for example, crystallization using selected solvents and temperatures.

One skilled in the art will appreciate that not all nitrogen-containing heterocycles can form N-oxides since the nitrogen requires an available lone pair for oxidation to the oxide; one skilled in the art will recognize those nitrogen-containing heterocycles which can form N-oxides. One skilled in the art will also recognize that tertiary amines can form N-oxides. Synthetic methods for the preparation of N-oxides of heterocycles and tertiary amines are very well known by one skilled in the art including the oxidation of heterocycles and tertiary amines with peroxy acids such as peracetic and m-chloroperbenzoic acid (MCPBA), hydrogen peroxide, alkyl hydroperoxides such as tert-butyl hydroperoxide, sodium perborate, and dioxiranes such as dimethyldioxirane. These methods for the preparation of N-oxides have been extensively described and reviewed in the literature, see for example: T. L. Gilchrist in Comprehensive Organic Synthesis, vol. 7, pp 748-750, S. V. Ley, Ed., Pergamon Press; M. Tisler and B. Stanovnik in Comprehensive Heterocyclic Chemistry, vol. 3, pp 18-20, A. J. Boulton and A. McKillop, Eds., Pergamon Press; M. R. Grimmett and B. R. T. Keene in Advances in Heterocyclic Chemistry, vol. 43, pp 149-161, A. R. Katritzky, Ed., Academic Press; M. Tisler and B. Stanovnik in Advances in Heterocyclic Chemistry, vol. 9, pp 285-291, A. R. Katritzky and A. J. Boulton, Eds., Academic Press; and G. W. H. Cheeseman and E. S. G. Werstiuk in Advances in Heterocyclic Chemistry, vol. 22, pp 390-392, A. R. Katritzky and A. J. Boulton, Eds., Academic Press.

One skilled in the art recognizes that because in the environment and under physiological conditions salts of chemical compounds are in equilibrium with their corresponding nonsalt forms, salts share the biological utility of the nonsalt forms. Thus a wide variety of salts of a compound of Formula 1 are useful for control of undesired vegetation (i.e. are agriculturally suitable). The salts of a compound of Formula 1 include acid-addition salts with inorganic or organic acids such as hydrobromic, hydrochloric, nitric, phosphoric, sulfuric, acetic, butyric, fumaric, lactic, maleic, malonic, oxalic, propionic, salicylic, tartaric, 4-toluenesulfonic or valeric acids. When a compound of Formula 1 contains an acidic moiety such as a carboxylic acid or phenol, salts also include those formed with organic or inorganic bases such as pyridine, triethylamine or ammonia, or amides, hydrides, hydroxides or carbonates of sodium, potassium, lithium, calcium, magnesium or barium. Accordingly, the present invention comprises compounds selected from Formula 1, N-oxides and agriculturally suitable salts thereof.

Embodiments of the present invention as described in the Summary of the Invention include (where Formula 1 as used in the following Embodiments includes N-oxides and salts thereof):
Embodiment 1. A compound of Formula 1 wherein A is A-1, A-3, A-4, A-5 or A-6.
Embodiment 2. A compound of Embodiment 1 wherein A is A-1, A-3, A-5 or A-6.
Embodiment 3. A compound of Embodiment 2 wherein A is A-1, A-3 or A-5.
Embodiment 4. A compound of Embodiment 3 wherein A is A-1 or A-3.
Embodiment 5. A compound of Embodiment 4 wherein A is A-1.
Embodiment 6. A compound of Embodiment 4 wherein A is A-3.
Embodiment 7. A compound of Formula 1 or any one of Embodiments 1 through 3 wherein A is other than A-1.
Embodiment 8. A compound of Formula 1 or any one of Embodiments 1 through 7 wherein B¹ is C-1.
Embodiment 9. A compound of Formula 1 or any one of Embodiments 1 through 7 wherein B¹ is C-2.
Embodiment 10. A compound of Formula 1 or any one of Embodiments 1 through 9 wherein B² is C-3.
Embodiment 11. A compound of Formula 1 or any one of Embodiments 1 through 9 wherein B² is C-4.
Embodiment 12. A compound of Formula 1 or any one of Embodiments 1 through 11 wherein B³ is C-1.
Embodiment 13. A compound of Formula 1 or any one of Embodiments 1 through 11 wherein B³ is C-2.
Embodiment 14. A compound of Formula 1 or any one of Embodiments 1 through 13 wherein when R¹ is taken separately (i.e. not taken together with R² and the atoms linking R¹ and R² to form a fused ring), R¹ is phenyl, phenylsulfonyl, —W¹(phenyl), —W¹(S-phenyl), —W¹(SO₂-phenyl), —W²(SO₂CH₂-phenyl) or —W²(SCH₂-phenyl), each optionally substituted on ring members with up to five substituents selected from R²¹; or -G¹ or —W²G²; or cyano, C₂-C₁₀ cyanoalkyl, hydroxy, amino, —C(═O)OH, —C(═O)NHCN, —C(═O)NHOH, —SO₂NH₂, —SO₂NHCN, —SO₂NHOH, —NHCHO, C₁-C₁₀ alkyl, C₂-C₁₀ alkenyl, C₂-C₁₀ alkynyl, C₁-C₁₀ haloalkyl, C₂-C₁₀ haloalkenyl, C₂-C₁₂ haloalkynyl, C₃-C₁₂ cycloalkyl, C₃-C₁₂ halocycloalkyl, C₄-C₁₄ alkylcycloalkyl, C₄-C₁₄ cycloalkylalkyl, C₆-C₁₈ cycloalkylcycloalkyl, C₄-C₁₄ halocycloalkylalkyl, C₅-C₁₆ alkylcycloalkylalkyl, C₃-C₁₂ cycloalkenyl, C₃-C₁₂ halocycloalkenyl, C₂-C₁₂ alkoxyalkyl, C₃-C₁₂ alkoxyalkenyl, C₄-C₁₄ alkylcycloalkyl, C₄-C₁₄ alkoxycycloalkyl, C₄-C₁₄ cycloalkoxyalkyl, C₅-C₁₄ cycloalkoxyalkoxyalkyl, C₃-C₁₄ alkoxyalkoxyalkyl, C₂-C₁₂ alkylthioalkyl, C₂-C₁₂ alkylsulfonylalkyl, C₂-C₁₂ alkylsulfonylalkyl, C₂-C₁₂ alkylaminoalkyl, C₃-C₁₄ dialkylaminoalkyl, C₂-C₁₂ haloalkylaminoalkyl, C₄-C₁₄ cycloalkylaminoalkyl, C₂-C₁₂ alkylcarbonyl, C₂-C₁₂ haloalkylcarbonyl, C₄-C₁₄ cycloalkylcarbonyl, C₂-C₁₂ alkoxycarbonyl, C₄-C₁₆ cycloalkoxycarbonyl, C₅-C₁₄ cycloalkylalkoxycarbonyl, C₂-C₁₂ alkylaminocarbonyl, C₃-C₁₄ dialkylaminocarbonyl, C₄-C₁₄ cycloalkylaminocarbonyl, C₂-C₉ cyanoalkyl, C₁-C₁₀ hydroxyalkyl, C₄-C₁₄ cycloalkenylalkyl, C₂-C₁₂ haloalkoxyalkyl, C₂-C₁₂ alkoxyhaloalkyl, C₂-C₁₂ haloalkoxyhaloalkyl, C₄-C₁₄ halocycloalkoxyalkyl, C₄-C₁₄ cycloalkenyloxyalkyl, C₄-C₁₄ halocycloalkenyloxyalkyl, C₃-C₁₄ dialkoxyalkyl, C₃-C₁₄ alkoxyalkylcarbonyl, C₃-C₁₄ alkoxycarbonylalkyl or C₂-C₁₂ haloalkoxycarbonyl.
Embodiment 15. A compound of Embodiment 14 wherein when R¹ is taken separately, R¹ is phenyl, phenylsulfonyl, —W¹(phenyl), —W¹(S-phenyl), —W¹(SO₂-phenyl), —W²(SO₂CH₂-phenyl) or —W²(SCH₂-phenyl), each optionally substituted on ring members with up to five substituents selected from R²¹; or -G¹ or —W²G²; or cyano, C₂-C₆ cyanoalkyl, hydroxy, amino, —C(═O)OH, —C(═O)NHCN, —C(═O)NHOH, —SO₂NH₂, —SO₂NHCN, —SO₂NHOH, —NHCHO, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl, C₃-C₈ halocycloalkyl, C₄-C₁₀ alkylcycloalkyl, C₄-C₁₀ cycloalkylalkyl, C₆-C₁₄ cycloalkylcycloalkyl, C₄-C₁₀ halocycloalkylalkyl, C₅-C₁₂ alkylcycloalkylalkyl, C₃-C₈ cycloalkenyl, C₃-C₈ halocycloalkenyl, C₂-C₈ alkoxyalkyl, C₃-C₁₀ alkoxyalkenyl, C₄-C₁₀ alkylcycloalkyl, C₄-C₁₀ alkoxycycloalkyl, C₄-C₁₀ cycloalkoxyalkyl, C₃-C₁₀ alkoxyalkoxyalkyl, C₂-C₈ alkylthioalkyl, C₂-C₈ alkylsulfinylalkyl, C₂-C₈ alkylsulfonylalkyl, C₂-C₈ alkylaminoalkyl, C₃-C₁₀ dialkylaminoalkyl, C₂-C₈ haloalkylaminoalkyl, C₄-C₁₀ cycloalkylaminoalkyl, C₂-C₈ alkylcarbonyl, C₂-C₈ haloalkylcarbonyl, C₄-C₁₀ cycloalkylcarbonyl, C₂-C₈ alkoxycarbonyl, C₄-C₁₀ cycloalkoxycarbonyl, C₅-C₁₂ cycloalkylalkoxycarbonyl, C₂-C₈ alkylaminocarbonyl, C₃-C₁₀ dialkylaminocarbonyl, C₄-C₁₀ cycloalkylaminocarbonyl, C₂-C₅ cyanoalkyl, C₁-C₆ hydroxyalkyl, C₄-C₁₀ cycloalkenylalkyl, C₂-C₈ haloalkoxyalkyl, C₂-C₈ alkoxyhaloalkyl, C₂-C₈ haloalkoxyhaloalkyl, C₄-C₁₀ halocycloalkoxyalkyl, C₄-C₁₀ cycloalkenyloxyalkyl, C₄-C₁₀ halocycloalkenyloxyalkyl, C₃-C₁₀ dialkoxyalkyl, C₃-C₁₀ alkoxyalkylcarbonyl, C₃-C₁₀ alkoxycarbonylalkyl or C₂-C₈ haloalkoxycarbonyl.
Embodiment 16. A compound of Embodiment 15 wherein when R¹ is taken separately, R¹ is phenyl, —W¹(phenyl), —W¹(S-phenyl), —W¹(SO₂-phenyl), —W²(SO₂CH₂-phenyl) or —W²(SCH₂-phenyl), each optionally substituted on ring members with up to five substituents selected from R²¹; or -G¹ or —W²G²; or C₁-C₆ alkyl, C₂-C₆ alkenyl, C₂-C₆ alkynyl, C₁-C₆ haloalkyl, C₂-C₆ haloalkenyl, C₃-C₈ cycloalkyl, C₄-C₁₀ cycloalkylalkyl, C₅-C₁₂ alkylcycloalkylalkyl, C₃-C₈ cycloalkenyl, C₃-C₈ halocycloalkenyl, C₂-C₈ alkoxyalkyl, C₃-C₁₀ alkoxyalkenyl, C₄-C₁₀ alkylcycloalkyl, C₄-C₁₀ alkoxycycloalkyl, C₃-C₁₀ alkoxyalkoxyalkyl, C₂-C₈ alkylthioalkyl or C₂-C₈ alkylsulfonylalkyl.
Embodiment 17. A compound of Embodiment 16 wherein when R¹ is taken separately, R¹ is phenyl or —W¹(phenyl), each optionally substituted on ring members with up to two substituents selected from R²¹; or -G¹ or —W²G²; or C₁-C₆ alkyl, C₂-C₆ alkenyl, C₂-C₆ alkynyl, C₁-C₆ haloalkyl, C₂-C₆ haloalkenyl, C₃-C₈ cycloalkyl, C₄-C₁₀ cycloalkylalkyl, C₅-C₁₂ alkylcycloalkylalkyl, C₃-C₈ cycloalkenyl, C₃-C₈ halocycloalkenyl, C₂-C₈ alkoxyalkyl C₃-C₁₀ alkoxyalkenyl, C₄-C₁₀ alkylcycloalkyl or C₄-C₁₀ alkoxycycloalkyl.
Embodiment 18. A compound of Embodiment 17 wherein when R¹ is taken separately, R¹ is phenyl, 2-fluorophenyl, 3-fluorophenyl, 4-fluorophenyl, 2-chlorophenyl, 3-chlorophenyl, 4-chlorophenyl, 4-methylphenyl, 4-ethylphenyl, 2-methylphenyl, 3-methoxyphenyl, 4-methoxyphenyl, 3,5-dimethylphenyl, 3,4-dimethoxyphenyl, 2,3-dimethylphenyl, 3-fluoro-2-methylphenyl, 4-fluoro-3-methylphenyl or 5-chloro-2-methylphenyl.
Embodiment 19. A compound of Embodiment 18 wherein when R¹ is taken separately, R¹ is phenyl, 4-ethylphenyl, 4-methoxyphenyl, 3,5-dimethylphenyl, 3,4-dimethoxyphenyl, 3-fluoro-2-methylphenyl, 4-fluoro-3-methylphenyl or 5-chloro-2-methylphenyl.
Embodiment 20. A compound of Embodiment 19 wherein when R¹ is taken separately, R¹ is phenyl, 3,4-dimethoxyphenyl or 5-chloro-2-methylphenyl.
Embodiment 21. A compound of Embodiment 20 wherein when R¹ is taken separately, R¹ is phenyl.
Embodiment 22. A compound of Embodiment 20 wherein when R¹ is taken separately, R¹ is 3,4-dimethoxyphenyl.
Embodiment 23. A compound of Embodiment 20 wherein when R¹ is taken separately, R¹ is 5-chloro-2-methylphenyl.
Embodiment 24. A compound of Formula 1 or any one of Embodiments 1 through 20 wherein R¹ is other than phenyl.
Embodiment 25. A compound of Embodiment 17 wherein when R¹ is taken separately, R¹ is -G¹ or —W²G²; or C₁-C₆ alkyl, C₃-C₈ cycloalkyl or C₂-C₈ alkoxyalkyl.
Embodiment 26. A compound of Embodiment 25 wherein when R¹ is taken separately, R¹ is -G¹ or —W²G².
Embodiment 27. A compound of Embodiment 26 wherein when R¹ is taken separately, R¹ is -G¹.
Embodiment 28. A compound of Embodiment 25 wherein when R¹ is taken separately, R¹ is C₁-C₆ alkyl, C₃-C₈ cycloalkyl or C₂-C₈ alkoxyalkyl.
Embodiment 29. A compound of Embodiment 28 wherein when R¹ is taken separately, R¹ is n-propyl, i-propyl, n-butyl, cyclohexyl, cycloheptyl, —CH₂CH₂OCH₃, —CH₂CH₂CH₂OCH₃ or —CH₂CH₂OCH₂CH₃.
Embodiment 30. A compound of Embodiment 29 wherein when R¹ is taken separately, R¹ is n-propyl, cyclohexyl, —CH₂CH₂OCH₃ or —CH₂CH₂CH₂OCH₃.
Embodiment 31. A compound of Embodiment 30 wherein when R¹ is taken separately, R¹ is n-propyl or —CH₂CH₂OCH₃.
Embodiment 32. A compound of Embodiment 30 wherein when R¹ is taken separately, R¹ is cyclohexyl.
Embodiment 33. A compound of Formula 1 or any one of Embodiments 1 through 17 wherein W¹ is C₁-C₆ alkylene.
Embodiment 34. A compound of Embodiment 33 wherein W¹ is —CH₂—.
Embodiment 35. A compound of Formula 1 or any one of Embodiments 1 through 17, 25, 26, 33 or 34 wherein W² is —CH₂—.
Embodiment 36. A compound of Formula 1 or any one of Embodiments 1 through 35 wherein when R² is taken separately (i.e. not taken together with R¹ and the atoms linking R¹ and R² to form a fused ring), R² is phenyl or —W³(phenyl), each optionally substituted on ring members with up to five substituents selected from R²¹; or -G³; or C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl, C₃-C₈ halocycloalkyl, C₄-C₁₀ alkylcycloalkyl, C₄-C₁₀ cycloalkylalkyl, C₆-C₁₄ cycloalkylcycloalkyl, C₄-C₁₀ halocycloalkylalkyl, C₅-C₁₂ alkylcycloalkylalkyl, C₃-C₈ cycloalkenyl, C₃-C₈ halocycloalkenyl, C₂-C₈ alkoxyalkyl, C₃-C₁₀ alkoxyalkenyl, C₄-C₁₀ cycloalkoxyalkyl, C₃-C₁₀ alkoxyalkoxyalkyl, C₂-C₈ alkylthioalkyl, C₂-C₈ alkylsulfinylalkyl, C₂-C₈ alkylsulfonylalkyl, C₂-C₈ alkylcarbonyl, C₄-C₁₀ cycloalkenylalkyl, C₂-C₈ haloalkoxyalkyl, C₂-C₈ alkoxyhaloalkyl, C₂-C₈ haloalkoxyhaloalkyl, C₄-C₁₀ halocycloalkoxyalkyl, C₄-C₁₀ cycloalkenyloxyalkyl, C₄-C₁₀ halocycloalkenyloxyalkyl, C₃-C₁₀ dialkoxyalkyl, C₁-C₆ alkoxy, C₁-C₆ haloalkoxy, C₃-C₈ cycloalkoxy, C₃-C₈ halocycloalkoxy, C₄-C₁₀ cycloalkylalkoxy, C₂-C₆ alkenyloxy, C₂-C₆ haloalkenyloxy, C₃-C₆ alkynyloxy, C₃-C₆ haloalkynyloxy, C₂-C₈ alkoxyalkoxy, C₂-C₈ alkylcarbonyloxy, C₂-C₈ haloalkylcarbonyloxy, C₄-C₁₀ cycloalkylcarbonyloxy, C₃-C₁₀ alkylcarbonylalkoxy, C₁-C₆ alkylthio, C₁-C₆ haloalkylthio, C₃-C₈ cycloalkylthio, C₁-C₆ alkylsulfinyl, C₁-C₆ haloalkylsulfinyl, C₁-C₆ alkylsulfonyl, C₁-C₆ haloalkylsulfonyl, C₃-C₈ cycloalkylsulfonyl, C₃-C₈ trialkylsilyl, C₃-C₈ cycloalkenyloxy, C₃-C₈ halocycloalkenyloxy, C₂-C₈ haloalkoxyalkoxy, C₂-C₈ alkoxyhaloalkoxy, C₂-C₈ haloalkoxyhaloalkoxy, C₃-C₁₀ alkoxycarbonylalkoxy, C₂-C₈ alkyl(thiocarbonyl)oxy, C₃-C₈ cycloalkylsulfinyl or C₃-C₁₀ halotrialkylsilyl.
Embodiment 37. A compound of Embodiment 36 wherein when R² is taken separately, R² is phenyl or —W³(phenyl), each optionally substituted on ring members with up to two substituents selected from R²¹; or -G³; or C₁-C₆ alkyl or C₃-C₈ cycloalkyl.
Embodiment 38. A compound of Embodiment 37 wherein when R² is taken separately, R² is phenyl optionally substituted on ring members with up to two substituents selected from R²¹; or -G³; or C₁-C₆ alkyl or C₃-C₈ cycloalkyl.
Embodiment 39. A compound of Embodiment 38 wherein when R² is taken separately, R² is phenyl, 2-methylphenyl, 3-methylphenyl, 4-chlorophenyl, 3-fluorophenyl or 3,5-difluorophenyl.
Embodiment 40. A compound of Embodiment 38 wherein when R² is taken separately, R² is phenyl, 3-bromophenyl, 3-chlorophenyl or 2-methylphenyl.
Embodiment 41. A compound of Embodiment 38 wherein when R² is taken separately, R² is phenyl.
Embodiment 42. A compound of Formula 1 or any one of Embodiments 1 through 40 wherein R² is other than phenyl.
Embodiment 43. A compound of Embodiment 38 wherein when R² is taken separately, R² is 3-thienyl or 2-thienyl.
Embodiment 44. A compound of Embodiment 38 wherein when R² is taken separately, R² is n-propyl, n-butyl, or cyclopropyl.
Embodiment 44a. A compound of Formula 1 or any one of Embodiments 1 through 44 wherein R¹ and R² are taken separately (i.e. R¹ and R² are not taken together with the atoms linking R¹ and R² to form a fused ring).
Embodiment 45. A compound of Formula 1 or any one of Embodiments 1 through 44 wherein when R¹ and R² are taken together with the atoms linking R¹ and R² to form a fused ring, said ring is 6- or 7-membered.
Embodiment 46. A compound of Embodiment 45 wherein when R¹ and R² are taken together with the atoms linking R¹ and R² to form a fused ring, said ring is 7-membered.
Embodiment 47. A compound of Formula 1 or any one of Embodiments 1 through 46 wherein when R¹ and R² are taken together with the atoms linking R¹ and R² to form a fused ring, a single pair of adjacent ring atoms of said ring are linked together through a double bond.
Embodiment 48. A compound of Formula 1 or any one of Embodiments 1 through 47 wherein when R¹ and R² are taken together with the atoms linking R¹ and R² to form a fused ring, said ring contains ring members selected from carbon atoms, 1 to 2 nitrogen atoms, and optionally up to 1 oxygen atom and up to 1 sulfur atom, wherein up to 1 carbon ring member is selected from C(═O), and the sulfur atom ring member selected from S(═O)ₘ.
Embodiment 48a. A compound of Formula 1 or any one of Embodiments 1 through 48 wherein when R¹ and R² are taken together with the atoms linking R¹ and R² to form a fused ring, said ring is optionally substituted with up to 3 substituents selected from R²⁴ on carbon ring members and from R²⁵ on nitrogen ring members.
Embodiment 48b. A compound of Embodiment 48a wherein when R¹ and R² are taken together with the atoms linking R¹ and R² to form a fused ring, said ring is optionally substituted with up to 2 substituents.
Embodiment 49. A compound of Formula 1 or any one of Embodiments 1 through 48b wherein when R¹ and R² are taken together with the atoms linking R¹ and R² to form a fused ring, said ring is unsubstituted on nitrogen atom ring members.
Embodiment 50. A compound of Formula 1 or any one of Embodiments 1 through 49 wherein when R¹ and R² are taken together with the atoms linking R¹ and R² to form a fused ring, said ring is unsubstituted on carbon atom ring members.
Embodiment 51. A compound of Formula 1 or any one of Embodiments 1 through 49 wherein each R²⁴ is independently halogen, cyano, C₁-C₆ alkyl, C₂-C₆ alkenyl, C₂-C₆ alkynyl, C₁-C₆ haloalkyl, C₃-C₈ cycloalkyl or C₂-C₈ alkoxyalkyl.
Embodiment 52. A compound of Formula 1 or any one of Embodiments 1 through 48b or 50 or 51 wherein each R²⁵ is independently C₁-C₆ alkyl.
Embodiment 53. A compound of Formula 1 or any one of Embodiments 1 through 52 wherein W³ is —CH₂—.
Embodiment 54. A compound of Formula 1 or any one of Embodiments 1 through 53 wherein W⁴ is —CH₂—.
Embodiment 55. A compound of Formula 1 or any one of Embodiments 1 through 54 wherein R³ is H, halogen or methyl.
Embodiment 56. A compound of Embodiment 55 wherein R³ is H or halogen.
Embodiment 57. A compound of Embodiment 56 where R³ is H, F or Cl.
Embodiment 58. A compound of Embodiment 57 wherein R³ is H or Cl.
Embodiment 59. A compound of Embodiment 58 wherein R³ is H.
Embodiment 60. A compound of Embodiment 58 wherein R³ is Cl.
Embodiment 61. A compound of Formula 1 or any one of Embodiments 1 through 60 wherein R⁴ is hydroxy, —O⁻M⁺, C₂-C₈ alkylcarbonyloxy, C₂-C₈ haloalkylcarbonyloxy, C₄-C₁₀ cycloalkylcarbonyloxy or C₃-C₁₀ alkylcarbonylalkoxy; or benzyloxy, phenyloxy, benzylcarbonyloxy, phenylcarbonyloxy, phenylsulfonyloxy or benzylsulfonyloxy, each optionally substituted on ring members with up to two substituents selected from R²¹.
Embodiment 62. A compound of Embodiment 61 wherein R⁴ is hydroxy, —O⁻M⁺ or C₂-C₈ alkylcarbonyloxy; or phenylsulfonyloxy optionally substituted with up to two substituents selected from R²¹.
Embodiment 63. A compound of Formula 1 or any one of Embodiments 1 through 62 wherein M⁺ is a sodium or potassium cation.
Embodiment 64. A compound of Embodiment 62 wherein R⁴ is hydroxy or C₂-C₈ alkylcarbonyloxy.
Embodiment 65. A compound of Embodiment 64 wherein R⁴ is hydroxy or —OC(═O)CH₂CH(CH₃)₂.
Embodiment 65a. A compound of Embodiment 65 wherein R⁴ is hydroxy.
Embodiment 66. A compound of Formula 1 or any one of Embodiments 1 through 65a wherein R⁵, R⁶, R⁷ and R⁸ are each independently H or C₁-C₆ alkyl.
Embodiment 67. A compound of Formula 1 or any one of Embodiments 1 through 66 wherein R⁹ is C₁-C₆ alkyl or C₃-C₈ cycloalkyl.
Embodiment 68. A compound of Embodiment 67 wherein R⁹ is CH₃, CH₂CH₃ or cyclopropyl.
Embodiment 69. A compound of Formula 1 or any one of Embodiments 1 through 68 wherein R¹⁰ is C₁-C₆ alkyl.
Embodiment 70. A compound of Embodiment 69 wherein R¹⁰ is CH₂CH₃.
Embodiment 71. A compound of Formula 1 or any one of Embodiments 1 through 70 wherein R¹¹ is H, halogen or C₁-C₆ alkyl.
Embodiment 72. A compound of Embodiment 71 wherein R¹¹ is H or CH₃.
Embodiment 73. A compound of Formula 1 or any one of Embodiments 1 through 72 wherein R¹² is H or C₁-C₆ alkyl.
Embodiment 74. A compound of Embodiment 73 wherein R¹² is H.
Embodiment 75. A compound of Formula 1 or any one of Embodiments 1 through 74 wherein R¹³ is H, halogen, cyano, hydroxy, amino or C₁-C₆ alkyl.
Embodiment 76. A compound of Formula 1 or any one of Embodiments 1 through 74 wherein R¹³ is H, halogen, cyano, C₁-C₆ alkyl or C₃-C₈ cycloalkyl.
Embodiment 77. A compound of Embodiment 76 wherein R¹³ is CH₃, CH₂CH₃ or cyclopropyl.
Embodiment 78. A compound of Formula 1 or any one of Embodiments 1 through 77 wherein R¹⁴ is H, halogen, cyano or nitro.
Embodiment 79. A compound of Embodiment 78 wherein R¹⁴ is cyano or nitro.
Embodiment 80. A compound of Formula 1 or any one of Embodiments 1 through 79 wherein when instances of R¹⁵ and R¹⁸ are taken separately (i.e. R¹⁵ and R¹⁸ are not taken together as alkylene or alkenylene), then independently said instances of R¹⁵ and R¹⁸ are H or C₁-C₆ alkyl.
Embodiment 81. A compound of Embodiment 80 wherein when instances of R¹⁵ and R¹⁸ are taken separately, then independently said instances of R¹⁵ and R¹⁸ are H or CH₃.
Embodiment 82. A compound of Embodiment 81 wherein when instances of R¹⁵ and R¹⁸ are taken separately, then independently said instances of R¹⁵ and R¹⁸ are H.
Embodiment 83. A compound of Formula 1 or any one of Embodiments 1 through 82 wherein when instances of R¹⁵ and R¹⁸ are taken together, then said instances of R¹⁵ and R¹⁸ are taken together as —CH₂CH₂CH₂—, —CH═CHCH₂— or —CH₂CH═CH—, wherein the bond on the left is connected as R¹⁵ and the bond on the right is connected as R¹⁸.
Embodiment 83a. A compound of Embodiment 83 wherein when instances of R¹⁵ and R¹⁸ are taken together, then said instances of R¹⁵ and R¹⁸ are taken together as as —CH₂CH₂CH₂— or —CH═CHCH₂—.
Embodiment 84. A compound of Formula 1 or any one of Embodiments 1 through 82 wherein all instances of R¹⁵ and R¹⁸ are taken separately.
Embodiment 85. A compound of Formula 1 or any one of Embodiments 1 through 84 wherein independently each R¹⁶ and R¹⁹ is H or C₁-C₆ alkyl.
Embodiment 86. A compound of Embodiment 85 wherein independently each R¹⁶ and R¹⁹ is H or CH₃.
Embodiment 87. A compound of Embodiment 86 wherein independently each R¹⁶ and R¹⁹ is H.
Embodiment 88. A compound of Formula 1 or any one of Embodiments 1 through 81, or 85 or 86 wherein each R¹⁵, R¹⁶, R¹⁸ and R¹⁹ is independently H or CH₃.
Embodiment 89. A compound of Embodiment 88 wherein each R¹⁵, R¹⁶, R¹⁸ and R¹⁹ is H.
Embodiment 90. A compound of Formula 1 or any one of Embodiments 1 through 89 wherein R¹⁷ and R²⁰ are independently H, C₁-C₆ alkyl, C₂-C₆ alkenyl or C₃-C₈ cycloalkyl.
Embodiment 91. A compound of Embodiment 90 wherein R¹⁷ and R²⁰ are independently H or CH₃.
Embodiment 92. A compound of Formula 1 or any one of Embodiments 1 through 91 wherein T is —CH₂CH₂— or —CH═CH—.
Embodiment 93. A compound of Embodiment 92 wherein T is —CH₂CH₂—.
Embodiment 94. A compound of Formula 1 or any one of Embodiments 1 through 93 wherein G¹, G², G³ and G⁴ are independently a 5- or 6-membered heterocyclic ring optionally substituted with up to five substituents selected from R²¹ on carbon ring members and R²⁶ on nitrogen ring members.
Embodiment 95. A compound of Embodiment 94 wherein G¹, G², G³ and G⁴ are independently selected from:

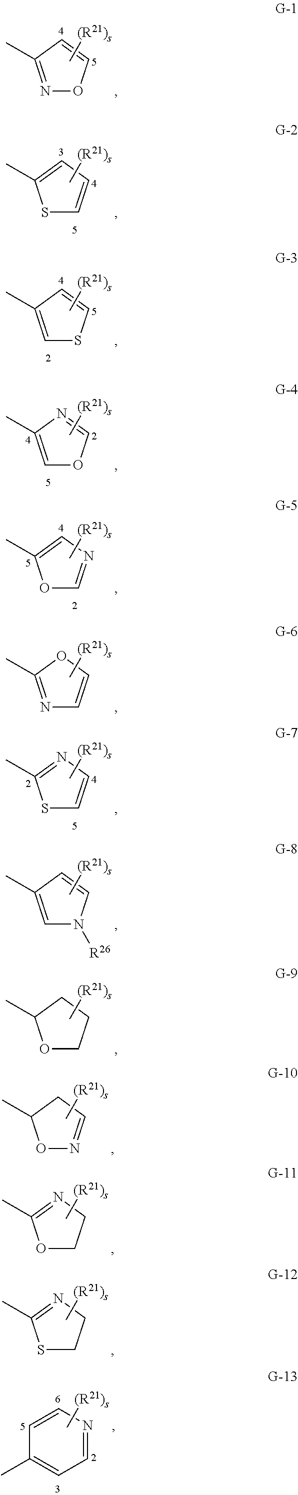

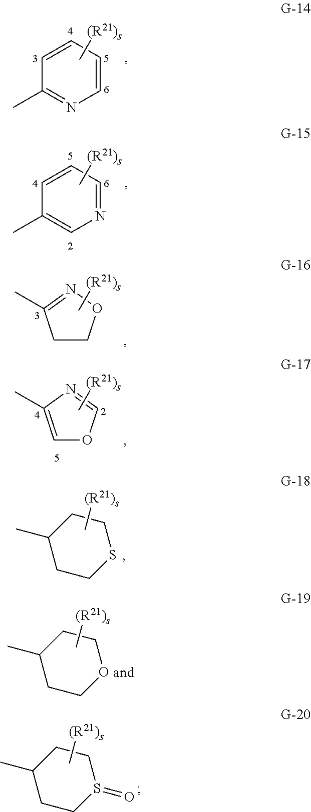

wherein s is 0, 1, 2 or 3.
Embodiment 96. A compound of Embodiment 95 wherein G¹, G², G³ and G⁴ are independently G-2, G-3, G-9, G-15, G-18, G-19 or G-20.
Embodiment 97. A compound of any one of Embodiments 95 or 96 wherein G¹ is G-18, G-19 or G-20.
Embodiment 98. A compound of Embodiment 97 wherein G¹ is G-19 or G-20.
Embodiment 99. A compound of Embodiment 98 wherein G¹ is G-19.
Embodiment 100. A compound of Embodiment 98 wherein G¹ is G-20.
Embodiment 101. A compound of any one of Embodiments 95 through 100 wherein G³ is G-2, G-3 or G-15.
Embodiment 102. A compound of Embodiment 101 wherein G³ is G-2 or G-3.
Embodiment 103. A compound of Embodiment 102 wherein G³ is G-2.
Embodiment 104. A compound of Embodiment 102 wherein when G³ is G-3.
Embodiment 105. A compound of Formula 1 or any one of Embodiments 1 through 104 wherein each R²¹ is independently halogen, cyano, hydroxy, nitro, —CHO, —SH, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl, C₃-C₈ halocycloalkyl, C₄-C₁₀ alkylcycloalkyl, C₄-C₁₀ cycloalkylalkyl, C₃-C₈ cycloalkenyl, C₃-C₈ halocycloalkenyl, C₂-C₈ alkoxyalkyl, C₄-C₁₀ cycloalkoxyalkyl, C₃-C₁₀ alkoxyalkoxyalkyl, C₂-C₈ alkylthioalkyl, C₂-C₈ alkylsulfinylalkyl, C₂-C₈ alkoxyhaloalkyl, C₂-C₅ cyanoalkyl, C₁-C₆ hydroxyalkyl, C₁-C₆ alkoxy, C₁-C₆ haloalkoxy, C₃-C₈ cycloalkoxy, C₃-C₈ halocycloalkoxy, C₄-C₁₀ cycloalkylalkoxy, C₂-C₆ alkenyloxy, C₂-C₆ haloalkenyloxy, C₂-C₈ alkoxyalkoxy, C₂-C₈ alkylcarbonyloxy, C₁-C₆ alkylthio, C₁-C₆ haloalkylthio, C₃-C₈ cycloalkylthio, C₁-C₆ alkylsulfinyl, C₁-C₆ haloalkylsulfinyl, C₁-C₆ alkylsulfonyl, C₁-C₆ haloalkylsulfonyl or C₃-C₈ cycloalkylsulfonyl.
Embodiment 106. A compound of Embodiment 105 wherein each R²¹ is independently halogen, nitro, C₁-C₆ alkyl, C₁-C₆ haloalkyl, C₁-C₆ alkoxy, C₁-C₆ haloalkoxy or C₁-C₆ alkylthio.
Embodiment 107. A compound of Embodiment 106 wherein each R²¹ is independently fluorine, chlorine, bromine, CH₃, CF₃, OCH₃, OCF₃ or SCH₃.
Embodiment 108. A compound of Formula 1 or any one of Embodiments 1 through 107 wherein each R²⁶ is independently C₁-C₆ alkyl or C₁-C₆ haloalkyl.
Embodiment 109. A compound of Embodiment 108 wherein each R²⁶ is independently CH₃ or CH₂CF₃.
Embodiment 110. A compound of Formula 1 or any one of Embodiments 1 through 109 wherein when R⁴ is optionally substituted benzyloxy or R⁵, R⁶, R⁷ or R⁸ is optionally substituted benzyl, then R¹ and R² are taken separately.

This invention also includes a herbicidal mixture comprising (a) a compound selected from Formula 1, N-oxides, and salts thereof, and (b) at least one additional active ingredient compound selected from (b1) photosystem II inhibitors, (b2) acetohydroxy acid synthase inhibitors, (b3) acetyl-CoA carboxylase inhibitors, (b4) auxin mimics and (b5) 5-enol-pyruvylshikimate-3-phosphate synthase inhibitors, (b6) photosystem I electron diverters, (b7) protoporphyrinogen oxidase inhibitors, (b8) glutamine synthetase inhibitors, (b9) very long chain fatty acid elongase inhibitors, (b10) auxin transport inhibitors, (b11) phytoene desaturase inhibitors, (b12) 4-hydroxyphenyl-pyruvate dioxygenase inhibitors, (b13) homogentisate solenesyltransererase inhibitors, (b14) other herbicides including mitotic disruptors, organic arsenicals, asulam, difenzoquat, bromobutide, flurenol, cinmethylin, cumyluron, dazomet, dymron, methyldymron, etobenzanid, fosamine, fosamine-ammonium, metam, oxaziclomefone, oleic acid, pelargonic acid and pyributicarb, and (b15) herbicide safeners; and salts of compounds of (b1) through (b15).
Embodiment 111. A herbicidal mixture comprising (a) a compound of Formula 1 or any one of Embodiments 1 through 110 and (b) at least one additional active ingredient compound selected from (b1), (b2), (b3), (b12), (b13) and (b15).
Embodiment 112. A herbicidal mixture of Embodiment 111 wherein component (b) comprises at least one active ingredient compound selected from (b1), (b12), (b13) and (b15).
Embodiment 113. A herbicidal mixture of Embodiment 112 wherein component (b) comprises at least one active ingredient compound selected from (b1) photosystem II inhibitors.
Embodiment 114. A herbicidal mixture of Embodiment 113 wherein component (b) comprises bromoxynil.
Embodiment 115. A herbicidal mixture of Embodiment 113 wherein component (b) comprises dimethametryn.
Embodiment 116. A herbicidal mixture of Embodiment 112 wherein component (b) comprises at least one active ingredient compound selected from (b13) homogentisate solenesyltransererase inhibitors.
Embodiment 117. A herbicidal mixture of Embodiment 116 wherein component (b) comprises haloxydine.
Embodiment 118. A herbicidal mixture of Embodiment 112 wherein component (b) comprises at least one active ingredient compound selected from (b15) herbicide safeners.
Embodiment 119. A herbicidal mixture of Embodiment 118 wherein component (b) comprises at least one active ingredient compound selected from benoxacor, 1-bromo-4-[(chloromethyl)sulfonyl]benzene, cloquintocet-mexyl, cumyluron, cyometrinil, cyprosulfamide, daimuron, dichlormid, dicyclonon, 4-(dichloroacetyl)-1-oxa-4-azospiro[4.5]decane (MON 4660), 2-(dichloromethyl)-2-methyl-1,3-dioxolane (MG 191), dimepiperate, fenchlorazole-ethyl, fenclorim, flurazole, fluxofenim, furilazole, isoxadifen-ethyl, mefenpyr-diethyl, mephenate, methoxyphenone, naphthalic anhydride and oxabetrinil.
Embodiment 120. A herbicidal mixture of Embodiment 119 wherein component (b) comprises at least one active ingredient compound selected from benoxacor, cloquintocet-mexyl, cyprosulfamide, daimuron, fenchlorazole-ethyl, mefenpyr-diethyl, mephenate and oxabetrinil.
Embodiment 121. A herbicidal mixture of Embodiment 120 wherein component (b) comprises at least one active ingredient compound selected from cloquintocet-mexyl, mefenpyr-diethyl and oxabetrinil.
Embodiment 122. A herbicidal mixture of Embodiment 121 wherein component (b) comprises at least one active ingredient compound selected from mefenpyr-diethyl and cloquinocet-mexyl
Embodiment 123. A herbicidal mixture or Embodiment 122 wherein component (b) comprises cloquintocet-mexyl.
Embodiment 124. A herbicidal mixture or Embodiment 121 wherein component (b) comprises oxabetrinil.

Embodiments of this invention, including Embodiments 1-110 above as well as any other embodiments described herein, can be combined in any manner, and the descriptions of variables in the embodiments pertain not only to the compounds of Formula 1 but also to the starting compounds and intermediate compounds, including compounds of Formulae 2, 3 and 4, useful for preparing the compounds of Formula 1. In addition, embodiments of this invention, including Embodiments 1-110 above as well as any other embodiments described herein, and any combination thereof, pertain to the compositions and methods of the present invention.

Combinations of Embodiments 1-110 are illustrated by:

Embodiment A. A compound of Formula 1 wherein
A is A-1, A-3, A-4, A-5 or A-6;
R¹ is phenyl, phenylsulfonyl, —W¹(phenyl), —W¹(S-phenyl), —W¹(SO₂-phenyl), —W²(SO₂CH₂-phenyl) or —W²(SCH₂-phenyl), each optionally substituted on ring members with up to five substituents selected from R²¹; or -G¹ or —W²G²; or cyano, C₂-C₁₀ cyanoalkyl, hydroxy, amino, —C(═O)OH, —C(═O)NHCN, —C(═O)NHOH, —SO₂NH₂, —SO₂NHCN, —SO₂NHOH, —NHCHO, C₁-C₁₀ alkyl, C₂-C₁₀ alkenyl, C₂-C₁₀ alkynyl, C₁-C₁₀ haloalkyl, C₂-C₁₀ haloalkenyl, C₂-C₁₂ haloalkynyl, C₃-C₁₂ cycloalkyl, C₃-C₁₂ halocycloalkyl, C₄-C₁₄ alkylcycloalkyl, C₄-C₁₄ cycloalkylalkyl, C₆-C₁₈ cycloalkylcycloalkyl, C₄-C₁₄ halocycloalkylalkyl, C₅-C₁₆ alkylcycloalkylalkyl, C₃-C₁₂ cycloalkenyl, C₃-C₁₂ halocycloalkenyl, C₂-C₁₂ alkoxyalkyl, C₃-C₁₂ alkoxyalkenyl, C₄-C₁₄ alkylcycloalkyl, C₄-C₁₄ alkoxycycloalkyl, C₄-C₁₄ cycloalkoxyalkyl, C₅-C₁₄ cycloalkoxyalkoxyalkyl, C₃-C₁₄ alkoxyalkoxyalkyl, C₂-C₁₂ alkylthioalkyl, C₂-C₁₂ alkylsulfinylalkyl, C₂-C₁₂ alkylsulfonylalkyl, C₂-C₁₂ alkylaminoalkyl, C₃-C₁₄ dialkylaminoalkyl, C₂-C₁₂ haloalkylaminoalkyl, C₄-C₁₄ cycloalkylaminoalkyl, C₂-C₁₂ alkylcarbonyl, C₂-C₁₂ haloalkylcarbonyl, C₄-C₁₄ cycloalkylcarbonyl, C₂-C₁₂ alkoxycarbonyl, C₄-C₁₆ cycloalkoxycarbonyl, C₅-C₁₄ cycloalkylalkoxycarbonyl, C₂-C₁₂ alkylaminocarbonyl, C₃-C₁₄ dialkylaminocarbonyl, C₄-C₁₄ cycloalkylaminocarbonyl, C₂-C₉ cyanoalkyl, C₁-C₁₀ hydroxyalkyl, C₄-C₁₄ cycloalkenylalkyl, C₂-C₁₂ haloalkoxyalkyl, C₂-C₁₂ alkoxyhaloalkyl, C₂-C₁₂ haloalkoxyhaloalkyl, C₄-C₁₄ halocycloalkoxyalkyl, C₄-C₁₄ cycloalkenyloxyalkyl, C₄-C₁₄ halocycloalkenyloxyalkyl, C₃-C₁₄ dialkoxyalkyl, C₃-C₁₄ alkoxyalkylcarbonyl, C₃-C₁₄ alkoxycarbonylalkyl or C₂-C₁₂ haloalkoxycarbonyl;
R² is phenyl or —W³(phenyl), each optionally substituted on ring members with up to five substituents selected from R²¹; or -G³; C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl, C₃-C₈ halocycloalkyl, C₄-C₁₀ alkylcycloalkyl, C₄-C₁₀ cycloalkylalkyl, C₆-C₁₄ cycloalkylcycloalkyl, C₄-C₁₀ halocycloalkylalkyl, C₅-C₁₂ alkylcycloalkylalkyl, C₃-C₈ cycloalkenyl, C₃-C₈ halocycloalkenyl, C₂-C₈ alkoxyalkyl, C₃-C₁₀ alkoxyalkenyl, C₄-C₁₀ cycloalkoxyalkyl, C₃-C₁₀ alkoxyalkoxyalkyl, C₂-C₈ alkylthioalkyl, C₂-C₈ alkylsulfinylalkyl, C₂-C₈ alkylsulfonylalkyl, C₂-C₈ alkylcarbonyl, C₄-C₁₀ cycloalkenylalkyl, C₂-C₈ haloalkoxyalkyl, C₂-C₈ alkoxyhaloalkyl, C₂-C₈ haloalkoxyhaloalkyl, C₄-C₁₀ halocycloalkoxyalkyl, C₄-C₁₀ cycloalkenyloxyalkyl, C₄-C₁₀ halocycloalkenyloxyalkyl, C₃-C₁₀ dialkoxyalkyl, C₁-C₆ alkoxy, C₁-C₆ haloalkoxy, C₃-C₈ cycloalkoxy, C₃-C₈ halocycloalkoxy, C₄-C₁₀ cycloalkylalkoxy, C₂-C₆ alkenyloxy, C₂-C₆ haloalkenyloxy, C₃-C₆ alkynyloxy, C₃-C₆ haloalkynyloxy, C₂-C₈ alkoxyalkoxy, C₂-C₈ alkylcarbonyloxy, C₂-C₈ haloalkylcarbonyloxy, C₄-C₁₀ cycloalkylcarbonyloxy, C₃-C₁₀ alkylcarbonylalkoxy, C₁-C₆ alkylthio, C₁-C₆ haloalkylthio, C₃-C₈ cycloalkylthio, C₁-C₆ alkylsulfinyl, C₁-C₆ haloalkylsulfinyl, C₁-C₆ alkylsulfonyl, C₁-C₆ haloalkylsulfonyl, C₃-C₈ cycloalkylsulfonyl, C₃-C₈ trialkylsilyl, C₃-C₈ cycloalkenyloxy, C₃-C₈ halocycloalkenyloxy, C₂-C₈ haloalkoxyalkoxy, C₂-C₈ alkoxyhaloalkoxy, C₂-C₈ haloalkoxyhaloalkoxy, C₃-C₁₀ alkoxycarbonylalkoxy, C₂-C₈ alkyl(thiocarbonyl)oxy, C₃-C₈ cycloalkylsulfinyl or C₃-C₁₀ halotrialkylsilyl; or
R¹ and R² are taken together with the atoms linking R¹ and R² to form a fused 6- or 7-membered ring containing ring members selected from carbon atoms, 1 to 3 nitrogen atoms, and optionally up to 2 oxygen atoms and up to 2 sulfur atoms, wherein up to 2 carbon atom ring members are selected from C(═O), and the sulfur atom ring members are independently selected from S(═O)ₘ; the ring optionally substituted on carbon atom ring members with substituents selected from R²⁴; and optionally substituted on nitrogen atom ring members with substituents selected from R²⁵;
R³ is H, halogen or methyl;
R⁴ is hydroxy, —O⁻M⁺, C₂-C₈ alkylcarbonyloxy, C₂-C₈ haloalkylcarbonyloxy, C₄-C₁₀ cycloalkylcarbonyloxy or C₃-C₁₀ alkylcarbonylalkoxy; or benzyloxy, phenyloxy, benzylcarbonyloxy, phenylcarbonyloxy, phenylsulfonyloxy or benzylsulfonyloxy, each optionally substituted on ring members with up to two substituents selected from R²¹;
M⁺ is a sodium or potassium cation;
R¹⁰ is C₁-C₆ alkyl;
R¹¹ is H, halogen or C₁-C₆ alkyl;
R¹² is H or C₁-C₆ alkyl;
R¹³ is H, halogen, cyano, hydroxy, amino or C₁-C₆ alkyl;
R¹⁴ is cyano or nitro;
each R¹⁵, R¹⁶, R¹⁸ and R¹⁹ is independently H or CH₃;
R¹⁷ and R²⁰ are independently H or CH₃;
W¹ is C₁-C₆ alkylene;
W² is —CH₂—;
W³ is —CH₂—;
W⁴ is —CH₂—;
T is —CH₂CH₂— or —CH═CH—;
G¹, G², G³ and G⁴ are independently selected from G-1 through G-20 (as depicted in Embodiment 95);
s is 0, 1, 2 or 3;
each R²¹ is independently halogen, cyano, hydroxy, nitro, —CHO, —SH, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl, C₃-C₈ halocycloalkyl, C₄-C₁₀ alkylcycloalkyl, C₄-C₁₀ cycloalkylalkyl, C₃-C₈ cycloalkenyl, C₃-C₈ halocycloalkenyl, C₂-C₈ alkoxyalkyl, C₄-C₁₀ cycloalkoxyalkyl, C₃-C₁₀ alkoxyalkoxyalkyl, C₂-C₈ alkylthioalkyl, C₂-C₈ alkylsulfinylalkyl, C₂-C₈ alkoxyhaloalkyl, C₂-C₅ cyanoalkyl, C₁-C₆ hydroxyalkyl, C₁-C₆ alkoxy, C₁-C₆ haloalkoxy, C₃-C₈ cycloalkoxy, C₃-C₈ halocycloalkoxy, C₄-C₁₀ cycloalkylalkoxy, C₂-C₆ alkenyloxy, C₂-C₆ haloalkenyloxy, C₂-C₈ alkoxyalkoxy, C₂-C₈ alkylcarbonyloxy, C₁-C₆ alkylthio, C₁-C₆ haloalkylthio, C₃-C₈ cycloalkylthio, C₁-C₆ alkylsulfinyl, C₁-C₆ haloalkylsulfinyl, C₁-C₆ alkylsulfonyl, C₁-C₆ haloalkylsulfonyl or C₃-C₈ cycloalkylsulfonyl; and
each R²⁶ is independently C₁-C₆ alkyl or C₁-C₆ haloalkyl.

Embodiment B. A compound of Embodiment A wherein
A is A-1, A-3 or A-5;
B¹ is C-1;
B² is C-3;
B³ is C-1;
R¹ is phenyl, —W¹(phenyl), —W¹(S-phenyl), —W¹(SO₂-phenyl), —W²(SO₂CH₂-phenyl) or —W²(SCH₂-phenyl), each optionally substituted on ring members with up to five substituents selected from R²¹; or -G¹ or —W²G²; or C₁-C₆ alkyl, C₂-C₆ alkenyl, C₂-C₆ alkynyl, C₁-C₆ haloalkyl, C₂-C₆ haloalkenyl, C₃-C₈ cycloalkyl, C₄-C₁₀ cycloalkylalkyl, C₅-C₁₂ alkylcycloalkylalkyl, C₃-C₈ cycloalkenyl, C₃-C₈ halocycloalkenyl, C₂-C₈ alkoxyalkyl, C₃-C₁₀ alkoxyalkenyl, C₄-C₁₀ alkylcycloalkyl, C₄-C₁₀ alkoxycycloalkyl, C₃-C₁₀ alkoxyalkoxyalkyl, C₂-C₈ alkylthioalkyl, C₂-C₁₂ alkylsulfinylalkyl or C₂-C₈ alkylsulfonylalkyl;
W¹ is —CH₂—;
R² is phenyl or —W³(phenyl), each optionally substituted on ring members with up to two substituents selected from R²¹; or -G³; or C₁-C₆ alkyl or C₃-C₈ cycloalkyl;
R³ is H or halogen;
R⁴ is hydroxy or C₂-C₈ alkylcarbonyloxy;
R¹⁰ is CH₂CH₃;
R¹¹ is H or CH₃;
G¹, G², G³ and G⁴ are independently G-2, G-3, G-9, G-15, G-18, G-19 or G-20; and
each R²¹ is independently halogen, nitro, C₁-C₆ alkyl, C₁-C₆ haloalkyl, C₁-C₆ alkoxy, C₁-C₆ haloalkoxy or C₁-C₆ alkylthio.

Embodiment C. A compound of Embodiment B wherein
A is A-1 or A-3;
R¹ is phenyl, 2-fluorophenyl, 3-fluorophenyl, 4-fluorophenyl, 2-chlorophenyl, 3-chlorophenyl, 4-chlorophenyl, 4-methylphenyl, 4-ethylphenyl, 2-methylphenyl, 3-methoxyphenyl, 4-methoxyphenyl, 3,5-dimethylphenyl, 3,4-dimethoxyphenyl, 2,3-dimethylphenyl, 3-fluoro-2-methylphenyl, 4-fluoro-3-methylphenyl or 5-chloro-2-methylphenyl;
R² is phenyl, 2-methylphenyl, 3-methylphenyl, 3-bromophenyl, 3-chlorophenyl, 4-chlorophenyl, 3-fluorophenyl or 3,5-difluorophenyl;
R³ is H, F or Cl;
R⁴ is hydroxy or —OC(═O)CH₂CH(CH₃)₂; and
T is —CH₂CH₂—.

Embodiment D. A compound of Embodiment C wherein
A is A-1;
R¹ is phenyl, 4-ethylphenyl, 4-methoxyphenyl, 3,5-dimethylphenyl, 3,4-dimethoxyphenyl, 3-fluoro-2-methylphenyl, 4-fluoro-3-methylphenyl or 5-chloro-2-methylphenyl;
R² is phenyl, 3-chlorophenyl, or 2-methylphenyl; and
each R¹⁵, R¹⁶, R¹⁸ and R¹⁹ is H.

Embodiment E. A compound of Embodiment B wherein
A is A-3;
R¹ is n-propyl or —CH₂CH₂OCH₃;
R² is phenyl, 2-methylphenyl, 3-methylphenyl, 4-chlorophenyl, 3-fluorophenyl or 3,5-difluorophenyl;
R³ is H, F or Cl;
R⁴ is hydroxy; and
each R¹⁵, R¹⁶, R¹⁸ and R¹⁹ is H.

Embodiment F. A compound of Embodiment B wherein
A is A-1;
R¹ is -G¹ or —W²G²; or C₁-C₆ alkyl, C₃-C₈ cycloalkyl, or C₂-C₈ alkoxyalkyl;
G¹ is G-19 or G-20;
R² is phenyl, 2-methylphenyl, 3-methylphenyl, 4-chlorophenyl, 3-fluorophenyl or 3,5-difluorophenyl;
R³ is H, F or Cl;
R⁴ is hydroxy; and
each R¹⁵, R¹⁶, R¹⁸ and R¹⁹ is H.

Embodiment G. A compound of Embodiment B wherein
A is A-1;
R¹ is n-propyl, cyclohexyl, —CH₂CH₂OCH₃ or —CH₂CH₂CH₂OCH₃;
R² is 3-thienyl or 2-thienyl;
R³ is H, F or Cl;
R⁴ is hydroxy; and
each R¹⁵, R¹⁶, R¹⁸ and R¹⁹ is H.

Specific embodiments include a compound of Formula 1 selected from:
1-butyl-3-[(2-hydroxy-6-oxo-1-cyclohexen-1-yl)carbonyl]-6-phenyl-2(1H)-pyrazinone (Compound 1),
5-chloro-1-cyclohexyl-6-(3-fluorophenyl)-3-[(2-hydroxy-6-oxo-1-cyclohexen-1-yl)carbonyl]-2(1H)pyrazinone (Compound 2),
5-chloro-6-(3-chlorophenyl)-1-cyclohexyl-3-[(2-hydroxy-6-oxo-1-cyclohexen-1-yl)carbonyl]-2(1H)-pyrazinone (Compound 3),
5-chloro-6-(3-fluorophenyl)-3-[(2-hydroxy-6-oxo-1-cyclohexen-1-yl)carbonyl]-1-(2-methoxyethyl)-2(1H)pyrazinone (Compound 4),
6-(3,5-difluorophenyl)-3-[(2-hydroxy-6-oxo-1-cyclohexen-1-yl)carbonyl]-1-(2-methoxyethyl)-2(1H)-pyrazinone (Compound 5),
5-chloro-6-(3,5-difluorophenyl)-3-[(2-hydroxy-6-oxo-1-cyclohexen-1-yl)carbonyl]-1-(2-methoxyethyl)-2(1H)pyrazinone (Compound 6) and
5-chloro-6-(3-fluorophenyl)-3-[(2-hydroxy-6-oxo-1-cyclohexen-1-yl)carbonyl]-1-(2-methoxyethyl)-2(1H)pyrazinone (Compound 7).

This invention also relates to a method for controlling undesired vegetation comprising applying to the locus of the vegetation a herbicidally effective amount of a compound of the invention (e.g., as a composition described herein). Of note as embodiments relating to methods of use are those involving the compounds of embodiments described above.

This invention also includes a herbicidal mixture comprising (a) a compound selected from Formula 1, N-oxides, and salts thereof, and (b) at least one additional active ingredient compound selected from (b1) photosystem II inhibitors, (b2) acetohydroxy acid synthase (AHAS) inhibitors, (b3) acetyl-CoA carboxylase (ACCase) inhibitors, (b4) auxin mimics, (b5) 5-enol-pyruvylshikimate-3-phosphate (EPSP) synthase inhibitors, (b6) photosystem I electron diverters, (b7) protoporphyrinogen oxidase (PPO) inhibitors, (b8) glutamine synthetase (GS) inhibitors, (b9) very long chain fatty acid (VLCFA) elongase inhibitors, (b10) auxin transport inhibitors, (b11) phytoene desaturase (PDS) inhibitors, (b12) 4-hydroxyphenyl-pyruvate dioxygenase (HPPD) inhibitors, (b13) homogentisate solenesyltransererase (HST) inhibitors, (b14) other herbicides including mitotic disruptors, organic arsenicals, asulam, difenzoquat, bromobutide, flurenol, cinmethylin, cumyluron, dazomet, dymron, methyldymron, etobenzanid, fosamine, fosamine-ammonium, metam, oxaziclomefone, oleic acid, pelargonic acid and pyributicarb, and (b15) herbicide safeners; and salts of compounds of (b1) through (b15).

“Photosystem II inhibitors” (b1) are chemical compounds that bind to the D-1 protein at the Q_{B}-binding niche and thus block electron transport from Q_{A} to Q_{B} in the chloroplast thylakoid membranes. The electrons blocked from passing through photosystem II are transferred through a series of reactions to form toxic compounds that disrupt cell membranes and cause chloroplast swelling, membrane leakage, and ultimately cellular destruction. The Q_{B}-binding niche has three different binding sites: binding site A binds the triazines such as atrazine, triazinones such as hexazinone, and uracils such as bromacil, binding site B binds the phenylureas such as diuron, and binding site C binds benzothiadiazoles such as bentazon, nitriles such as bromoxynil and phenyl-pyridazines such as pyridate. Examples of photosystem II inhibitors include ametryn, atrazine, cyanazine, desmetryne, dimethametryn, prometon, prometryne, propazine, simazine, simetryn, terbumeton, terbuthylazine, terbutryne, trietazine, hexazinone, metamitron, metribuzin, amicarbazone, bromacil, lenacil, terbacil, chloridazon, desmedipham, phenmedipham, chlorobromuron, chlorotoluron, chloroxuron, dimefuron, diuron, ethidimuron, fenuron, fluometuron, isoproturon, isouron, linuron, methabenzthiazuron, metobromuron, metoxuron, monolinuron, neburon, siduron, tebuthiuron, propanil, pentanochlor, bromofenoxim, bromoxynil, ioxynil, bentazon, pyridate and pyridafol.

“AHAS inhibitors” (b2) are chemical compounds that inhibit acetohydroxy acid synthase (AHAS), also known as acetolactate synthase (ALS), and thus kill plants by inhibiting the production of the branched-chain aliphatic amino acids such as valine, leucine and isoleucine, which are required for DNA synthesis and cell growth. Examples of AHAS inhibitors include amidosulfuron, azimsulfuron, bensulfuron-methyl, chlorimuron-ethyl, chlorsulfuron, cinosulfuron, cyclosulfamuron, ethametsulfuron-methyl, ethoxysulfuron, flazasulfuron, flupyrsulfuron-methyl (including sodium salt), foramsulfuron, halosulfuron-methyl, imazosulfuron, iodosulfuron-methyl (including sodium salt), mesosulfuron-methyl, metazosulfuron, metsulfuron-methyl, nicosulfuron, oxasulfuron, primisulfuron-methyl, propyrisulfuron, prosulfuron, pyrazosulfuron-ethyl, rimsulfuron, sulfometuron-methyl, sulfosulfuron, thifensulfuron-methyl, triasulfuron, tribenuron-methyl, trifloxysulfuron (including sodium salt), triflusulfuron-methyl, tritosulfuron, imazapic, imazamethabenz-methyl, imazamox, imazapyr, imazaquin, imazethapyr, cloransulam-methyl, diclosulam, florasulam, flumetsulam, metosulam, penoxsulam, bispyribac-sodium, pyribenzoxim, pyriftalid, pyrithiobac-sodium, pyriminobac-methyl, thiencarbazone (e.g., thiencarbazone-methyl), flucarbazone-sodium and prop oxyc arbazone-sodium.

“ACCase inhibitors” (b3) are chemical compounds that inhibit the acetyl-CoA carboxylase enzyme, which is responsible for catalyzing an early step in lipid and fatty acid synthesis in plants. Lipids are essential components of cell membranes, and without them, new cells cannot be produced. The inhibition of acetyl CoA carboxylase and the subsequent lack of lipid production leads to losses in cell membrane integrity, especially in regions of active growth such as meristems. Eventually shoot and rhizome growth ceases, and shoot meristems and rhizome buds begin to die back. Examples of ACCase inhibitors include clodinafop, cyhalofop, diclofop, fenoxaprop, fluazifop, haloxyfop, propaquizafop, quizalofop, alloxydim, butroxydim, clethodim, cycloxydim, pinoxaden, profoxydim, sethoxydim, tepraloxydim and tralkoxydim, including resolved forms such as fenoxaprop-P, fluazifop-P, haloxyfop-P and quizalofop-P and ester forms such as clodinafop-propargyl, cyhalofop-butyl, diclofop-methyl and fenoxaprop-P-ethyl.

Auxin is a plant hormone that regulates growth in many plant tissues. “Auxin mimics” (b4) are chemical compounds mimicking the plant growth hormone auxin, thus causing uncontrolled and disorganized growth leading to plant death in susceptible species. Examples of auxin mimics include aminocyclopyrachlor, aminopyralid benazolin-ethyl, chloramben, clomeprop, clopyralid, dicamba, 2,4-D, 2,4-DB, dichlorprop, fluoroxypyr, mecoprop, MCPA, MCPB, 2,3,6-TBA, picloram, triclopyr, quinclorac, quinmerac and amino-3-chloro-6-(4-chloro-2-fluoro-3-methoxyphenyl)-2-pyridinecarboxylic acid.

“EPSP (5-enol-pyruvylshikimate-3-phosphate) synthase inhibitors” (b5) are chemical compounds that inhibit the enzyme, 5-enol-pyruvylshikimate-3-phosphate synthase, which is involved in the synthesis of aromatic amino acids such as tyrosine, tryptophan and phenylalanine. EPSP inhibitor herbicides are readily absorbed through plant foliage and translocated in the phloem to the growing points. Glyphosate is a relatively nonselective postemergence herbicide that belongs to this group. Glyphosate includes esters and salts such as ammonium, isopropylammonium, potassium, sodium (including sesquisodium) and trimesium (alternatively named sulfosate).

“Photosystem I electron diverters” (b6) are chemical compounds that accept electrons from Photosystem I, and after several cycles, generate hydroxyl radicals. These radicals are extremely reactive and readily destroy unsaturated lipids, including membrane fatty acids and chlorophyll. This destroys cell membrane integrity, so that cells and organelles “leak”, leading to rapid leaf wilting and desiccation, and eventually to plant death. Examples of this second type of photosynthesis inhibitor include paraquat and diquat.

“PPO inhibitors” (b7) are chemical compounds that inhibit the enzyme protoporphyrinogen oxidase, quickly resulting in formation of highly reactive compounds in plants that rupture cell membranes, causing cell fluids to leak out. Examples of PPO inhibitors include acifluorfen-sodium, bifenox, chlomethoxyfen, fluoroglycofen-ethyl, fomesafen, halosafen, lactofen, oxyfluorfen, fluazolate, pyraflufen-ethyl, cinidon-ethyl, flumioxazin, flumiclorac-pentyl, fluthiacet-methyl, thidiazimin, oxadiazon, oxadiargyl, saflufencil, azafenidin, carfentrazone-ethyl, sulfentrazone, pentoxazone, benzfendizone, butafenacil, pyraclonil, profluazol and flufenpyr-ethyl.

“GS (glutamine synthase) inhibitors” (b8) are chemical compounds that inhibit the activity of the glutamine synthetase enzyme, which plants use to convert ammonia into glutamine. Consequently, ammonia accumulates and glutamine levels decrease. Plant damage probably occurs due to the combined effects of ammonia toxicity and deficiency of amino acids required for other metabolic processes. The GS inhibitors include glufosinate and its esters and salts such as glufosinate-ammonium and other phosphinothricin derivatives, glufosinate-P and bilanaphos.

“VLCFA (very long chain fatty acid) elongase inhibitors” (b9) are herbicides having a wide variety of chemical structures, which inhibit the elongase. Elongase is one of the enzymes located in or near chloroplasts which are involved in biosynthesis of VLCFAs. In plants, very-long-chain fatty acids are the main constituents of hydrophobic polymers that prevent desiccation at the leaf surface and provide stability to pollen grains. Such herbicides include acetochlor, alachlor, butachlor, dimethachlor, dimethanamid, metazachlor, metolachlor, pethoxamid, pretilachlor, propachlor, propisochlor, pyroxasulfone, thenylchlor, diphenamid, napropamide, naproanilide, fenoxasulfone, flufenacet, indanofan, mefenacet, fentrazamide, anilofos, cafenstrole, piperophos including resolved forms such as S-metolachlor and chloroacetamides and oxyacetamides.

“Auxin transport inhibitors” (b10) are chemical substances that inhibit auxin transport in plants, such as by binding with an auxin-carrier protein. Examples of auxin transport inhibitors include naptalam (also known as N-(1-naphthyl)phthalamic acid and 2-[(1-naphthalenylamino)carbonyl]benzoic acid) and diflufenzopyr.

“PDS (phytoene desaturase inhibitors)” (b11) are chemical compounds that inhibit carotenoid biosynthesis pathway at the phytoene desaturase step. Examples of PDS inhibitors include norflurzon, diflufenican, picolinafen, beflubutamide, fluridone, fluorochloridone and flurtamone.

“HPPD (4-hydroxyphenyl-pyruvate dioxygenase) inhibitors” (b12) are chemical substances that inhibit the biosynthesis of synthesis of 4-hydroxyphenyl-pyruvate dioxygenase. Examples of HPPD inhibitors include mesotrione, sulcotrione, topramezone, tembotrione, tefuryltrione, isoxachlortole, isoxaflutole, benzofenap, pyrasulfatole, pyrazolynate, pyrazoxyfen, bicyclopyrone and benzobicyclon.

“HST (homogentisate solenesyltransererase) inhibitors” (b13) disrupt a plant's ability to convert homogentisate to 2-methyl-6-solanyl-1,4-benzoquinone, thereby disrupting carotenoid biosynthesis. Examples of HST inhibitors include haloxydine, pyriclor and the compounds of Formulae A, B and C.

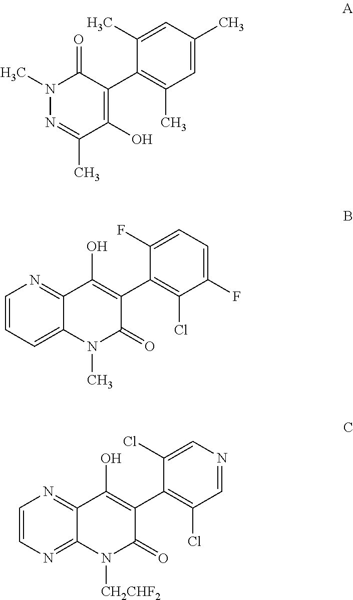

HST inhibitors also include compounds of Formulae D and E.

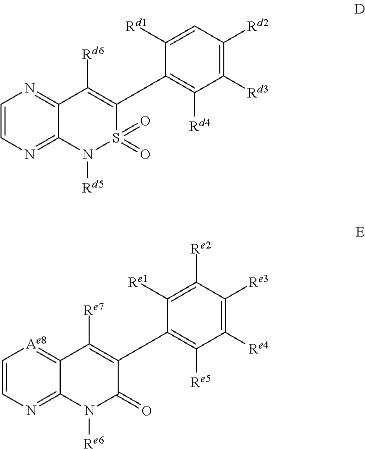

wherein R^{d1} is H, Cl or CF₃; R^{d2} is H, Cl or Br; R^{d3} is H or Cl; R^{d4} is H, Cl or CF₃; R^{d5} is CH₃, CH₂CH₃ or CH₂CHF₂; and R^{d6} is OH, or —OC(═O)-i-Pr; and R^{e1} is H, F, Cl, CH₃ or CH₂CH₃; R^{e2} is H or CF₃; R^{e3} is H, CH₃ or CH₂CH₃; R^{e4} is H, F or Br; R^{e5} is Cl, CH₃, CF₃, OCF₃ or CH₂CH₃; R^{e6} is H, CH₃, CH₂CHF₂ or C≡CH; R^{e7} is OH, —OC(═O)Et, —OC(═O)-i-Pr or —OC(═O)-t-Bu; and A^{e8} is N or CH.

Other herbicides (b14) include herbicides that act through a variety of different modes of action such as mitotic disruptors (e.g., flamprop-M-methyl and flamprop-M-isopropyl) organic arsenicals (e.g., DSMA, and MSMA), 7,8-dihydropteroate synthase inhibitors, chloroplast isoprenoid synthesis inhibitors and cell-wall biosynthesis inhibitors. Other herbicides include those herbicides having unknown modes of action or do not fall into a specific category listed in (b1) through (b12) or act through a combination of modes of action listed above. Examples of other herbicides include aclonifen, asulam, amitrole, clomezone, fluometuron, difenzoquat, bromobutide, flurenol, cinmethylin, cumyluron, dazomet, dymron, methyldymron, methiozolon, ipfencarbazone, etobenzanid, fosamine, fosamine-ammonium, metam, oxaziclomefone, oleic acid, pelargonic acid and pyributicarb.

“Herbicide safeners” (b15) are substances added to a herbicide formulation to eliminate or reduce phytotoxic effects of the herbicide to certain crops. These compounds protect crops from injury by herbicides but typically do not prevent the herbicide from controlling undesired vegetation. Examples of herbicide safeners include but are not limited to benoxacor, 1-bromo-4-[(chloromethyl)sulfonyl]benzene, cloquintocet-mexyl, cumyluron, cyometrinil, cyprosulfamide, daimuron, dichlormid, dicyclonon, 4-(dichloroacetyl)-1-oxa-4-azospiro[4.5]decane (MON 4660), 2-(dichloromethyl)-2-methyl-1,3-dioxolane (MG 191), dimepiperate, fenchlorazole-ethyl, fenclorim, flurazole, fluxofenim, furilazole, isoxadifen-ethyl, mefenpyr-diethyl, mephenate, methoxyphenone, naphthalic anhydride and oxabetrinil.

One or more of the following methods and variations as described in Schemes 1a-14 can be used to prepare the compounds of Formula 1. The definitions of A, A¹, B¹, B², B³, T, R¹, R², R³, R⁴, R⁵, R⁶, R⁷, R⁸, R⁹, R¹⁰, R¹¹, R¹² and R¹³ in the compounds of Formulae 1-14 below are as defined above in the Summary of the Invention unless otherwise noted. Formulae 1a-1g, 2a-2d, 5a-5d and 6a are various subsets of Formulae 1, 2, 5 and 6, respectively. All substituents for Formulae 1a-1g are as defined above for Formula 1 unless otherwise noted.

As described in further detail below, compounds of Formula 1 wherein A is A-1, A-2, A-3 or A-5 can be prepared by reacting a compound of Formula 5 which is A¹-H wherein A¹ is

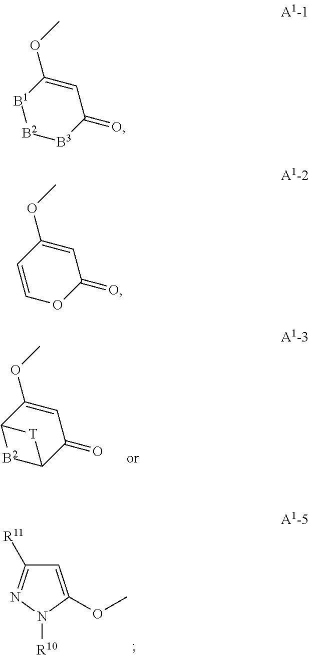

with a compound of Formula 6

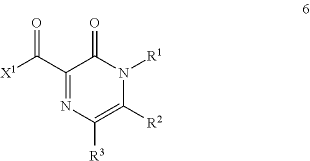

wherein X¹ is a nucleophilic reaction leaving group (i.e. nucleofuge), for example, a halogen, alkylcarbonyloxy, haloalkyloxy, haloalkoxycarbonyloxy, 1-pyridinyl or 1-imidazolyl group;
in the presence of a base to form a compound of Formula 2,

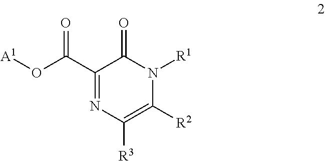

which then in the presence of a cyanide or fluoride ion source and base is rearranged to form the corresponding compound of Formula 1.

Thus compounds of Formula 1a, 1b, 1c or 1d (i.e. Formula 1 in which A is A-1, A-2, A-3 or A-5, respectively) wherein R⁴ is hydroxy can be prepared via the two-step process shown in Schemes 1a, 1b, 1c and 1d, respectively. Intermediate compounds of Formula 2a, 2b, 2c or 2d (i.e. Formula 2 wherein A1 is A-1, A-2, A-3 or A-5, respectively) are prepared by reacting a compound of Formula 5a, 5b, 5c or 5d with a compound of Formula 6 in the presence of a base such as triethylamine. In the presence of an appropriate source of cyanide ion (e.g., acetone cyanohydrin, potassium cyanide, sodium cyanide) and a base such as triethylamine or pyridine, the intermediate compound of Formula 2a, 2b, 2c or 2d is then rearranged to the corresponding compound of Formula 1a, 1b, 1c or 1d. Alternatively a fluoride anion source such as potassium fluoride or cesium fluoride, optionally in the presence of a phase transfer catalyst (e.g. tetrabutyl ammonium bromide), can be used to cause this rearrangement. Typically the reaction is conducted in a solvent such as dimethylsulfoxide, N,N-dimethylformamide, acetonitrile or dichloromethane at temperatures ranging from ambient temperature to the reflux temperature of the solvent. Alternatively, compounds of Formula 1a, 1b, 1c or 1d can be prepared by Process 2 (in Schemes 1a, 1b, 1c and 1d respectively) by reacting a compound of Formula 5a, 5b, 5c or 5d with a compound of Formula 6 in the presence of a cyanide or fluoride anion source along with a base. For reaction conditions for this general coupling methodology, see Edmunds, A. in Modern Crop Protection Compounds; Kramer, W. and Schirmer, U., Eds.; Wiley, Weinheim, 2007; Chapters 4.3 and 4.4, and references cited therein. The first process of the method of Scheme 1a is illustrated by Step G of Synthesis Example 1 and Steps B and C of Synthesis Example 2.

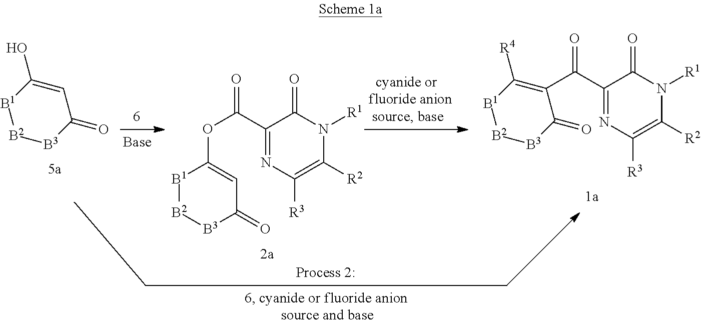

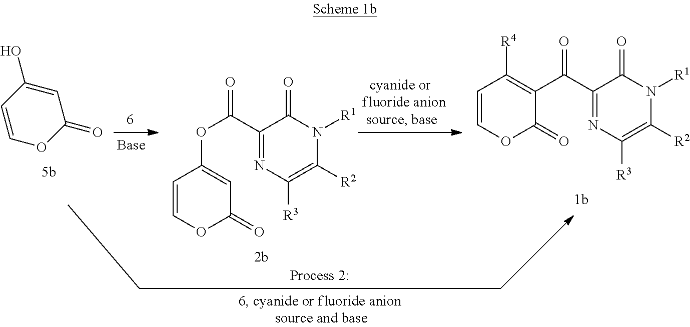

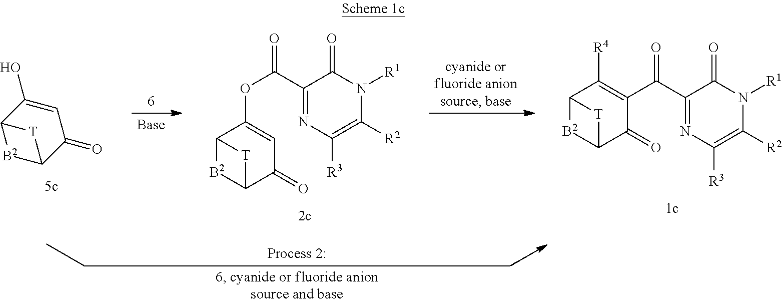

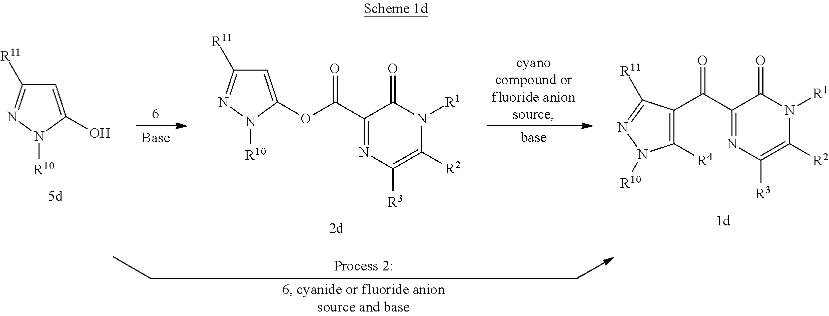

Compounds of Formula 1a, 1b or 1c can also be prepared as shown in Scheme 2, by reacting dione 5a, 5b or 5c with intermediate 6a (i.e. Formula 6 in which X¹ is —CN) in the presence of a base or Lewis acid. For reaction conditions for this general coupling methodology, see Edmunds, A. in Modern Crop Protection Compounds; Kramer, W. and Schirmer, U., Eds.; Wiley, Weinheim, 2007; Chapter 4.3 and references cited therein.

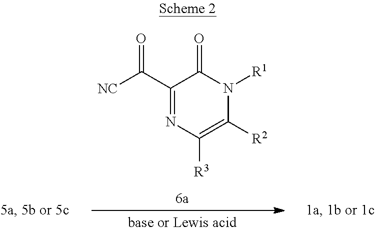

As shown in Scheme 3, a compound of Formula 2a, 2b, 2c or 2d useful as an intermediate in the method of Schemes 1a-1d can also be prepared by reacting a compound of Formula 5a, 5b, 5c or 5d, respectively, with carboxylic acid of Formula 3 in the presence of a dehydrating condensation agent such as 2-chloro-1-pyridinium iodide (known as the Mukaiyama coupling agent), dicyclohexyl carbodiimide (DCC) or the like and optionally in the presence of a base. For additional reaction conditions for this general enol ester coupling methodology, see Edmunds, A. in Modern Crop Protection Compounds; Kramer, W. and Schirmer, U., Eds.; Wiley, Weinheim, 2007; Chapter 4.3 and references cited therein.

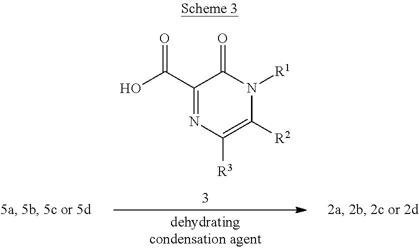

As shown in Scheme 4, an intermediate compound of Formula 2a, 2b or 2c can also be made by the palladium-catalyzed carbonylation reaction of a halo compound of Formula 7 in the presence of a compound of Formula 5a, 5b or 5c, respectively. For reaction conditions for this general enol ester forming methodology, see Edmunds, A. in Modern Crop Protection Compounds; Kramer, W. and Schirmer, U., Eds.; Wiley, Weinheim, 2007; Chapter 4.3 and references cited therein.

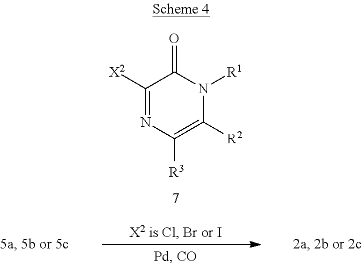

As shown in Scheme 5, a compound of Formula 1e (i.e. Formula 1 in which A is A-4) wherein R⁴ is hydroxy can be prepared by reacting a compound of Formula 8 with a compound of Formula 6 in the presence of a strong base such n-butyllithium or lithium diisopropylamide in an appropriate solvent such as tetrahydrofuran or diethyl ether. For reaction conditions for this type of transformation, see Japanese Patent Publication JP 2003327580.

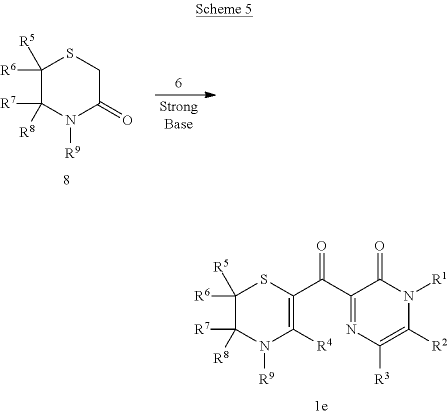

As shown in Scheme 6, compounds of Formula 1 wherein A is A-1, A-2, A-3, A-4 or A-5 (i.e. Formula 1a, 1b, 1c, 1d or 1e) and R⁴ is a substituent group bonded to the remainder of Formula 1 through an oxygen atom are prepared by reacting corresponding compounds of Formula 1 wherein R⁴ is hydroxy with a compound of formula R^{a}-X² (Formula 9) wherein R^{a} is the part of R⁴ not including the oxygen atom and X² is nucleophilic leaving group such as Cl, Br or I in the presence of a base. Alternatively, a compound of Formula 1 wherein A is A-1, A-2, A-3, A-4 or A-5 and R⁴ is bonded to the remainder of Formula 1 through a nitrogen, sulfur or carbon atom can be prepared by reacting a compound of Formula 1 wherein R⁴ is hydroxy with an appropriate halogenating agent to prepare a corresponding halo compound of Formula 1 wherein R⁴ is halogen, followed by reacting the halo compound with an appropriate nucleophilic compound to replace the halogen with R⁴ through displacement. For reaction conditions for this general functionalization method, see Edmunds, A. or van Almsick, A. in Modern Crop Protection Compounds; Kramer, W. and Schirmer, U., Eds.; Wiley, Weinheim, 2007; Chapter 4.3 or Chapter 4.4, and references cited therein.

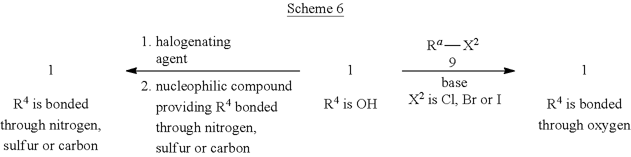

As shown in Scheme 7, compounds of Formula 1f (i.e. Formula 1 wherein A is A-7) can be prepared from corresponding compounds of Formulae 6 and 10. In this method, a compound of Formula 6 is reacted with a compound Formula 10 in the presence of a base that promotes carbon-centered acylation. Magnesium enolates, which can be formed by reaction of the compound of Formula 10 with magnesium metal or magnesium alcoholates such as magnesium ethoxide, are preferred for carbon-centered acylation. This type of acylation is well known in the literature and typical conditions which result in acylation on carbon can be found in U.S. Pat. Nos. 4,741,769 and 4,781,750, and van Almsick, A. in Modern Crop Protection Compounds; Kramer, W. and Schirmer, U., Eds.; Wiley, Weinheim, 2007; Chapter 4.4, and references cited therein.

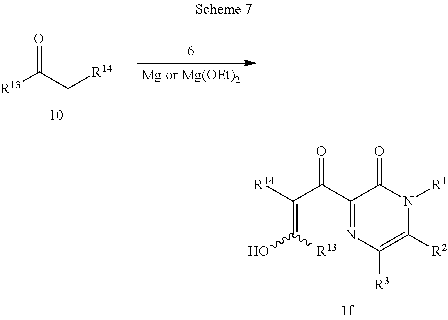

As shown in Scheme 8, compounds of Formula 1g (i.e. Formula 1 in which A is A-6 and R¹² is H) can be prepared from diketones of Formula 12. Compounds of Formula 12 can be prepared by acylation of compounds of Formula 11 with a compound of Formula 6. Acylation on carbon can be achieved by using a magnesium enolate of the compound of Formula 11 produced using conditions previously described in Scheme 7. Removal of the ester can be conveniently carried out by heating the reaction product with a source of acid which cleaves the tert-butyl group and results in decarboxylation producing the compound of Formula 12. Acid sources such as hydrochloric acid, hydrobromic acid, sulfuric acid, trifluoroacetic acid, and p-toluenesulfonic acid as well as many others may be employed. The compound of Formula 12 is then reacted with an orthoformate ester or N,N-dimethylformamide dimethylacetal (DMF-DMA) to provide an intermediate compound of Formula 13. Reaction of the compound of Formula 13 with hydroxylamine hydrochloride salt in a solvent such as ethanol, acetonitrile, water or acetic acid provides the isoxazole compound of Formula 1g. For reaction conditions for synthesis of 4-acyl isoxazoles, see European Patent Application EP 527036 and World Patent Application WO 99/02489 as well as van Almsick, A. in Modern Crop Protection Compounds; Kramer, W. and Schirmer, U., Eds.; Wiley, Weinheim, 2007; Chapter 4.4, and references cited therein.

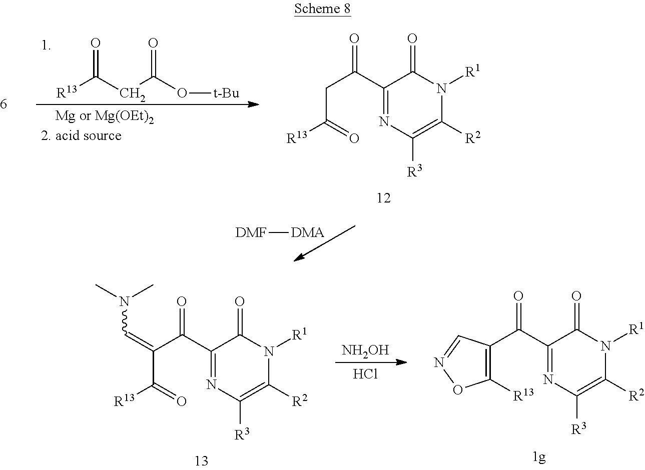

Compounds of Formula 6 can be prepared by a wide variety of methods known in the art of synthetic organic chemistry. As shown in Scheme 9, acid chlorides of Formula 6a (i.e. Formula 6 wherein X¹ is Cl) are easily prepared from corresponding carboxylic acids of Formula 3 by numerous well-known methods. For example, reacting a carboxylic acid of Formula 3 with a chlorinating reagent such as oxalyl chloride or thionyl chloride in a solvent such as dichloromethane or toluene, optionally in the presence of a catalytic amount of N,N-dimethylformamide, provides the corresponding acid chloride of Formula 6a. The method of Scheme 9 is illustrated by Step G of Synthesis Example 1 and Step B of Synthesis Example 2.

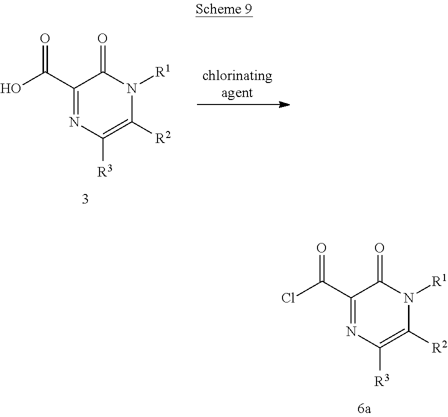

As shown in Scheme 10, carboxylic acids of Formula 3 can be prepared by de-esterification of esters of Formula 4. The de-esterification can be accomplished by many well-known methods, for example, saponification procedures using alkali hydroxides such as LiOH, NaOH or KOH in a lower alkanol such methanol or ethanol or in mixtures of alkanols and water. Alternatively, a dealkylating agent such as lithium iodide or trimethylsilyl iodide can be used in the presence of a base in a solvent such as pyridine or ethyl acetate. Alternatively, boron tribromide (BBr₃) can be used to prepare a compound of Formula 3 from a compound of Formula 4 in solvents such as dichloromethane, hexanes and toluene. A typical procedure using boron tribromide is disclosed in Bioorg. & Med. Chem. Lett. 2009, 19(16), 4733-4739. Additional reaction procedures for de-esterification can be found in PCT Patent Publication WO 2006/133242. The method of Scheme 10 using a saponification procedure is illustrated by Step F of Synthesis Example 1 and Step A of Synthesis Example 2.

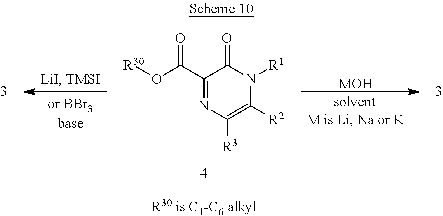

As shown in Scheme 11, carboxylic acid esters of Formula 4 wherein R³ is H can be prepared by hydrogenolysis of corresponding carboxylic acid esters of Formula 4 wherein R³ is Cl, Br or I in the presence of a source of hydrogen, an acid acceptor and a metal catalyst. Sources of hydrogen include alkali salts of formic acid, cyclohexadiene or hydrogen gas. Suitable acid acceptors include, but are not limited to tertiary amines such as triethylamine, alkali carbonates such as potassium carbonate, alkali phosphates, alkali acetates and alkali hydrogencarbonates. A variety of metal catalysts such as palladium on carbon, palladium hydroxide, and Raney nickel can be used in hydrogenolysis of esters of Formula 4 wherein R³ is Cl, Br or I. The reaction with hydrogen is generally conducted under an atmosphere of hydrogen in the presence of palladium on carbon at ambient temperature. The reaction can be carried out at temperatures between 0 and 200° C. and at hydrogen pressures of about 100 to 10000 kPa. Suitable solvents include lower alkanols such as methanol and ethanol, esters such as ethyl acetate, and ethers such as tetrahydrofuran. For conditions for a related hydrogenolysis on pyrazinones see PCT Patent Publication WO 2009/033084. The method of Scheme 11 is illustrated by Step E of Synthesis Example 1.

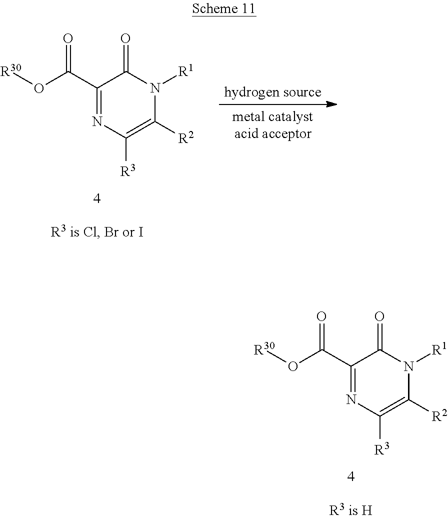

As shown in Scheme 12, esters of Formula 4 can be prepared from corresponding nitriles of Formula 14. As is well known in the art, in the presence of an acid and an alkanol, a nitrile is converted into the ester of the alkanol. Suitable acids include, for example, hydrochloric, hydrobromic acid and sulfuric acid. To prepare an ester of Formula 4 wherein R³⁰ is C₁-C₆ alkyl, the corresponding C₁-C₆ alkanol is used. Lower (i.e. C₁-C₄) alkanols are preferred, and methanol is especially preferred for this method. In a typical reaction, the nitrile of Formula 14 is reacted with hydrochloric acid in the presence of methanol as a solvent. The reaction temperature can be from about 0 to 200° C. depending upon the alcohol used and whether the pressure is increased above ambient atmospheric pressure. An especially useful procedure to perform the reaction involves generating the hydrochloric acid by addition of thionyl chloride, trimethylsilyl chloride or acetyl chloride to methanol in the presence of the compound of Formula 14. The method of Scheme 12 is illustrated by Step D of Synthesis Example 1.

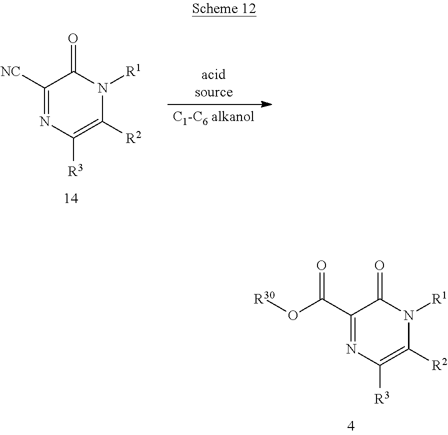

As shown in Scheme 13, esters of Formula 4 can also be prepared from corresponding halo compounds of Formula 7 wherein X³ is Cl, Br or I. In this method the compound of Formula 7 is reacted with carbon monoxide and the appropriate C₁-C₆ alkanol in the presence of an acid acceptor and a transition metal catalyst. Typically lower alkanols such as methanol and ethanol are preferred in this transformation. Carbon monoxide can be present at pressures ranging from about 100 to 10000 kPa. Examples of suitable acid acceptors include tertiary amines such as triethylamine, alkali metal carbonates such as potassium carbonate, alkali metal phosphates, alkali metal acetates and alkali metal hydrogencarbonates. Tertiary amines are most preferred. Palladium catalysts are most preferred for use in this carbonylation reaction. A wide variety of commercially available ligands and palladium sources can be employed. Among the most useful catalysts are those generated from 1,3-bis(diphenylphosphino)propane (dppp) and 1,1′-bis(diphenylphosphino)-ferrocene (dppf). These reactions can be performed at temperatures between about 0 and 200° C.; temperatures between about 50 and 100° C. are most commonly employed. Suitable solvents include polar aprotic solvents such as N,N-dimethylformamide, dimethylsulfoxide, N-methylpyrrolidinone and N,N-dimethylacetamide as well as ethers such as dioxane and tetrahydrofuran. For related carbonylations on the pyrazinone ring system see PCT Patent Publications WO 2009/058076, WO 2007/129963 and WO 2009/061271.

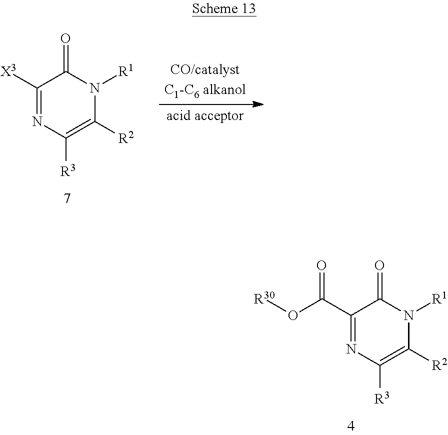

As shown in Scheme 14, nitriles of Formula 14 can be prepared by cyanation of corresponding halo compounds of Formula 7 wherein X³ is Cl, Br or I. Cyanation reactions are well known in the art. A particularly useful cyanide source for this reaction is copper(I) cyanide. Heating a halide of Formula 7 with an excess of copper(I) cyanide in an aprotic polar solvent such as N,N-dimethylacetamide, N,N-dimethylformamide or N-methyl-pyrrolidinone forms the compound of Formula 14. The reaction can be performed at temperatures ranging from about 0 to 250° C., but preferably at temperatures between 100° C. and 150° C. For conditions reported for a related cyanation with copper(I) cyanide on pyrazinones, see PCT Patent Publication WO 2009/033084. This reaction may also be performed with the aid of a transition metal catalyst. For reagents, conditions and procedures, see PCT Patent Publications WO 2008/070158, WO 2009/061991 and WO 2009/085816, and the references cited therein. The method of Scheme 14 is illustrated by Step C of Synthesis Example 1.

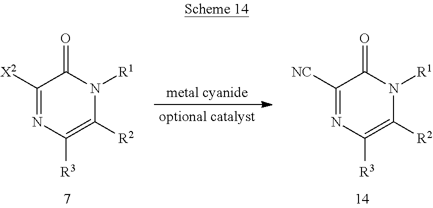

Methods for preparing halides of Formula 7 are well known in the art. For example, halides of Formula 7 can be prepared by methods outlined in PCT Patent Publications WO 2007/149448 and WO 2006/089060, and references cited therein. For a thorough study of optimization of the methods for the synthesis of pyrazinones, see Leahy et al. Organic Process Research and Development, 2010, 14, 1221. An alternative method for the synthesis of halides of Formula 7 is disclosed in Ashwood et al. Organic Process Research and Development, 2004, 8, 192. Another useful reference for the synthesis of pyrazinones by a different approach is Garg and Stolz, Chemical Communications, 2006, 3679.

Interconversion of functional groups on pyrazinones has also been well studied and can serve for introducing various substituents on the final products and intermediates of this invention particularly on esters of Formula 4. For reagents, conditions and procedures for functionalization of pyrazinones see Pawar and DeBorggraeve, Synthesis, 2006, 2799 and references cited therein.

It is recognized that some reagents and reaction conditions described above for preparing compounds of Formula 1 may not be compatible with certain functionalities present in the intermediates. In these instances, the incorporation of protection/deprotection sequences or functional group interconversions into the synthesis will aid in obtaining the desired products. The use and choice of the protecting groups will be apparent to one skilled in chemical synthesis (see, for example, Greene, T. W.; Wuts, P. G. M. Protective Groups in Organic Synthesis, 2nd ed.; Wiley: New York, 1991). One skilled in the art will recognize that, in some cases, after the introduction of a given reagent as it is depicted in any individual scheme, it may be necessary to perform additional routine synthetic steps not described in detail to complete the synthesis of compounds of Formula 1. One skilled in the art will also recognize that it may be necessary to perform a combination of the steps illustrated in the above schemes in an order other than that implied by the particular sequence presented to prepare the compounds of Formula 1.

One skilled in the art will also recognize that compounds of Formula 1 and the intermediates described herein can be subjected to various electrophilic, nucleophilic, radical, organometallic, oxidation, and reduction reactions to add substituents or modify existing substituents.

Without further elaboration, it is believed that one skilled in the art using the preceding description can utilize the present invention to its fullest extent. The following Synthesis Examples are, therefore, to be construed as merely illustrative, and not limiting of the disclosure in any way whatsoever. Steps in the following Examples illustrate a procedure for each step in an overall synthetic transformation, and the starting material for each step may not have necessarily been prepared by a particular preparative run whose procedure is described in other Synthesis Examples or Steps. Percentages are by weight except for chromatographic solvent mixtures or where otherwise indicated. Parts and percentages for chromatographic solvent mixtures are by volume unless otherwise indicated. MPLC means medium pressure chromatography on silica gel. ¹H NMR spectra are reported in ppm downfield from tetramethylsilane in CDCl₃ unless otherwise noted; “s” means singlet, “m” means multiplet, “br s” means broad singlet, “d” means doublet, “t” means triplet, and “q” means quartet.

### Synthesis Example 1

### Preparation of 6-(3,5-difluorophenyl)-3-[(2-hydroxy-6-oxo-1-cyclohexen-1-yl)carbonyl]-1-(2-methoxyethyl)-2(1H)-pyrazinone (Compound 5)

### Step A: Preparation of 3,5-difluoro-α-[(2-methoxyethyl)amino]benzeneacetonitrile hydrochloride (1:1)

To a solution of sodium hydrogen sulfite (7.76 g, 74.6 mmol) in water (100 mL) and methanol (20 mL) at 0° C. was added under nitrogen 3,5-difluorobenzaldehyde (10.0 g, 70.4 mmol), and the resulting mixture was stirred at 0° C. for 15 minutes. Then sodium cyanide (3.52 g, 71.8 mmol) was added in one portion, and the reaction mixture was stirred at 0° C. for 15 minutes. Then 2-methoxyethylamine (6.66 mL, 74.6 mmol) was added, and the resulting solution was heated at 40° C. for 2 h. The cooled reaction mixture was diluted with dichloromethane (100 mL), the layers were separated, and the aqueous layer was extracted with dichloromethane (50 mL). The combined organic layers were washed with brine (100 mL), dried (MgSO₄), filtered and concentrated under reduced pressure to give a yellow oil. The residual oil was taken up in diethyl ether (40 mL), and the resulting solution treated with 2M ethereal hydrogen chloride (40 mL). The mixture was stirred at room temperature overnight. The resulting solid was filtered and dried to provide the title compound as a pale yellow solid (16.17 g).

¹H NMR δ7.09-7.16 (m, 2H), 6.78-6.87 (m, 1H), 4.87 (s, 1H), 3.53-3.58 (m, 2H), 3.37 (s, 3H), 2.90-2.97 (m, 2H).

### Step B: Preparation of 3,5-dichloro-6-(3,5-difluorophenyl)-1-(2-methoxyethyl)-2(1H)-pyrazinone

To a suspension of 3,5-difluoro-α-[(2-methoxyethyl)amino]benzeneacetonitrile hydrochloride (1:1) (i.e. the product of Step A) (14.32 g, 67.8 mmol) in chlorobenzene (250 mL) was added oxalyl chloride (17 mL, 203 mmol). The reaction mixture was then warmed to 95° C. and stirred for 2 h. Then N,N-dimethylformamide was added, and stirring at 95° C. was continued overnight. The resulting mixture was concentrated under reduced pressure, and the residual orange solid was dissolved in dichloromethane, concentrated onto a minimum of silica gel, and purified by MPLC (Medium Pressure Liquid Chromatography) (0 to 100% ethyl acetate in hexanes as eluant, RediSep® Rf (Teledyne ISCO, Lincoln, Nebr., U.S.A.) 220-g silica column) to afford a solid which on trituration with hexane gave the title compound as a solid (11.75 g).

¹H NMR δ7.00 (s, 1H), 6.89-6.94 (m, 2H), 3.94-4.05 (m, 2H), 3.56-3.64 (m, 2H), 3.23 (s, 3H).

### Step C: Preparation of 6-chloro-5-(3,5-difluorophenyl)-3,4-dihydro-4-(2-methoxy-ethyl)-3-oxo-2-pyrazinecarbonitrile

To a solution of 3,5-dichloro-6-(3,5-difluorophenyl)-1-(2-methoxyethyl)-2(1H)-pyrazinone (i.e. the product of Step B) (11.75 g, 35.1 mmol) in N,N-dimethylacetamide (20 mL) was added cuprous cyanide (4.71 g, 52.0 mmol). The resulting mixture was heated to 130° C. and stirred overnight. After cooling to room temperature, reaction mixture was filtered through a pad of Celite® diatomaceous filter aid, and the pad was washed with chloroform. The volume of the filtrate was reduced to 50% under reduced pressure. Water (50 mL) was added, and the layers were separated. The organic layer was washed with water (50 mL) and brine (100 mL), dried (MgSO₄), filtered and concentrated under reduced pressure. The residual oil was dissolved in dichloromethane (50 mL), concentrated onto a minimum amount of silica gel and purified by MPLC (0 to 60% ethyl acetate in hexanes as eluant, RediSep® Rf Gold (Teledyne ISCO) 40-g silica column) to afford the title compound as a yellow solid (7.67 g).

¹H NMR δ7.04 (s, 1H), 6.88-6.98 (m, 2H), 4.01-4.10 (m, 2H), 3.58-3.71 (m, 2H), 3.23 (s, 3H).

### Step D: Preparation of methyl 6-chloro-5-(3,5-difluorophenyl)-3,4-dihydro-4-(2-methoxyethyl)-3-oxo-2-pyrazinecarboxylate

Thionyl chloride (8.16 mL, 111.8 mmol) was added dropwise to a stirred solution of 6-chloro-5-(3,5-difluorophenyl)-3,4-dihydro-4-(2-methoxyethyl)-3-oxo-2-pyrazinecarbonitrile (i.e. the product of Step C) (7.67 g, 28.0 mmol) in methanol (30 mL) at room temperature, and the resulting reaction mixture was refluxed overnight. The cooled reaction mixture was then concentrated under reduced pressure, and the residue was dissolved in dichloromethane. The dichloromethane solution was washed with water, saturated aqueous ammonium chloride, dried (MgSO₄), concentrated onto a minimum amount of silica gel and purified by MPLC (0 to 100% ethyl acetate in hexane as eluant, RediSep® Rf Gold 40-g silica column) to afford the title compound as a yellow solid (4.25 g).

¹H NMR δ6.97-7.07 (m, 1H), 6.85-6.97 (m, 2H), 4.01-4.06 (m, 2H), 4.00 (s, 3H), 3.60-3.65 (m, 2H), 3.22 (s, 3H).

### Step E: Preparation of methyl 5-(3,5-difluorophenyl)-3,4-dihydro-4-(2-methoxy-ethyl)-3-oxo-2-pyrazinecarboxylate

A solution of methyl 6-chloro-5-(3,5-difluorophenyl)-3,4-dihydro-4-(2-methoxy-ethyl)-3-oxo-2-pyrazinecarboxylate (i.e. the product of Step D) (1.00 g, 2.78 mmol) in tetrahydrofuran (20 mL) was purged with nitrogen. Triethylamine (0.388 mL, 2.78 mmol) and 10% palladium on carbon were then added, and the reaction mixture was again purged with nitrogen. A balloon containing hydrogen gas was attached to the reaction flask, and the mixture was stirred at room temperature for 2 h. The balloon was removed and the reaction mixture was purged with nitrogen. The reaction mixture was then filtered through a pad of Celite® diatomaceous filter aid, and the pad was washed with ethyl acetate. The filtrate was concentrated under reduced pressure. The residue concentrated onto a minimum amount of silica gel and purified by MPLC (20 to 80% ethyl acetate in hexane as eluant, RediSep® Rf Gold 40-g silica column) to afford the title compound as a yellow oil (0.91 g).

¹H NMR (CDCl₃) δ 7.33 (s, 1H), 6.95-7.10 (m, 3H), 4.08-4.15 (m, 2H), 4.01 (s, 3H), 3.65-3.73 (m, 2H), 3.23 (s, 3H).

### Step F: Preparation of 5-(3,5-difluorophenyl)-3,4-dihydro-4-(2-methoxyethyl)-3-oxo-2-pyrazinecarboxylic acid

To a solution of methyl 5-(3,5-difluorophenyl)-3,4-dihydro-4-(2-methoxyethyl)-3-oxo-2-pyrazinecarboxylate (i.e. the product of Step E) (0.910 g, 2.80 mmol) in 2:1 methanol/water (10 mL) was added potassium hydroxide (0.185 g, 3.30 mmol), and the resulting mixture was stirred at room temperature for 1 h. The reaction mixture was concentrated under reduced pressure, and the residue was partitioned between 1 N hydrochloric acid (30 mL) and ethyl acetate (30 mL). The organic layer was separated, dried (MgSO₄) and concentrated under reduced pressure to afford the title compound as a yellow solid (0.60 g).

¹H NMR δ7.77 (s, 1H), 7.02-7.15 (m, 3H), 4.22-4.28 (m, 2H), 3.68-3.79 (m, 2H), 3.22 (s, 3H).

### Step G: Preparation of 6-(3,5-difluorophenyl)-3-[(2-hydroxy-6-oxo-1-cyclohexen-1-yl)carbonyl]-1-(2-methoxyethyl)-2 (1H)-pyrazinone

To a solution of 5-(3,5-difluorophenyl)-3,4-dihydro-4-(2-methoxyethyl)-3-oxo-2-pyrazinecarboxylic acid (i.e. the product of Step F) (0.600 g, 1.93 mmol) in dichloromethane (10 mL) was added N,N-dimethylformamide (1 drop) and then oxalyl chloride (0.250 mL, 2.90 mmol) in one portion. The resulting mixture was stirred at room temperature for 1 h and concentrated under reduced pressure. The residue was redissolved in dichloromethane and again concentrated under reduced pressure to yield an orange residue. This residue was dissolved in dichloromethane (5 mL) and added to a stirred solution of 1,3-cyclohexanedione (tautomeric equivalent of 3-hydroxy-2-cyclohexen-1-one) (0.216 g, 1.93 mmol) and triethylamine (0.538 mL, 3.86 mmol) in dichloromethane (5 mL) at room temperature. The reaction mixture was stirred overnight at room temperature. The reaction mixture was then washed with saturated aqueous ammonium chloride, dried (MgSO₄) and filtered into a round bottom flask. The filtrate was treated with triethylamine (0.538 mL, 33.86 mmol) and acetone cyanohydrin (1 drop), and the resulting solution was stirred overnight at room temperature. The reaction mixture was loaded onto a Gold RediSep column (24 g) and purified by MPLC (0 to 40% of 30% methanol/dichloromethane in dichloromethane). The material purified by MPLC was triturated with diethyl ether to provide further purified title product, a compound of the present invention, as a solid (20 mg).

¹H NMR δ16.37 (br s, 1H), 7.20 (s, 1H), 7.03-7.11 (m, 2H), 6.93-7.01 (m, 1H), 4.00-4.09 (m, 2H), 3.58-3.66 (m, 2H), 3.21 (s, 3H), 2.68-2.84 (m, 2H), 2.41-2.56 (m, 2H), 2.01-2.15 (m, 2H).

### Synthesis Example 2

### Preparation of 5-chloro-6-(3,5-difluorophenyl)-3-[(2-hydroxy-6-oxo-1-cyclohexen-1-yl)carbonyl]-1-(2-methoxyethyl)-2(1H)-pyrazinone (Compound 6)

### Step A: Preparation of 6-chloro-5-(3,5-difluorophenyl)-3,4-dihydro-4-(2-methoxy-ethyl)-3-oxo-2-pyrazinecarboxylic acid

To a solution of methyl 6-chloro-5-(3,5-difluorophenyl)-3,4-dihydro-4-(2-methoxy-ethyl)-3-oxo-2-pyrazinecarboxylate (i.e. the product of Step D of Synthesis Example 1) (0.680 g, 1.89 mmol) in 2:1 methanol/water (10 mL) was added potassium hydroxide (0.159 g, 2.84 mmol), and the resulting mixture was stirred at reflux for 1 h. The reaction mixture was concentrated under reduced pressure, and the residue was partitioned between 1 N hydrochloric acid (30 mL) and ethyl acetate (30 mL). The organic layer was separated, dried (MgSO₄) and concentrated under reduced pressure, and the residual solid was triturated with hexane/diethyl ether, filtered and dried to afford the title compound as a yellow solid (0.46 g).

¹H NMR δ7.02-7.12 (m, 1H), 6.92-7.00 (m, 2H), 4.13-4.20 (m, 2H), 3.64-3.72 (m, 2H), 3.24 (s, 3H).

### Step B: Preparation of 3-oxo-1-cyclohexen-1-yl 6-chloro-5-(3,5-difluorophenyl)-3,4-dihydro-4-(2-methoxyethyl)-3-oxo-2-pyrazinecarboxylate

To a stirred solution of oxalyl chloride (0.286 ml, 3.32 mmol) and anhydrous N,N-dimethylformamide (1 drop) in anhydrous dichloromethane (5 mL) under nitrogen at room temperature was added dropwise a solution of 6-chloro-5-(3,5-difluorophenyl)-3,4-dihydro-4-(2-methoxyethyl)-3-oxo-2-pyrazinecarboxylic acid (i.e. the product of Step A) (0.460 g, 1.33 mmol) in anhydrous dichloromethane (5 mL) via syringe. The resulting solution was stirred at room temperature for 1 h and then concentrated under reduced pressure. The residue was redissolved in anhydrous dichloromethane and again concentrated under reduced pressure to give an orange solid. This solid was dissolved in anhydrous dichloromethane (5 mL) and added to a stirred solution of 1,3-cyclohexanedione (0.157 g, 1.40 mmol) and triethylamine (0.463 mL, 3.32 mmol) in anhydrous dichloromethane (5 mL) at 0° C. The reaction mixture was allowed to warm to room temperature and stirred for 1 h. The reaction mixture was then loaded via syringe onto a RediSep® Rf Gold 12-g silica column and purified by MPLC (30 to 100% ethyl acetate in hexane as eluant) to afford the title compound as a yellow solid (0.170 g).

¹H NMR δ7.00-7.09 (m, 1H), 6.88-6.97 (m, 2H), 6.08 (s, 1H), 3.99-4.09 (m, 2H), 3.59-3.69 (m, 2H), 3.26 (s, 3H), 2.68-2.77 (m, 2H), 2.40-2.53 (m, 2H), 2.07-2.27 (m, 2H).

### Step C: Preparation of 5-chloro-6-(3,5-difluorophenyl)-3-[(2-hydroxy-6-oxo-1-cyclohexen-1-yl)carbonyl]-1-(2-methoxyethyl)-2 (1H)-pyrazinone

Finely powdered cesium fluoride (0.170 g) was added to a 50-mL, oven-dried round bottom flask, and the flask was purged with nitrogen. Solid 3-oxo-1-cyclohexen-1-yl 6-chloro-5-(3,5-difluorophenyl)-3,4-dihydro-4-(2-methoxyethyl)-3-oxo-2-pyrazinecarboxylate (i.e. the product of Step B) (0.170 g, 0.387 mmol) was then added to the reaction flask under a blanket of nitrogen. Anhydrous acetonitrile (5 mL) was added, and the resulting solution was stirred at room temperature under nitrogen for 1 h. The solution was then loaded via syringe onto a RediSep® Rf Gold 12-g silica column and purified by MPLC (0 to 40% of 30% methanol/dichloromethane in dichloromethane) to afford crude solid. The solid was further purified by silica gel flash chromatography (5 to 10% methanol in dichloromethane eluant) to afford the title product, a compound of the present invention, as a yellow solid (0.060 g).

¹H NMR δ16.14 (s, 1H), 6.88-7.07 (m, 3H), 3.81-4.06 (m, 2H), 3.45-3.69 (m, 2H), 3.24 (s, 3H), 2.78 (d, J=12.7 Hz, 2H), 2.30-2.60 (m, 2H), 1.85-2.20 (m, 2H).

By the procedures described herein together with methods known in the art, the following compounds of Tables 1 to 51Z can be prepared. The following abbreviations are used in the Tables which follow: Me means methyl, Et means ethyl, n-Pr means normal propyl, i-Pr means isopropyl, n-Bu means normal butyl, i-Bu means isobutyl, s-Bu means secondary butyl, t-Bu means tertiary butyl, n-Hex means normal hexyl, Ph means phenyl, OMe means methoxy, OEt means ethoxy, SMe means methylthio, SEt means ethylthio, thp means tetrahydropyran, thtp means tetrahydrothiopyran, thf means tetrahydrofuran, —CN means cyano, —NO₂ means nitro, S(O)Me means methylsulfinyl, SO₂ means sulfonyl and SO₂Me means methylsulfonyl.

TABLE 1

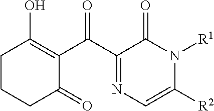

R₂ is Ph.

| R¹ | R¹ |
|---|---|
| Me | CH₂Ph(2-Cl) |
| Et | CH₂Ph(3-Cl) |
| n-Pr | CH₂Ph(4-Cl) |
| i-Pr | thiazol-3-yl |
| cyclopropyl | thiazol-2-yl |
| n-Bu | thiazolin-2-yl |
| i-Bu | oxazol-2-yl |
| s-Bu | CH₂CF₂CF₃ |
| cyclobutyl | CH═CH₂ |
| t-Bu | CH₂(thf-2-yl) |
| n-pentyl | CH₂(3-methylisoxazolin-5-yl) |
| cyclopenyl | isoxazol-4-yl |
| n-hexyl | CH₂(3-methylisoxazol-5-yl) |
| cyclohexyl | 5-methylisoxazol-3-yl |
| Ph | 4-methyloxazol-2-yl |
| CH₂-cyclopropyl | 4-methylthiazol-2-yl |
| CH₂-cyclobutyl | CH₂CH₂CH≡CH₂ |
| CH₂SPh | CH₂SO₂CH₂CH₃ |
| CH₂SCH₃ | CH₂CH₂SO₂Me |
| CH₂CF₃ | CH₂OCH₂OCH₃ |
| CH₂Ph | 3-methylthiazol-2-yl |
| Ph(4-Me) | 5-chloropyridin-2-yl |
| CH₂CHC(CH₃)₂ | 5-methylpyridin-2-yl |
| CH₂CH₂C≡CH | 5-methoxypyridin-2-yl |
| CH₂CH≡CCl₂ | 6-methylpyridin-2-yl |
| CH₂CH═CF₂ | 6-methylpyridin-3-yl |
| CH₂CF═CF₂ | 3-methoxypyridin-4-yl |
| CH₂CCl═CCl₂ | 3-methylpyridin-4-yl |
| CH₂C≡CCH₃ | 3-chloropyridin-4-yl |
| CH₂OCH₂CH₃ | CH₂OCH₂CH₂OCH₃ |
| CH₂CH₂OCH₃ | CH₂C(CH₃)═C(CH₃)₂ |
| CH₂SO₂CH₃ | n-heptyl |
| CH₂SCH₂CH₃ | cycloheptyl |
| Ph(2,3-di-OMe) | thp-4-yl |
| CH₂SO₂-n-Pr | thtp-4-yl |
| CH₂CH₂SO₂Et | Ph(2,3-di-OMe) |
| Ph(2,4-di-OMe) | Ph(3,4-di-OMe) |
| Ph(2,5-di-OMe) | Ph(3,4-di-Me) |
| Ph(2,6-di-OMe) | Ph(3,4-di-F) |
| Ph(3,5-di-OMe) | Ph(3,4,5-tri-OMe) |
| CH₂Ph(2-OMe) | Ph(2-I) |
| CH₂Ph(3-OMe) | Ph(3-I) |
| CH₂Ph(4-OMe) | Ph(4-I) |
| CH₂CH₂SMe | Ph(2-Et) |
| CH₂SCH₂Ph | Ph(3-Et) |
| CH₂SO₂Ph | Ph(4-Et) |
| CH₂CH₂SEt | CH₂CH₂OCH₂CH₃ |
| Ph(2,4-di-Cl) | CH(CH₃)CH₂OCH₃ |
| Ph(2,5-di-Cl) | Ph(2-OCF₃) |
| Ph(2,6-di-Cl) | Ph(3-OCF₃) |
| Ph(3,5-di-Cl) | Ph(4-OCF₃) |
| Ph(2,3-di-Me) | Ph(2-Me-3-F) |
| Ph(2,4-di-Me) | Ph(2-Me-4-F) |
| Ph(2,5-di-Me) | Ph(2-Me-5-F) |
| Ph(2,6-di-Me) | Ph(2-F-3-Me) |
| Ph(3,5-di-Me) | Ph(2-F-4-Me) |
| CH₂-cyclohexyl | Ph(2-F-5-Me) |
| Ph(2,3-di-F) | Ph(3-F-4-Me) |
| Ph(2,4-di-F) | Ph(3-F-5-Me) |
| Ph(2,4-di-F) | Ph(3-Me-4-F) |
| Ph(2,6-di-F) | CH₂CH₂CH₂OCH₃ |
| CH₂CH₂CF₃ | CH₂CH₂CH₂OCH₂CH₃ |
| CH₂C≡CH | CH₂(thp-2-yl) |
| Ph(2,3-di-Cl) | CH₂(thp-4-yl) |
| Ph(3,5-di-F) | CH₂CH₂CH═CH₂ |
| isoxazolin-2-yl | CH₂C≡CH |
| Ph(2-Cl) | CH₂CH₂SCH₃ |
| Ph(3-Cl) | CH₂CH₂SOCH₃ |
| Ph(4-Cl) | CH₂CH₂SO₂CH₃ |
| Ph(2-Me) | CH₂CH₂CH₂SCH₃ |
| Ph(3-Me) | CH₂CH₂CH₂SOCH₃ |
| CH₂OCH₃ | CH₂CH₂CH₂SO₂CH₃ |
| CH₂CH═CH₂ | cyclohexyl(3-OCH₃) |
| Ph(2-OMe) | cyclohexyl(4-OCH₃) |
| Ph(3-OMe) | cyclohexyl(3,4-di-OCH₃) |
| Ph(4-OMe) | cyclohexyl(3,5-di-OCH₃) |
| Ph(2-CN) | CH₂CH₂SCH₃ |
| Ph(3-CN) | Ph(3-OEt) |
| Ph(4-CN) | Ph(4-OEt) |
| Ph(2-F) | Ph(3,4-di-OEt) |
| Ph(3-F) | Ph(3,5-di-OEt) |
| Ph(4-F) | Ph(3,4,5-tri-OEt) |
| CH₂S-n-Pr | Ph(3-OCH₂CH═CH₂) |
| CH₂-cyclopentyl | Ph(4-OCH₂CH═CH₂) |
| oxazolin-2-yl | cyclohexyl(3-OEt) |
| 2-pyridinyl | cyclohexyl(4-OEt) |
| 3-pyridinyl | cyclohexyl(3-Me) |
| 4-pyridinyl | cyclohexyl(4-Me) |
| Ph(2-NO₂) | cyclohexyl(4,4-di-Me) |
| Ph(3-NO₂) | —CH₂CH(OCH₃)CH₂OCH₃ |
| Ph(4-NO₂) | —CH(CH₂OCH₃)₂ |
| Ph(2-CF₃) | —CH₂CH(OCH₂CH₃)CH₂OCH₂CH₃ |
| Ph(3-CF₃) | —CH(CH₃)CH₂OCH₃ |
| Ph(4-CF₃) | —CH(CH₂OCH₂CH₃) |
| Ph(2-Br) | —CH₂CH₂OCH₂CH₂OCH₃ |
| Ph(3-Br) | CH(CH₃)Ph |
| Ph(4-Br) | 4,6-dimethoxypyrimidin-2-yl |
| CH₂Ph(2-Me) | 4,6-dimethoxytriazin-2-yl |
| CH₂Ph(3-Me) | 4,6-diethoxypyrimidin-2-yl |
| CH₂Ph(4-Me) | 4,6-diethoxytriazine-2-yl |

The present disclosure also includes Tables 1A through 88A, each of which is constructed the same as Table 1 above except that the row heading in Table 1 (i.e. “R² is Ph”) is replaced with the respective row headings shown below. For example, in Table 1A the row heading is “R² is Me”, and R¹ is as defined in Table 1 above. Thus, the first entry in Table 1A specifically discloses a compound of Formula 1 wherein R¹ is Me; R² is Me; R³ is H; R⁴ is OH; A is A-1; B¹ is C-1; B² is C-3; B³ is C-1; and each R¹⁵, R¹⁶, R¹⁸ and R¹⁹ is H. Tables 2A through 88A are constructed similarly.

TABLE 2

| Table | Row Heading |
|---|---|
| 1A | R² is Me. |
| 2A | R² is Et. |
| 3A | R² is n-Pr. |
| 4A | R² is cyclopropyl. |
| 5A | R² is CF_{3.} |
| 6A | R² is SO₂Me. |
| 7A | R² is Ph. |
| 8A | R² is Ph(2-Cl). |
| 9A | R² is Ph(3-Cl). |
| 10A | R² is Ph(4-Cl). |
| 11A | R² is Ph(2-Me). |
| 12A | R² is Ph(3-Me). |
| 13A | R² is Ph(4-Me). |
| 14A | R² is Ph(2-OMe). |
| 15A | R² is Ph(3-OMe). |
| 16A | R² is Ph(4-OMe). |
| 17A | R² is Ph(2-F). |
| 15A | R² is Ph(3-F). |
| 19A | R² is Ph(4-F). |
| 20A | R² is OMe. |
| 21A | R² is OEt. |
| 22A | R² is CH₂Ph. |
| 23A | R² is 2-pyridinyl. |
| 24A | R² is 3-pyridinyl. |
| 25A | R² is 4-pyridinyl. |
| 26A | R² is H. |
| 27A | R² is Ph(3,5-di-F). |
| 28A | R² is Ph(3,4-di-F). |
| 29A | R² is Ph(3,4,5-tri-F). |
| 30A | R² is Ph(2,3-di-F). |
| 31A | R² is Ph(3-CF₃). |
| 32A | R² is Ph(4-CF₃). |
| 33A | R² is Ph(3,5-di-CF₃). |
| 34A | R² is n-Bu. |
| 35A | R² is CH₂OCH₃. |
| 36A | R² is CH₂CH₂OCH_{3.} |
| 37A | R² is CH₂CH₂CF_{3.} |
| 38A | R² is CH₂CF_{3.} |
| 39A | R² is n-pentyl. |
| 40A | R² is cyclopentyl. |
| 41A | R² is cyclohexyl. |
| 42A | R² is n-hexyl. |
| 43A | R² is tetrahydropyran-4-yl. |
| 44A | R² is Ph(2-CN). |
| 45A | R² is Ph(3-CN). |
| 46A | R² is Ph(4-CN). |
| 47A | R² is Ph(2-C≡CH). |
| 48A | R² is Ph(3-C≡CH). |
| 49A | R² is Ph(4-C≡CH). |
| 50A | R² is Ph(3-Me, 2-F). |
| 51A | R² is Ph(3-Me-4-F). |
| 52A | R² is Ph(3-Me, 5-F). |
| 53A | R² is Ph(3-Me, 6-F). |
| 54A | R² is Ph(3-F, 2-Me). |
| 55A | R² is Ph(3-F-4-Me). |
| 56A | R² is Ph(3-F-5-Me). |
| 57A | R² is Ph(3-F, 6-Me). |
| 58A | R² is i-Pr. |
| 59A | R² is i-Bu. |
| 60A | R² is thien-2-yl. |
| 61A | R² is thien-3-yl. |
| 62A | R² is furan-2-yl. |
| 63A | R² is furan-3-yl. |
| 64A | 1-Me-pyrazol-3-yl. |
| 65A | R² is isoxazolin-2-yl. |
| 66A | R² is oxazolin-2-yl. |
| 67A | R² is thiazol-3-yl. |
| 68A | R² is thiazol-2-yl. |
| 69A | R² is thiazolin-2-yl. |
| 70A | R² is oxazol-2-yl. |
| 71A | R² is isoxazolin-4-yl. |
| 72A | R² is pyridin-3-yl(5-Me). |
| 73A | R² is pyridin-3-yl(5-Cl). |
| 74A | R² is Ph(3,4-di-OMe). |
| 75A | R² is Ph(3,5-di-OMe). |
| 76A | R² is Ph(3-OEt). |
| 77A | R² is Ph(4-OEt). |
| 78A | R² is Ph(3,4-di-OEt). |
| 79A | R² is Ph(3,5-di-OEt). |
| 80A | R² is Ph(3,4-di-Me). |
| 81A | R² is Ph(3,5-di-Me). |
| 82A | R² is Ph(3,4,5-tri-OEt). |
| 83A | R² is Ph(3-OCH₂CH═CH₂). |
| 84A | R² is Ph(4-OCH₂CH═CH₂). |
| 85A | R² is 4,6-dimethoxypyrimidin-2-yl. |
| 86A | R² is 4,6-dimethoxytriazin-2-yl. |
| 87A | R² is 4,6-diethoxypyrimidin-2-yl. |
| 88A | R² is 4,6-diethoxytriazin-2-yl. |

Table 2 is constructed the same as Table 1, except the structure is replaced with

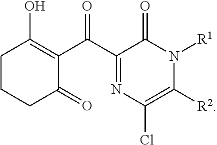

The present disclosure also includes Tables 1B through 88B, each of which is constructed the same as Table 2 above except that the row heading in Table 2 (i.e. “R² is Ph”) is replaced with the respective row headings shown below. For example, in Table 1B the row heading is “R² is Me”, and R¹ is as defined in Table 2 above. Thus, the first entry in Table 1B specifically discloses a compound of Formula 1 wherein R¹ is Me; R² is Me; R³ is Cl; R⁴ is OH; A is A-1; B¹ is C-1; B² is C-3; B³ is C-1; and each R¹⁵, R¹⁶, R¹⁸ and R¹⁹ is H. Tables 2B through 88B are constructed similarly.

TABLE 3

| Table | Row Heading |
|---|---|
| 1B | R² is Me. |
| 2B | R² is Et. |
| 3B | R² is n-Pr. |
| 4B | R² is cyclopropyl. |
| 5B | R² is CF_{3.} |
| 6B | R² is SO₂Me. |
| 7B | R² is Ph. |
| 8B | R² is Ph(2-Cl). |
| 9B | R² is Ph(3-Cl). |
| 10B | R² is Ph(4-Cl). |
| 11B | R² is Ph(2-Me). |
| 12B | R² is Ph(3-Me). |
| 13B | R² is Ph(4-Me). |
| 14B | R² is Ph(2-OMe). |
| 15B | R² is Ph(3-OMe). |
| 16B | R² is Ph(4-OMe). |
| 17B | R² is Ph(2-F). |
| 18B | R² is Ph(3-F). |
| 19B | R² is Ph(4-F). |
| 20B | R² is OMe. |
| 21B | R² is OEt. |
| 22B | R² is CH₂Ph. |
| 23B | R² is 2-pyridinyl. |
| 24B | R² is 3-pyridinyl. |
| 25B | R² is 4-pyridinyl. |
| 26B | R² is H. |
| 27B | R² is Ph(3,5-di-F). |
| 28B | R² is Ph(3,4-di-F). |
| 29B | R² is Ph(3,4,5-tri-F). |
| 30B | R² is Ph(2,3-di-F). |
| 31B | R² is Ph(3-CF₃). |
| 32B | R² is Ph(4-CF₃). |
| 33B | R² is Ph(3,5-di-CF₃). |
| 34B | R² is n-Bu. |
| 35B | R² is CH₂OCH₃. |
| 36B | R² is CH₂CH₂OCH_{3.} |
| 37B | R² is CH₂CH₂CF_{3.} |
| 38B | R² is CH₂CF_{3.} |
| 39B | R² is n-pentyl. |
| 40B | R² is cyclopentyl. |
| 41B | R² is cyclohexyl. |
| 42B | R² is n-hexyl. |
| 43B | R² is tetrahydropyran-4-yl. |
| 44B | R² is Ph(2-CN). |
| 45B | R² is Ph(3-CN). |
| 46B | R² is Ph(4-CN). |
| 47B | R² is Ph(2-C≡CH). |
| 48B | R² is Ph(3-C≡CH). |
| 49B | R² is Ph(4-C≡CH). |
| 50B | R² is Ph(3-Me, 2-F). |
| 51B | R² is Ph(3-Me-4-F). |
| 52B | R² is Ph(3-Me, 5-F). |
| 53B | R² is Ph(3-Me, 6-F). |
| 54B | R² is Ph(3-F, 2-Me). |
| 55B | R² is Ph(3-F-4-Me). |
| 56B | R² is Ph(3-F-5-Me). |
| 57B | R² is Ph(3-F, 6-Me). |
| 58B | R² is i-Pr. |
| 59B | R² is i-Bu. |
| 60B | R² is thien-2-yl. |
| 61B | R² is thien-3-yl. |
| 62B | R² is furan-2-yl. |
| 63B | R² is furan-3-yl. |
| 64B | 1-Me-pyrazol-3-yl. |
| 65B | R² is isoxazolin-2-yl. |
| 66B | R² is oxazolin-2-yl. |
| 67B | R² is thiazol-3-yl. |
| 68B | R² is thiazol-2-yl. |
| 69B | R² is thiazolin-2-yl. |
| 70B | R² is oxazol-2-yl. |
| 71B | R² is isoxazolin-4-yl. |
| 72B | R² is pyridin-3-yl(5-Me). |
| 73B | R² is pyridin-3-yl(5-Cl). |
| 74B | R² is Ph(3,4-di-OMe). |
| 75B | R² is Ph(3,5-di-OMe). |
| 76B | R² is Ph(3-OEt). |
| 77B | R² is Ph(4-OEt). |
| 78B | R² is Ph(3,4-di-OEt). |
| 79B | R² is Ph(3,5-di-OEt). |
| 80B | R² is Ph(3,4-di-Me). |
| 81B | R² is Ph(3,5-di-Me). |
| 82B | R² is Ph(3,4,5-tri-OEt). |
| 83B | R² is Ph(3-OCH₂CH═CH₂). |
| 84B | R² is Ph(4-OCH₂CH═CH₂). |
| 85B | R² is 4,6-dimethoxypyrimidin-2-yl. |
| 86B | R² is 4,6-dimethoxytriazin-2-yl. |
| 87B | R² is 4,6-diethoxypyrimidin-2-yl. |
| 88B | R² is 4,6-diethoxytriazin-2-yl. |

Table 3 is constructed the same as Table 1, except the structure is replaced with

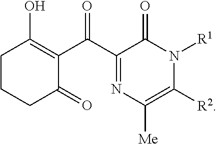

The present disclosure also includes Tables 1C through 88C, each of which is constructed the same as Table 3 above except that the row heading in Table 3 (i.e. “R² is Ph”) is replaced with the respective row headings shown below. For example, in Table 1C the row heading is “R² is Me”, and R¹ is as defined in Table 3 above. Thus, the first entry in Table 1C specifically discloses a compound of Formula 1 wherein R¹ is Me; R² is Me; R³ is Me; R⁴ is OH; A is A-1; B¹ is C-1; B² is C-3; B³ is C-1; and each R¹⁵, R¹⁶, R¹⁸ and R¹⁹ is H. Tables 2C through 88C are constructed similarly.

TABLE 4

| Table | Row Heading |
|---|---|
| 1C | R² is Me. |
| 2C | R² is Et. |
| 3C | R² is n-Pr. |
| 4C | R² is cyclopropyl. |
| 5C | R² is CF_{3.} |
| 6C | R² is SO₂Me. |
| 7C | R² is Ph. |
| 8C | R² is Ph(2-Cl). |
| 9C | R² is Ph(3-Cl). |
| 10C | R² is Ph(4-Cl). |
| 11C | R² is Ph(2-Me). |
| 12C | R² is Ph(3-Me). |
| 13C | R² is Ph(4-Me). |
| 14C | R² is Ph(2-OMe). |
| 15C | R² is Ph(3-OMe). |
| 16C | R² is Ph(4-OMe). |
| 17C | R² is Ph(2-F). |
| 18C | R² is Ph(3-F). |
| 19C | R² is Ph(4-F). |
| 20C | R² is OMe. |
| 21C | R² is OEt. |
| 22C | R² is CH₂Ph. |
| 23C | R² is 2-pyridinyl. |
| 24C | R² is 3-pyridinyl. |
| 25C | R² is 4-pyridinyl. |
| 26C | R² is H. |
| 27C | R² is Ph(3,5-di-F). |
| 28C | R² is Ph(3,4-di-F). |
| 29C | R² is Ph(3,4,5-tri-F). |
| 30C | R² is Ph(2,3-di-F). |
| 31C | R² is Ph(3-CF₃). |
| 32C | R² is Ph(4-CF₃). |
| 33C | R² is Ph(3,5-di-CF₃). |
| 34C | R² is n-Bu. |
| 35C | R² is CH₂OCH₃. |
| 36C | R² is CH₂CH₂OCH_{3.} |
| 37C | R² is CH₂CH₂CF_{3.} |
| 38C | R² is CH₂CF_{3.} |
| 39C | R² is n-pentyl. |
| 40C | R² is cyclopentyl. |
| 41C | R² is cyclohexyl. |
| 42C | R² is n-hexyl. |
| 43C | R² is tetrahydropyran-4-yl. |
| 44C | R² is Ph(2-CN). |
| 45C | R² is Ph(3-CN). |
| 46C | R² is Ph(4-CN). |
| 47C | R² is Ph(2-C≡CH). |
| 48C | R² is Ph(3-C≡CH). |
| 49C | R² is Ph(4-C≡CH). |
| 50C | R² is Ph(3-Me, 2-F). |
| 51C | R² is Ph(3-Me-4-F). |
| 52C | R² is Ph(3-Me, 5-F). |
| 53C | R² is Ph(3-Me, 6-F). |
| 54C | R² is Ph(3-F, 2-Me). |
| 55C | R² is Ph(3-F-4-Me). |
| 56C | R² is Ph(3-F-5-Me). |
| 57C | R² is Ph(3-F, 6-Me). |
| 58C | R² is i-Pr. |
| 59C | R² is i-Bu. |
| 60C | R² is thien-2-yl. |
| 61C | R² is thien-3-yl. |
| 62C | R² is furan-2-yl. |
| 63C | R² is furan-3-yl. |
| 64C | 1-Me-pyrazol-3-yl. |
| 65C | R² is is oxazolin-2-yl. |
| 66C | R² is oxazolin-2-yl. |
| 67C | R² is thiazol-3-yl. |
| 68C | R² is thiazol-2-yl. |
| 69C | R² is thiazolin-2-yl. |
| 70C | R² is oxazol-2-yl. |
| 71C | R² is is oxazolin-4-yl. |
| 72C | R² is pyridin-3-yl(5-Me). |
| 73C | R² is pyridin-3-yl(5-Cl). |
| 74C | R² is Ph(3,4-di-OMe). |
| 75C | R² is Ph(3,5-di-OMe). |
| 76C | R² is Ph(3-OEt). |
| 77C | R² is Ph(4-OEt). |
| 78C | R² is Ph(3,4-di-OEt). |
| 79C | R² is Ph(3,5-di-OEt). |
| 80C | R² is Ph(3,4-di-Me). |
| 81C | R² is Ph(3,5-di-Me). |
| 82C | R² is Ph(3,4,5-tri-OEt). |
| 83C | R² is Ph(3-OCH₂CH═CH₂). |
| 84C | R² is Ph(4-OCH₂CH═CH₂). |
| 85C | R² is 4,6-dimethoxypyrimidin-2-yl. |
| 86C | R² is 4,6-dimethoxytriazin-2-yl. |
| 87C | R² is 4,6-diethoxypyrimidin-2-yl. |
| 88C | R² is 4,6-diethoxytriazin-2-yl. |

Table 4 is constructed the same as Table 1, except the structure is replaced with

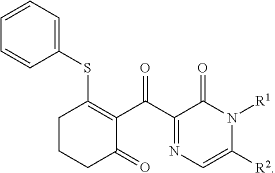

The present disclosure also includes Tables 1D through 51D, each of which is constructed the same as Table 4 above except that the row heading in Table 4 (i.e. “R² is Ph”) is replaced with the respective row headings shown below. For example, in Table 1D the row heading is “R² is Me”, and R¹ is as defined in Table 4 above. Thus, the first entry in Table 1D specifically discloses a compound of Formula 1 wherein R¹ is Me; R² is Me; R³ is H; R⁴ is SPh; A is A-1; B¹ is C-1; B² is C-3; B³ is C-1; and each R¹⁵, R¹⁶, R¹⁸ and R¹⁹ is H. Tables 2D through 51D are constructed similarly.

TABLE 5

| Table | Row Heading |
|---|---|
| 1D | R² is Me. |
| 2D | R² is Et. |
| 3D | R² is n-Pr. |
| 4D | R² is cyclopropyl. |
| 5D | R² is CF_{3.} |
| 6D | R² is SO₂Me. |
| 7D | R² is Ph. |
| 8D | R² is Ph(2-Cl). |
| 9D | R² is Ph(3-Cl). |
| 10D | R² is Ph(4-Cl). |
| 11D | R² is Ph(2-Me). |
| 12D | R² is Ph(3-Me). |
| 13D | R² is Ph(4-Me). |
| 14D | R² is Ph(3-OMe). |
| 15D | R² is Ph(4-OMe). |
| 16D | R² is Ph(2-F). |
| 17D | R² is Ph(3-F). |
| 18D | R² is Ph(4-F). |
| 19D | R² is 2-pyridinyl. |
| 20D | R² is 3-pyridinyl. |
| 21D | R² is 4-pyridinyl. |
| 22D | R² is Ph(3,5-di-F). |
| 23D | R² is Ph(3,4-di-F). |
| 24D | R² is Ph(3-CF₃). |
| 25D | R² is Ph(4-CF₃). |
| 26D | R² is n-Bu. |
| 27D | R² is CH₂OCH₃. |
| 28D | R² is CH₂CH₂OCH_{3.} |
| 29D | R² is CH₂CF_{3.} |
| 30D | R² is n-pentyl. |
| 31D | R² is cyclopentyl. |
| 32D | R² is cyclohexyl. |
| 33D | R² is n-hexyl. |
| 34D | R² is Ph(3-Me-4-F). |
| 35D | R² is Ph(3-F-4-Me). |
| 36D | R² is i-Pr. |
| 37D | R² is thien-2-yl. |
| 38D | R² is thien-3-yl. |
| 39D | R² is furan-2-yl. |
| 40D | R² is furan-3-yl. |
| 41D | R² is thiazol-3-yl. |
| 42D | R² is thiazol-2-yl. |
| 43D | R² is oxazol-2-yl. |
| 44D | R² is Ph(3,4-di-OMe). |
| 45D | R² is Ph(3,5-di-OMe). |
| 46D | R² is Ph(3-OEt). |
| 47D | R² is Ph(4-OEt). |
| 48D | R² is Ph(3,4-di-OEt). |
| 49D | R² is Ph(3,5-di-OEt). |
| 50D | R² is Ph(3,4-di-Me). |
| 51D | R² is Ph(3,5-di-Me). |

Table 5 is constructed the same as Table 1, except the structure is replaced with

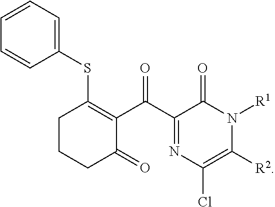

The present disclosure also includes Tables 1E through 51E, each of which is constructed the same as Table 5 above except that the row heading in Table 5 (i.e. “R² is Ph”) is replaced with the respective row headings shown below. For example, in Table 1E the row heading is “R² is Me”, and R¹ is as defined in Table 5 above. Thus, the first entry in Table 1E specifically discloses a compound of Formula 1 wherein R¹ is Me; R² is Me; R³ is Cl; R⁴ is SPh; A is A-1; B¹ is C-1; B² is C-3; B³ is C-1; and each R¹⁵, R¹⁶, R¹⁸ and R¹⁹ is H. Tables 2E through 51E are constructed similarly.

TABLE 6

| Table | Row Heading |
|---|---|
| 1E | R² is Me. |
| 2E | R² is Et. |
| 3E | R² is n-Pr. |
| 4E | R² is cyclopropyl. |
| 5E | R² is CF_{3.} |
| 6E | R² is SO₂Me. |
| 7E | R² is Ph. |
| 8E | R² is Ph(2-Cl). |
| 9E | R² is Ph(3-Cl). |
| 10E | R² is Ph(4-Cl). |
| 11E | R² is Ph(2-Me). |
| 12E | R² is Ph(3-Me). |
| 13E | R² is Ph(4-Me). |
| 14E | R² is Ph(3-OMe). |
| 15E | R² is Ph(4-OMe). |
| 16E | R² is Ph(2-F). |
| 17E | R² is Ph(3-F). |
| 18E | R² is Ph(4-F). |
| 19E | R² is 2-pyridinyl. |
| 20E | R² is 3-pyridinyl. |
| 21E | R² is 4-pyridinyl. |
| 22E | R² is Ph(3,5-di-F). |
| 23E | R² is Ph(3,4-di-F). |
| 24E | R² is Ph(3-CF₃). |
| 25E | R² is Ph(4-CF₃). |
| 26E | R² is n-Bu. |
| 27E | R² is CH₂OCH₃. |
| 28E | R² is CH₂CH₂OCH_{3.} |
| 29E | R² is CH₂CF_{3.} |
| 30E | R² is n-pentyl. |
| 31E | R² is cyclopentyl. |
| 32E | R² is cyclohexyl. |
| 33E | R² is n-hexyl. |
| 34E | R² is Ph(3-Me-4-F). |
| 35E | R² is Ph(3-F-4-Me). |
| 36E | R² is i-Pr. |
| 37E | R² is thien-2-yl. |
| 38E | R² is thien-3-yl. |
| 39E | R² is furan-2-yl. |
| 40E | R² is furan-3-yl. |
| 41E | R² is thiazol-3-yl. |
| 42E | R² is thiazol-2-yl. |
| 43E | R² is oxazol-2-yl. |
| 44E | R² is Ph(3,4-di-OMe). |
| 45E | R² is Ph(3,5-di-OMe). |
| 46E | R² is Ph(3-OEt). |
| 47E | R² is Ph(4-OEt). |
| 48E | R² is Ph(3,4-di-OEt). |
| 49E | R² is Ph(3,5-di-OEt). |
| 50E | R² is Ph(3,4-di-Me). |
| 51E | R² is Ph(3,5-di-Me). |

Table 6 is constructed the same as Table 1, except the structure is replaced with

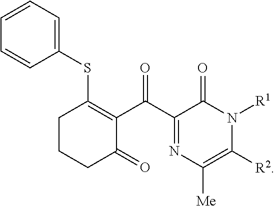

The present disclosure also includes Tables 1F through 51F, each of which is constructed the same as Table 6 above except that the row heading in Table 6 (i.e. “R² is Ph”) is replaced with the respective row headings shown below. For example, in Table 1F the row heading is “R² is Me”, and R¹ is as defined in Table 6 above. Thus, the first entry in Table 1F specifically discloses a compound of Formula 1 wherein R¹ is Me; R² is Me; R³ is Me; R⁴ is SPh; A is A-1; B¹ is C-1; B² is C-3; B³ is C-1; and each R¹⁵, R¹⁶, R¹⁸ and R¹⁹ is H. Tables 2F through 51F are constructed similarly.

TABLE 7

| Table | Row Heading |
|---|---|
| 1F | R² is Me. |
| 2F | R² is Et. |
| 3F | R² is n-Pr. |
| 4F | R² is cyclopropyl. |
| 5F | R² is CF_{3.} |
| 6F | R² is SO₂Me. |
| 7F | R² is Ph. |
| 8F | R² is Ph(2-Cl). |
| 9F | R² is Ph(3-Cl). |
| 10F | R² is Ph(4-Cl). |
| 11F | R² is Ph(2-Me). |
| 12F | R² is Ph(3-Me). |
| 13F | R² is Ph(4-Me). |
| 14F | R² is Ph(3-OMe). |
| 15F | R² is Ph(4-OMe). |
| 16F | R² is Ph(2-F). |
| 17F | R² is Ph(3-F). |
| 18F | R² is Ph(4-F). |
| 19F | R² is 2-pyridinyl. |
| 20F | R² is 3-pyridinyl. |
| 21F | R² is 4-pyridinyl. |
| 22F | R² is Ph(3,5-di-F). |
| 23F | R² is Ph(3,4-di-F). |
| 24F | R² is Ph(3-CF₃). |
| 25F | R² is Ph(4-CF₃). |
| 26F | R² is n-Bu. |
| 27F | R² is CH₂OCH₃. |
| 28F | R² is CH₂CH₂OCH_{3.} |
| 29F | R² is CH₂CF_{3.} |
| 30F | R² is n-pentyl. |
| 31F | R² is cyclopentyl. |
| 32F | R² is cyclohexyl. |
| 33F | R² is n-hexyl. |
| 34F | R² is Ph(3-Me-4-F). |
| 35F | R² is Ph(3-F-4-Me). |
| 36F | R² is i-Pr. |
| 37F | R² is thien-2-yl. |
| 38F | R² is thien-3-yl. |
| 39F | R² is furan-2-yl. |
| 40F | R² is furan-3-yl. |
| 41F | R² is thiazol-3-yl. |
| 42F | R² is thiazol-2-yl. |
| 43F | R² is oxazol-2-yl. |
| 44F | R² is Ph(3,4-di-OMe). |
| 45F | R² is Ph(3,5-di-OMe). |
| 46F | R² is Ph(3-OEt). |
| 47F | R² is Ph(4-OEt). |
| 48F | R² is Ph(3,4-di-OEt). |
| 49F | R² is Ph(3,5-di-OEt). |
| 50F | R² is Ph(3,4-di-Me). |
| 51F | R² is Ph(3,5-di-Me). |

Table 7 is constructed the same as Table 1, except the structure is replaced with

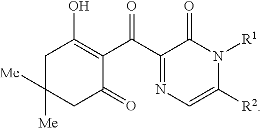

The present disclosure also includes Tables 1G through 51G, each of which is constructed the same as Table 7 above except that the row heading in Table 7 (i.e. “R² is Ph”) is replaced with the respective row headings shown below. For example, in Table 1G the row heading is “R² is Me”, and R¹ is as defined in Table 7 above. Thus, the first entry in Table 1G specifically discloses a compound of Formula 1 wherein R¹ is Me; R² is Me; R³ is H; R⁴ is OH; A is A-1; B¹ is C-1; B² is C-3; B³ is C-1; each R¹⁵ and R¹⁶ is H; and R¹⁸ and R¹⁹ are each Me. Tables 2G through 51G are constructed similarly.

TABLE 8

| Table | Row Heading |
|---|---|
| 1G | R² is Me. |
| 2G | R² is Et. |
| 3G | R² is n-Pr. |
| 4G | R² is cyclopropyl. |
| 5G | R² is CF_{3.} |
| 6G | R² is SO₂Me. |
| 7G | R² is Ph. |
| 8G | R² is Ph(2-Cl). |
| 9G | R² is Ph(3-Cl). |
| 10G | R² is Ph(4-Cl). |
| 11G | R² is Ph(2-Me). |
| 12G | R² is Ph(3-Me). |
| 13G | R² is Ph(4-Me). |
| 14G | R² is Ph(3-OMe). |
| 15G | R² is Ph(4-OMe). |
| 16G | R² is Ph(2-F). |
| 17G | R² is Ph(3-F). |
| 18G | R² is Ph(4-F). |
| 19G | R² is 2-pyridinyl. |
| 20G | R² is 3-pyridinyl. |
| 21G | R² is 4-pyridinyl. |
| 22G | R² is Ph(3,5-di-F). |
| 23G | R² is Ph(3,4-di-F). |
| 24G | R² is Ph(3-CF₃). |
| 25G | R² is Ph(4-CF₃). |
| 26G | R² is n-Bu. |
| 27G | R² is CH₂OCH₃. |
| 28G | R² is CH₂CH₂OCH_{3.} |
| 29G | R² is CH₂CF_{3.} |
| 30G | R² is n-pentyl. |
| 31G | R² is cyclopentyl. |
| 32G | R² is cyclohexyl. |
| 33G | R² is n-hexyl. |
| 34G | R² is Ph(3-Me-4-F). |
| 35G | R² is Ph(3-F-4-Me). |
| 36G | R² is i-Pr. |
| 37G | R² is thien-2-yl. |
| 38G | R² is thien-3-yl. |
| 39G | R² is furan-2-yl. |
| 40G | R² is furan-3-yl. |
| 41G | R² is thiazol-3-yl. |
| 42G | R² is thiazol-2-yl. |
| 43G | R² is oxazol-2-yl. |
| 44G | R² is Ph(3,4-di-OMe). |
| 45G | R² is Ph(3,5-di-OMe). |
| 46G | R² is Ph(3-OEt). |
| 47G | R² is Ph(4-OEt). |
| 48G | R² is Ph(3,4-di-OEt). |
| 49G | R² is Ph(3,5-di-OEt). |
| 50G | R² is Ph(3,4-di-Me). |
| 51G | R² is Ph(3,5-di-Me). |

Table 8 is constructed the same as Table 1, except the structure is replaced with

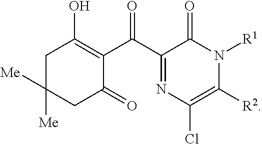

The present disclosure also includes Tables 1H through 51H, each of which is constructed the same as Table 8 above except that the row heading in Table 8 (i.e. “R² is Ph”) is replaced with the respective row headings shown below. For example, in Table 1H the row heading is “R² is Me”, and R¹ is as defined in Table 8 above. Thus, the first entry in Table 1H specifically discloses a compound of Formula 1 wherein R¹ is Me; R² is Me; R³ is Cl; R⁴ is OH; A is A-1; B¹ is C-1; B² is C-3; B³ is C-1; each R¹⁵ and R¹⁶ is H; and R¹⁸ and R¹⁹ are each Me. Tables 2H through 51H are constructed similarly.

TABLE 9

| Table | Row Heading |
|---|---|
| 1H | R² is Me. |
| 2H | R² is Et. |
| 3H | R² is n-Pr. |
| 4H | R² is cyclopropyl |
| 5H | R² is CF_{3.} |
| 6H | R² is SO₂Me. |
| 7H | R² is Ph. |
| 8H | R² is Ph(2-Cl). |
| 9H | R² is Ph(3-Cl). |
| 10H | R² is Ph(4-Cl). |
| 11H | R² is Ph(2-Me). |
| 12H | R² is Ph(3-Me). |
| 13H | R² is Ph(4-Me). |
| 14H | R² is Ph(3-OMe). |
| 15H | R² is Ph(4-OMe). |
| 16H | R² is Ph(2-F). |
| 17H | R² is Ph(3-F). |
| 18H | R² is Ph(4-F). |
| 19H | R² is 2-pyridinyl. |
| 20H | R² is 3-pyridinyl. |
| 21H | R² is 4-pyridinyl. |
| 22H | R² is Ph(3,5-di-F). |
| 23H | R² is Ph(3,4-di-F). |
| 24H | R² is Ph(3-CF₃). |
| 25H | R² is Ph(4-CF₃). |
| 26H | R² is n-Bu. |
| 27H | R² is CH₂OCH₃. |
| 28H | R² is CH₂CH₂OCH_{3.} |
| 29H | R² is CH₂CF_{3.} |
| 30H | R² is n-pentyl. |
| 31H | R² is cyclopentyl. |
| 32H | R² is cyclohexyl. |
| 33H | R² is n-hexyl. |
| 34H | R² is Ph(3-Me-4-F). |
| 35H | R² is Ph(3-F-4-Me). |
| 36H | R² is i-Pr. |
| 37H | R² is thien-2-yl. |
| 38H | R² is thien-3-yl. |
| 39H | R² is furan-2-yl. |
| 40H | R² is furan-3-yl. |
| 41H | R² is thiazol-3-yl. |
| 42H | R² is thiazol-2-yl. |
| 43H | R² is oxazol-2-yl. |
| 44H | R² is Ph(3,4-di-OMe). |
| 45H | R² is Ph(3,5-di-OMe). |
| 46H | R² is Ph(3-OEt). |
| 47H | R² is Ph(4-OEt). |
| 48H | R² is Ph(3,4-di-OEt). |
| 49H | R² is Ph(3,5-di-OEt). |
| 50H | R² is Ph(3,4-di-Me). |
| 51H | R² is Ph(3,5-di-Me). |

Table 9 is constructed the same as Table 1, except the structure is replaced with

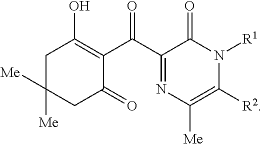

The present disclosure also includes Tables 1I through 51I, each of which is constructed the same as Table 9 above except that the row heading in Table 9 (i.e. “R² is Ph”) is replaced with the respective row headings shown below. For example, in Table 1I the row heading is “R² is Me”, and R¹ is as defined in Table 9 above. Thus, the first entry in Table 1I specifically discloses a compound of Formula 1 wherein R¹ is Me; R² is Me; R³ is Me; R⁴ is OH; A is A-1; B¹ is C-1; B² is C-3; B³ is C-1; each R¹⁵ and R¹⁶ is H; and R¹⁸ and R¹⁹ are each Me. Tables 2I through 51I are constructed similarly.

TABLE 10

| Table | Row Heading |
|---|---|
| 1I | R² is Me. |
| 2I | R² is Et. |
| 3I | R² is n-Pr. |
| 4I | R² is cyclopropyl |
| 5I | R² is CF_{3.} |
| 6I | R² is SO₂Me. |
| 7I | R² is Ph. |
| 8I | R² is Ph(2-Cl). |
| 9I | R² is Ph(3-Cl). |
| 10I | R² is Ph(4-Cl). |
| 11I | R² is Ph(2-Me). |
| 12I | R² is Ph(3-Me). |
| 13I | R² is Ph(4-Me). |
| 14I | R² is Ph(3-OMe). |
| 15I | R² is Ph(4-OMe). |
| 16I | R² is Ph(2-F). |
| 17I | R² is Ph(3-F). |
| 18I | R² is Ph(4-F). |
| 19I | R² is 2-pyridinyl. |
| 20I | R² is 3-pyridinyl. |
| 21I | R² is 4-pyridinyl. |
| 22I | R² is Ph(3,5-di-F). |
| 23I | R² is Ph(3,4-di-F). |
| 24I | R² is Ph(3-CF₃). |
| 25I | R² is Ph(4-CF₃). |
| 26I | R² is n-Bu. |
| 27I | R² is CH₂OCH₃. |
| 28I | R² is CH₂CH₂OCH_{3.} |
| 29I | R² is CH₂CF_{3.} |
| 30I | R² is n-pentyl. |
| 31I | R² is cyclopentyl. |
| 32I | R² is cyclohexyl. |
| 33I | R² is n-hexyl. |
| 34I | R² is Ph(3-Me-4-F). |
| 35I | R² is Ph(3-F-4-Me). |
| 36I | R² is i-Pr. |
| 37I | R² is thien-2-yl. |
| 38I | R² is thien-3-yl. |
| 39I | R² is furan-2-yl. |
| 40I | R² is furan-3-yl. |
| 41I | R² is thiazol-3-yl. |
| 42I | R² is thiazol-2-yl. |
| 43I | R² is oxazol-2-yl. |
| 44I | R² is Ph(3,4-di-OMe). |
| 45I | R² is Ph(3,5-di-OMe). |
| 46I | R² is Ph(3-OEt). |
| 47I | R² is Ph(4-OEt). |
| 48I | R² is Ph(3,4-di-OEt). |
| 49I | R² is Ph(3,5-di-OEt). |
| 50I | R² is Ph(3,4-di-Me). |
| 51I | R² is Ph(3,5-di-Me). |

Table 10 is constructed the same as Table 1, except the structure is replaced with

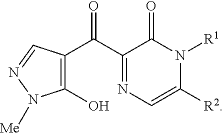

The present disclosure also includes Tables 1J through 51J, each of which is constructed the same as Table 10 above except that the row heading in Table 10 (i.e. “R² is Ph”) is replaced with the respective row headings shown below. For example, in Table 1J the row heading is “R² is Me”, and R¹ is as defined in Table 10 above. Thus, the first entry in Table 1J specifically discloses a compound of Formula 1 wherein R¹ is Me; R² is Me; R³ is H; R⁴ is OH; A is A-5; R¹⁰ is Me; and R¹¹ is H. Tables 2J through 51J are constructed similarly.

TABLE 11

| Table | Row Heading |
|---|---|
| 1J | R² is Me. |
| 2J | R² is Et. |
| 3J | R² is n-Pr. |
| 4J | R² is cyclopropyl. |
| 5J | R² is CF_{3.} |
| 6J | R² is SO₂Me. |
| 7J | R² is Ph. |
| 8J | R² is Ph(2-Cl). |
| 9J | R² is Ph(3-Cl). |
| 10J | R² is Ph(4-Cl). |
| 11J | R² is Ph(2-Me). |
| 12J | R² is Ph(3-Me). |
| 13J | R² is Ph(4-Me). |
| 14J | R² is Ph(3-OMe). |
| 15J | R² is Ph(4-OMe). |
| 16J | R² is Ph(2-F). |
| 17J | R² is Ph(3-F). |
| 18J | R² is Ph(4-F). |
| 19J | R² is 2-pyridinyl. |
| 20J | R² is 3-pyridinyl. |
| 21J | R² is 4-pyridinyl. |
| 22J | R² is Ph(3,5-di-F). |
| 23J | R² is Ph(3,4-di-F). |
| 24J | R² is Ph(3-CF₃). |
| 25J | R² is Ph(4-CF₃). |
| 26J | R² is n-Bu. |
| 27J | R² is CH₂OCH₃. |
| 28J | R² is CH₂CH₂OCH_{3.} |
| 29J | R² is CH₂CF_{3.} |
| 30J | R² is n-pentyl. |
| 31J | R² is cyclopentyl. |
| 32J | R² is cyclohexyl. |
| 33J | R² is n-hexyl. |
| 34J | R² is Ph(3-Me-4-F). |
| 35J | R² is Ph(3-F-4-Me). |
| 36J | R² is i-Pr. |
| 37J | R² is thien-2-yl. |
| 38J | R² is thien-3-yl. |
| 39J | R² is furan-2-yl. |
| 40J | R² is furan-3-yl. |
| 41J | R² is thiazol-3-yl. |
| 42J | R² is thiazol-2-yl. |
| 43J | R² is oxazol-2-yl. |
| 44J | R² is Ph(3,4-di-OMe). |
| 45J | R² is Ph(3,5-di-OMe). |
| 46J | R² is Ph(3-OEt). |
| 47J | R² is Ph(4-OEt). |
| 48J | R² is Ph(3,4-di-OEt). |
| 49J | R² is Ph(3,5-di-OEt). |
| 50J | R² is Ph(3,4-di-Me). |
| 51J | R² is Ph(3,5-di-Me). |

Table 11 is constructed the same as Table 1, except the structure is replaced with

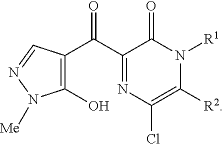

The present disclosure also includes Tables 1K through 51K, each of which is constructed the same as Table 11 above except that the row heading in Table 11 (i.e. “R² is Ph”) is replaced with the respective row headings shown below. For example, in Table 1K the row heading is “R² is Me”, and R¹ is as defined in Table 11 above. Thus, the first entry in Table 1K specifically discloses a compound of Formula 1 wherein R¹ is Me; R² is Me; R³ is Cl; R⁴ is OH; A is A-5; R¹⁰ is Me; and R¹¹ is H. Tables 2K through 51K are constructed similarly.

TABLE 12

| Table | Row Heading |
|---|---|
| 1K | R² is Me. |
| 2K | R² is Et. |
| 3K | R² is n-Pr. |
| 4K | R² is cyclopropyl. |
| 5K | R² is CF₃ |
| 6K | R² is SO₂Me. |
| 7K | R² is Ph. |
| 8K | R² is Ph(2-Cl). |
| 9K | R² is Ph(3-Cl). |
| 10K | R² is Ph(4-Cl). |
| 11K | R² is Ph(2-Me). |
| 12K | R² is Ph(3-Me). |
| 13K | R² is Ph(4-Me). |
| 14K | R² is Ph(3-OMe). |
| 15K | R² is Ph(4-OMe). |
| 16K | R² is Ph(2-F). |
| 17K | R² is Ph(3-F). |
| 18K | R² is Ph(4-F). |
| 19K | R² is 2-pyridinyl. |
| 20K | R² is 3-pyridinyl. |
| 21K | R² is 4-pyridinyl. |
| 22K | R² is Ph(3,5-di-F). |
| 23K | R² is Ph(3,4-di-F). |
| 24K | R² is Ph(3-CF₃). |
| 25K | R² is Ph(4-CF₃). |
| 26K | R² is n-Bu. |
| 27K | R² is CH₂OCH₃. |
| 28K | R² is CH₂CH₂OCH₃ |
| 29K | R² is CH₂CF₃ |
| 30K | R² is n-pentyl. |
| 31K | R² is cyclopentyl. |
| 32K | R² is cyclohexyl. |
| 33K | R² is n-hexyl. |
| 34K | R² is Ph(3-Me-4-F). |
| 35K | R² is Ph(3-F-4-Me). |
| 36K | R² is i-Pr. |
| 37K | R² is thien-2-yl. |
| 38K | R² is thien-3-yl. |
| 39K | R² is furan-2-yl. |
| 40K | R² is furan-3-yl. |
| 41K | R² is thiazol-3-yl. |
| 42K | R² is thiazol-2-yl. |
| 43K | R² is oxazol-2-yl. |
| 44K | R² is Ph(3,4-di-OMe). |
| 45K | R² is Ph(3,5-di-OMe). |
| 46K | R² is Ph(3-OEt). |
| 47K | R² is Ph(4-OEt). |
| 48K | R² is Ph(3,4-di-OEt). |
| 49K | R² is Ph(3,5-di-OEt). |
| 50K | R² is Ph(3,4-di-Me). |
| 51K | R² is Ph(3,5-di-Me). |

Table 12 is constructed the same as Table 1, except the structure is replaced with

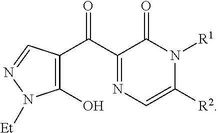

The present disclosure also includes Tables 1L through 51L, each of which is constructed the same as Table 12 above except that the row heading in Table 12 (i.e. “R¹ is Me”) is replaced with the respective row headings shown below. For example, in Table 1L the row heading is “R² is Me”, and R¹ is as defined in Table 12 above. Thus, the first entry in Table 1L specifically discloses a compound of Formula 1 wherein R¹ is Me; R² is Me; R³ is H; R⁴ is OH; A is A-5; R¹⁰ is Et; and R¹¹ is H. Tables 2L through 51L are constructed similarly.

TABLE 13

| Table | Row Heading |
|---|---|
| 1L | R² is Me. |
| 2L | R² is Et. |
| 3L | R² is n-Pr. |
| 4L | R² is cyclopropyl. |
| 5L | R² is CF₃ |
| 6L | R² is SO₂Me. |
| 7L | R² is Ph. |
| 8L | R² is Ph(2-Cl). |
| 9L | R² is Ph(3-Cl). |
| 10L | R² is Ph(4-Cl). |
| 11L | R² is Ph(2-Me). |
| 12L | R² is Ph(3-Me). |
| 13L | R² is Ph(4-Me). |
| 14L | R² is Ph(3-OMe). |
| 15L | R² is Ph(4-OMe). |
| 16L | R² is Ph(2-F). |
| 17L | R² is Ph(3-F). |
| 18L | R² is Ph(4-F). |
| 19L | R² is 2-pyridinyl. |
| 20L | R² is 3-pyridinyl. |
| 21L | R² is 4-pyridinyl. |
| 22L | R² is Ph(3,5-di-F). |
| 23L | R² is Ph(3,4-di-F). |
| 24L | R² is Ph(3-CF₃). |
| 25L | R² is Ph(4-CF₃). |
| 26L | R² is n-Bu. |
| 27L | R² is CH₂OCH₃. |
| 28L | R² is CH₂CH₂OCH_{3.} |
| 29L | R² is CH₂CF_{3.} |
| 30L | R² is n-pentyl. |
| 31L | R² is cyclopentyl. |
| 32L | R² is cyclohexyl. |
| 33L | R² is n-hexyl. |
| 34L | R² is Ph(3-Me-4-F). |
| 35L | R² is Ph(3-F-4-Me). |
| 36L | R² is i-Pr. |
| 37L | R² is thien-2-yl. |
| 38L | R² is thien-3-yl. |
| 39L | R² is furan-2-yl. |
| 40L | R² is furan-3-yl. |
| 41L | R² is thiazol-3-yl. |
| 42L | R² is thiazol-2-yl. |
| 43L | R² is oxazol-2-yl. |
| 44L | R² is Ph(3,4-di-OMe). |
| 45L | R² is Ph(3,5-di-OMe). |
| 46L | R² is Ph(3-OEt). |
| 47L | R² is Ph(4-OEt). |
| 48L | R² is Ph(3,4-di-OEt). |
| 49L | R² is Ph(3,5-di-OEt). |
| 50L | R² is Ph(3,4-di-Me). |
| 51L | R² is Ph(3,5-di-Me). |

Table 13 is constructed the same as Table 1, except the structure is replaced with

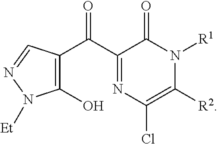

The present disclosure also includes Tables 1M through 51M, each of which is constructed the same as Table 13 above except that the row heading in Table 13 (i.e. “R² is Ph”) is replaced with the respective row headings shown below. For example, in Table 1M the row heading is “R² is Me”, and R¹ is as defined in Table 13 above. Thus, the first entry in Table 1M specifically discloses a compound of Formula 1 wherein R¹ is Me; R² is Me; R³ is Cl; R⁴ is OH; A is A-5; R¹⁰ is Et; and R¹¹ is H. Tables 2M through 51M are constructed similarly.

TABLE 14

| Table | Row Heading |
|---|---|
| 1M | R² is Me. |
| 2M | R² is Et. |
| 3M | R² is n-Pr. |
| 4M | R² is cyclopropyl. |
| 5M | R² is CF_{3.} |
| 6M | R² is SO₂Me. |
| 7M | R² is Ph. |
| 8M | R² is Ph(2-Cl). |
| 9M | R² is Ph(3-Cl). |
| 10M | R² is Ph(4-Cl). |
| 11M | R² is Ph(2-Me). |
| 12M | R² is Ph(3-Me). |
| 13M | R² is Ph(4-Me). |
| 14M | R² is Ph(3-OMe). |
| 15M | R² is Ph(4-OMe). |
| 16M | R² is Ph(2-F). |
| 17M | R² is Ph(3-F). |
| 18M | R² is Ph(4-F). |
| 19M | R² is 2-pyridinyl. |
| 20M | R² is 3-pyridinyl. |
| 21M | R² is 4-pyridinyl. |
| 22M | R² is Ph(3,5-di-F). |
| 23M | R² is Ph(3,4-di-F). |
| 24M | R² is Ph(3-CF₃). |
| 25M | R² is Ph(4-CF₃). |
| 26M | R² is n-Bu. |
| 27M | R² is CH₂OCH₃. |
| 28M | R² is CH₂CH₂OCH_{3.} |
| 29M | R² is CH₂CF_{3.} |
| 30M | R² is n-pentyl. |
| 31M | R² is cyclopentyl. |
| 32M | R² is cyclohexyl. |
| 33M | R² is n-hexyl. |
| 34M | R² is Ph(3-Me-4-F). |
| 35M | R² is Ph(3-F-4-Me). |
| 36M | R² is i-Pr. |
| 37M | R² is thien-2-yl. |
| 38M | R² is thien-3-yl. |
| 39M | R² is furan-2-yl. |
| 40M | R² is furan-3-yl. |
| 41M | R² is thiazol-3-yl. |
| 42M | R² is thiazol-2-yl. |
| 43M | R² is oxazol-2-yl. |
| 44M | R² is Ph(3,4-di-OMe). |
| 45M | R² is Ph(3,5-di-OMe). |
| 46M | R² is Ph(3-OEt). |
| 47M | R² is Ph(4-OEt). |
| 48M | R² is Ph(3,4-di-OEt). |
| 49M | R² is Ph(3,5-di-OEt). |
| 50M | R² is Ph(3,4-di-Me). |
| 51M | R² is Ph(3,5-di-Me). |

Table 14 is constructed the same as Table 1, except the structure is replaced with

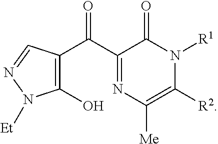

The present disclosure also includes Tables 1N through 51N, each of which is constructed the same as Table 14 above except that the row heading in Table 14 (i.e. “R² is Ph”) is replaced with the respective row headings shown below. For example, in Table 1N the row heading is “R² is Me”, and R¹ is as defined in Table 14 above. Thus, the first entry in Table 1N specifically discloses a compound of Formula 1 wherein R¹ is Me; R² is Me; R³ is Me; R⁴ is OH; A is A-5; R¹⁰ is Et; and R¹¹ is H. Tables 2N through 51N are constructed similarly.

TABLE 15

| Table | Row Heading |
|---|---|
| 1N | R² is Me. |
| 2N | R² is Et. |
| 3N | R² is n-Pr. |
| 4N | R² is cyclopropyl. |
| 5N | R² is CF_{3.} |
| 6N | R² is SO₂Me. |
| 7N | R² is Ph. |
| 8N | R² is Ph(2-Cl). |
| 9N | R² is Ph(3-Cl). |
| 10N | R² is Ph(4-Cl). |
| 11N | R² is Ph(2-Me). |
| 12N | R² is Ph(3-Me). |
| 13N | R² is Ph(4-Me). |
| 14N | R² is Ph(3-OMe). |
| 15N | R² is Ph(4-OMe). |
| 16N | R² is Ph(2-F). |
| 17N | R² is Ph(3-F). |
| 18N | R² is Ph(4-F). |
| 19N | R² is 2-pyridinyl. |
| 20N | R² is 3-pyridinyl. |
| 21N | R² is 4-pyridinyl. |
| 22N | R² is Ph(3,5-di-F). |
| 23N | R² is Ph(3,4-di-F). |
| 24N | R² is Ph(3-CF₃). |
| 25N | R² is Ph(4-CF₃). |
| 26N | R² is n-Bu. |
| 27N | R² is CH₂OCH₃. |
| 28N | R² is CH₂CH₂OCH_{3.} |
| 29N | R² is CH₂CF_{3.} |
| 30N | R² is n-pentyl. |
| 31N | R² is cyclopentyl. |
| 32N | R² is cyclohexyl. |
| 33N | R² is n-hexyl. |
| 34N | R² is Ph(3-Me-4-F). |
| 35N | R² is Ph(3-F-4-Me). |
| 36N | R² is i-Pr. |
| 37N | R² is thien-2-yl. |
| 38N | R² is thien-3-yl. |
| 39N | R² is furan-2-yl. |
| 40N | R² is furan-3-yl. |
| 41N | R² is thiazol-3-yl. |
| 42N | R² is thiazol-2-yl. |
| 43N | R² is oxazol-2-yl. |
| 44N | R² is Ph(3,4-di-OMe). |
| 45N | R² is Ph(3,5-di-OMe). |
| 46N | R² is Ph(3-OEt). |
| 47N | R² is Ph(4-OEt). |
| 48N | R² is Ph(3,4-di-OEt). |
| 49N | R² is Ph(3,5-di-OEt). |
| 50N | R² is Ph(3,4-di-Me). |
| 51N | R² is Ph(3,5-di-Me). |

Table 15 is constructed the same as Table 1, except the structure is replaced with

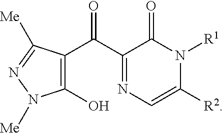

The present disclosure also includes Tables 1O through 51O, each of which is constructed the same as Table 15 above except that the row heading in Table 15 (i.e. “R² is Ph”) is replaced with the respective row headings shown below. For example, in Table 1O the row heading is “R² is Me”, and R¹ is as defined in Table 15 above. Thus, the first entry in Table 1O specifically discloses a compound of Formula 1 wherein R¹ is Me; R² is Me; R³ is H; R⁴ is OH; A is A-5; R¹⁰ is Me; and R¹¹ is Me. Tables 2O through 51O are constructed similarly.

TABLE 16

| Table | Row Heading |
|---|---|
| 1O | R² is Me. |
| 2O | R² is Et. |
| 3O | R² is n-Pr. |
| 4O | R² is cyclopropyl. |
| 5O | R² is CF_{3.} |
| 6O | R² is SO₂Me. |
| 7O | R² is Ph. |
| 8O | R² is Ph(2-Cl). |
| 9O | R² is Ph(3-Cl). |
| 10O | R² is Ph(4-Cl). |
| 11O | R² is Ph(2-Me). |
| 12O | R² is Ph(3-Me). |
| 13O | R² is Ph(4-Me). |
| 14O | R² is Ph(3-OMe). |
| 15O | R² is Ph(4-OMe). |
| 16O | R² is Ph(2-F). |
| 17O | R² is Ph(3-F). |
| 18O | R² is Ph(4-F). |
| 19O | R² is 2-pyridinyl. |
| 20O | R² is 3-pyridinyl. |
| 21O | R² is 4-pyridinyl. |
| 22O | R² is Ph(3,5-di-F). |
| 23O | R² is Ph(3,4-di-F). |
| 24O | R² is Ph(3-CF₃). |
| 25O | R² is Ph(4-CF₃). |
| 26O | R² is n-Bu. |
| 27O | R² is CH₂OCH₃. |
| 28O | R² is CH₂CH₂OCH_{3.} |
| 29O | R² is CH₂CF_{3.} |
| 30O | R² is n-pentyl. |
| 31O | R² is cyclopentyl. |
| 32O | R² is cyclohexyl. |
| 33O | R² is n-hexyl. |
| 34O | R² is Ph(3-Me-4-F). |
| 35O | R² is Ph(3-F-4-Me). |
| 36O | R² is i-Pr. |
| 37O | R² is thien-2-yl. |
| 38O | R² is thien-3-yl. |
| 39O | R² is furan-2-yl. |
| 40O | R² is furan-3-yl. |
| 41O | R² is thiazol-3-yl. |
| 42O | R² is thiazol-2-yl. |
| 43O | R² is oxazol-2-yl. |
| 44O | R² is Ph(3,4-di-OMe). |
| 45O | R² is Ph(3,5-di-OMe). |
| 46O | R² is Ph(3-OEt). |
| 47O | R² is Ph(4-OEt). |
| 48O | R² is Ph(3,4-di-OEt). |
| 49O | R² is Ph(3,5-di-OEt). |
| 50O | R² is Ph(3,4-di-Me). |
| 51O | R² is Ph(3,5-di-Me). |

Table 16 is constructed the same as Table 1, except the structure is replaced with

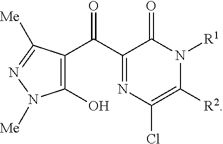

The present disclosure also includes Tables 1P through 51P, each of which is constructed the same as Table 16 above except that the row heading in Table 16 (i.e. “R² is Ph”) is replaced with the respective row headings shown below. For example, in Table 1P the row heading is “R² is Me”, and R¹ is as defined in Table 16 above. Thus, the first entry in Table 1P specifically discloses a compound of Formula 1 wherein R¹ is Me; R² is Me; R³ is Cl; R⁴ is OH; A is A-5; R¹⁰ is Me; and R¹¹ is Me. Tables 2P through 51P are constructed similarly.

TABLE 17

| Table | Row Heading |
|---|---|
| 1P | R² is Me. |
| 2P | R² is Et. |
| 3P | R² is n-Pr. |
| 4P | R² is cyclopropyl. |
| 5P | R² is CF_{3.} |
| 6P | R² is SO₂Me. |
| 7P | R² is Ph. |
| 8P | R² is Ph(2-Cl). |
| 9P | R² is Ph(3-Cl). |
| 10P | R² is Ph(4-Cl). |
| 11P | R² is Ph(2-Me). |
| 12P | R² is Ph(3-Me). |
| 13P | R² is Ph(4-Me). |
| 14P | R² is Ph(3-OMe). |
| 15P | R² is Ph(4-OMe). |
| 16P | R² is Ph(2-F). |
| 17P | R² is Ph(3-F). |
| 18P | R² is Ph(4-F). |
| 19P | R² is 2-pyridinyl. |
| 20P | R² is 3-pyridinyl. |
| 21P | R² is 4-pyridinyl. |
| 22P | R² is Ph(3,5-di-F). |
| 23P | R² is Ph(3,4-di-F). |
| 24P | R² is Ph(3-CF₃). |
| 25P | R² is Ph(4-CF₃). |
| 26P | R² is n-Bu. |
| 27P | R² is CH₂OCH₃. |
| 28P | R² is CH₂CH₂OCH_{3.} |
| 29P | R² is CH₂CF_{3.} |
| 30P | R² is n-pentyl. |
| 31P | R² is cyclopentyl. |
| 32P | R² is cyclohexyl. |
| 33P | R² is n-hexyl. |
| 34P | R² is Ph(3-Me-4-F). |
| 35P | R² is Ph(3-F-4-Me). |
| 36P | R² is i-Pr. |
| 37P | R² is thien-2-yl. |
| 38P | R² is thien-3-yl. |
| 39P | R² is furan-2-yl. |
| 40P | R² is furan-3-yl. |
| 41P | R² is thiazol-3-yl. |
| 42P | R² is thiazol-2-yl. |
| 43P | R² is oxazol-2-yl. |
| 44P | R² is Ph(3,4-di-OMe). |
| 45P | R² is Ph(3,5-di-OMe). |
| 46P | R² is Ph(3-OEt). |
| 47P | R² is Ph(4-OEt). |
| 48P | R² is Ph(3,4-di-OEt). |
| 49P | R² is Ph(3,5-di-OEt). |
| 50P | R² is Ph(3,4-di-Me). |
| 51P | R² is Ph(3,5-di-Me). |

Table 17 is constructed the same as Table 1, except the structure is replaced with

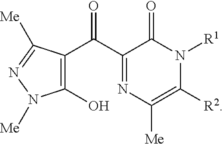

The present disclosure also includes Tables 1Q through 51Q, each of which is constructed the same as Table 17 above except that the row heading in Table 17 (i.e. “R² is Ph”) is replaced with the respective row headings shown below. For example, in Table 1Q the row heading is “R² is Me”, and R¹ is as defined in Table 17 above. Thus, the first entry in Table 1Q specifically discloses a compound of Formula 1 wherein R¹ is Me; R² is Me; R³ is Me; R⁴ is OH; A is A-5; R¹⁰ is Me; and R¹¹ is Me. Tables 2Q through 51Q are constructed similarly.

TABLE 18

| Table | Row Heading |
|---|---|
| 1Q | R² is Me. |
| 2Q | R² is Et. |
| 3Q | R² is n-Pr. |
| 4Q | R² is cyclopropyl. |
| 5Q | R² is CF_{3.} |
| 6Q | R² is SO₂Me. |
| 7Q | R² is Ph. |
| 8Q | R² is Ph(2-Cl). |
| 9Q | R² is Ph(3-Cl). |
| 10Q | R² is Ph(4-Cl). |
| 11Q | R² is Ph(2-Me). |
| 12Q | R² is Ph(3-Me). |
| 13Q | R² is Ph(4-Me). |
| 14Q | R² is Ph(3-OMe). |
| 15Q | R² is Ph(4-OMe). |
| 16Q | R² is Ph(2-F). |
| 17Q | R² is Ph(3-F). |
| 18Q | R² is Ph(4-F). |
| 19Q | R² is 2-pyridinyl. |
| 20Q | R² is 3-pyridinyl. |
| 21Q | R² is 4-pyridinyl. |
| 22Q | R² is Ph(3,5-di-F). |
| 23Q | R² is Ph(3,4-di-F). |
| 24Q | R² is Ph(3-CF₃). |
| 25Q | R² is Ph(4-CF₃). |
| 26Q | R² is n-Bu. |
| 27Q | R² is CH₂OCH₃. |
| 28Q | R² is CH₂CH₂OCH_{3.} |
| 29Q | R² is CH₂CF_{3.} |
| 30Q | R² is n-pentyl. |
| 31Q | R² is cyclopentyl. |
| 32Q | R² is cyclohexyl. |
| 33Q | R² is n-hexyl. |
| 34Q | R² is Ph(3-Me-4-F). |
| 35Q | R² is Ph(3-F-4-Me). |
| 36Q | R² is i-Pr. |
| 37Q | R² is thien-2-yl. |
| 38Q | R² is thien-3-yl. |
| 39Q | R² is furan-2-yl. |
| 40Q | R² is furan-3-yl. |
| 41Q | R² is thiazol-3-yl. |
| 42Q | R² is thiazol-2-yl. |
| 43Q | R² is oxazol-2-yl. |
| 44Q | R² is Ph(3,4-di-OMe). |
| 45Q | R² is Ph(3,5-di-OMe). |
| 46Q | R² is Ph(3-OEt). |
| 47Q | R² is Ph(4-OEt). |
| 48Q | R² is Ph(3,4-di-OEt). |
| 49Q | R² is Ph(3,5-di-OEt). |
| 50Q | R² is Ph(3,4-di-Me). |
| 51Q | R² is Ph(3,5-di-Me). |

Table 18 is constructed the same as Table 1, except the structure is replaced with

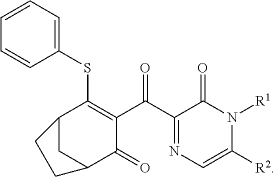

The present disclosure also includes Tables 1R through 51R, each of which is constructed the same as Table 18 above except that the row heading in Table 18 (i.e. “R² is Ph”) is replaced with the respective row headings shown below. For example, in Table 1R the row heading is “R² is Me”, and R¹ is as defined in Table 18 above. Thus, the first entry in Table 1R specifically discloses a compound of Formula 1 wherein R¹ is Me; R² is Me; R³ is H; R⁴ is SPh; A is A-4; B² is C-3; T is —CH₂CH₂—; and R¹⁸ and R¹⁹ are each H. Tables 2R through 51R are constructed similarly.

TABLE 19

| Table | Row Heading |
|---|---|
| 1R | R² is Me. |
| 2R | R² is Et. |
| 3R | R² is n-Pr. |
| 4R | R² is cyclopropyl. |
| 5R | R² is CF_{3.} |
| 6R | R² is SO₂Me. |
| 7R | R² is Ph. |
| 8R | R² is Ph(2-Cl). |
| 9R | R² is Ph(3-Cl). |
| 10R | R² is Ph(4-Cl). |
| 11R | R² is Ph(2-Me). |
| 12R | R² is Ph(3-Me). |
| 13R | R² is Ph(4-Me). |
| 14R | R² is Ph(3-OMe). |
| 15R | R² is Ph(4-OMe). |
| 16R | R² is Ph(2-F). |
| 17R | R² is Ph(3-F). |
| 18R | R² is Ph(4-F). |
| 19R | R² is 2-pyridinyl. |
| 20R | R² is 3-pyridinyl. |
| 21R | R² is 4-pyridinyl. |
| 22R | R² is Ph(3,5-di-F). |
| 23R | R² is Ph(3,4-di-F). |
| 24R | R² is Ph(3-CF₃). |
| 25R | R² is Ph(4-CF₃). |
| 26R | R² is n-Bu. |
| 27R | R² is CH₂OCH₃. |
| 28R | R² is CH₂CH₂OCH_{3.} |
| 29R | R² is CH₂CF_{3.} |
| 30R | R² is n-pentyl. |
| 31R | R² is cyclopentyl. |
| 32R | R² is cyclohexyl. |
| 33R | R² is n-hexyl. |
| 34R | R² is Ph(3-Me-4-F). |
| 35R | R² is Ph(3-F-4-Me). |
| 36R | R² is i-Pr. |
| 37R | R² is thien-2-yl. |
| 38R | R² is thien-3-yl. |
| 39R | R² is furan-2-yl. |
| 40R | R² is furan-3-yl. |
| 41R | R² is thiazol-3-yl. |
| 42R | R² is thiazol-2-yl. |
| 43R | R² is oxazol-2-yl. |
| 44R | R² is Ph(3,4-di-OMe). |
| 45R | R² is Ph(3,5-di-OMe). |
| 46R | R² is Ph(3-OEt). |
| 47R | R² is Ph(4-OEt). |
| 48R | R² is Ph(3,4-di-OEt). |
| 49R | R² is Ph(3,5-di-OEt). |
| 50R | R² is Ph(3,4-di-Me). |
| 51R | R² is Ph(3,5-di-Me). |

Table 19 is constructed the same as Table 1, except the structure is replaced with

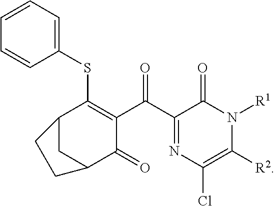

The present disclosure also includes Tables 1S through 51S, each of which is constructed the same as Table 19 above except that the row heading in Table 19 (i.e. “R² is Ph”) is replaced with the respective row headings shown below. For example, in Table 15 the row heading is “R² is Me”, and R¹ is as defined in Table 19 above. Thus, the first entry in Table 1S specifically discloses a compound of Formula 1 wherein R¹ is Me; R² is Me; R³ is Cl; R⁴ is SPh; A is A-4; B² is C-3; T is —CH₂CH₂—; and R¹⁸ and R¹⁹ are each H. Tables 2S through 51S are constructed similarly.

TABLE 20

| Table | Row Heading |
|---|---|
| 1S | R² is Me. |
| 2S | R² is Et. |
| 3S | R² is n-Pr. |
| 4S | R² is cyclopropyl. |
| 5S | R² is CF_{3.} |
| 6S | R² is SO₂Me. |
| 7S | R² is Ph. |
| 8S | R² is Ph(2-Cl). |
| 9S | R² is Ph(3-Cl). |
| 10S | R² is Ph(4-Cl). |
| 11S | R² is Ph(2-Me). |
| 12S | R² is Ph(3-Me). |
| 13S | R² is Ph(4-Me). |
| 14S | R² is Ph(3-OMe). |
| 15S | R² is Ph(4-OMe). |
| 16S | R² is Ph(2-F). |
| 17S | R² is Ph(3-F). |
| 18S | R² is Ph(4-F). |
| 19S | R² is 2-pyridinyl. |
| 20S | R² is 3-pyridinyl. |
| 21S | R² is 4-pyridinyl. |
| 22S | R² is Ph(3,5-di-F). |
| 23S | R² is Ph(3,4-di-F). |
| 24S | R² is Ph(3-CF₃). |
| 25S | R² is Ph(4-CF₃). |
| 26S | R² is n-Bu. |
| 27S | R² is CH₂OCH₃. |
| 28S | R² is CH₂CH₂OCH_{3.} |
| 29S | R² is CH₂CF_{3.} |
| 30S | R² is n-pentyl. |
| 31S | R² is cyclopentyl. |
| 32S | R² is cyclohexyl. |
| 33S | R² is n-hexyl. |
| 34S | R² is Ph(3-Me-4-F). |
| 35S | R² is Ph(3-F-4-Me). |
| 36S | R² is i-Pr. |
| 37S | R² is thien-2-yl. |
| 38S | R² is thien-3-yl. |
| 39S | R² is furan-2-yl. |
| 40S | R² is furan-3-yl. |
| 41S | R² is thiazol-3-yl. |
| 42S | R² is thiazol-2-yl. |
| 43S | R² is oxazol-2-yl. |
| 44S | R² is Ph(3,4-di-OMe). |
| 45S | R² is Ph(3,5-di-OMe). |
| 46S | R² is Ph(3-OEt). |
| 47S | R² is Ph(4-OEt). |
| 48S | R² is Ph(3,4-di-OEt). |
| 49S | R² is Ph(3,5-di-OEt). |
| 50S | R² is Ph(3,4-di-Me). |
| 51S | R² is Ph(3,5-di-Me). |

Table 20 is constructed the same as Table 1 except the structure is replaced with

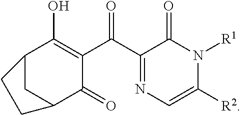

The present disclosure also includes Tables 1T through 51T, each of which is constructed the same as Table 20 above except that the row heading in Table 20 (i.e. “R² is Ph”) is replaced with the respective row headings shown below. For example, in Table 1T the row heading is “R² is Me”, and R¹ is as defined in Table 20 above. Thus, the first entry in Table 1T specifically discloses a compound of Formula 1 wherein R¹ is Me; R² is Me; R³ is H; R⁴ is OH; A is A-4; B² is C-3; T is —CH₂CH₂—; and R¹⁸ and R¹⁹ are each H. Tables 2T through 51T are constructed similarly.

TABLE 21

| Table | Row Heading |
|---|---|
| 1T | R² is Me. |
| 2T | R² is Et. |
| 3T | R² is n-Pr. |
| 4T | R² is cyclopropyl. |
| 5T | R² is CF_{3.} |
| 6T | R² is SO₂Me. |
| 7T | R² is Ph. |
| 8T | R² is Ph(2-Cl). |
| 9T | R² is Ph(3-Cl). |
| 10T | R² is Ph(4-Cl). |
| 11T | R² is Ph(2-Me). |
| 12T | R² is Ph(3-Me). |
| 13T | R² is Ph(4-Me). |
| 14T | R² is Ph(3-OMe). |
| 15T | R² is Ph(4-OMe). |
| 16T | R² is Ph(2-F). |
| 17T | R² is Ph(3-F). |
| 18T | R² is Ph(4-F). |
| 19T | R² is 2-pyridinyl. |
| 20T | R² is 3-pyridinyl. |
| 21T | R² is 4-pyridinyl. |
| 22T | R² is Ph(3,5-di-F). |
| 23T | R² is Ph(3,4-di-F). |
| 24T | R² is Ph(3-CF₃). |
| 25T | R² is Ph(4-CF₃). |
| 26T | R² is n-Bu. |
| 27T | R² is CH₂OCH₃. |
| 28T | R² is CH₂CH₂OCH_{3.} |
| 29T | R² is CH₂CF_{3.} |
| 30T | R² is n-pentyl. |
| 31T | R² is cyclopentyl. |
| 32T | R² is cyclohexyl. |
| 33T | R² is n-hexyl. |
| 34T | R² is Ph(3-Me-4-F). |
| 35T | R² is Ph(3-F-4-Me). |
| 36T | R² is i-Pr. |
| 37T | R² is thien-2-yl. |
| 38T | R² is thien-3-yl. |
| 39T | R² is furan-2-yl. |
| 40T | R² is furan-3-yl. |
| 41T | R² is thiazol-3-yl. |
| 42T | R² is thiazol-2-yl. |
| 43T | R² is oxazol-2-yl. |
| 44T | R² is Ph(3,4-di-OMe). |
| 45T | R² is Ph(3,5-di-OMe). |
| 46T | R² is Ph(3-OEt). |
| 47T | R² is Ph(4-OEt). |
| 48T | R² is Ph(3,4-di-OEt). |
| 49T | R² is Ph(3,5-di-OEt). |
| 50T | R² is Ph(3,4-di-Me). |
| 51T | R² is Ph(3,5-di-Me). |

Table 21 is constructed the same as Table 1 except the structure is replaced with

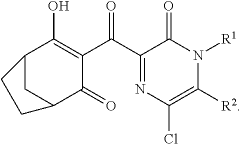

The present disclosure also includes Tables 1U through 51U, each of which is constructed the same as Table 21 above except that the row heading in Table 21 (i.e. “R² is Ph”) is replaced with the respective row headings shown below. For example, in Table 1U the row heading is “R² is Me”, and R¹ is as defined in Table 21 above. Thus, the first entry in Table 1U specifically discloses a compound of Formula 1 wherein R¹ is Me; R² is Me; R³ is Cl; R⁴ is OH; A is A-4; B² is C-3; T is —CH₂CH₂—; and R¹⁸ and R¹⁹ are each H. Tables 2U through 51U are constructed similarly.

TABLE 22

| Table | Row Heading |
|---|---|
| 1U | R² is Me. |
| 2U | R² is Et. |
| 3U | R² is n-Pr. |
| 4U | R² is cyclopropyl. |
| 5U | R² is CF_{3.} |
| 6U | R² is SO₂Me. |
| 7U | R² is Ph. |
| 8U | R² is Ph(2-Cl). |
| 9U | R² is Ph(3-Cl). |
| 10U | R² is Ph(4-Cl). |
| 11U | R² is Ph(2-Me). |
| 12U | R² is Ph(3-Me). |
| 13U | R² is Ph(4-Me). |
| 14U | R² is Ph(3-OMe). |
| 15U | R² is Ph(4-OMe). |
| 16U | R² is Ph(2-F). |
| 17U | R² is Ph(3-F). |
| 18U | R² is Ph(4-F). |
| 19U | R² is 2-pyridinyl. |
| 20U | R² is 3-pyridinyl. |
| 21U | R² is 4-pyridinyl. |
| 22U | R² is Ph(3,5-di-F). |
| 23U | R² is Ph(3,4-di-F). |
| 24U | R² is Ph(3-CF₃). |
| 25U | R² is Ph(4-CF₃). |
| 26U | R² is n-Bu. |
| 27U | R² is CH₂OCH₃. |
| 28U | R² is CH₂CH₂OCH_{3.} |
| 29U | R² is CH₂CF_{3.} |
| 30U | R² is n-pentyl. |
| 31U | R² is cyclopentyl. |
| 32U | R² is cyclohexyl. |
| 33U | R² is n-hexyl. |
| 34U | R² is Ph(3-Me-4-F). |
| 35U | R² is Ph(3-F-4-Me). |
| 36U | R² is i-Pr. |
| 37U | R² is thien-2-yl. |
| 38U | R² is thien-3-yl. |
| 39U | R² is furan-2-yl. |
| 40U | R² is furan-3-yl. |
| 41U | R² is thiazol-3-yl. |
| 42U | R² is thiazol-2-yl. |
| 43U | R² is oxazol-2-yl. |
| 44U | R² is Ph(3,4-di-OMe). |
| 45U | R² is Ph(3,5-di-OMe). |
| 46U | R² is Ph(3-OEt). |
| 47U | R² is Ph(4-OEt). |
| 48U | R² is Ph(3,4-di-OEt). |
| 49U | R² is Ph(3,5-di-OEt). |
| 50U | R² is Ph(3,4-di-Me). |
| 51U | R² is Ph(3,5-di-Me). |

Table 22 is constructed the same as Table 1 except the structure is replaced with

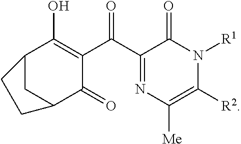

The present disclosure also includes Tables 1V through 51V, each of which is constructed the same as Table 22 above except that the row heading in Table 22 (i.e. “R² is Ph”) is replaced with the respective row headings shown below. For example, in Table 1V the row heading is “R² is Me”, and R¹ is as defined in Table 22 above. Thus, the first entry in Table 1V specifically discloses a compound of Formula 1 wherein R¹ is Me; R² is Me; R³ is Me; R⁴ is OH; A is A-4; B² is C-3; T is —CH₂CH₂—; and R¹⁸ and R¹⁹ are each H. Tables 2V through 51V are constructed similarly.

TABLE 23

| Table | Row Heading |
|---|---|
| 1V | R² is Me. |
| 2V | R² is Et. |
| 3V | R² is n-Pr. |
| 4V | R² is cyclopropyl. |
| 5V | R² is CF_{3.} |
| 6V | R² is SO₂Me. |
| 7V | R² is Ph. |
| 8V | R² is Ph(2-Cl). |
| 9V | R² is Ph(3-Cl). |
| 10V | R² is Ph(4-Cl). |
| 11V | R² is Ph(2-Me). |
| 12V | R² is Ph(3-Me). |
| 13V | R² is Ph(4-Me). |
| 14V | R² is Ph(3-OMe). |
| 15V | R² is Ph(4-OMe). |
| 16V | R² is Ph(2-F). |
| 17V | R² is Ph(3-F). |
| 18V | R² is Ph(4-F). |
| 19V | R² is 2-pyridinyl. |
| 20V | R² is 3-pyridinyl. |
| 21V | R² is 4-pyridinyl. |
| 22V | R² is Ph(3,5-di-F). |
| 23V | R² is Ph(3,4-di-F). |
| 24V | R² is Ph(3-CF₃). |
| 25V | R² is Ph(4-CF₃). |
| 26V | R² is n-Bu. |
| 27V | R² is CH₂OCH₃. |
| 28V | R² is CH₂CH₂OCH_{3.} |
| 29V | R² is CH₂CF_{3.} |
| 30V | R² is n-pentyl. |
| 31V | R² is cyclopentyl. |
| 32V | R² is cyclohexyl. |
| 33V | R² is w-hexyl. |
| 34V | R² is Ph(3-Me-4-F). |
| 35V | R² is Ph(3-F-4-Me). |
| 36V | R² is i-Pr. |
| 37V | R² is thien-2-yl. |
| 38V | R² is thien-3-yl. |
| 39V | R² is furan-2-yl. |
| 40V | R² is furan-3-yl. |
| 41V | R² is thiazol-3-yl. |
| 42V | R² is thiazol-2-yl. |
| 43V | R² is oxazol-2-yl. |
| 44V | R² is Ph(3,4-di-OMe). |
| 45V | R² is Ph(3,5-di-OMe). |
| 46V | R² is Ph(3-OEt). |
| 47V | R² is Ph(4-OEt). |
| 48V | R² is Ph(3,4-di-OEt). |
| 49V | R² is Ph(3,5-di-OEt). |
| 50V | R² is Ph(3,4-di-Me). |
| 51V | R² is Ph(3,5-di-Me). |

Table 23 is constructed the same as Table 1 except the structure is replaced with

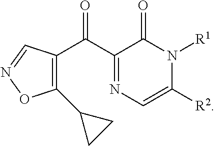

The present disclosure also includes Tables 1W through 51W, each of which is constructed the same as Table 23 above except that the row heading in Table 23 (i.e. “R² is Ph”) is replaced with the respective row headings shown below. For example, in Table 1W the row heading is “R² is Me”, and R¹ is as defined in Table 23 above. Thus, the first entry in Table 1W specifically discloses a compound of Formula 1 wherein R¹ is Me; R² is Me; R³ is H; A is A-6; R¹² is H; and R¹³ is cyclopropyl. Tables 2W through 51W are constructed similarly.

TABLE 24

| Table | Row Heading |
|---|---|
| 1W | R² is Me. |
| 2W | R² is Et. |
| 3W | R² is n-Pr. |
| 4W | R² is cyclopropyl. |
| 5W | R² is CF_{3.} |
| 6W | R² is SO₂Me. |
| 7W | R² is Ph. |
| 8W | R² is Ph(2-Cl). |
| 9W | R² is Ph(3-Cl). |
| 10W | R² is Ph(4-Cl). |
| 11W | R² is Ph(2-Me). |
| 12W | R² is Ph(3-Me). |
| 13W | R² is Ph(4-Me). |
| 14W | R² is Ph(3-OMe). |
| 15W | R² is Ph(4-OMe). |
| 16W | R² is Ph(2-F). |
| 17W | R² is Ph(3-F). |
| 18W | R² is Ph(4-F). |
| 19W | R² is 2-pyridinyl. |
| 20W | R² is 3-pyridinyl. |
| 21W | R² is 4-pyridinyl. |
| 22W | R² is Ph(3,5-di-F). |
| 23W | R² is Ph(3,4-di-F). |
| 24W | R² is Ph(3-CF₃). |
| 25W | R² is Ph(4-CF₃). |
| 26W | R² is n-Bu. |
| 27W | R² is CH₂OCH₃. |
| 28W | R² is CH₂CH₂OCH_{3.} |
| 29W | R² is CH₂CF_{3.} |
| 30W | R² is n-pentyl. |
| 31W | R² is cyclopentyl. |
| 32W | R² is cyclohexyl. |
| 33W | R² is n-hexyl. |
| 34W | R² is Ph(3-Me-4-F). |
| 35W | R² is Ph(3-F-4-Me). |
| 36W | R² is i-Pr. |
| 37W | R² is thien-2-yl. |
| 38W | R² is thien-3-yl. |
| 39W | R² is furan-2-yl. |
| 40W | R² is furan-3-yl. |
| 41W | R² is thiazol-3-yl. |
| 42W | R² is thiazol-2-yl. |
| 43W | R² is oxazol-2-yl. |
| 44W | R² is Ph(3,4-di-OMe). |
| 45W | R² is Ph(3,5-di-OMe). |
| 46W | R² is Ph(3-OEt). |
| 47W | R² is Ph(4-OEt). |
| 48W | R² is Ph(3,4-di-OEt). |
| 49W | R² is Ph(3,5-di-OEt). |
| 50W | R² is Ph(3,4-di-Me). |
| 51W | R² is Ph(3,5-di-Me). |

Table 24 is constructed the same as Table 1 except the structure is replaced with

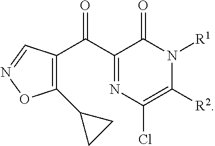

The present disclosure also includes Tables 1X through 51X, each of which is constructed the same as Table 24 above except that the row heading in Table 24 (i.e. “R² is Ph”) is replaced with the respective row headings shown below. For example, in Table 1X the row heading is “R² is Me”, and R¹ is as defined in Table 24 above. Thus, the first entry in Table 1X specifically discloses a compound of Formula 1 wherein R¹ is Me; R² is Me; R³ is Cl; A is A-6; R¹² is H; and R¹³ is cyclopropyl. Tables 2X through 51X are constructed similarly.

TABLE 25

| Table | Row Heading |
|---|---|
| 1X | R² is Me. |
| 2X | R² is Et. |
| 3X | R² is n-Pr. |
| 4X | R² is cyclopropyl. |
| 5X | R² is CF₃ |
| 6X | R² is SO₂Me. |
| 7X | R² is Ph. |
| 8X | R² is Ph(2-Cl). |
| 9X | R² is Ph(3-Cl). |
| 10X | R² is Ph(4-Cl). |
| 11X | R² is Ph(2-Me). |
| 12X | R² is Ph(3-Me). |
| 13X | R² is Ph(4-Me). |
| 14X | R² is Ph(3-OMe). |
| 15X | R² is Ph(4-OMe). |
| 16X | R² is Ph(2-F). |
| 17X | R² is Ph(3-F). |
| 18X | R² is Ph(4-F). |
| 19X | R² is 2-pyridinyl. |
| 20X | R² is 3-pyridinyl. |
| 21X | R² is 4-pyridinyl. |
| 22X | R² is Ph(3,5-di-F). |
| 23X | R² is Ph(3,4-di-F). |
| 24X | R² is Ph(3-CF₃). |
| 25X | R² is Ph(4-CF₃). |
| 26X | R² is n-Bu. |
| 27X | R² is CH₂OCH₃. |
| 28X | R² is CH₂CH₂OCH₃ |
| 29X | R² is CH₂CF₃ |
| 30X | R² is n-pentyl. |
| 31X | R² is cyclopentyl. |
| 32X | R² is cyclohexyl. |
| 33X | R² is n-hexyl. |
| 34X | R² is Ph(3-Me-4-F). |
| 35X | R² is Ph(3-F-4-Me). |
| 36X | R² is i-Pr. |
| 37X | R² is thien-2-yl. |
| 38X | R² is thien-3-yl. |
| 39X | R² is furan-2-yl. |
| 40X | R² is furan-3-yl. |
| 41X | R² is thiazol-3-yl. |
| 42X | R² is thiazol-2-yl. |
| 43X | R² is oxazol-2-yl. |
| 44X | R² is Ph(3,4-di-OMe). |
| 45X | R² is Ph(3,5-di-OMe). |
| 46X | R² is Ph(3-OEt). |
| 47X | R² is Ph(4-OEt). |
| 48X | R² is Ph(3,4-di-OEt). |
| 49X | R² is Ph(3,5-di-OEt). |
| 50X | R² is Ph(3,4-di-Me). |
| 51X | R² is Ph(3,5-di-Me). |

Table 25 is constructed the same as Table 1 except the structure is replaced with

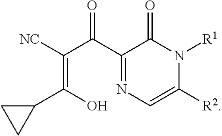

The present disclosure also includes Tables 1Y through 51Y, each of which is constructed the same as Table 25 above except that the row heading in Table 25 (i.e. “R² is Ph”) is replaced with the respective row headings shown below. For example, in Table 1Y the row heading is “R² is Me”, and R¹ is as defined in Table 25 above. Thus, the first entry in Table 1Y specifically discloses a compound of Formula 1 wherein R¹ is Me; R² is Me; R³ is H; A is A-7; R¹³ is cyclopropyl; and R¹⁴ is cyano. Tables 2Y through 51Y are constructed similarly.

TABLE 26

| Table | Row Heading |
|---|---|
| 1Y | R² is Me. |
| 2Y | R² is Et. |
| 3Y | R² is n-Pr. |
| 4Y | R² is cyclopropyl. |
| 5Y | R² is CF_{3.} |
| 6Y | R² is SO₂Me. |
| 7Y | R² is Ph. |
| 8Y | R² is Ph(2-Cl). |
| 9Y | R² is Ph(3-Cl). |
| 10Y | R² is Ph(4-Cl). |
| 11Y | R² is Ph(2-Me). |
| 12Y | R² is Ph(3-Me). |
| 13Y | R² is Ph(4-Me). |
| 14Y | R² is Ph(3-OMe). |
| 15Y | R² is Ph(4-OMe). |
| 16Y | R² is Ph(2-F). |
| 17Y | R² is Ph(3-F). |
| 18Y | R² is Ph(4-F). |
| 19Y | R² is 2-pyridinyl. |
| 20Y | R² is 3-pyridinyl. |
| 21Y | R² is 4-pyridinyl. |
| 22Y | R² is Ph(3,5-di-F). |
| 23Y | R² is Ph(3,4-di-F). |
| 24Y | R² is Ph(3-CF₃). |
| 25Y | R² is Ph(4-CF₃). |
| 26Y | R² is n-Bu. |
| 27Y | R² is CH₂OCH₃. |
| 28Y | R² is CH₂CH₂OCH_{3.} |
| 29Y | R² is CH₂CF_{3.} |
| 30Y | R² is n-pentyl. |
| 31Y | R² is cyclopentyl. |
| 32Y | R² is cyclohexyl. |
| 33Y | R² is n-hexyl. |
| 34Y | R² is Ph(3-Me-4-F). |
| 35Y | R² is Ph(3-F-4-Me). |
| 36Y | R² is i-Pr. |
| 37Y | R² is thien-2-yl. |
| 38Y | R² is thien-3-yl. |
| 39Y | R² is furan-2-yl. |
| 40Y | R² is furan-3-yl. |
| 41Y | R² is thiazol-3-yl. |
| 42Y | R² is thiazol-2-yl. |
| 43Y | R² is oxazol-2-yl. |
| 44Y | R² is Ph(3,4-di-OMe). |
| 45Y | R² is Ph(3,5-di-OMe). |
| 46Y | R² is Ph(3-OEt). |
| 47Y | R² is Ph(4-OEt). |
| 48Y | R² is Ph(3,4-di-OEt). |
| 49Y | R² is Ph(3,5-di-OEt). |
| 50Y | R² is Ph(3,4-di-Me). |
| 51Y | R² is Ph(3,5-di-Me). |

Table 26 is the same as Table 1 except the structure is replaced with

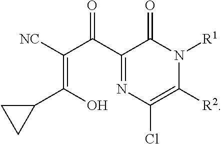

The present disclosure also includes Tables 1Z through 51Z, each of which is constructed the same as Table 26 above except that the row heading in Table 26 (i.e. “R² is Ph”) is replaced with the respective row headings shown below. For example, in Table 1Z the row heading is “R² is Me”, and R¹ is as defined in Table 26 above. Thus, the first entry in Table 1Z specifically discloses a compound of Formula 1 wherein R¹ is Me; R² is Me; R³ is Cl; A is A-7; R¹³ is cyclopropyl; and R¹⁴ is cyano. Tables 2Z through 51Z are constructed similarly.

TABLE 27

| Table | Row Heading |
|---|---|
| 1Z | R² is Me. |
| 2Z | R² is Et. |
| 3Z | R² is n-Pr. |
| 4Z | R² is cyclopropyl. |
| 5Z | R² is CF₃ |
| 6Z | R² is SO₂Me. |
| 7Z | R² is Ph. |
| 8Z | R² is Ph(2-Cl). |
| 9Z | R² is Ph(3-Cl). |
| 10Z | R² is Ph(4-Cl). |
| 11Z | R² is Ph(2-Me). |
| 12Z | R² is Ph(3-Me). |
| 13Z | R² is Ph(4-Me). |
| 14Z | R² is Ph(3-OMe). |
| 15Z | R² is Ph(4-OMe). |
| 16Z | R² is Ph(2-F). |
| 17Z | R² is Ph(3-F). |
| 18Z | R² is Ph(4-F). |
| 19Z | R² is 2-pyridinyl. |
| 20Z | R² is 3-pyridinyl. |
| 21Z | R² is 4-pyridinyl. |
| 22Z | R² is Ph(3,5-di-F). |
| 23Z | R² is Ph(3,4-di-F). |
| 24Z | R² is Ph(3-CF₃). |
| 25Z | R² is Ph(4-CF₃). |
| 26Z | R² is n-Bu. |
| 27Z | R² is CH₂OCH₃. |
| 28Z | R² is CH₂CH₂OCH_{3.} |
| 29Z | R² is CH₂CF_{3.} |
| 30Z | R² is n-pentyl. |
| 31Z | R² is cyclopentyl. |
| 32Z | R² is cyclohexyl. |
| 33Z | R² is n-hexyl. |
| 34Z | R² is Ph(3-Me-4-F). |
| 35Z | R² is Ph(3-F-4-Me). |
| 36Z | R² is i-Pr. |
| 37Z | R² is thien-2-yl. |
| 38Z | R² is thien-3-yl. |
| 39Z | R² is furan-2-yl. |
| 40Z | R² is furan-3-yl. |
| 41Z | R² is thiazol-3-yl. |
| 42Z | R² is thiazol-2-yl. |
| 43Z | R² is oxazol-2-yl. |
| 44Z | R² is Ph(3,4-di-OMe). |
| 45Z | R² is Ph(3,5-di-OMe). |
| 46Z | R² is Ph(3-OEt). |
| 47Z | R² is Ph(4-OEt). |
| 48Z | R² is Ph(3,4-di-OEt). |
| 49Z | R² is Ph(3,5-di-OEt). |
| 50Z | R² is Ph(3,4-di-Me). |
| 51Z | R² is Ph(3,5-di-Me). |

As described above (e.g., methods of Schemes 1a, 1b, 1c, 1d, 2, 3, 5, 6, 7, 8, 9, 10, 11) compounds of Formulae 2, 3 and 4 are useful intermediates for preparing compounds of Formula 1. Therefore this invention also relates to a compound selected from novel compounds of Formula 2 (including all stereoisomers), or an N-oxide or salt thereof:

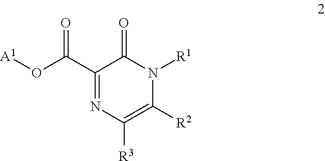

wherein A¹ is a radical selected from the group consisting of

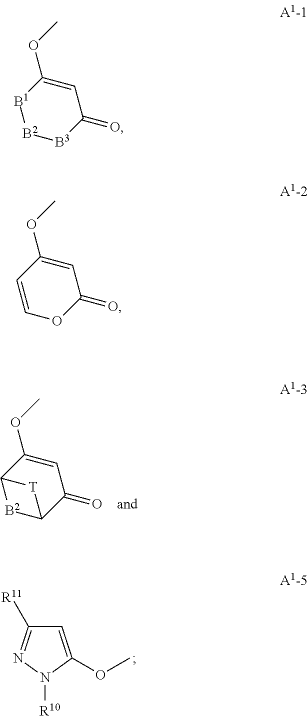

and R¹, R², R³, B¹, B², B³, T, R¹⁰ and R¹¹ are as defined above for a compound of Formula 1. Also, this invention relates to a compound selected from novel compounds of Formula 3 (including all stereoisomers), or an N-oxide or salt thereof:

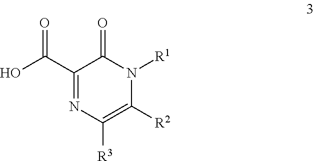

wherein R¹, R² and R³ are as defined above for a compound of Formula 1. Furthermore this invention relates a compound selected from novel compounds of Formula 4 (including all stereoisomers), or an N-oxide or salt thereof:

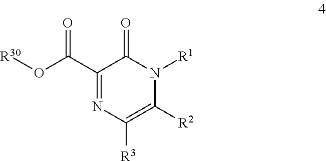

wherein R¹, R² and R³ are as defined above for a compound of Formula 1, and R³⁰ is C₁-C₆ alkyl. Of note is a particular compound of Formula 2, 3 or 4 useful for preparing a particular compound disclosed in Tables 1 through 51Z by one of the aforedescribed methods.

### Formulation/Utility

A compound of Formula 1 of this invention (including N-oxides and salts thereof) will generally be used as a herbicidal active ingredient in a composition, i.e. formulation, with at least one additional component selected from the group consisting of surfactants, solid diluents and liquid diluents, which serve as a carrier. The formulation or composition ingredients are selected to be consistent with the physical properties of the active ingredient, mode of application and environmental factors such as soil type, moisture and temperature.

Useful formulations include both liquid and solid compositions. Liquid compositions include solutions (including emulsifiable concentrates), suspensions, emulsions (including microemulsions and/or suspoemulsions) and the like, which optionally can be thickened into gels. The general types of aqueous liquid compositions are soluble concentrate, suspension concentrate, capsule suspension, concentrated emulsion, microemulsion and suspo-emulsion. The general types of nonaqueous liquid compositions are emulsifiable concentrate, microemulsifiable concentrate, dispersible concentrate and oil dispersion.

The general types of solid compositions are dusts, powders, granules, pellets, prills, pastilles, tablets, filled films (including seed coatings) and the like, which can be water-dispersible (“wettable”) or water-soluble. Films and coatings formed from film-forming solutions or flowable suspensions are particularly useful for seed treatment. Active ingredient can be (micro)encapsulated and further formed into a suspension or solid formulation; alternatively the entire formulation of active ingredient can be encapsulated (or “overcoated”). Encapsulation can control or delay release of the active ingredient. An emulsifiable granule combines the advantages of both an emulsifiable concentrate formulation and a dry granular formulation. High-strength compositions are primarily used as intermediates for further formulation.

Sprayable formulations are typically extended in a suitable medium before spraying. Such liquid and solid formulations are formulated to be readily diluted in the spray medium, usually water. Spray volumes can range from about from about one to several thousand liters per hectare, but more typically are in the range from about ten to several hundred liters per hectare. Sprayable formulations can be tank mixed with water or another suitable medium for foliar treatment by aerial or ground application, or for application to the growing medium of the plant. Liquid and dry formulations can be metered directly into drip irrigation systems or metered into the furrow during planting.

The formulations will typically contain effective amounts of active ingredient, diluent and surfactant within the following approximate ranges which add up to 100 percent by weight.

| | Weight Percent | | |
|---|---|---|---|
| | Active | | |
| | Ingredient | Diluent | Surfactant |
| Water-Dispersible and Water- | 0.001-90 | 0-99.999 | 0-15 |
| soluble Granules, Tablets and | | | |
| Powders | | | |
| Oil Dispersions, Suspensions, | 1-50 | 40-99 | 0-50 |
| Emulsions, Solutions | | | |
| (including Emulsifiable | | | |
| Concentrates) | | | |
| Dusts | 1-25 | 70-99 | 0-5 |
| Granules and Pellets | 0.001-99 | 5-99.999 | 0-15 |
| High Strength Compositions | 90-99 | 0-10 | 0-2 |

Solid diluents include, for example, clays such as bentonite, montmorillonite, attapulgite and kaolin, gypsum, cellulose, titanium dioxide, zinc oxide, starch, dextrin, sugars (e.g., lactose, sucrose), silica, talc, mica, diatomaceous earth, urea, calcium carbonate, sodium carbonate and bicarbonate, and sodium sulfate. Typical solid diluents are described in Watkins et al., Handbook of Insecticide Dust Diluents and Carriers, 2nd Ed., Dorland Books, Caldwell, N.J.

Liquid diluents include, for example, water, N,N-dimethylalkanamides (e.g., N,N-dimethylformamide), limonene, dimethyl sulfoxide, N-alkylpyrrolidones (e.g., N-methylpyrrolidinone), ethylene glycol, triethylene glycol, propylene glycol, dipropylene glycol, polypropylene glycol, propylene carbonate, butylene carbonate, paraffins (e.g., white mineral oils, normal paraffins, isoparaffins), alkylbenzenes, alkylnaphthalenes, glycerine, glycerol triacetate, sorbitol, aromatic hydrocarbons, dearomatized aliphatics, alkylbenzenes, alkylnaphthalenes, ketones such as cyclohexanone, 2-heptanone, isophorone and 4-hydroxy-4-methyl-2-pentanone, acetates such as isoamyl acetate, hexyl acetate, heptyl acetate, octyl acetate, nonyl acetate, tridecyl acetate and isobornyl acetate, other esters such as alkylated lactate esters, dibasic esters and γ-butyrolactone, and alcohols, which can be linear, branched, saturated or unsaturated, such as methanol, ethanol, n-propanol, isopropyl alcohol, n-butanol, isobutyl alcohol, n-hexanol, 2-ethylhexanol, n-octanol, decanol, isodecyl alcohol, isooctadecanol, cetyl alcohol, lauryl alcohol, tridecyl alcohol, oleyl alcohol, cyclohexanol, tetrahydrofurfuryl alcohol, diacetone alcohol and benzyl alcohol. Liquid diluents also include glycerol esters of saturated and unsaturated fatty acids (typically C₆-C₂₂), such as plant seed and fruit oils (e.g., oils of olive, castor, linseed, sesame, corn (maize), peanut, sunflower, grapeseed, safflower, cottonseed, soybean, rapeseed, coconut and palm kernel), animal-sourced fats (e.g., beef tallow, pork tallow, lard, cod liver oil, fish oil), and mixtures thereof. Liquid diluents also include alkylated fatty acids (e.g., methylated, ethylated, butylated) wherein the fatty acids may be obtained by hydrolysis of glycerol esters from plant and animal sources, and can be purified by distillation. Typical liquid diluents are described in Marsden, Solvents Guide, 2nd Ed., Interscience, New York, 1950.

The solid and liquid compositions of the present invention often include one or more surfactants. When added to a liquid, surfactants (also known as “surface-active agents”) generally modify, most often reduce, the surface tension of the liquid. Depending on the nature of the hydrophilic and lipophilic groups in a surfactant molecule, surfactants can be useful as wetting agents, dispersants, emulsifiers or defoaming agents.

Surfactants can be classified as nonionic, anionic or cationic. Nonionic surfactants useful for the present compositions include, but are not limited to: alcohol alkoxylates such as alcohol alkoxylates based on natural and synthetic alcohols (which may be branched or linear) and prepared from the alcohols and ethylene oxide, propylene oxide, butylene oxide or mixtures thereof; amine ethoxylates, alkanolamides and ethoxylated alkanolamides; alkoxylated triglycerides such as ethoxylated soybean, castor and rapeseed oils; alkylphenol alkoxylates such as octylphenol ethoxylates, nonylphenol ethoxylates, dinonyl phenol ethoxylates and dodecyl phenol ethoxylates (prepared from the phenols and ethylene oxide, propylene oxide, butylene oxide or mixtures thereof); block polymers prepared from ethylene oxide or propylene oxide and reverse block polymers where the terminal blocks are prepared from propylene oxide; ethoxylated fatty acids; ethoxylated fatty esters and oils; ethoxylated methyl esters; ethoxylated tristyrylphenol (including those prepared from ethylene oxide, propylene oxide, butylene oxide or mixtures thereof); fatty acid esters, glycerol esters, lanolin-based derivatives, polyethoxylate esters such as polyethoxylated sorbitan fatty acid esters, polyethoxylated sorbitol fatty acid esters and polyethoxylated glycerol fatty acid esters; other sorbitan derivatives such as sorbitan esters; polymeric surfactants such as random copolymers, block copolymers, alkyd peg (polyethylene glycol) resins, graft or comb polymers and star polymers; polyethylene glycols (pegs); polyethylene glycol fatty acid esters; silicone-based surfactants; and sugar-derivatives such as sucrose esters, alkyl polyglycosides and alkyl polysaccharides.

Useful anionic surfactants include, but are not limited to: alkylaryl sulfonic acids and their salts; carboxylated alcohol or alkylphenol ethoxylates; diphenyl sulfonate derivatives; lignin and lignin derivatives such as lignosulfonates; maleic or succinic acids or their anhydrides; olefin sulfonates; phosphate esters such as phosphate esters of alcohol alkoxylates, phosphate esters of alkylphenol alkoxylates and phosphate esters of styryl phenol ethoxylates; protein-based surfactants; sarcosine derivatives; styryl phenol ether sulfate; sulfates and sulfonates of oils and fatty acids; sulfates and sulfonates of ethoxylated alkylphenols; sulfates of alcohols; sulfates of ethoxylated alcohols; sulfonates of amines and amides such as N,N-alkyltaurates; sulfonates of benzene, cumene, toluene, xylene, and dodecyl and tridecylbenzenes; sulfonates of condensed naphthalenes; sulfonates of naphthalene and alkyl naphthalene; sulfonates of fractionated petroleum; sulfosuccinamates; and sulfosuccinates and their derivatives such as dialkyl sulfosuccinate salts.

Useful cationic surfactants include, but are not limited to: amides and ethoxylated amides; amines such as N-alkyl propanediamines, tripropylenetriamines and dipropylenetetramines, and ethoxylated amines, ethoxylated diamines and propoxylated amines (prepared from the amines and ethylene oxide, propylene oxide, butylene oxide or mixtures thereof); amine salts such as amine acetates and diamine salts; quaternary ammonium salts such as quaternary salts, ethoxylated quaternary salts and diquaternary salts; and amine oxides such as alkyldimethylamine oxides and bis-(2-hydroxyethyl)-alkylamine oxides.

Also useful for the present compositions are mixtures of nonionic and anionic surfactants or mixtures of nonionic and cationic surfactants. Nonionic, anionic and cationic surfactants and their recommended uses are disclosed in a variety of published references including McCutcheon's Emulsifiers and Detergents, annual American and International Editions published by McCutcheon's Division, The Manufacturing Confectioner Publishing Co.; Sisely and Wood, Encyclopedia of Surface Active Agents, Chemical Publ. Co., Inc., New York, 1964; and A. S. Davidson and B. Milwidsky, Synthetic Detergents, Seventh Edition, John Wiley and Sons, New York, 1987.

Compositions of this invention may also contain formulation auxiliaries and additives, known to those skilled in the art as formulation aids (some of which may be considered to also function as solid diluents, liquid diluents or surfactants). Such formulation auxiliaries and additives may control: pH (buffers), foaming during processing (antifoams such polyorganosiloxanes), sedimentation of active ingredients (suspending agents), viscosity (thixotropic thickeners), in-container microbial growth (antimicrobials), product freezing (antifreezes), color (dyes/pigment dispersions), wash-off (film formers or stickers), evaporation (evaporation retardants), and other formulation attributes. Film formers include, for example, polyvinyl acetates, polyvinyl acetate copolymers, polyvinylpyrrolidone-vinyl acetate copolymer, polyvinyl alcohols, polyvinyl alcohol copolymers and waxes. Examples of formulation auxiliaries and additives include those listed in McCutcheon's Volume 2. Functional Materials, annual International and North American editions published by McCutcheon's Division, The Manufacturing Confectioner Publishing Co.; and PCT Publication WO 03/024222.

The compound of Formula 1 and any other active ingredients are typically incorporated into the present compositions by dissolving the active ingredient in a solvent or by grinding in a liquid or dry diluent. Solutions, including emulsifiable concentrates, can be prepared by simply mixing the ingredients. If the solvent of a liquid composition intended for use as an emulsifiable concentrate is water-immiscible, an emulsifier is typically added to emulsify the active-containing solvent upon dilution with water. Active ingredient slurries, with particle diameters of up to 2,000 μm can be wet milled using media mills to obtain particles with average diameters below 3 μm. Aqueous slurries can be made into finished suspension concentrates (see, for example, U.S. Pat. No. 3,060,084) or further processed by spray drying to form water-dispersible granules. Dry formulations usually require dry milling processes, which produce average particle diameters in the 2 to 10 μm range. Dusts and powders can be prepared by blending and usually grinding (such as with a hammer mill or fluid-energy mill). Granules and pellets can be prepared by spraying the active material upon preformed granular carriers or by agglomeration techniques. See Browning, “Agglomeration”, Chemical Engineering, Dec. 4, 1967, pp 147-48, Perry's Chemical Engineer's Handbook, 4th Ed., McGraw-Hill, New York, 1963, pages 8-57 and following, and WO 91/13546. Pellets can be prepared as described in U.S. Pat. No. 4,172,714. Water-dispersible and water-soluble granules can be prepared as taught in U.S. Pat. No. 4,144,050, U.S. Pat. No. 3,920,442 and DE 3,246,493. Tablets can be prepared as taught in U.S. Pat. No. 5,180,587, U.S. Pat. No. 5,232,701 and U.S. Pat. No. 5,208,030. Films can be prepared as taught in GB 2,095,558 and U.S. Pat. No. 3,299,566.

For further information regarding the art of formulation, see T. S. Woods, “The Formulator's Toolbox—Product Forms for Modern Agriculture” in Pesticide Chemistry and Bioscience, The Food-Environment Challenge, T. Brooks and T. R. Roberts, Eds., Proceedings of the 9th International Congress on Pesticide Chemistry, The Royal Society of Chemistry, Cambridge, 1999, pp. 120-133. See also U.S. Pat. No. 3,235,361, Col. 6, line 16 through Col. 7, line 19 and Examples 10-41; U.S. Pat. No. 3,309,192, Col. 5, line 43 through Col. 7, line 62 and Examples 8, 12, 15, 39, 41, 52, 53, 58, 132, 138-140, 162-164, 166, 167 and 169-182; U.S. Pat. No. 2,891,855, Col. 3, line 66 through Col. 5, line 17 and Examples 1-4; Klingman, Weed Control as a Science, John Wiley and Sons, Inc., New York, 1961, pp 81-96; Hance et al., Weed Control Handbook, 8th Ed., Blackwell Scientific Publications, Oxford, 1989; and Developments in formulation technology, PJB Publications, Richmond, UK, 2000.

In the following Examples, all percentages are by weight and all formulations are prepared in conventional ways. Compound numbers refer to compounds in Index Table A. Without further elaboration, it is believed that one skilled in the art using the preceding description can utilize the present invention to its fullest extent. The following Examples are, therefore, to be construed as merely illustrative, and not limiting of the disclosure in any way whatsoever. Percentages are by weight except where otherwise indicated.

### Example A

High Strength Concentrate

| | |
|---|---|
| Compound 1 | 98.5% |
| silica aerogel | 0.5% |
| synthetic amorphous fine silica | 1.0% |

### Example B

Wettable Powder

| | |
|---|---|
| Compound 2 | 65.0% |
| dodecylphenol polyethylene glycol ether | 2.0% |
| sodium ligninsulfonate | 4.0% |
| sodium silicoaluminate | 6.0% |
| montmorillonite (calcined) | 23.0% |

### Example C

Granule

| | |
|---|---|
| Compound 3 | 10.0% |
| attapulgite granules (low volatile matter, 0.71/0.30 mm; | 90.0% |
| U.S.S. No. 25-50 sieves) | |

### Example D

Extruded Pellet

| | |
|---|---|
| Compound 4 | 25.0% |
| anhydrous sodium sulfate | 10.0% |
| crude calcium ligninsulfonate | 5.0% |
| sodium alkylnaphthalenesulfonate | 1.0% |
| calcium/magnesium bentonite | 59.0% |

### Example E

Emulsifiable Concentrate

| | |
|---|---|
| Compound 5 | 10.0% |
| polyoxyethylene sorbitol hexoleate | 20.0% |
| C₆-C₁₀ fatty acid methyl ester | 70.0% |

### Example F

Microemulsion

| | |
|---|---|
| Compound 6 | 5.0% |
| polyvinylpyrrolidone-vinyl acetate copolymer | 30.0% |
| alkylpolyglycoside | 30.0% |
| glyceryl monooleate | 15.0% |
| water | 20.0% |

These compounds generally show highest activity for early postemergence weed control (i.e. applied when the emerged weed seedlings are still young) and preemergence weed control (i.e. applied before weed seedlings emerge from the soil). Many of them have utility for broad-spectrum pre- and/or postemergence weed control in areas where complete control of all vegetation is desired such as around fuel storage tanks, industrial storage areas, parking lots, drive-in theaters, air fields, river banks, irrigation and other waterways, around billboards and highway and railroad structures. Many of the compounds of this invention, by virtue of selective metabolism in crops versus weeds, or by selective activity at the locus of physiological inhibition in crops and weeds, or by selective placement on or within the environment of a mixture of crops and weeds, are useful for the selective control of grass and broadleaf weeds within a crop/weed mixture. One skilled in the art will recognize that the preferred combination of these selectivity factors within a compound or group of compounds can readily be determined by performing routine biological and/or biochemical assays. Compounds of this invention may show tolerance to important agronomic crops including, but not limited to, alfalfa, barley, cotton, wheat, rape, sugar beets, corn (maize), sorghum, soybeans, rice, oats, peanuts, vegetables, tomato, potato, perennial plantation crops including coffee, cocoa, oil palm, rubber, sugarcane, citrus, grapes, fruit trees, nut trees, banana, plantain, pineapple, hops, tea and forests such as eucalyptus and conifers (e.g., loblolly pine), and turf species (e.g., Kentucky bluegrass, St. Augustine grass, Kentucky fescue and Bermuda grass). Compounds of the invention are particularly useful for selective control of weeds in wheat, barley, and particularly maize, soybean, cotton and perennial plantation crops such as sugarcane and citrus. Compounds of this invention can be used in crops genetically transformed or bred to incorporate resistance to herbicides, express proteins toxic to invertebrate pests (such as Bacillus thuringiensis toxin), and/or express other useful traits. Those skilled in the art will appreciate that not all compounds are equally effective against all weeds. Alternatively, the subject compounds are useful to modify plant growth.

As the compounds of the invention have both postemergent and preemergent herbicidal activity, to control undesired vegetation by killing or injuring the vegetation or reducing its growth, the compounds can be usefully applied by a variety of methods involving contacting a herbicidally effective amount of a compound of the invention, or a composition comprising said compound and at least one of a surfactant, a solid diluent or a liquid diluent, to the foliage or other part of the undesired vegetation or to the environment of the undesired vegetation such as the soil or water in which the undesired vegetation is growing or which surrounds the seed or other propagule of the undesired vegetation.

A herbicidally effective amount of the compounds of this invention is determined by a number of factors. These factors include: formulation selected, method of application, amount and type of vegetation present, growing conditions, etc. In general, a herbicidally effective amount of a compound of this invention is about 0.001 to 20 kg/ha with a typical range of about 0.004 to 1 kg/ha. One skilled in the art can easily determine the herbicidally effective amount necessary for the desired level of weed control.

Compounds of this invention can also be mixed with one or more other biologically active compounds or agents including herbicides, herbicide safeners, fungicides, insecticides, nematocides, bactericides, acaricides, growth regulators such as insect molting inhibitors and rooting stimulants, chemosterilants, semiochemicals, repellents, attractants, pheromones, feeding stimulants, plant nutrients, other biologically active compounds or entomopathogenic bacteria, virus or fungi to form a multi-component pesticide giving an even broader spectrum of agricultural protection. Mixtures of the compounds of the invention with other herbicides can broaden the spectrum of activity against additional weed species, and suppress the proliferation of any resistant biotypes. Thus the present invention also pertains to a composition comprising a compound of Formula 1 (in a herbicidally effective amount) and at least one additional biologically active compound or agent (in a biologically effective amount) and can further comprise at least one of a surfactant, a solid diluent or a liquid diluent. The other biologically active compounds or agents can be formulated in compositions comprising at least one of a surfactant, solid or liquid diluent. For mixtures of the present invention, one or more other biologically active compounds or agents can be formulated together with a compound of Formula 1, to form a premix, or one or more other biologically active compounds or agents can be formulated separately from the compound of Formula 1, and the formulations combined together before application (e.g., in a spray tank) or, alternatively, applied in succession.

A mixture of one or more of the following herbicides with a compound of this invention may be particularly useful for weed control: acetochlor, acifluorfen and its sodium salt, aclonifen, acrolein (2-propenal), alachlor, alloxydim, ametryn, amicarbazone, amidosulfuron, aminocyclopyrachlor and its esters (e.g., methyl, ethyl) and salts (e.g., sodium, potassium), 4-amino-3-chloro-6-(4-chloro-2-fluoro-3-methoxyphenyl)-2-pyridine-carboxylic acid and its esters (e.g., methyl) and salts (e.g., sodium, potassium), aminopyralid, amitrole, ammonium sulfamate, anilofos, asulam, atrazine, azimsulfuron, beflubutamid, benazolin, benazolin-ethyl, bencarbazone, benfluralin, benfuresate, bensulfuron-methyl, bensulide, bentazone, benzobicyclon, benzofenap, bicyclopyrone, bifenox, bilanafos, bispyribac and its sodium salt, bromacil, bromobutide, bromofenoxim, bromoxynil, bromoxynil octanoate, butachlor, butafenacil, butamifos, butralin, butroxydim, butylate, cafenstrole, carbetamide, carfentrazone-ethyl, catechin, chlomethoxyfen, chloramben, chlorbromuron, chlorflurenol-methyl, chloridazon, chlorimuron-ethyl, chlorotoluron, chlorpropham, chlorsulfuron, chlorthal-dimethyl, chlorthiamid, cinidon-ethyl, cinmethylin, cinosulfuron, clefoxydim, clethodim, clodinafop-propargyl, clomazone, clomeprop, clopyralid, clopyralid-olamine, cloransulam-methyl, cumyluron, cyanazine, cycloate, cyclosulfamuron, cycloxydim, cyhalofop-butyl, 2,4-D and its butotyl, butyl, isoctyl and isopropyl esters and its dimethylammonium, diolamine and trolamine salts, daimuron, dalapon, dalapon-sodium, dazomet, 2,4-DB and its dimethylammonium, potassium and sodium salts, desmedipham, desmetryn, dicamba and its diglycolammonium, dimethylammonium, potassium and sodium salts, dichlobenil, dichlorprop, diclofop-methyl, diclosulam, difenzoquat metilsulfate, diflufenican, diflufenzopyr, dimefuron, dimepiperate, dimethachlor, dimethametryn, dimethenamid, dimethenamid-P, dimethipin, dimethylarsinic acid and its sodium salt, dinitramine, dinoterb, diphenamid, diquat dibromide, dithiopyr, diuron, DNOC, endothal, EPTC, esprocarb, ethalfluralin, ethametsulfuron-methyl, ethiozin, ethofumesate, ethoxyfen, ethoxysulfuron, etobenzanid, fenoxaprop-ethyl, fenoxaprop-P-ethyl, fenoxasulfone, fentrazamide, fenuron, fenuron-TCA, flamprop-methyl, flamprop-M-isopropyl, flamprop-M-methyl, flazasulfuron, florasulam, fluazifop-butyl, fluazifop-P-butyl, fluazolate, flucarbazone, flucetosulfuron, fluchloralin, flufenacet, flufenpyr, flufenpyr-ethyl, flumetsulam, flumiclorac-pentyl, flumioxazin, fluometuron, fluoroglycofen-ethyl, flupoxam, flupyrsulfuron-methyl and its sodium salt, flurenol, flurenol-butyl, fluridone, fluorochloridone, fluoroxypyr, flurtamone, fluthiacet-methyl, fomesafen, foramsulfuron, fosamine-ammonium, glufosinate, glufosinate-ammonium, glyphosate and its salts such as ammonium, isopropylammonium, potassium, sodium (including sesquisodium) and trimesium (alternatively named sulfosate), halo sulfuron-methyl, haloxyfop-etotyl, haloxyfop-methyl, hexazinone, imazamethabenz-methyl, imazamox, imazapic, imazapyr, imazaquin, imazaquin-ammonium, imazethapyr, imazethapyr-ammonium, imazosulfuron, indanofan, iodosulfuron-methyl, ioxynil, ioxynil octanoate, ioxynil-sodium, isoproturon, isouron, isoxaben, isoxaflutole, isoxachlortole, lactofen, lenacil, linuron, maleic hydrazide, MCPA and its salts (e.g., MCPA-dimethylammonium, MCPA-potassium and MCPA-sodium, esters (e.g., MCPA-2-ethylhexyl, MCPA-butotyl) and thioesters (e.g., MCPA-thioethyl), MCPB and its salts (e.g., MCPB-sodium) and esters (e.g., MCPB-ethyl), mecoprop, mecoprop-P, mefenacet, mefluidide, mesosulfuron-methyl, mesotrione, metam-sodium, metamifop, metamitron, metazachlor, metazosulfuron, methabenzthiazuron, methylarsonic acid and its calcium, monoammonium, monosodium and disodium salts, methyldymron, metobenzuron, metobromuron, metolachlor, S-metolachlor, metosulam, metoxuron, metribuzin, metsulfuron-methyl, molinate, monolinuron, naproanilide, napropamide, naptalam, neburon, nicosulfuron, norflurazon, orbencarb, orthosulfamuron, oryzalin, oxadiargyl, oxadiazon, oxasulfuron, oxaziclomefone, oxyfluorfen, paraquat dichloride, pebulate, pelargonic acid, pendimethalin, penoxsulam, pentanochlor, pentoxazone, perfluidone, pethoxamid, pethoxyamid, phenmedipham, picloram, picloram-potassium, picolinafen, pinoxaden, piperophos, pretilachlor, primisulfuron-methyl, prodiamine, profoxydim, prometon, prometryn, propachlor, propanil, propaquizafop, propazine, propham, propisochlor, propoxycarbazone, propyzamide, prosulfocarb, prosulfuron, pyraclonil, pyraflufen-ethyl, pyrasulfotole, pyrazogyl, pyrazolynate, pyrazoxyfen, pyrazosulfuron-ethyl, pyribenzoxim, pyributicarb, pyridate, pyriftalid, pyriminobac-methyl, pyrimisulfan, pyrithiobac, pyrithiobac-sodium, pyroxasulfone, pyroxsulam, quinclorac, quinmerac, quinoclamine, quizalofop-ethyl, quizalofop-P-ethyl, quizalofop-P-tefuryl, rimsulfuron, saflufenacil, sethoxydim, siduron, simazine, simetryn, sulcotrione, sulfentrazone, sulfometuron-methyl, sulfosulfuron, 2,3,6-TBA, TCA, TCA-sodium, tebutam, tebuthiuron, tefuryltrione, tembotrione, tepraloxydim, terbacil, terbumeton, terbuthylazine, terbutryn, thenylchlor, thiazopyr, thiencarbazone-methyl, thifensulfuron-methyl, thiobencarb, tiocarbazil, topramezone, tralkoxydim, tri-allate, triasulfuron, triaziflam, tribenuron-methyl, triclopyr, triclopyr-butotyl, triclopyr-triethylammonium, tridiphane, trietazine, trifloxysulfuron, trifluralin, triflusulfuron-methyl, tritosulfuron and vernolate. Other herbicides also include bioherbicides such as Alternaria destruens Simmons, Colletotrichum gloeosporiodes (Penz.) Penz. & Sacc., Drechsiera monoceras (MTB-951), Myrothecium verrucaria (Albertini & Schweinitz) Ditmar: Fries, Phytophthora palmivora (Butl.) Butl. and Puccinia thlaspeos Schub.

Compounds of this invention can also be used in combination with plant growth regulators such as aviglycine, N-(phenylmethyl)-1H-purin-6-amine, epocholeone, gibberellic acid, gibberellin A₄ and A₇, harpin protein, mepiquat chloride, prohexadione calcium, prohydrojasmon, sodium nitrophenolate and trinexapac-methyl, and plant growth modifying organisms such as Bacillus cereus strain BP01.

General references for agricultural protectants (i.e. herbicides, herbicide safeners, insecticides, fungicides, nematocides, acaricides and biological agents) include The Pesticide Manual, 13th Edition, C. D. S. Tomlin, Ed., British Crop Protection Council, Farnham, Surrey, U.K., 2003 and The BioPesticide Manual, 2nd Edition, L. G. Copping, Ed., British Crop Protection Council, Farnham, Surrey, U.K., 2001.

For embodiments where one or more of these various mixing partners are used, the weight ratio of these various mixing partners (in total) to the compound of Formula 1 is typically between about 1:3000 and about 3000:1. Of note are weight ratios between about 1:300 and about 300:1 (for example ratios between about 1:30 and about 30:1). One skilled in the art can easily determine through simple experimentation the biologically effective amounts of active ingredients necessary for the desired spectrum of biological activity. It will be evident that including these additional components may expand the spectrum of weeds controlled beyond the spectrum controlled by the compound of Formula 1 alone.

In certain instances, combinations of a compound of this invention with other biologically active (particularly herbicidal) compounds or agents (i.e. active ingredients) can result in a greater-than-additive (i.e. synergistic) effect on weeds and/or a less-than-additive effect (i.e. safening) on crops or other desirable plants. Reducing the quantity of active ingredients released in the environment while ensuring effective pest control is always desirable. Ability to use greater amounts of active ingredients to provide more effective weed control without excessive crop injury is also desirable. When synergism of herbicidal active ingredients occurs on weeds at application rates giving agronomically satisfactory levels of weed control, such combinations can be advantageous for reducing crop production cost and decreasing environmental load. When safening of herbicidal active ingredients occurs on crops, such combinations can be advantageous for increasing crop protection by reducing weed competition.

Of note is a combination of a compound of the invention with at least one other herbicidal active ingredient. Of particular note is such a combination where the other herbicidal active ingredient has different site of action from the compound of the invention. In certain instances, a combination with at least one other herbicidal active ingredient having a similar spectrum of control but a different site of action will be particularly advantageous for resistance management. Thus, a composition of the present invention can further comprise (in a herbicidally effective amount) at least one additional herbicidal active ingredient having a similar spectrum of control but a different site of action.

Compounds of this invention can also be used in combination with herbicide safeners such as allidochlor, benoxacor, BCS (1-bromo-4-[(chloromethyl)sulfonyl]benzene), cloquintocet-mexyl, cyometrinil, cyprosulfonamide, dichlormid, 4-(dichloroacetyl)-1-oxa-4-azospiro[4.5]decane (MON 4660), 2-(dichloromethyl)-2-methyl-1,3-dioxolane (MG 191), dicyclonon, dietholate, fenchlorazole-ethyl, fenclorim, flurazole, fluxofenim, furilazole, isoxadifen-ethyl, mefenpyr-diethyl, mephenate, methoxyphenone ((4-methoxy-3-methylphenyl)(3-methylphenyl)methanone), naphthalic anhydride (1,8-naphthalic anhydride) and oxabetrinil to increase safety to certain crops. Antidotally effective amounts of the herbicide safeners can be applied at the same time as the compounds of this invention, or applied as seed treatments. Therefore an aspect of the present invention relates to a herbicidal mixture comprising a compound of this invention and an antidotally effective amount of a herbicide safener. Seed treatment is particularly useful for selective weed control, because it physically restricts antidoting to the crop plants. Therefore a particularly useful embodiment of the present invention is a method for selectively controlling the growth of undesired vegetation in a crop comprising contacting the locus of the crop with a herbicidally effective amount of a compound of this invention wherein seed from which the crop is grown is treated with an antidotally effective amount of safener. Antidotally effective amounts of safeners can be easily determined by one skilled in the art through simple experimentation.

Of note is a composition comprising a compound of the invention (in a herbicidally effective amount), at least one additional active ingredient compound selected from the group consisting of other herbicides and herbicide safeners (in an effective amount), and at least one component selected from the group consisting of surfactants, solid diluents and liquid diluents.

Preferred for better control of undesired vegetation (e.g., lower use rate such as from synergism, broader spectrum of weeds controlled, or enhanced crop safety) or for preventing the development of resistant weeds are mixtures of a compound of this invention with a herbicide selected from the group consisting of 2,4-D, ametryne, aminocyclopyrachlor, aminopyralid, atrazine, bromacil, bromoxynil, bromoxynil octanoate, carfentrazone-ethyl, chlorimuron-ethyl, chlorsulfuron, clopyralid, clopyralid-olamine, dicamba and its diglycolammonium, dimethylammonium, potassium and sodium salts, diflufenican, dimethenamid, dimethenamid-P, diuron, florasulam, flufenacet, flumetsulam, flumioxazin, flupyrsulfuron-methyl, flupyrsulfuron-methyl-sodium, fluoroxypyr, glyphosate (particularly glyphosate-isopropylammonium, glyphosate-sodium, glyphosate-potassium, glyphosate-trimesium), hexazinone, imazamethabenz-methyl, imazaquin, imazethapyr, iodosulfuron-methyl, lactofen, lenacil, linuron, MCPA and its dimethylammonium, potassium and sodium salts, MCPA-isoctyl, MCPA-thioethyl, mesosulfuron-methyl, S-metolachlor, metribuzin, metsulfuron-methyl, nicosulfuron, oxyfluorfen, pendimethalin, pinoxaden, pronamide, prosulfuron, pyroxasulfone, pyroxsulam, quinclorac, rimsulfuron, saflufenacil, sulfentrazone, thifensulfuron-methyl, triasulfuron, tribenuron-methyl, triclopyr, triclopyr-butotyl, and triclopyr-triethylammonium.

Table A1 lists specific combinations of a Component (a) with Component (b) illustrative of the mixtures, compositions and methods of the present invention. Compound 1 in the Component (a) column is identified in Index Table A. The second column of Table A1 lists the specific Component (b) compound (e.g., “2,4-D” in the first line). The third, fourth and fifth columns of Table A1 lists ranges of weight ratios for rates at which the Component (a) compound is typically applied to a field-grown crop relative to Component (b). Thus, for example, the first line of Table A1 specifically discloses the combination of Component (a) with 2,4-D is typically applied in a weight ratio between 1:192 to 6:1. The remaining lines of Table A1 are to be construed similarly.

TABLE A1

| | | Typical | More Typical | Most Typical |
|---|---|---|---|---|
| Component (a) | Component (b) | Weight Ratio | Weight Ratio | Weight Ratio |
| Compound 1 | 2,4-D | 1:192 to 6:1 | 1:64 to 2:1 | 1:24 to 1:3 |
| Compound 1 | 4-amino-3-chloro-6-(4-chloro- | 1:20 to 56:1 | 1:6 to 19:1 | 1:2 to 4:1 |
| | 2-fluoro-3-methoxyphenyl)- | | | |
| | 2-pyridinecarboxylic acid | | | |
| Compound 1 | 4-amino-3-chloro-6-(4-chloro- | 1:20 to 56:1 | 1:6 to 19:1 | 1:2 to 4:1 |
| | 2-fluoro-3-methoxyphenyl)- | | | |
| | 2-pyridinecarboxylic acid | | | |
| | methyl ester | | | |
| Compound 1 | Acetochlor | 1:768 to 2:1 | 1:256 to 1:2 | 1:96 to 1:11 |
| Compound 1 | Acifluorfen | 1:96 to 12:1 | 1:32 to 4:1 | 1:12 to 1:2 |
| Compound 1 | Aclonifen | 1:857 to 2:1 | 1:285 to 1:3 | 1:107 to 1:12 |
| Compound 1 | Alachlor | 1:768 to 2:1 | 1:256 to 1:2 | 1:96 to 1:11 |
| Compound 1 | Ametryn | 1:384 to 3:1 | 1:128 to 1:1 | 1:48 to 1:6 |
| Compound 1 | Amicarbazone | 1:192 to 6:1 | 1:64 to 2:1 | 1:24 to 1:3 |
| Compound 1 | Amidosulfiiron | 1:6 to 168:1 | 1:2 to 56:1 | 1:1 to 11:1 |
| Compound 1 | Aminocyclopyrachlor | 1:48 to 24:1 | 1:16 to 8:1 | 1:6 to 2:1 |
| Compound 1 | Aminopyralid | 1:20 to 56:1 | 1:6 to 19:1 | 1:2 to 4:1 |
| Compound 1 | Amitrole | 1:768 to 2:1 | 1:256 to 1:2 | 1:96 to 1:11 |
| Compound 1 | Anilofos | 1:96 to 12:1 | 1:32 to 4:1 | 1:12 to 1:2 |
| Compound 1 | Asulam | 1:960 to 2:1 | 1:320 to 1:3 | 1:120 to 1:14 |
| Compound 1 | Atrazine | 1:192 to 6:1 | 1:64 to 2:1 | 1:24 to 1:3 |
| Compound 1 | Azimsulfuron | 1:6 to 168:1 | 1:2 to 56:1 | 1:1 to 11:1 |
| Compound 1 | Beflubutamid | 1:342 to 4:1 | 1:114 to 2:1 | 1:42 to 1:5 |
| Compound 1 | Benfuresate | 1:617 to 2:1 | 1:205 to 1:2 | 1:77 to 1:9 |
| Compound 1 | Bensulfuron-methyl | 1:25 to 45:1 | 1:8 to 15:1 | 1:3 to 3:1 |
| Compound 1 | Bentazon | 1:192 to 6:1 | 1:64 to 2:1 | 1:24 to 1:3 |
| Compound 1 | Benzobicyclon | 1:85 to 14:1 | 1:28 to 5:1 | 1:10 to 1:2 |
| Compound 1 | Benzofenap | 1:257 to 5:1 | 1:85 to 2:1 | 1:32 to 1:4 |
| Compound 1 | Bicyclopyrone | 1:42 to 27:1 | 1:14 to 9:1 | 1:5 to 2:1 |
| Compound 1 | Bifenox | 1:257 to 5:1 | 1:85 to 2:1 | 1:32 to 1:4 |
| Compound 1 | Bispyribac-sodium | 1:10 to 112:1 | 1:3 to 38:1 | 1:1 to 7:1 |
| Compound 1 | Bromacil | 1:384 to 3:1 | 1:128 to 1:1 | 1:48 to 1:6 |
| Compound 1 | Bromobutide | 1:384 to 3:1 | 1:128 to 1:1 | 1:48 to 1:6 |
| Compound 1 | Bromoxynil | 1:96 to 12:1 | 1:32 to 4:1 | 1:12 to 1:2 |
| Compound 1 | Butachlor | 1:768 to 2:1 | 1:256 to 1:2 | 1:96 to 1:11 |
| Compound 1 | Butafenacil | 1:42 to 27:1 | 1:14 to 9:1 | 1:5 to 2:1 |
| Compound 1 | Butylate | 1:1542 to 1:2 | 1:514 to 1:5 | 1:192 to 1:22 |
| Compound 1 | Carfenstrole | 1:192 to 6:1 | 1:64 to 2:1 | 1:24 to 1:3 |
| Compound 1 | Carfentrazone-ethyl | 1:128 to 9:1 | 1:42 to 3:1 | 1:16 to 1:2 |
| Compound 1 | Chlorimuron-ethyl | 1:8 to 135:1 | 1:2 to 45:1 | 1:1 to 9:1 |
| Compound 1 | Chlorotoluron | 1:768 to 2:1 | 1:256 to 1:2 | 1:96 to 1:11 |
| Compound 1 | Chlorsulfiiron | 1:6 to 168:1 | 1:2 to 56:1 | 1:1 to 11:1 |
| Compound 1 | Cincosulfuron | 1:17 to 68:1 | 1:5 to 23:1 | 1:2 to 5:1 |
| Compound 1 | Cinidon-ethyl | 1:384 to 3:1 | 1:128 to 1:1 | 1:48 to 1:6 |
| Compound 1 | Cinmethylin | 1:34 to 34:1 | 1:11 to 12:1 | 1:4 to 3:1 |
| Compound 1 | Clethodim | 1:48 to 24:1 | 1:16 to 8:1 | 1:6 to 2:1 |
| Compound 1 | Clodinafop-propargyl | 1:20 to 56:1 | 1:6 to 19:1 | 1:2 to 4:1 |
| Compound 1 | Clomazone | 1:384 to 3:1 | 1:128 to 1:1 | 1:48 to 1:6 |
| Compound 1 | Clomeprop | 1:171 to 7:1 | 1:57 to 3:1 | 1:21 to 1:3 |
| Compound 1 | Clopyralid | 1:192 to 6:1 | 1:64 to 2:1 | 1:24 to 1:3 |
| Compound 1 | Cloransulam-methyl | 1:12 to 96:1 | 1:4 to 32:1 | 1:1 to 6:1 |
| Compound 1 | Cumyluron | 1:384 to 3:1 | 1:128 to 1:1 | 1:48 to 1:6 |
| Compound 1 | Cyanazine | 1:384 to 3:1 | 1:128 to 1:1 | 1:48 to 1:6 |
| Compound 1 | Cyclosulfamuron | 1:17 to 68:1 | 1:5 to 23:1 | 1:2 to 5:1 |
| Compound 1 | Cycloxydim | 1:96 to 12:1 | 1:32 to 4:1 | 1:12 to 1:2 |
| Compound 1 | Cyhalofop | 1:25 to 45:1 | 1:8 to 15:1 | 1:3 to 3:1 |
| Compound 1 | Daimuron | 1:192 to 6:1 | 1:64 to 2:1 | 1:24 to 1:3 |
| Compound 1 | Desmedipham | 1:322 to 4:1 | 1:107 to 2:1 | 1:40 to 1:5 |
| Compound 1 | Dicamba | 1:192 to 6:1 | 1:64 to 2:1 | 1:24 to 1:3 |
| Compound 1 | Dichlobenil | 1:1371 to 1:2 | 1:457 to 1:4 | 1:171 to 1:20 |
| Compound 1 | Dichlorprop | 1:925 to 2:1 | 1:308 to 1:3 | 1:115 to 1:13 |
| Compound 1 | Diclofop-methyl | 1:384 to 3:1 | 1:128 to 1:1 | 1:48 to 1:6 |
| Compound 1 | Diclosulam | 1:10 to 112:1 | 1:3 to 38:1 | 1:1 to 7:1 |
| Compound 1 | Difenzoquat | 1:288 to 4:1 | 1:96 to 2:1 | 1:36 to 1:4 |
| Compound 1 | Diflufenican | 1:857 to 2:1 | 1:285 to 1:3 | 1:107 to 1:12 |
| Compound 1 | Diflufenzopyr | 1:12 to 96:1 | 1:4 to 32:1 | 1:1 to 6:1 |
| Compound 1 | Dimethachlor | 1:768 to 2:1 | 1:256 to 1:2 | 1:96 to 1:11 |
| Compound 1 | Dimethametryn | 1:192 to 6:1 | 1:64 to 2:1 | 1:24 to 1:3 |
| Compound 1 | Dimethenamid-P | 1:384 to 3:1 | 1:128 to 1:1 | 1:48 to 1:6 |
| Compound 1 | Dithiopyr | 1:192 to 6:1 | 1:64 to 2:1 | 1:24 to 1:3 |
| Compound 1 | Diuron | 1:384 to 3:1 | 1:128 to 1:1 | 1:48 to 1:6 |
| Compound 1 | EPIC | 1:768 to 2:1 | 1:256 to 1:2 | 1:96 to 1:11 |
| Compound 1 | Esprocarb | 1:1371 to 1:2 | 1:457 to 1:4 | 1:171 to 1:20 |
| Compound 1 | Ethalfluralin | 1:384 to 3:1 | 1:128 to 1:1 | 1:48 to 1:6 |
| Compound 1 | Ethametsulfuron-methyl | 1:17 to 68:1 | 1:5 to 23:1 | 1:2 to 5:1 |
| Compound 1 | Ethoxyfen | 1:8 to 135:1 | 1:2 to 45:1 | 1:1 to 9:1 |
| Compound 1 | Ethoxysulfuron | 1:20 to 56:1 | 1:6 to 19:1 | 1:2 to 4:1 |
| Compound 1 | Etobenzanid | 1:257 to 5:1 | 1:85 to 2:1 | 1:32 to 1:4 |
| Compound 1 | Fenoxaprop-ethyl | 1:120 to 10:1 | 1:40 to 4:1 | 1:15 to 1:2 |
| Compound 1 | Fenoxasulfone | 1:85 to 14:1 | 1:28 to 5:1 | 1:10 to 1:2 |
| Compound 1 | Fentrazamide | 1:17 to 68:1 | 1:5 to 23:1 | 1:2 to 5:1 |
| Compound 1 | Flazasulfuron | 1:17 to 68:1 | 1:5 to 23:1 | 1:2 to 5:1 |
| Compound 1 | Florasulam | 1:2 to 420:1 | 1:1 to 140:1 | 2:1 to 27:1 |
| Compound 1 | Fluazifop-butyl | 1:192 to 6:1 | 1:64 to 2:1 | 1:24 to 1:3 |
| Compound 1 | Flucarbazone | 1:8 to 135:1 | 1:2 to 45:1 | 1:1 to 9:1 |
| Compound 1 | Flucetosulfuron | 1:8 to 135:1 | 1:2 to 45:1 | 1:1 to 9:1 |
| Compound 1 | Flufenacet | 1:257 to 5:1 | 1:85 to 2:1 | 1:32 to 1:4 |
| Compound 1 | Flumetsulam | 1:24 to 48:1 | 1:8 to 16:1 | 1:3 to 3:1 |
| Compound 1 | Flumiclorac-pentyl | 1:10 to 112:1 | 1:3 to 38:1 | 1:1 to 7:1 |
| Compound 1 | Flumioxazin | 1:25 to 45:1 | 1:8 to 15:1 | 1:3 to 3:1 |
| Compound 1 | Fluometuron | 1:384 to 3:1 | 1:128 to 1:1 | 1:48 to 1:6 |
| Compound 1 | Flupyrsulfuron-methyl | 1:3 to 336:1 | 1:1 to 112:1 | 2:1 to 21:1 |
| Compound 1 | Fluridone | 1:384 to 3:1 | 1:128 to 1:1 | 1:48 to 1:6 |
| Compound 1 | Fluroxypyr | 1:96 to 12:1 | 1:32 to 4:1 | 1:12 to 1:2 |
| Compound 1 | Flurtamone | 1:857 to 2:1 | 1:285 to 1:3 | 1:107 to 1:12 |
| Compound 1 | Fluthiacet-methyl | 1:48 to 42:1 | 1:16 to 14:1 | 1:3 to 3:1 |
| Compound 1 | Fomesafen | 1:96 to 12:1 | 1:32 to 4:1 | 1:12 to 1:2 |
| Compound 1 | Foramsulfuron | 1:13 to 84:1 | 1:4 to 28:1 | 1:1 to 6:1 |
| Compound 1 | Glufosinate | 1:288 to 4:1 | 1:96 to 2:1 | 1:36 to 1:4 |
| Compound 1 | Glyphosate | 1:288 to 4:1 | 1:96 to 2:1 | 1:36 to 1:4 |
| Compound 1 | Halo sulfuron-methyl | 1:17 to 68:1 | 1:5 to 23:1 | 1:2 to 5:1 |
| Compound 1 | Haloxyfop-methyl | 1:34 to 34:1 | 1:11 to 12:1 | 1:4 to 3:1 |
| Compound 1 | Hexazinone | 1:192 to 6:1 | 1:64 to 2:1 | 1:24 to 1:3 |
| Compound 1 | Imazamox | 1:13 to 84:1 | 1:4 to 28:1 | 1:1 to 6:1 |
| Compound 1 | Imazapic | 1:20 to 56:1 | 1:6 to 19:1 | 1:2 to 4:1 |
| Compound 1 | Imazapyr | 1:85 to 14:1 | 1:28 to 5:1 | 1:10 to 1:2 |
| Compound 1 | Imazaquin | 1:34 to 34:1 | 1:11 to 12:1 | 1:4 to 3:1 |
| Compound 1 | Imazmethabenz-methyl | 1:171 to 7:1 | 1:57 to 3:1 | 1:21 to 1:3 |
| Compound 1 | Imazethapyr | 1:24 to 48:1 | 1:8 to 16:1 | 1:3 to 3:1 |
| Compound 1 | Imazosulfuron | 1:27 to 42:1 | 1:9 to 14:1 | 1:3 to 3:1 |
| Compound 1 | Indanofan | 1:342 to 4:1 | 1:114 to 2:1 | 1:42 to 1:5 |
| Compound 1 | Indaziflam | 1:25 to 45:1 | 1:8 to 15:1 | 1:3 to 3:1 |
| Compound 1 | Iodosulfuron-methyl | 1:3 to 336:1 | 1:1 to 112:1 | 2:1 to 21:1 |
| Compound 1 | Ioxynil | 1:192 to 6:1 | 1:64 to 2:1 | 1:24 to 1:3 |
| Compound 1 | Ipfencarbazone | 1:85 to 14:1 | 1:28 to 5:1 | 1:10 to 1:2 |
| Compound 1 | Isoproturon | 1:384 to 3:1 | 1:128 to 1:1 | 1:48 to 1:6 |
| Compound 1 | Isoxaben | 1:288 to 4:1 | 1:96 to 2:1 | 1:36 to 1:4 |
| Compound 1 | Isoxaflutole | 1:60 to 20:1 | 1:20 to 7:1 | 1:7 to 2:1 |
| Compound 1 | Lactofen | 1:42 to 27:1 | 1:14 to 9:1 | 1:5 to 2:1 |
| Compound 1 | Lenacil | 1:384 to 3:1 | 1:128 to 1:1 | 1:48 to 1:6 |
| Compound 1 | Linuron | 1:384 to 3:1 | 1:128 to 1:1 | 1:48 to 1:6 |
| Compound 1 | MCPA | 1:192 to 6:1 | 1:64 to 2:1 | 1:24 to 1:3 |
| Compound 1 | MCPB | 1:288 to 4:1 | 1:96 to 2:1 | 1:36 to 1:4 |
| Compound 1 | Mecoprop | 1:768 to 2:1 | 1:256 to 1:2 | 1:96 to 1:11 |
| Compound 1 | Mefenacet | 1:384 to 3:1 | 1:128 to 1:1 | 1:48 to 1:6 |
| Compound 1 | Mefluidide | 1:192 to 6:1 | 1:64 to 2:1 | 1:24 to 1:3 |
| Compound 1 | Mesosulfuron-methyl | 1:5 to 224:1 | 1:1 to 75:1 | 1:1 to 14:1 |
| Compound 1 | Mesotrione | 1:42 to 27:1 | 1:14 to 9:1 | 1:5 to 2:1 |
| Compound 1 | Metamifop | 1:42 to 27:1 | 1:14 to 9:1 | 1:5 to 2:1 |
| Compound 1 | Metazachlor | 1:384 to 3:1 | 1:128 to 1:1 | 1:48 to 1:6 |
| Compound 1 | Metazo sulfuron | 1:25 to 45:1 | 1:8 to 15:1 | 1:3 to 3:1 |
| Compound 1 | Methabenzthiazuron | 1:768 to 2:1 | 1:256 to 1:2 | 1:96 to 1:11 |
| Compound 1 | Metolachlor | 1:768 to 2:1 | 1:256 to 1:2 | 1:96 to 1:11 |
| Compound 1 | Metosulam | 1:8 to 135:1 | 1:2 to 45:1 | 1:1 to 9:1 |
| Compound 1 | Metribuzin | 1:192 to 6:1 | 1:64 to 2:1 | 1:24 to 1:3 |
| Compound 1 | Metsulfuron-methyl | 1:2 to 560:1 | 1:1 to 187:1 | 3:1 to 35:1 |
| Compound 1 | Molinate | 1:1028 to 2:1 | 1:342 to 1:3 | 1:128 to 1:15 |
| Compound 1 | Napropamide | 1:384 to 3:1 | 1:128 to 1:1 | 1:48 to 1:6 |
| Compound 1 | Naptalam | 1:192 to 6:1 | 1:64 to 2:1 | 1:24 to 1:3 |
| Compound 1 | Nicosulfuron | 1:12 to 96:1 | 1:4 to 32:1 | 1:1 to 6:1 |
| Compound 1 | Norflurazon | 1:1152 to 1:1 | 1:384 to 1:3 | 1:144 to 1:16 |
| Compound 1 | Orbencarb | 1:1371 to 1:2 | 1:457 to 1:4 | 1:171 to 1:20 |
| Compound 1 | Orthosulfamuron | 1:20 to 56:1 | 1:6 to 19:1 | 1:2 to 4:1 |
| Compound 1 | Oryzalin | 1:514 to 3:1 | 1:171 to 1:2 | 1:64 to 1:8 |
| Compound 1 | Oxadiargyl | 1:384 to 3:1 | 1:128 to 1:1 | 1:48 to 1:6 |
| Compound 1 | Oxadiazon | 1:548 to 3:1 | 1:182 to 1:2 | 1:68 to 1:8 |
| Compound 1 | Oxasulfuron | 1:27 to 42:1 | 1:9 to 14:1 | 1:3 to 3:1 |
| Compound 1 | Oxaziclomefone | 1:42 to 27:1 | 1:14 to 9:1 | 1:5 to 2:1 |
| Compound 1 | Oxyfluorfen | 1:384 to 3:1 | 1:128 to 1:1 | 1:48 to 1:6 |
| Compound 1 | Paraquat | 1:192 to 6:1 | 1:64 to 2:1 | 1:24 to 1:3 |
| Compound 1 | Pendimethalin | 1:384 to 3:1 | 1:128 to 1:1 | 1:48 to 1:6 |
| Compound 1 | Penoxsulam | 1:10 to 112:1 | 1:3 to 38:1 | 1:1 to 7:1 |
| Compound 1 | Penthoxamid | 1:384 to 3:1 | 1:128 to 1:1 | 1:48 to 1:6 |
| Compound 1 | Pentoxazone | 1:102 to 12:1 | 1:34 to 4:1 | 1:12 to 1:2 |
| Compound 1 | Phenmedipham | 1:102 to 12:1 | 1:34 to 4:1 | 1:12 to 1:2 |
| Compound 1 | Picloram | 1:96 to 12:1 | 1:32 to 4:1 | 1:12 to 1:2 |
| Compound 1 | Picolinafen | 1:34 to 34:1 | 1:11 to 12:1 | 1:4 to 3:1 |
| Compound 1 | Pinoxaden | 1:25 to 45:1 | 1:8 to 15:1 | 1:3 to 3:1 |
| Compound 1 | Pretilachlor | 1:192 to 6:1 | 1:64 to 2:1 | 1:24 to 1:3 |
| Compound 1 | Primisulfuron-methyl | 1:8 to 135:1 | 1:2 to 45:1 | 1:1 to 9:1 |
| Compound 1 | Prodiamine | 1:384 to 3:1 | 1:128 to 1:1 | 1:48 to 1:6 |
| Compound 1 | Profoxydim | 1:42 to 27:1 | 1:14 to 9:1 | 1:5 to 2:1 |
| Compound 1 | Prometryn | 1:384 to 3:1 | 1:128 to 1:1 | 1:48 to 1:6 |
| Compound 1 | Propachlor | 1:1152 to 1:1 | 1:384 to 1:3 | 1:144 to 1:16 |
| Compound 1 | Propanil | 1:384 to 3:1 | 1:128 to 1:1 | 1:48 to 1:6 |
| Compound 1 | Propaquizafop | 1:48 to 24:1 | 1:16 to 8:1 | 1:6 to 2:1 |
| Compound 1 | Propoxycarbazone | 1:17 to 68:1 | 1:5 to 23:1 | 1:2 to 5:1 |
| Compound 1 | Propyrisulfuron | 1:17 to 68:1 | 1:5 to 23:1 | 1:2 to 5:1 |
| Compound 1 | Propyzamide | 1:384 to 3:1 | 1:128 to 1:1 | 1:48 to 1:6 |
| Compound 1 | Prosulfocarb | 1:1200 to 1:2 | 1:400 to 1:4 | 1:150 to 1:17 |
| Compound 1 | Prosulfuron | 1:6 to 168:1 | 1:2 to 56:1 | 1:1 to 11:1 |
| Compound 1 | Pyraclonil | 1:42 to 27:1 | 1:14 to 9:1 | 1:5 to 2:1 |
| Compound 1 | Pyraflufen-ethyl | 1:5 to 224:1 | 1:1 to 75:1 | 1:1 to 14:1 |
| Compound 1 | Pyrasulfotole | 1:13 to 84:1 | 1:4 to 28:1 | 1:1 to 6:1 |
| Compound 1 | Pyrazolynate | 1:857 to 2:1 | 1:285 to 1:3 | 1:107 to 1:12 |
| Compound 1 | Pyrazosulfuron-ethyl | 1:10 to 112:1 | 1:3 to 38:1 | 1:1 to 7:1 |
| Compound 1 | Pyrazoxyfen | 1:5 to 224:1 | 1:1 to 75:1 | 1:1 to 14:1 |
| Compound 1 | Pyribenzoxim | 1:10 to 112:1 | 1:3 to 38:1 | 1:1 to 7:1 |
| Compound 1 | Pyributicarb | 1:384 to 3:1 | 1:128 to 1:1 | 1:48 to 1:6 |
| Compound 1 | Pyridate | 1:288 to 4:1 | 1:96 to 2:1 | 1:36 to 1:4 |
| Compound 1 | Pyriftalid | 1:10 to 112:1 | 1:3 to 38:1 | 1:1 to 7:1 |
| Compound 1 | Pyriminobac-methyl | 1:20 to 56:1 | 1:6 to 19:1 | 1:2 to 4:1 |
| Compound 1 | Pyrimisulfan | 1:17 to 68:1 | 1:5 to 23:1 | 1:2 to 5:1 |
| Compound 1 | Pyrithiobac | 1:24 to 48:1 | 1:8 to 16:1 | 1:3 to 3:1 |
| Compound 1 | Pyroxasulfone | 1:85 to 14:1 | 1:28 to 5:1 | 1:10 to 1:2 |
| Compound 1 | Pyroxsulam | 1:5 to 224:1 | 1:1 to 75:1 | 1:1 to 14:1 |
| Compound 1 | Quinclorac | 1:192 to 6:1 | 1:64 to 2:1 | 1:24 to 1:3 |
| Compound 1 | Quizalofop-ethyl | 1:42 to 27:1 | 1:14 to 9:1 | 1:5 to 2:1 |
| Compound 1 | Rimsulfuron | 1:13 to 84:1 | 1:4 to 28:1 | 1:1 to 6:1 |
| Compound 1 | Saflufenacil | 1:25 to 45:1 | 1:8 to 15:1 | 1:3 to 3:1 |
| Compound 1 | Sethoxydim | 1:96 to 12:1 | 1:32 to 4:1 | 1:12 to 1:2 |
| Compound 1 | Simazine | 1:384 to 3:1 | 1:128 to 1:1 | 1:48 to 1:6 |
| Compound 1 | Sulcotrione | 1:120 to 10:1 | 1:40 to 4:1 | 1:15 to 1:2 |
| Compound 1 | Sulfentrazone | 1:147 to 8:1 | 1:49 to 3:1 | 1:18 to 1:3 |
| Compound 1 | Sulfometuron-methyl | 1:34 to 34:1 | 1:11 to 12:1 | 1:4 to 3:1 |
| Compound 1 | Sulfosulfuron | 1:8 to 135:1 | 1:2 to 45:1 | 1:1 to 9:1 |
| Compound 1 | Tebuthiuron | 1:384 to 3:1 | 1:128 to 1:1 | 1:48 to 1:6 |
| Compound 1 | Tefuryltrione | 1:42 to 27:1 | 1:14 to 9:1 | 1:5 to 2:1 |
| Compound 1 | Tembotrione | 1:31 to 37:1 | 1:10 to 13:1 | 1:3 to 3:1 |
| Compound 1 | Tepraloxydim | 1:25 to 45:1 | 1:8 to 15:1 | 1:3 to 3:1 |
| Compound 1 | Terbacil | 1:288 to 4:1 | 1:96 to 2:1 | 1:36 to 1:4 |
| Compound 1 | Terbuthylatrazine | 1:857 to 2:1 | 1:285 to 1:3 | 1:107 to 1:12 |
| Compound 1 | Terbutryn | 1:192 to 6:1 | 1:64 to 2:1 | 1:24 to 1:3 |
| Compound 1 | Thenylchlor | 1:85 to 14:1 | 1:28 to 5:1 | 1:10 to 1:2 |
| Compound 1 | Thiazopyr | 1:384 to 3:1 | 1:128 to 1:1 | 1:48 to 1:6 |
| Compound 1 | Thiencarbazone-methyl | 1:3 to 336:1 | 1:1 to 112:1 | 2:1 to 21:1 |
| Compound 1 | Thifensulfuron-methyl | 1:5 to 224:1 | 1:1 to 75:1 | 1:1 to 14:1 |
| Compound 1 | Thiobencarb | 1:768 to 2:1 | 1:256 to 1:2 | 1:96 to 1:11 |
| Compound 1 | Topramazone | 1:6 to 168:1 | 1:2 to 56:1 | 1:1 to 11:1 |
| Compound 1 | Tralkoxydim | 1:68 to 17:1 | 1:22 to 6:1 | 1:8 to 2:1 |
| Compound 1 | Triallate | 1:768 to 2:1 | 1:256 to 1:2 | 1:96 to 1:11 |
| Compound 1 | Triasulfuron | 1:5 to 224:1 | 1:1 to 75:1 | 1:1 to 14:1 |
| Compound 1 | Triaziflam | 1:171 to 7:1 | 1:57 to 3:1 | 1:21 to 1:3 |
| Compound 1 | Tribenuron-methyl | 1:3 to 336:1 | 1:1 to 112:1 | 2:1 to 21:1 |
| Compound 1 | Triclopyr | 1:192 to 6:1 | 1:64 to 2:1 | 1:24 to 1:3 |
| Compound 1 | Trifloxysulfuron | 1:2 to 420:1 | 1:1 to 140:1 | 2:1 to 27:1 |
| Compound 1 | Trifluralin | 1:288 to 4:1 | 1:96 to 2:1 | 1:36 to 1:4 |
| Compound 1 | Triflusulfuron-methyl | 1:17 to 68:1 | 1:5 to 23:1 | 1:2 to 5:1 |
| Compound 1 | Tritosulfuron | 1:13 to 84:1 | 1:4 to 28:1 | 1:1 to 6:1 |

The present disclosure also includes Tables A2 through A8 which are each constructed the same as Table A1 above except that entries below the “Component (a)” column heading are replaced with the respective Component (a) Column Entry shown below. Compound numbers refer to compounds in Index Table A. Thus, for example, in Table A2 the entries below the “Component (a)” column heading all recite “Compound 2”, and the first line below the column headings in Table A2 specifically discloses a mixture of Compound 2 with 2,4-D. Tables A3 through A8 are constructed similarly.

| Table Number | Component (a) Column Entries |
|---|---|
| A2 | Compound 2 |
| A3 | Compound 3 |
| A4 | Compound 4 |
| A5 | Compound 5 |
| A6 | Compound 6 |
| A7 | Compound 7 |
| A8 | Compound 8 |

The following Tests demonstrate the control efficacy of the compounds of this invention against specific weeds. The weed control afforded by the compounds is not limited, however, to these species.

See Index Table A for compound descriptions. See Index Table B for ¹H NMR data. The following abbreviations are used in Index Tables which follows: “Cmpd” means Compound, Me is methyl, n-Bu is n-butyl, Ph is phenyl and OMe is methoxy. The abbreviation “Ex.” stands for “Example” and is followed by a number indicating in which example the compound is prepared. Mass spectra (M.S.) are reported as the molecular weight of the highest isotopic abundance parent ion (M+1) formed by addition of H+ (molecular weight of 1) to the molecule, observed by mass spectrometry using atmospheric pressure chemical ionization (AP+). The presence of molecular ions containing one or more higher atomic weight isotopes of lower abundance (e.g., ³⁷Cl, ⁸¹Br) is not reported.

INDEX TABLE A

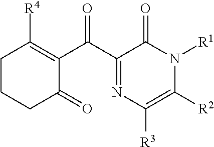

| Cmpd | R¹ | R² | R³ | R⁴ | M.S. |
|---|---|---|---|---|---|
| 1 | n-Bu | Ph | H | OH | 367 |
| 2 | cyclohexyl | 3-F-Ph | Cl | OH | 445 |
| 3 | cyclohexyl | 3-Cl-Ph | Cl | OH | 461 |
| 4 | CH₂CH₂OMe | 3-F-Ph | Cl | OH | 421 |
| 5 | CH₂CH₂OMe | 3,5-di-F-Ph | H | OH | 405 |
| 6 | CH₂CH₂OMe | 3,5-di-F-Ph | Cl | OH | 439 |
| 7 | 3-(OMe)-Ph | 3-F-Ph | Cl | OH | 469 |
| 8 | CH₂CH₂CH₂OMe | 3,5-di-F-Ph | Cl | OH | * |

* ¹H NMR data are listed in Index Table B.

INDEX TABLE B

| Cmpd No. | ¹H NMR Data (CDClg solution unless indicated otherwise)^{a} |
|---|---|
| 8 | δ 6.90-7.07 (m, 3H), 3.80-3.88 (m, 2H), 3.29 (t, J = 5.6 Hz, |
| | 2H), 3.17 (s, 3H), 2.78 (t, J = 6.3 Hz, 2H), 2.48 (t, J = |
| | 6.3 Hz, 2H), 2.04-2.14 (m, 2H), 1.79-1.89 (m, 2H). |

^{a1}H NMR data are in ppm downfield from tetramethylsilane. Couplings are designated by (s)—singlet, (br s)—broad singlet, (ddd)—doublet of doublets of doublets, (td)—triplet of doublets and (m)—multiplet.

### Biological Examples of the Invention

### Test A

Seeds of barnyardgrass (Echinochloa crus-galli), large crabgrass (Digitaria sanguinalis), giant foxtail (Setaria faberii), morningglory (Ipomoea spp.), pigweed (Amaranthus retroflexus), velvetleaf (Abutilon theophrasti), wheat (Triticum aestivum) and corn (Zea mays) were planted into a blend of loam soil and sand and treated preemergence with a directed soil spray using test chemicals formulated in a non-phytotoxic solvent mixture which included a surfactant. At the same time these species were also treated with postemergence applications of test compounds formulated in the same manner.

Plants ranged in height from 2 to 10 cm and were in the one- to two-leaf stage for the postemergence treatments. Treated plants and untreated controls were maintained in a greenhouse for approximately 10 days, after which time all treated plants were compared to untreated controls and visually evaluated for injury. Plant response ratings, summarized in Table A, are based on a 0 to 100 scale where 0 is no effect and 100 is complete control.

TABLE A

| 500 g ai/ha | Compounds | | | | | | 250 g ai/ha | Compound |
|---|---|---|---|---|---|---|---|---|
| Postemergence | 1 | 2 | 4 | 5 | 6 | 7 | Postemergence | 3 |
| Barnyardgrass | 80 | 30 | 100 | 90 | 100 | 80 | Barnyardgrass | 0 |
| Corn | 10 | 0 | 40 | 60 | 40 | 20 | Corn | 0 |
| Crabgrass, Large | 50 | 30 | 100 | 90 | 100 | 10 | Crabgrass, Large | 10 |
| Foxtail, Giant | 40 | 20 | 70 | 80 | 90 | 0 | Foxtail, Giant | 0 |
| Morningglory | 100 | 90 | 100 | 90 | 100 | 90 | Morningglory | 30 |
| Pigweed | 100 | 70 | 100 | 100 | 100 | 90 | Pigweed | 30 |
| Velvetleaf | 100 | 100 | 100 | 100 | 100 | 100 | Velvetleaf | 100 |
| Wheat | 0 | 0 | 10 | 30 | 20 | 0 | Wheat | 0 |

| 125 g ai/ha | Compounds | | | | | | | 62 g ai/ha | Compound |
|---|---|---|---|---|---|---|---|---|---|
| Postemergence | 1 | 2 | 4 | 5 | 6 | 7 | 8 | Postemergence | 3 |
| Barnyardgrass | 10 | 0 | 60 | 90 | 90 | 20 | 10 | Barnyardgrass | 0 |
| Corn | 0 | 0 | 0 | 50 | 0 | 0 | 0 | Corn | 0 |
| Crabgrass, Large | 10 | 0 | 80 | 90 | 80 | 0 | 30 | Crabgrass, Large | 0 |
| Foxtail, Giant | 10 | 0 | 30 | 60 | 50 | 0 | 10 | Foxtail, Giant | 0 |
| Morningglory | 40 | 60 | 90 | 90 | 90 | 80 | 50 | Morningglory | 0 |
| Pigweed | 60 | 30 | 80 | 100 | 70 | 80 | 40 | Pigweed | 0 |
| Velvetleaf | 100 | 70 | 100 | 80 | 100 | 100 | 50 | Velvetleaf | 60 |
| Wheat | 0 | 0 | 0 | 30 | 0 | 0 | 0 | Wheat | 0 |

| 31 g ai/ha | Compounds | | 500 g ai/ha | Compounds | | | | | |
|---|---|---|---|---|---|---|---|---|---|
| Postemergence | 5 | 8 | Preemergence | 1 | 2 | 4 | 5 | 6 | 7 |
| Barnyardgrass | 50 | 0 | Barnyardgrass | 80 | 40 | 70 | 80 | 90 | 10 |
| Corn | 10 | 0 | Corn | 0 | 0 | 0 | 0 | 20 | 0 |
| Crabgrass, Large | 70 | 0 | Crabgrass, Large | 40 | 50 | 100 | 100 | 100 | 0 |
| Foxtail, Giant | 30 | 0 | Foxtail, Giant | 30 | 30 | 30 | 80 | 70 | 0 |
| Morningglory | 80 | 0 | Morningglory | 70 | 80 | 70 | 80 | 80 | 20 |
| Pigweed | 80 | 20 | Pigweed | 100 | 80 | 100 | 90 | 90 | 50 |
| Velvetleaf | 70 | 10 | Velvetleaf | 100 | 90 | 90 | 80 | 100 | 20 |
| Wheat | 0 | 0 | Wheat | 0 | 0 | 0 | 0 | 20 | 0 |

| 250 g ai/ha | Compound | 125 g ai/ha | Compounds | | | | | | |
|---|---|---|---|---|---|---|---|---|---|
| Preemergence | 3 | Preemergence | 1 | 2 | 4 | 5 | 6 | 7 | 8 |
| Barnyardgrass | 20 | Barnyardgrass | 0 | 0 | 0 | 50 | 20 | 0 | 10 |
| Corn | 0 | Corn | 0 | 0 | 0 | 0 | 0 | 0 | 0 |
| Crabgrass, Large | 30 | Crabgrass, Large | 10 | 0 | 80 | 100 | 90 | 0 | 40 |
| Foxtail, Giant | 0 | Foxtail, Giant | 0 | 0 | 0 | 70 | 20 | 0 | 0 |
| Morningglory | 10 | Morningglory | 0 | 0 | 10 | 40 | 40 | 0 | 10 |
| Pigweed | 60 | Pigweed | 60 | 0 | 60 | 90 | 50 | 0 | 10 |
| Velvetleaf | 80 | Velvetleaf | 50 | 0 | 40 | 70 | 50 | 0 | 0 |
| Wheat | 0 | Wheat | 0 | 0 | 0 | 0 | 0 | 0 | 0 |

| 62 g ai/ha | Compound | 31 g ai/ha | Compounds | |
|---|---|---|---|---|
| Preemergence | 3 | Preemergence | 5 | 8 |
| Barnyardgrass | 0 | Barnyardgrass | 0 | 0 |
| Corn | 0 | Corn | 0 | 0 |
| Crabgrass, Large | 0 | Crabgrass, Large | 20 | 20 |
| Foxtail, Giant | 0 | Foxtail, Giant | 20 | 0 |
| Morningglory | 0 | Morningglory | 0 | 0 |
| Pigweed | 0 | Pigweed | 40 | 0 |
| Velvetleaf | 40 | Velvetleaf | 30 | 0 |
| Wheat | 0 | Wheat | 0 | 0 |

### Test B

Seeds of plant species selected from blackgrass (Alopecurus myosuroides), downy bromegrass (Bromus tectorum), green foxtail (Setaria viridis), Italian ryegrass (Lolium multiflorum), wheat (Triticum aestivum), wild oat (Avena fatua), galium (Galium aparine), bermudagrass (Cynodon dactylon), Surinam grass (Brachiaria decumbens), cocklebur (Xanthium strumarium), corn (Zea mays), large crabgrass (Digitaria sanguinalis), woolly cupgrass (Eriochloa villosa), giant foxtail (Setaria faberii), goosegrass (Eleusine indica), johnsongrass (Sorghum halepense), kochia (Kochia scoparia), lambsquarters (Chenopodium album), morningglory (Ipomoea coccinea), yellow nutsedge (Cyperus esculentus), pigweed (Amaranthus retroflexus), ragweed (Ambrosia elatior), soybean (Glycine max), velvetleaf (Abutilon theophrasti), barley (Hordeum vulgare), canarygrass (Phalaris minor), chickweed (Stellaria media), deadnettle (Lamium amplexicaule) and windgrass (Apera spica-venti) were planted in pots containing Redi-Earth® planting medium (Scotts Company, Marysville, Ohio, USA) comprising spaghnum peat moss, vermiculite, wetting agent and starter nutrients and treated postemergence with test compounds formulated in a non-phytotoxic solvent mixture which included a surfactant. Plants ranged in height from 2 to 18 cm (1- to 4-leaf stage).

Plant species in the flooded paddy test consisted of rice (Oryza sativa), umbrella sedge (Cyperus difformis), ducksalad (Heteranthera limosa) and barnyardgrass (Echinochloa crus-galli) grown to the 2-leaf stage for testing. At time of treatment, test pots were flooded to 3 cm above the soil surface, treated by application of test compounds directly to the paddy water, and then maintained at that water depth for the duration of the test.

Treated plants and controls were maintained in a greenhouse for 13 to 15 days, after which time all species were compared to controls and visually evaluated. Plant response ratings, summarized in Table B, are based on a scale of 0 to 100 where 0 is no effect and 100 is complete control. A dash (-) response means no test result.

TABLE B

| 250 g ai/ha | Compounds | | | | | | | |
|---|---|---|---|---|---|---|---|---|
| Flood | 1 | 2 | 3 | 4 | 5 | 6 | 7 | 8 |
| Barnyardgrass | 80 | 0 | 0 | 30 | 80 | 50 | 20 | 40 |
| Ducksalad | 95 | 80 | 80 | 85 | 90 | 80 | 80 | 80 |
| Rice | 85 | 0 | 0 | 30 | 20 | 15 | 15 | 25 |
| Sedge, Umbrella | 95 | 60 | 60 | 80 | 100 | 90 | 75 | 75 |
| 125 g ai/ha | | | | | | | | |
| Flood | 2 | 3 | 4 | 5 | 6 | 7 | 8 | |
| Barnyardgrass | 0 | 0 | 0 | 25 | 0 | 10 | 0 | |
| Ducksalad | 60 | 80 | 75 | 60 | 70 | 50 | 30 | |
| Rice | 0 | 0 | 0 | 10 | 0 | 0 | 0 | |
| Sedge, Umbrella | 20 | 30 | 75 | 90 | 85 | 50 | 40 | |
| 62 g ai/ha | | | | | | | | |
| Flood | 1 | 2 | 3 | 4 | 5 | 6 | 7 | 8 |
| Barnyardgrass | 60 | 0 | 0 | 0 | 0 | 0 | 0 | 0 |
| Ducksalad | 60 | 0 | 20 | 65 | 40 | 50 | 40 | 0 |
| Rice | 70 | 0 | 0 | 0 | 0 | 0 | 0 | 0 |
| Sedge, Umbrella | 70 | 0 | 0 | 75 | 70 | 70 | 20 | 40 |
| 31 g ai/ha | | | | | | | | |
| Flood | 2 | 3 | 4 | 5 | 6 | 7 | 8 | |
| Barnyardgrass | 0 | 0 | 0 | 0 | 0 | 0 | 0 | |
| Ducksalad | 0 | 0 | 60 | 0 | 30 | 0 | 0 | |
| Rice | 0 | 0 | 0 | 0 | 0 | 0 | 0 | |
| Sedge, Umbrella | 0 | 0 | 75 | 50 | 60 | 0 | 0 | |

| 250 g ai/ha | Compounds | | 125 g ai/ha | Compounds | |
|---|---|---|---|---|---|
| Postemergence | 4 | 6 | Postemergence | 4 | 6 |
| Barley | 30 | 70 | Barley | 20 | 50 |
| Bermudagrass | 40 | 95 | Bermudagrass | 35 | 75 |
| Blackgrass | 10 | 60 | Blackgrass | 5 | 60 |
| Bromegrass, Downy | 15 | 60 | Bromegrass, Downy | 15 | 50 |
| Canarygrass | 60 | 90 | Canarygrass | 50 | 70 |
| Chickweed | 45 | 75 | Chickweed | 15 | 55 |
| Cocklebur | 85 | 100 | Cocklebur | 65 | 95 |
| Corn | 55 | 80 | Corn | 35 | 65 |
| Crabgrass, Large | 85 | 98 | Crabgrass, Large | 80 | 95 |
| Cupgrass, Woolly | 85 | 100 | Cupgrass, Woolly | 75 | 100 |
| Deadnettle | — | 100 | Deadnettle | — | 85 |
| Foxtail, Giant | 75 | 95 | Foxtail, Giant | 70 | 80 |
| Foxtail, Green | 70 | 98 | Foxtail, Green | 35 | 85 |
| Galium | — | 65 | Galium | — | 60 |
| Goosegrass | 65 | 98 | Goosegrass | 50 | 95 |
| Johnsongrass | 85 | 100 | Johnsongrass | 75 | 85 |
| Kochia | 90 | 45 | Kochia | 55 | 40 |
| Lambsquarters | 100 | 100 | Lambsquarters | 98 | 100 |
| Morningglory | 95 | 100 | Morningglory | 95 | 100 |
| Nutsedge, Yellow | 65 | 80 | Nutsedge, Yellow | 45 | 80 |
| Oat, Wild | 40 | 90 | Oat, Wild | 30 | 40 |
| Pigweed | 98 | 98 | Pigweed | 90 | 98 |
| Ragweed | 90 | 98 | Ragweed | 75 | 65 |
| Ryegrass, Italian | 10 | 45 | Ryegrass, Italian | 0 | 15 |
| Soybean | 75 | 95 | Soybean | 75 | 70 |
| Surinam Grass | 70 | 98 | Surinam Grass | 65 | 85 |
| Velvetleaf | 75 | 80 | Velvetleaf | 60 | 80 |
| Wheat | 35 | 60 | Wheat | 30 | 50 |
| Windgrass | 65 | 80 | Windgrass | 40 | 80 |
| 62 g ai/ha | Compounds | | 31 g ai/ha | Compounds | |
| Postemergence | 4 | 6 | Postemergence | 4 | 6 |
| Barley | 20 | 35 | Barley | 0 | 25 |
| Bermudagrass | 20 | 45 | Bermudagrass | 5 | 5 |
| Blackgrass | 5 | 55 | Blackgrass | 5 | 50 |
| Bromegrass, Downy | 10 | 35 | Bromegrass, Downy | 0 | 15 |
| Canarygrass | 40 | 55 | Canarygrass | 25 | 55 |
| Chickweed | 10 | 25 | Chickweed | 5 | 10 |
| Cocklebur | 25 | 75 | Cocklebur | 5 | 50 |
| Corn | 20 | 45 | Corn | 0 | 45 |
| Crabgrass, Large | 75 | 85 | Crabgrass, Large | 70 | 75 |
| Cupgrass, Woolly | 70 | 100 | Cupgrass, Woolly | 50 | 90 |
| Deadnettle | 15 | 85 | Deadnettle | 15 | 85 |
| Foxtail, Giant | 60 | 65 | Foxtail, Giant | 40 | 65 |
| Foxtail, Green | 35 | 70 | Foxtail, Green | 35 | 50 |
| Galium | 50 | 50 | Galium | 50 | 40 |
| Goosegrass | 45 | 80 | Goosegrass | 5 | 75 |
| Johnsongrass | 60 | 80 | Johnsongrass | 60 | 80 |
| Kochia | 45 | 40 | Kochia | 10 | 5 |
| Lambsquarters | 98 | 98 | Lambsquarters | 95 | 80 |
| Morningglory | 95 | 100 | Morningglory | 90 | 95 |
| Nutsedge, Yellow | 20 | 45 | Nutsedge, Yellow | 5 | 40 |
| Oat, Wild | 30 | 40 | Oat, Wild | 5 | 10 |
| Pigweed | 80 | 95 | Pigweed | 65 | 80 |
| Ragweed | 65 | 60 | Ragweed | 50 | 40 |
| Ryegrass, Italian | 0 | 5 | Ryegrass, Italian | 0 | 0 |
| Soybean | 60 | 65 | Soybean | 55 | 45 |
| Surinam Grass | 60 | 75 | Surinam Grass | 55 | 75 |
| Velvetleaf | 50 | 65 | Velvetleaf | 50 | 60 |
| Wheat | 20 | 45 | Wheat | 5 | 45 |
| Windgrass | 30 | 75 | Windgrass | 5 | 60 |

What is claimed is:

1. A compound selected from Formula 1, N-oxides, and salts thereof, 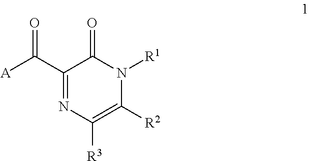
wherein
A is a radical selected from the group consisting of 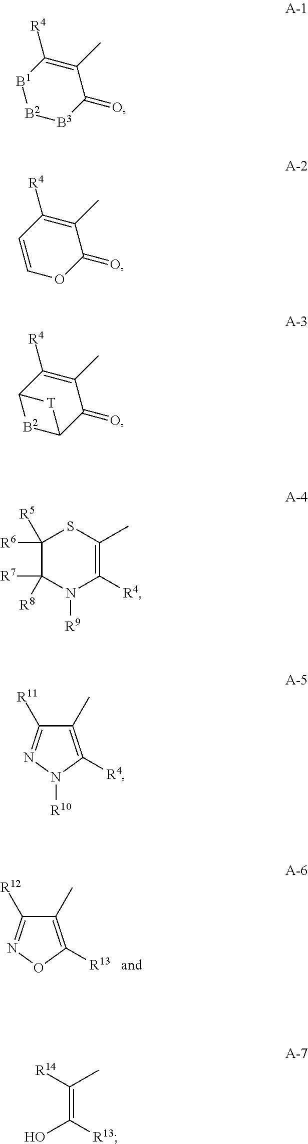
B¹ and B³ are each independently a radical selected from the group consisting of 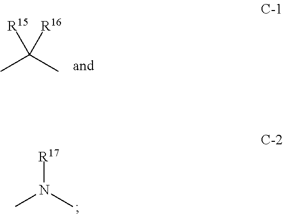
B² is a radical selected from the group consisting of 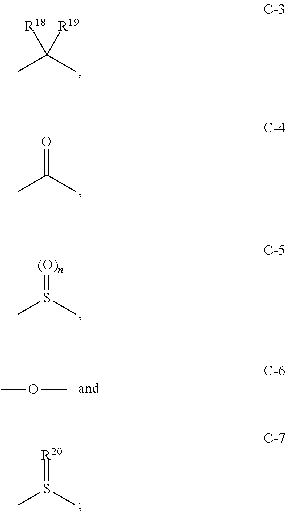
n is 0, 1 or 2;
T is C₁-C₆ alkylene or C₂-C₆ alkenylene;
R¹ is phenyl, phenylsulfonyl, —W¹(phenyl), —W¹(S-phenyl), —W¹(SO₂-phenyl), —W²(SO₂CH₂-phenyl) or —W²(SCH₂-phenyl), each optionally substituted on ring members with up to five substituents selected from R²¹; or -G¹ or —W²G²; or
cyano, C₂-C₁₀ cyanoalkyl, hydroxy, amino, —C(═O)OH, —C(═O)NHCN, —C(═O)NHOH, —SO₂NH₂, —SO₂NHCN, —SO₂NHOH, —NHCHO, C₁-C₁₀ alkyl, C₂-C₁₀ alkenyl, C₂-C₁₀ alkynyl, C₁-C₁₀ haloalkyl, C₂-C₁₀ haloalkenyl, C₂-C₁₂ haloalkynyl, C₃-C₁₂ cycloalkyl, C₃-C₁₂ halocycloalkyl, C₄-C₁₄ alkylcycloalkyl, C₄-C₁₄ cycloalkylalkyl, C₆-C₁₈ cycloalkylcycloalkyl, C₄-C₁₄ halocycloalkylalkyl, C₅-C₁₆ alkylcycloalkylalkyl, C₃-C₁₂ cycloalkenyl, C₃-C₁₂ halocycloalkenyl, C₂-C₁₂ alkoxyalkyl, C₃-C₁₂ alkoxyalkenyl, C₄-C₁₄ alkylcycloalkyl, C₄-C₁₄ alkoxycycloalkyl, C₄-C₁₄ cycloalkoxyalkyl, C₅-C₁₄ cycloalkoxyalkoxyalkyl, C₃-C₁₄ alkoxyalkoxyalkyl, C₂-C₁₂ alkylthioalkyl, C₂-C₁₂ alkylsulfinylalkyl, C₂-C₁₂ alkylsulfonylalkyl, C₂-C₁₂ alkylaminoalkyl, C₃-C₁₄ dialkylaminoalkyl, C₂-C₁₂ haloalkylaminoalkyl, C₄-C₁₄ cycloalkylaminoalkyl, C₂-C₁₂ alkylcarbonyl, C₂-C₁₂ haloalkylcarbonyl, C₄-C₁₄ cycloalkylcarbonyl, C₂-C₁₂ alkoxycarbonyl, C₄-C₁₆ cycloalkoxycarbonyl, C₅-C₁₄ cycloalkylalkoxycarbonyl, C₂-C₁₂ alkylaminocarbonyl, C₃-C₁₄ dialkylaminocarbonyl, C₄-C₁₄ cycloalkylaminocarbonyl, C₂-C₉ cyanoalkyl, C₁-C₁₀ hydroxyalkyl, C₄-C₁₄ cycloalkenylalkyl, C₂-C₁₂ haloalkoxyalkyl, C₂-C₁₂ alkoxyhaloalkyl, C₂-C₁₂ haloalkoxyhaloalkyl, C₄-C₁₄ halocycloalkoxyalkyl, C₄-C₁₄ cycloalkenyloxyalkyl, C₄-C₁₄ halocycloalkenyloxyalkyl, C₃-C₁₄ dialkoxyalkyl, C₃-C₁₄ alkoxyalkylcarbonyl, C₃-C₁₄ alkoxycarbonylalkyl, C₂-C₁₂ haloalkoxycarbonyl, C₁-C₁₀ alkoxy, C₁-C₁₀ haloalkoxy, C₃-C₁₂ cycloalkoxy, C₃-C₁₂ halocycloalkoxy, C₄-C₁₄ cycloalkylalkoxy, C₂-C₁₀ alkenyloxy, C₂-C₁₀ haloalkenyloxy, C₃-C₁₀ alkynyloxy, C₃-C₁₀ haloalkynyloxy, C₂-C₁₂ alkoxyalkoxy, C₂-C₁₂ alkylcarbonyloxy, C₂-C₁₂ haloalkylcarbonyloxy, C₄-C₁₄ cycloalkylcarbonyloxy, C₃-C₁₄ alkylcarbonylalkoxy, C₁-C₁₀ alkylthio, C₁-C₁₀ haloalkylthio, C₃-C₁₂ cycloalkylthio, C₁-C₁₀ alkylsulfonyl, C₁-C₁₀ haloalkylsulfinyl, C₁-C₁₀ alkylsulfonyl, C₁-C₁₀ haloalkylsulfonyl, C₃-C₁₂ cycloalkylsulfonyl, C₂-C₁₂ alkylcarbonylthio, C₂-C₁₂ alkyl(thiocarbonyl)thio, C₃-C₁₂ cycloalkylsulfinyl, C₁-C₁₀ alkylaminosulfonyl, C₂-C₁₂ dialkylaminosulfonyl, C₁-C₁₀ alkylamino, C₂-C₁₂ dialkylamino, C₁-C₁₀ haloalkylamino, C₂-C₁₂ halodialkylamino, C₃-C₁₂ cycloalkylamino, C₂-C₁₂ alkylcarbonylamino, C₂-C₁₂ haloalkylcarbonylamino, C₁-C₁₀ alkylsulfonylamino, C₁-C₁₀ haloalkylsulfonylamino or C₄-C₁₄ cycloalkyl(alkyl)amino; or 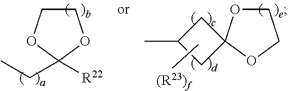
a is 2, 3 or 4;
b, c, d and e are independently 1 or 2;
f is an integer from 0 to 3;
W¹ is C₁-C₆ alkylene, C₂-C₆ alkenylene or C₂-C₆ alkynylene;
W² is C₁-C₆ alkylene;
R² is phenyl or —W³(phenyl), each optionally substituted on ring members with up to five substituents selected from R²¹; or -G³ or —W⁴G⁴; or H, cyano, hydroxy, amino, nitro, —CHO, —C(═O)OH, —C(═O)NH₂, —C(═S)NH₂, —C(═O)NHCN, —C(═O)NHOH, —SH, —SO₂NH₂, —SO₂NHCN, —SO₂NHOH, —SF₅, —NHCHO, —NHNH₂, —NHOH, —NHCN, —NHC(═O)NH₂, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl, C₃-C₈ halocycloalkyl, C₄-C₁₀ alkylcycloalkyl, C₄-C₁₀ cycloalkylalkyl, C₆-C₁₄ cycloalkylcycloalkyl, C₄-C₁₀ halocycloalkylalkyl, C₅-C₁₂ alkylcycloalkylalkyl, C₃-C₈ cycloalkenyl, C₃-C₈ halocycloalkenyl, C₂-C₈ alkoxyalkyl, C₃-C₁₀ alkoxyalkenyl, C₄-C₁₀ cycloalkoxyalkyl, C₃-C₁₀ alkoxyalkoxyalkyl, C₂-C₈ alkylthioalkyl, C₂-C₈ alkylsulfinylalkyl, C₂-C₈ alkylsulfonylalkyl, C₂-C₈ alkylaminoalkyl, C₃-C₁₀ dialkylaminoalkyl, C₂-C₈ haloalkylaminoalkyl, C₄-C₁₀ cycloalkylaminoalkyl, C₂-C₈ alkylcarbonyl, C₂-C₈ haloalkylcarbonyl, C₄-C₁₀ cycloalkylcarbonyl, C₂-C₈ alkoxycarbonyl, C₄-C₁₀ cycloalkoxycarbonyl, C₅-C₁₂ cycloalkylalkoxycarbonyl, C₂-C₈ alkylaminocarbonyl, C₃-C₁₀ dialkylaminocarbonyl, C₄-C₁₀ cycloalkylaminocarbonyl, C₂-C₅ cyanoalkyl, C₁-C₆ hydroxyalkyl, C₄-C₁₀ cycloalkenylalkyl, C₂-C₈ haloalkoxyalkyl, C₂-C₈ alkoxyhaloalkyl, C₂-C₈ haloalkoxyhaloalkyl, C₄-C₁₀ halocycloalkoxyalkyl, C₄-C₁₀ cycloalkenyloxyalkyl, C₄-C₁₀ halocycloalkenyloxyalkyl, C₃-C₁₀ dialkoxyalkyl, C₃-C₁₀ alkoxyalkylcarbonyl, C₃-C₁₀ alkoxycarbonylalkyl, C₂-C₈ haloalkoxycarbonyl, C₁-C₆ alkoxy, C₁-C₆ haloalkoxy, C₃-C₈ cycloalkoxy, C₃-C₈ halocycloalkoxy, C₄-C₁₀ cycloalkylalkoxy, C₂-C₆ alkenyloxy, C₂-C₆ haloalkenyloxy, C₃-C₆ alkynyloxy, C₃-C₆ haloalkynyloxy, C₂-C₈ alkoxyalkoxy, C₂-C₈ alkylcarbonyloxy, C₂-C₈ haloalkylcarbonyloxy, C₄-C₁₀ cycloalkylcarbonyloxy, C₃-C₁₀ alkylcarbonylalkoxy, C₁-C₆ alkylthio, C₁-C₆ haloalkylthio, C₃-C₈ cycloalkylthio, C₁-C₆ alkylsulfinyl, C₁-C₆ haloalkylsulfinyl, C₁-C₆ alkylsulfonyl, C₁-C₆ haloalkylsulfonyl, C₃-C₈ cycloalkylsulfonyl, C₃-C₈ trialkylsilyl, C₃-C₈ cycloalkenyloxy, C₃-C₈ halocycloalkenyloxy, C₂-C₈ haloalkoxyalkoxy, C₂-C₈ alkoxyhaloalkoxy, C₂-C₈ haloalkoxyhaloalkoxy, C₃-C₁₀ alkoxycarbonylalkoxy, C₂-C₈ alkyl(thiocarbonyl)oxy, C₂-C₈ alkylcarbonylthio, C₂-C₈ alkyl(thiocarbonyl)thio, C₃-C₈ cycloalkylsulfinyl, C₁-C₆ alkylaminosulfonyl, C₂-C₈ dialkylaminosulfonyl, C₃-C₁₀ halotrialkylsilyl, C₁-C₆ alkylamino, C₂-C₈ dialkylamino, C₁-C₆ haloalkylamino, C₂-C₈ halodialkylamino, C₃-C₈ cycloalkylamino, C₂-C₈ alkylcarbonylamino, C₂-C₈ haloalkylcarbonylamino, C₁-C₆ alkylsulfonylamino, C₁-C₆ haloalkylsulfonylamino or C₄-C₁₀ cycloalkyl(alkyl)amino; or
R¹ and R² are taken together with the atoms linking R¹ and R² to form a fused 5-, 6- or 7-membered ring containing ring members selected from carbon atoms, 1 to 3 nitrogen atoms, and optionally up to 2 oxygen atoms and up to 2 sulfur atoms, wherein up to 2 carbon atom ring members are selected from C(═O), and the sulfur atom ring members are independently selected from S(═O)ₘ; the ring optionally substituted on carbon atom ring members with substituents selected from R²⁴; and optionally substituted on nitrogen atom ring members with substituents selected from R²⁵;
each m is independently 0, 1 or 2;
W³ is C₁-C₆ alkylene, C₂-C₆ alkenylene or C₂-C₆ alkynylene;
W⁴ is C₁-C₆ alkylene;
R³ is H, halogen, cyano, nitro, C₁-C₆ alkyl, C₁-C₆ haloalkyl, C₁-C₆ alkoxy, C₁-C₆ haloalkoxy, C₁-C₆ alkylthio, C₁-C₆ haloalkylthio, C₁-C₆ alkylsulfinyl, C₁-C₆ haloalkylsulfinyl, C₁-C₆ alkylsulfonyl or C₁-C₆ haloalkylsulfonyl;
R⁴ is H, halogen, cyano, hydroxy, —O⁻M⁺, amino, nitro, —CHO, —C(═O)OH, —C(═O)NH₂, —C(═S)NH₂, —SH, —SO₂NH₂, —SO₂NHCN, —SO₂NHOH, —OCN, —SCN, —SF₅, —NHNH₂, —NHOH, —N═C═O, —N═C═S, C₁-C₆ alkoxy, C₁-C₆ haloalkoxy, C₃-C₈ cycloalkoxy, C₃-C₈ halocycloalkoxy, C₄-C₁₀ cycloalkylalkoxy, C₂-C₆ alkenyloxy, C₂-C₆ haloalkenyloxy, C₃-C₆ alkynyloxy, C₃-C₆ haloalkynyloxy, C₂-C₈ alkoxyalkoxy, C₂-C₈ alkylcarbonyloxy, C₂-C₈ haloalkylcarbonyloxy, C₄-C₁₀ cycloalkylcarbonyloxy, C₃-C₁₀ alkylcarbonylalkoxy, C₁-C₆ alkylthio, C₁-C₆ haloalkylthio, C₃-C₈ cycloalkylthio, C₁-C₆ alkylsulfinyl, C₁-C₆ haloalkylsulfinyl, C₁-C₆ alkylsulfonyl, C₁-C₆ haloalkylsulfonyl, C₃-C₈ cycloalkylsulfonyl, C₁-C₆ alkylsulfonyloxy, C₁-C₆ alkylamino, C₂-C₈ dialkylamino, C₁-C₆ haloalkylamino, C₂-C₈ halodialkylamino, C₃-C₈ cycloalkylamino, C₂-C₈ alkylcarbonylamino, C₂-C₈ haloalkylcarbonylamino, C₁-C₆ alkylsulfonylamino or C₁-C₆ haloalkylsulfonylamino; or benzyloxy, phenyloxy, benzylcarbonyloxy, phenylcarbonyloxy, phenylsulfonyloxy, benzylsulfonyloxy, phenylthio, benzylthio, phenylsulfinyl, benzylsulfinyl, phenylsulfonyl or benzylsulfonyl, each optionally substituted on ring members with up to five substituents selected from R²¹;
M⁺ is an alkali metal cation or an ammonium cation;
R⁵, R⁶, R⁷ and R⁸ are each independently H, halogen, hydroxy, C₁-C₆ alkyl, C₂-C₆ alkenyl, C₂-C₆ alkynyl, C₁-C₆ haloalkyl, C₁-C₆ alkoxy, C₁-C₆ haloalkoxy, C₃-C₈ cycloalkoxy or C₃-C₈ halocycloalkoxy; or phenyl or benzyl, each optionally substituted on ring members with up to five substituents selected from R²¹;
R⁹ is H, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl or C₃-C₈ halocycloalkyl; or benzyl optionally substituted on ring members with up to five substituents selected from R²¹;
R¹⁰ is H, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl, C₃-C₈ halocycloalkyl, C₄-C₁₀ alkylcycloalkyl, C₄-C₁₀ cycloalkylalkyl, C₆-C₁₄ cycloalkylcycloalkyl, C₄-C₁₀ halocycloalkylalkyl, C₅-C₁₂ alkylcycloalkylalkyl, C₃-C₈ cycloalkenyl, C₃-C₈ halocycloalkenyl, C₂-C₈ alkoxyalkyl, C₄-C₁₀ cycloalkoxyalkyl, C₃-C₁₀ alkoxyalkoxyalkyl or C₂-C₈ alkylthioalkyl;
R¹¹ is H, halogen, cyano, hydroxy, amino, nitro, SH, —SO₂NH₂, —SO₂NHCN, —SO₂NHOH, —OCN, —SCN, —SF₅, —NHCHO, —NHNH₂, —N₃, —NHOH, —NHCN, —NHC(═O)NH₂, —N═C═O, —N═C═S, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl, C₃-C₈ halocycloalkyl, C₄-C₁₀ alkylcycloalkyl, C₄-C₁₀ cycloalkylalkyl, C₆-C₁₄ cycloalkylcycloalkyl, C₄-C₁₀ halocycloalkylalkyl, C₅-C₁₂ alkylcycloalkylalkyl, C₃-C₈ cycloalkenyl, C₃-C₈ halocycloalkenyl, C₂-C₈ alkoxyalkyl, C₄-C₁₀ cycloalkoxyalkyl, C₃-C₁₀ alkoxyalkoxyalkyl or C₂-C₈ alkylthioalkyl;
R¹² is H, halogen, cyano, hydroxy, amino, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl, C₃-C₈ halocycloalkyl, C₄-C₁₀ alkylcycloalkyl, C₄-C₁₀ cycloalkylalkyl, C₄-C₁₀ halocycloalkylalkyl, C₅-C₁₂ alkylcycloalkylalkyl, C₃-C₈ cycloalkenyl, C₃-C₈ halocycloalkenyl, C₂-C₈ alkoxyalkyl, C₄-C₁₀ cycloalkoxyalkyl, C₃-C₁₀ alkoxyalkoxyalkyl, C₂-C₈ alkylthioalkyl, C₂-C₈ alkylsulfinylalkyl or C₂-C₈ alkylsulfonylalkyl; or phenyl optionally substituted with up to five substituents selected from R²¹;
R¹³ is H, halogen, cyano, hydroxy, amino, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl, C₃-C₈ halocycloalkyl, C₄-C₁₀ alkylcycloalkyl, C₄-C₁₀ cycloalkylalkyl, C₆-C₁₄ cycloalkylcycloalkyl, C₄-C₁₀ halocycloalkylalkyl, C₅-C₁₂ alkylcycloalkylalkyl, C₃-C₈ cycloalkenyl, C₃-C₈ halocycloalkenyl or C₂-C₈ alkoxycarbonylamino;
R¹⁴ is H, halogen, cyano, hydroxy, amino, nitro or C₂-C₈ alkoxycarbonyl;
each R¹⁵, R¹⁶, R¹⁸ and R¹⁹ is independently H, halogen, cyano, hydroxy or C₁-C₆ alkyl; or
a pair of R¹⁵ and R¹⁸ is taken together as C₂-C₆ alkylene or C₂-C₆ alkenylene;
R¹⁷ and R²⁰ are independently H, C₁-C₆ haloalkyl, C₂-C₆ haloalkenyl, C₁-C₆ alkoxy, C₁-C₆ haloalkoxy, C₃-C₈ cycloalkoxy, C₁-C₆ alkyl, C₂-C₆ alkenyl, C₂-C₆ alkynyl or C₃-C₈ cycloalkyl;
G¹, G², G³ and G⁴ are independently a 5- or 6-membered heterocyclic ring or an 8-, 9- or 10-membered fused bicyclic ring system, each ring or ring system optionally substituted with up to five substituents selected from R²¹ on carbon ring members and R²⁶ on nitrogen ring members;
each R²¹ is independently halogen, cyano, hydroxy, amino, nitro, —CHO, —C(═O)OH, —C(═O)NH₂, —C(═S)NH₂, —C(═O)NHCN, —C(═O)NHOH, —SH, —SO₂NH₂, —SO₂NHCN, —SO₂NHOH, —OCN, —SCN, —SF₅, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl, C₃-C₈ halocycloalkyl, C₄-C₁₀ alkylcycloalkyl, C₄-C₁₀ cycloalkylalkyl, C₃-C₈ cycloalkenyl, C₃-C₈ halocycloalkenyl, C₂-C₈ alkoxyalkyl, C₄-C₁₀ cycloalkoxyalkyl, C₃-C₁₀ alkoxyalkoxyalkyl, C₂-C₈ alkylthioalkyl, C₂-C₈ alkylsulfinylalkyl, C₂-C₈ alkoxyhaloalkyl, C₂-C₅ cyanoalkyl, C₁-C₆ hydroxyalkyl, C₁-C₆ alkoxy, C₁-C₆ haloalkoxy, C₃-C₈ cycloalkoxy, C₃-C₈ halocycloalkoxy, C₄-C₁₀ cycloalkylalkoxy, C₂-C₆ alkenyloxy, C₂-C₆ haloalkenyloxy, C₂-C₈ alkoxyalkoxy, C₂-C₈ alkylcarbonyloxy, C₁-C₆ alkylthio, C₁-C₆ haloalkylthio, C₃-C₈ cycloalkylthio, C₁-C₆ alkylsulfinyl, C₁-C₆ haloalkylsulfinyl, C₁-C₆ alkylsulfonyl, C₁-C₆ haloalkylsulfonyl, C₃-C₈ cycloalkylsulfonyl, C₁-C₆ alkylamino, C₂-C₈ dialkylamino, C₁-C₆ haloalkylamino, C₂-C₈ halodialkylamino or C₃-C₈ cycloalkylamino;
R²² is H or C₁-C₃ alkyl;
each R²³ is independently halogen, cyano, hydroxy, amino, nitro, —CHO, —C(═O)OH, —C(═O)NH₂, —C(═S)NH₂, —C(═O)NHCN, —C(═O)NHOH, —SH, —SO₂NH₂, —SO₂NHCN, —SO₂NHOH, —OCN, —SCN, —SF₅, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl, C₃-C₈ halocycloalkyl, C₄-C₁₀ alkylcycloalkyl, C₄-C₁₀ cycloalkylalkyl, C₃-C₈ cycloalkenyl, C₃-C₈ halocycloalkenyl, C₂-C₈ alkoxyalkyl, C₄-C₁₀ cycloalkoxyalkyl, C₃-C₁₀ alkoxyalkoxyalkyl, C₂-C₈ alkylthioalkyl, C₂-C₈ alkylsulfinylalkyl, C₂-C₈ alkoxyhaloalkyl, C₂-C₅ cyanoalkyl, C₁-C₆ hydroxyalkyl, C₁-C₆ alkoxy, C₁-C₆ haloalkoxy, C₃-C₈ cycloalkoxy, C₃-C₈ halocycloalkoxy, C₄-C₁₀ cycloalkylalkoxy, C₂-C₆ alkenyloxy, C₂-C₆ haloalkenyloxy, C₂-C₈ alkoxyalkoxy, C₂-C₈ alkylcarbonyloxy, C₁-C₆ alkylthio, C₁-C₆ haloalkylthio, C₃-C₈ cycloalkylthio, C₁-C₆ alkylsulfinyl, C₁-C₆ haloalkylsulfinyl, C₁-C₆ alkylsulfonyl, C₁-C₆ haloalkylsulfonyl, C₃-C₈ cycloalkylsulfonyl, C₁-C₆ alkylamino, C₂-C₈ dialkylamino, C₁-C₆ haloalkylamino, C₂-C₈ halodialkylamino or C₃-C₈ cycloalkylamino;
each R²⁴ is independently halogen, cyano, C₁-C₆ alkyl, C₂-C₆ alkenyl, C₂-C₆ alkynyl, C₁-C₆ haloalkyl, C₃-C₈ cycloalkyl or C₂-C₈ alkoxyalkyl; or phenyl optionally substituted with up to 5 substituents independently selected from cyano, nitro, halogen, C₁-C₆ alkyl, C₁-C₆ alkoxy and C₁-C₆ haloalkoxy;
each R²⁵ is independently C₁-C₆ alkyl; or phenyl optionally substituted with up to 5 substituents independently selected from cyano, nitro, halogen, C₁-C₆ alkyl, C₁-C₆ alkoxy and C₁-C₆ haloalkoxy; and
each R²⁶ is independently C₁-C₆ alkyl, C₂-C₆ alkenyl, C₂-C₆ alkynyl, C₁-C₆ haloalkyl, C₃-C₈ cycloalkyl or C₂-C₈ alkoxyalkyl.

2. The compound of claim 1 wherein
A is A-1, A-3, A-4, A-5 or A-6;
R¹ is phenyl, phenylsulfonyl, —W¹(phenyl), —W¹(S-phenyl), —W¹(SO₂-phenyl), —W²(SO₂CH₂-phenyl) or —W²(SCH₂-phenyl), each optionally substituted on ring members with up to five substituents selected from R²¹; or -G¹ or —W²G²; or cyano, C₂-C₁₀ cyanoalkyl, hydroxy, amino, —C(═O)OH, —C(═O)NHCN, —C(═O)NHOH, —SO₂NH₂, —SO₂NHCN, —SO₂NHOH, —NHCHO, C₁-C₁₀ alkyl, C₂-C₁₀ alkenyl, C₂-C₁₀ alkynyl, C₁-C₁₀ haloalkyl, C₂-C₁₀ haloalkenyl, C₂-C₁₂ haloalkynyl, C₃-C₁₂ cycloalkyl, C₃-C₁₂ halocycloalkyl, C₄-C₁₄ alkylcycloalkyl, C₄-C₁₄ cycloalkylalkyl, C₆-C₁₈ cycloalkylcycloalkyl, C₄-C₁₄ halocycloalkylalkyl, C₅-C₁₆ alkylcycloalkylalkyl, C₃-C₁₂ cycloalkenyl, C₃-C₁₂ halocycloalkenyl, C₂-C₁₂ alkoxyalkyl, C₃-C₁₂ alkoxyalkenyl, C₄-C₁₄ alkylcycloalkyl, C₄-C₁₄ alkoxycycloalkyl, C₄-C₁₄ cycloalkoxyalkyl, C₅-C₁₄ cycloalkoxyalkoxyalkyl, C₃-C₁₄ alkoxyalkoxyalkyl, C₂-C₁₂ alkylthioalkyl, C₂-C₁₂ alkylsulfinylalkyl, C₂-C₁₂ alkylsulfonylalkyl, C₂-C₁₂ alkylaminoalkyl, C₃-C₁₄ dialkylaminoalkyl, C₂-C₁₂ haloalkylaminoalkyl, C₄-C₁₄ cycloalkylaminoalkyl, C₂-C₁₂ alkylcarbonyl, C₂-C₁₂ haloalkylcarbonyl, C₄-C₁₄ cycloalkylcarbonyl, C₂-C₁₂ alkoxycarbonyl, C₄-C₁₆ cycloalkoxycarbonyl, C₅-C₁₄ cycloalkylalkoxycarbonyl, C₂-C₁₂ alkylaminocarbonyl, C₃-C₁₄ dialkylaminocarbonyl, C₄-C₁₄ cycloalkylaminocarbonyl, C₂-C₉ cyanoalkyl, C₁-C₁₀ hydroxyalkyl, C₄-C₁₄ cycloalkenylalkyl, C₂-C₁₂ haloalkoxyalkyl, C₂-C₁₂ alkoxyhaloalkyl, C₂-C₁₂ haloalkoxyhaloalkyl, C₄-C₁₄ halocycloalkoxyalkyl, C₄-C₁₄ cycloalkenyloxyalkyl, C₄-C₁₄ halocycloalkenyloxyalkyl, C₃-C₁₄ dialkoxyalkyl, C₃-C₁₄ alkoxyalkylcarbonyl, C₃-C₁₄ alkoxycarbonylalkyl or C₂-C₁₂ haloalkoxycarbonyl;
R² is phenyl or —W³(phenyl), each optionally substituted on ring members with up to five substituents selected from R²¹; or -G³; C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl, C₃-C₈ halocycloalkyl, C₄-C₁₀ alkylcycloalkyl, C₄-C₁₀ cycloalkylalkyl, C₆-C₁₄ cycloalkylcycloalkyl, C₄-C₁₀ halocycloalkylalkyl, C₅-C₁₂ alkylcycloalkylalkyl, C₃-C₈ cycloalkenyl, C₃-C₈ halocycloalkenyl, C₂-C₈ alkoxyalkyl, C₃-C₁₀ alkoxyalkenyl, C₄-C₁₀ cycloalkoxyalkyl, C₃-C₁₀ alkoxyalkoxyalkyl, C₂-C₈ alkylthioalkyl, C₂-C₈ alkylsulfinylalkyl, C₂-C₈ alkylsulfonylalkyl, C₂-C₈ alkylcarbonyl, C₄-C₁₀ cycloalkenylalkyl, C₂-C₈ haloalkoxyalkyl, C₂-C₈ alkoxyhaloalkyl, C₂-C₈ haloalkoxyhaloalkyl, C₄-C₁₀ halocycloalkoxyalkyl, C₄-C₁₀ cycloalkenyloxyalkyl, C₄-C₁₀ halocycloalkenyloxyalkyl, C₃-C₁₀ dialkoxyalkyl, C₁-C₆ alkoxy, C₁-C₆ haloalkoxy, C₃-C₈ cycloalkoxy, C₃-C₈ halocycloalkoxy, C₄-C₁₀ cycloalkylalkoxy, C₂-C₆ alkenyloxy, C₂-C₆ haloalkenyloxy, C₃-C₆ alkynyloxy, C₃-C₆ haloalkynyloxy, C₂-C₈ alkoxyalkoxy, C₂-C₈ alkylcarbonyloxy, C₂-C₈ haloalkylcarbonyloxy, C₄-C₁₀ cycloalkylcarbonyloxy, C₃-C₁₀ alkylcarbonylalkoxy, C₁-C₆ alkylthio, C₁-C₆ haloalkylthio, C₃-C₈ cycloalkylthio, C₁-C₆ alkylsulfinyl, C₁-C₆ haloalkylsulfinyl, C₁-C₆ alkylsulfonyl, C₁-C₆ haloalkylsulfonyl, C₃-C₈ cycloalkylsulfonyl, C₃-C₈ trialkylsilyl, C₃-C₈ cycloalkenyloxy, C₃-C₈ halocycloalkenyloxy, C₂-C₈ haloalkoxyalkoxy, C₂-C₈ alkoxyhaloalkoxy, C₂-C₈ haloalkoxyhaloalkoxy, C₃-C₁₀ alkoxycarbonylalkoxy, C₂-C₈ alkyl(thiocarbonyl)oxy, C₃-C₈ cycloalkylsulfinyl or C₃-C₁₀ halotrialkylsilyl; or
R¹ and R² are taken together with the atoms linking R¹ and R² to form a fused 6- or 7-membered ring containing ring members selected from carbon atoms, 1 to 3 nitrogen atoms, and optionally up to 2 oxygen atoms and up to 2 sulfur atoms, wherein up to 2 carbon atom ring members are selected from C(═O), and the sulfur atom ring members are independently selected from S(═O)ₘ; the ring optionally substituted on carbon atom ring members with substituents selected from R²⁴; and optionally substituted on nitrogen atom ring members with substituents selected from R²⁵;
R³ is H, halogen or methyl;
R⁴ is hydroxy, —O⁻M⁺, C₂-C₈ alkylcarbonyloxy, C₂-C₈ haloalkylcarbonyloxy, C₄-C₁₀ cycloalkylcarbonyloxy or C₃-C₁₀ alkylcarbonylalkoxy; or benzyloxy, phenyloxy, benzylcarbonyloxy, phenylcarbonyloxy, phenylsulfonyloxy or benzylsulfonyloxy, each optionally substituted on ring members with up to two substituents selected from R²¹;
M⁺ is a sodium or potassium cation;
R¹⁰ is C₁-C₆ alkyl;
R¹¹ is H, halogen or C₁-C₆ alkyl;
R¹² is H or C₁-C₆ alkyl;
R¹³ is H, halogen, cyano, hydroxy, amino or C₁-C₆ alkyl;
R¹⁴ is cyano or nitro;
each R¹⁵, R¹⁶, R¹⁸ and R¹⁹ is independently H or CH₃;
R¹⁷ and R²⁰ are independently H or CH₃;
W¹ is C₁-C₆ alkylene;
W² is —CH₂—;
W³ is —CH₂—;
W⁴ is —CH₂—;
T is —CH₂CH₂— or —CH═CH—;
G¹, G², G³ and G⁴ are independently selected from 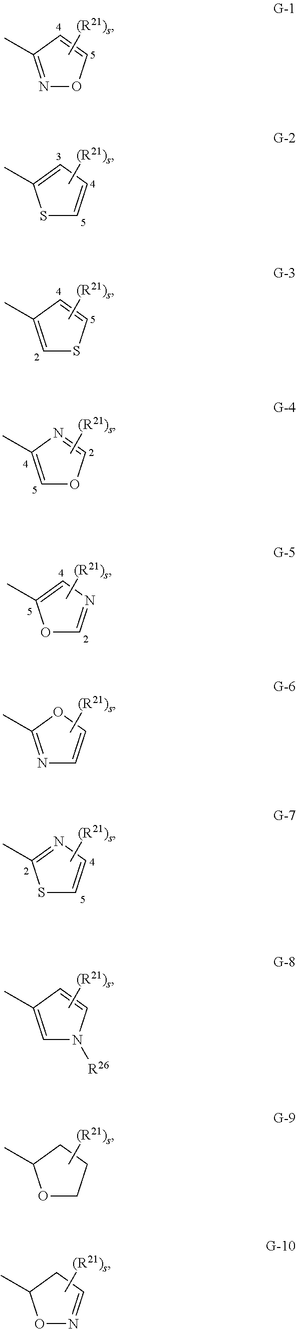 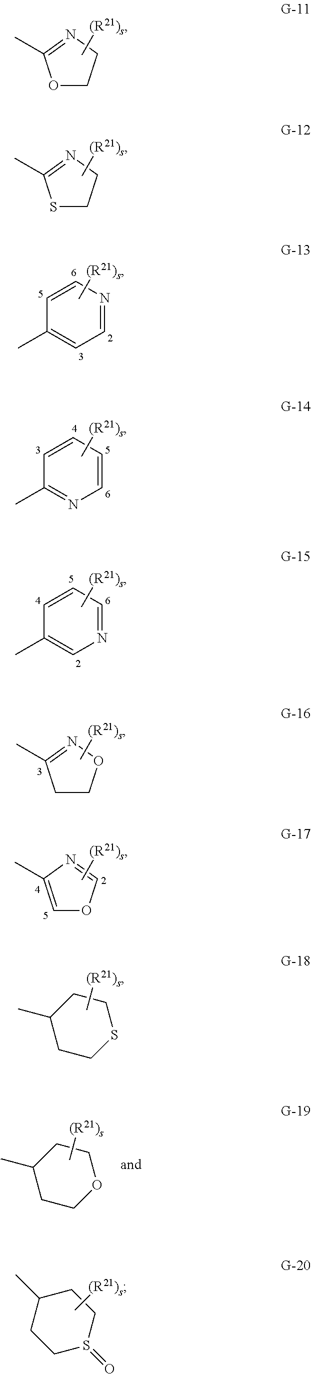
s is 0, 1, 2 or 3;
each R²¹ is independently halogen, cyano, hydroxy, nitro, —CHO, —SH, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl, C₃-C₈ halocycloalkyl, C₄-C₁₀ alkylcycloalkyl, C₄-C₁₀ cycloalkylalkyl, C₃-C₈ cycloalkenyl, C₃-C₈ halocycloalkenyl, C₂-C₈ alkoxyalkyl, C₄-C₁₀ cycloalkoxyalkyl, C₃-C₁₀ alkoxyalkoxyalkyl, C₂-C₈ alkylthioalkyl, C₂-C₈ alkylsulfinylalkyl, C₂-C₈ alkoxyhaloalkyl, C₂-C₅ cyanoalkyl, C₁-C₆ hydroxyalkyl, C₁-C₆ alkoxy, C₁-C₆ haloalkoxy, C₃-C₈ cycloalkoxy, C₃-C₈ halocycloalkoxy, C₄-C₁₀ cycloalkylalkoxy, C₂-C₆ alkenyloxy, C₂-C₆ haloalkenyloxy, C₂-C₈ alkoxyalkoxy, C₂-C₈ alkylcarbonyloxy, C₁-C₆ alkylthio, C₁-C₆ haloalkylthio, C₃-C₈ cycloalkylthio, C₁-C₆ alkylsulfinyl, C₁-C₆ haloalkylsulfinyl, C₁-C₆ alkylsulfonyl, C₁-C₆ haloalkylsulfonyl or C₃-C₈ cycloalkylsulfonyl; and
each R²⁶ is independently C₁-C₆ alkyl or C₁-C₆ haloalkyl.

3. A compound of claim 2 wherein
A is A-1, A-3 or A-5;
B¹ is C-1;
B² is C-3;
B³ is C-1;
R¹ is phenyl, —W¹(phenyl), —W¹(S-phenyl), —W¹(SO₂-phenyl), —W²(SO₂CH₂-phenyl) or —W²(SCH₂-phenyl), each optionally substituted on ring members with up to five substituents selected from R²¹; or -G¹ or —W²G²; or C₁-C₆ alkyl, C₂-C₆ alkenyl, C₂-C₆ alkynyl, C₁-C₆ haloalkyl, C₂-C₆ haloalkenyl, C₃-C₈ cycloalkyl, C₄-C₁₀ cycloalkylalkyl, C₅-C₁₂ alkylcycloalkylalkyl, C₃-C₈ cycloalkenyl, C₃-C₈ halocycloalkenyl, C₂-C₈ alkoxyalkyl, C₃-C₁₀ alkoxyalkenyl, C₄-C₁₀ alkylcycloalkyl, C₄-C₁₀ alkoxycycloalkyl, C₃-C₁₀ alkoxyalkoxyalkyl, C₂-C₈ alkylthioalkyl, C₂-C₁₂ alkylsulfinylalkyl or C₂-C₈ alkylsulfonylalkyl;
W¹ is —CH₂—;
R² is phenyl or —W³(phenyl), each optionally substituted on ring members with up to two substituents selected from R²¹; or -G³; or C₁-C₆ alkyl or C₃-C₈ cycloalkyl;
R³ is H or halogen;
R⁴ is hydroxy or C₂-C₈ alkylcarbonyloxy;
R¹⁰ is CH₂CH₃;
R¹¹ is H or CH₃;
G¹, G², G³ and G⁴ are independently G-2, G-3, G-9, G-15, G-18, G-19 or G-20; and
each R²¹ is independently halogen, nitro, C₁-C₆ alkyl, C₁-C₆ haloalkyl, C₁-C₆ alkoxy, C₁-C₆ haloalkoxy or C₁-C₆ alkylthio.

4. A compound of claim 3 wherein
A is A-1 or A-3;
R¹ is phenyl, 2-fluorophenyl, 3-fluorophenyl, 4-fluorophenyl, 2-chlorophenyl, 3-chlorophenyl, 4-chlorophenyl, 4-methylphenyl, 4-ethylphenyl, 2-methylphenyl, 3-methoxyphenyl, 4-methoxyphenyl, 3,5-dimethylphenyl, 3,4-dimethoxyphenyl, 2,3-dimethylphenyl, 3-fluoro-2-methylphenyl, 4-fluoro-3-methylphenyl or 5-chloro-2-methylphenyl;
R² is phenyl, 2-methylphenyl, 3-methylphenyl, 3-bromophenyl, 3-chlorophenyl, 4-chlorophenyl, 3-fluorophenyl or 3,5-difluorophenyl;
R³ is H, F or Cl;
R⁴ is hydroxy or —OC(═O)CH₂CH(CH₃)₂; and
T is —CH₂CH₂—.

5. A compound of claim 4 wherein
A is A-1;
R¹ is phenyl, 4-ethylphenyl, 4-methoxyphenyl, 3,5-dimethylphenyl, 3,4-dimethoxyphenyl, 3-fluoro-2-methylphenyl, 4-fluoro-3-methylphenyl or 5-chloro-2-methylphenyl;
R² is phenyl, 3-chlorophenyl, or 2-methylphenyl; and
each R¹⁴, R¹⁵, R¹⁸ and R¹⁹ is H.

6. A compound of claim 3 wherein
A is A-3;
R¹ is n-propyl or —CH₂CH₂OCH₃;
R² is phenyl, 2-methylphenyl, 3-methylphenyl, 4-chlorophenyl, 3-fluorophenyl or 3,5-difluorophenyl;
R³ is H, F or Cl;
R⁴ is hydroxy; and
each R¹⁵, R¹⁶, R¹⁸ and R¹⁹ is H.

7. A compound of claim 3 wherein
A is A-1;
R¹ is -G¹ or —W²G²; or C₁-C₆ alkyl, C₃-C₈ cycloalkyl, or C₂-C₈ alkoxyalkyl;
G¹ is G-19 or G-20;
R² is phenyl, 2-methylphenyl, 3-methylphenyl, 4-chlorophenyl, 3-fluorophenyl or 3,5-difluorophenyl;
R³ is H, F or Cl;
R⁴ is hydroxy; and
each R¹⁵, R¹⁶, R¹⁸ and R¹⁹ is H.

8. A compound of claim 3 wherein
A is A-1;
R¹ is n-propyl, cyclohexyl, —CH₂CH₂OCH₃ or —CH₂CH₂CH₂OCH₃;
R² is 3-thienyl or 2-thienyl;
R³ is H, F or Cl;
R⁴ is hydroxy; and
each R¹⁵, R¹⁶, R¹⁸ and R¹⁹ is H.

9. A compound of Formula 1 in claim 1 that is
1-butyl-3-[(2-hydroxy-6-oxo-1-cyclohexen-1-yl)carbonyl]-6-phenyl-2(1H)-pyrazinone,
5-chloro-1-cyclohexyl-6-(3-fluorophenyl)-3-[(2-hydroxy-6-oxo-1-cyclohexen-1-yl)carbonyl]-2 (1H)pyrazinone,
5-chloro-6-(3-chlorophenyl)-1-cyclohexyl-3-[(2-hydroxy-6-oxo-1-cyclohexen-1-yl)carbonyl]-2 (1H)-pyrazinone,
5-chloro-6-(3-fluorophenyl)-3-[(2-hydroxy-6-oxo-1-cyclohexen-1-yl)carbonyl]-1-(2-methoxyethyl)-2(1H)pyrazinone,
6-(3,5-difluorophenyl)-3-[(2-hydroxy-6-oxo-1-cyclohexen-1-yl)carbonyl]-1-(2-methoxyethyl)-2(1H)-pyrazinone,
5-chloro-6-(3,5-difluorophenyl)-3-[(2-hydroxy-6-oxo-1-cyclohexen-1-yl)carbonyl]-1-(2-methoxyethyl)-2(1H)pyrazinone or
5-chloro-6-(3-fluorophenyl)-3-[(2-hydroxy-6-oxo-1-cyclohexen-1-yl)carbonyl]-1-(2-methoxyethyl)-2(1H)pyrazinone.

10. A herbicidal mixture comprising (a) a compound of claim 1 and (b) at least one additional active ingredient compound selected from (b1) photosystem II inhibitors, (b2) acetohydroxy acid synthase inhibitors, (b3) acetyl-CoA carboxylase inhibitors, (b4) auxin mimics and (b5) 5-enol-pyruvylshikimate-3-phosphate synthase inhibitors, (b6) photosystem I electron diverters, (b7) protoporphyrinogen oxidase inhibitors, (b8) glutamine synthetase inhibitors, (b9) very long chain fatty acid elongase inhibitors, (b10) auxin transport inhibitors, (b11) phytoene desaturase inhibitors, (b12) 4-hydroxyphenyl-pyruvate dioxygenase inhibitors, (b13) homogentisate solenesyltransererase inhibitors, (b14) other herbicides including mitotic disruptors, organic arsenicals, asulam, difenzoquat, bromobutide, flurenol, cinmethylin, cumyluron, dazomet, dymron, methyldymron, etobenzanid, fosamine, fosamine-ammonium, metam, oxaziclomefone, oleic acid, pelargonic acid and pyributicarb, and (b15) herbicide safeners; and salts of compounds of (b1) through (b15).

11. The herbicidal mixture of claim 10 wherein component (b) comprises at least one active ingredient compound selected from (b1) photosystem II inhibitors.

12. The herbicidal mixture of claim 11 wherein component (b) comprises bromoxynil.

13. The herbicidal mixture of claim 11 wherein component (b) comprises dimethametryn.

14. The herbicidal mixture of claim 10 wherein component (b) comprises at least one active ingredient compound selected from (b15) herbicide safeners.

15. The herbicidal mixture of claim 14 wherein component (b) comprises at least one active ingredient compound selected from mefenpyr-diethyl and cloquintocet-mexyl.

16. A herbicidal composition comprising a compound of claim 1 and at least one component selected from the group consisting of surfactants, solid diluents and liquid diluents.

17. A herbicidal composition comprising a compound of claim 1, at least one additional active ingredient compound selected from the group consisting of other herbicides and herbicide safeners, and at least one component selected from the group consisting of surfactants, solid diluents and liquid diluents.

18. A method for controlling the growth of undesired vegetation comprising contacting the vegetation or its environment with a herbicidally effective amount of a compound of claim 1.
